(19) United States
(12) Patent Application Publication
(10) Pub. No.: US 2018/0268341 A1
(43) Pub. Date: Sep. 20, 2018

(54) METHODS, SYSTEMS AND NETWORKS FOR AUTOMATED ASSESSMENT, DEVELOPMENT, AND MANAGEMENT OF THE SELLING INTELLIGENCE AND SALES PERFORMANCE OF INDIVIDUALS COMPETING IN A FIELD

(71) Applicant: Selleration, Inc., New York, NY (US)

(72) Inventors: Nick Anthony Rini, Manhattan, NY (US); Joeseph Robert Flaherty, Jackson Heights, NY (US); Michael W. Bealmear, Alamo, CA (US)

(73) Assignee: Selleration, Inc., New York, NY (US)

(21) Appl. No.: 15/461,390

(22) Filed: Mar. 16, 2017

(51) Int. Cl. G06Q 10/06

(52) U.S. Cl. CPC G06Q 10/06398

(57) ABSTRACT

Methods, systems and networks for assessment, development, and management of the selling intelligence and sales performance of individuals among a population of individuals competing in a field. The systems and networks support (i) 3D avatar-based virtual reality (VR) gaming environments supporting conservations and simulations that challenge and assess sales people and develop their sales skills, (ii) automated scoreboards showing the standing among assessed individuals competing on a team, within a company or industry, and (iii) automated coaching and performance feedback with dashboards and reporting tools to help sales managers/leaders develop the selling intelligence of sales representatives and increase their sales productivity. The systems, networks and automated methods support numerous applications including: screening and hiring; determining likelihood of success during on-boarding; developing selling intelligence through personalized training/reinforcement; improving selling intelligence to accelerate time to quota; offering sales leaders coaching insights during sales training management and team development.

### BACKGROUND OF INVENTION

### Field of Invention

The present invention relates to methods of and apparatus for assessing, developing and managing the human intelligence of individuals within a population of individuals competing in a field to support their successful performance within society.

### Brief Description of the State of Knowledge in the Art

Over 1 trillion dollars are spent annually on sales forces. Everybody wants to hire the best sales representatives; expedite time to quota; improve and fine tune their sales force; and sell.

All companies seeking to sell products and/or services face essentially the same challenges in the marketplace: the average cost to hire a sales representative is over $115K; the average tenure of a sales representative is approximately 2 years; 47% of companies say it takes 10+ months for sales representative to become productive; the average percentage of sales representatives making quota is only less than 37%; most sales leaders are faced with managing after a salesperson is already failing; only 11% of reprentatives adopt a new skill with training alone; about 87% of sales representatives adopt a new skill with training, demo, practice and coaching; continuous training provides 50% higher net sales per representative; the ability to manage emotions has a direct link to sales outcomes; it takes approximately 2 years to know whether or not a sales representative is successful; and bad hires present real problems for all sales organizations.

In general, sales leaders make hiring decisions, set sales quotas for the new sales representatives, invest heavily in training and acclimating, make introductions to valuable customers, observe strengths and skill gaps, remediate where possible, observe a while longer, and then make a decision as to whether to retain the salesperson. This process takes an average of 2 years for each salesperson. The time, expense, productivity, and opportunity lost if a sales representative is not retained, is significant to every company. Meanwhile, there is a great amount of time and expense required to hire new candidates. Therefore, companies would welcome better ways to identify best of breed candidates, address and rehabilitate underperforming sales representatives, and avoid employment termination.

Ideally, sales leaders would establish a profile based on key attributes of top performers on their sales teams. This would provide sales leaders with a baseline, against which new-hire candidates and existing sales team members can be measured and compared, for the purpose of ensuring the sales team is made up of salespeople who are likely to succeed.

### Conventional Sales Skill Assessment and Training Programs

For decades, companies have demanded better techniques and programs to more effectively assess and train their sales forces. One program developed over the past two decades is called the ACTION SELLING™ Program by The Sales Board, Inc. based in Minneapolis, Minn. The ActionSelling™ Program seeks to help sales people learn proven skills, and apply them to their selling situations and measure their effectiveness, and relies on printed books for sales training and education. The Action Selling Sales Process supports a web-based LearningLink™ Sales Skills Assessment tool, where representatives and candidates complete the online Action Selling Skills Assessment, and immediately upon completion, learning reports are provided to both the student and manager. These reports document and measure each student's learning progress on 5 critical sales skills assessed by the LearningLink Sales Skills Assessment tool: (i) buyer/seller relationship skills; (ii) sales call planning skills; (iii) sales questioning skills; (iv) sales presentation skills; and (v) gaining commitment skills. As disclosed, the LearningLink™ Sales Skills Assessment tool diagnoses selling problems and measures sales skill level. The Results from LearningLink are compared to the student's initial Benchmark Sales Skills Assessment, as well as results in the Action Selling Universe database. Students are evaluated based on both the knowledge gained since training began, as well as their ability to apply the knowledge in the field. Specific training recommendations are made for each student based on their performance on each skill. They are assigned up to 10 additional exercises to complete based on their prescribed learning needs. Completion of these exercises will prepare students for the Final Certification on Action Selling.

### A Need for a Comprehensive Approach to Managing and Improving Sales Performance

The airline industry has been using flight simulators for decades to evaluate the flying judgment of pilots. The flight simulator serves as a powerful way to learn and record how a pilot prioritizes, reacts to, and resolves real-world situations occurring in a simulated flight without putting passengers, crew, and those on the ground at risk. After completion of the task, the simulator produces volumes of data on the pilot's performance under simulated conditions. Pilots return to the simulator to develop a level of mastery that reduces risk for passengers, bystanders, and airlines.

Much like pilots, sales professionals must also make quick decisions in stressful and unpredictable sales situations that test and challenge their various skills and judgment. Historically, sales organizations have had little or no visibility into the crucial aspects of a salesperson's performance and have only been able to measure success by the degree to which salespeople attained quota—which generally takes place after a minimum of one year on the job, and in most cases two years.

In August 2015, Applicant, Selleration, Inc. introduced a revolutionary new tool for sales management supporting the assessment and development of the selling skills of salespeople. This tool was specifically created for sales management to provide insight into the selling capacity of particular individuals and addressing many unsolved problems in sales force hiring, assessment, training and management. Instead of having salespeople read binders, watch videos, or engage in role plays with co-workers, Selleration developed, and delivered to the market, an Internet-based system branded under the servicemark UPtick™. The UPtick™ system functioned like a flight simulator for salespeople, putting them in a highly-competitive game-based simulation environment where salespeople “learn by doing” without suffering the actual risks of the real world presented by physical, economic and financial reality.

Selleration's original version of the UPtick™ selling simulation system introduced VR and game-based technologies to provide companies with an Internet-based selling simulator that provided improved ways of assessing the selling capabilities of salespeople for the purpose of increasing sales, and helping to predict a salesperson's success.

The Selleration's UPtick™ selling simulation system supported two distinct modalities: (1) traditional assessments for measuring cognitive, behavioral and sales skills of sales representatives; and (2) 3D Avatar-based sales simulations, supported by the Unity® game engine, that put sales representatives in real-world simulated sales conversations, and required them to make decisions at certain points during the conversation.

The original UPtick™ selling simulation system also supported detailed scenarios to build, develop, enhance, reinforce and remediate selling judgment skills, and improve the salesperson's knowledge and understanding of the supply chain, category management, shopper marketing and trade fund management. Using the UPtick™ system, sales professionals develop sales skills when they prospect new accounts, perform a needs assessment, present a product or service, uncover and respond to objections, negotiate contract terms, and close sale. During operation, the UPtick™ selling simulation system puts sales representatives “face to face” with avatar-based customers, within a private, safe, risk-free learning environment where salespeople direct the conversation and improve their ability to sell. Sales professionals learn by observing and applying behavior, as well as from making mistakes within the UPtick's role-play learning environment. Within the confines of the automated role-play environments, sales representatives used the original UPtick™ system to learn how to: (i) reroute sales conversations heading in the wrong direction; (ii) understand and respond to a customer's needs; and (iii) build rapport and become a ‘trusted advisor’ to the customer.

While the original UPtick™ selling simulation system provided sales professionals with real-world practice in leveraging sales knowledge, and understanding the real value of resources to their organization and perceived value to their customers, the original UPtick™ system suffered from numerous shortcomings and drawbacks.

In particular, Selleration's earlier UPtick™ selling simulation system was capable of capturing assessment data on numerous selling behaviors and skills, using multiple-choice question-based and conversation-based assessments. However, the UPtick™ system lacked the capacity to analyze and understand collected assessment data on sales representatives, and develop conclusions based on that data, in significantly meaningful terms. Consequently, Selleration's original UPtick™ system was incapable of (i) supporting scientific predictions as to a particular sale representative's likelihood of success, or (ii) making reliable prescriptions as to what training is actually required to reinforce current selling skills, and further develop new selling skills.

Certain skill categories assessed by the earlier UPtick™ system were loosely organized under the concept of “selling competency”, while other selling skills were organized under the concept of “selling judgement”. Also, early attempts at understanding notions of selling competency, selling judgment, and selling intelligence, were not as successful as required for the many predictive applications at hand. For example, David's Stein's Aug. 27, 2015 interview entitled “Selleration on Selling Intelligence” reveals that Selleration's understanding of Selling Intelligence (SI) has been continuously evolving, and great efforts have been made to better understand the qualitative and quantitative characteristics of skill scores supporting the human capacity of any individual, referred to as “selling intelligence (SI)” and marketed by Selleration as “the Selling DNA makeup of a salesperson”.

Further, any metrics produced using earlier versions of the UPtick™ system did not follow standardized approaches to measuring an Intelligence Quotient (IQ) of individual, such as, for example, involving (i) dividing the mental age of the individual, reflecting the age-graded level of performance derived from population norms, by the individual's chronological age, and (iii) multiplying the resulting quotient by 100, so that an IQ score of 100 indicates a performance at exactly the normal level for that age group.

While great efforts have been made at developing 3D Avatar-based game-simulations that put sales representatives in real world simulated sales conversations, there has still remained a great need for new and improved methods of and apparatus for more reliably assessing and measuring the cognitive, behavioral and sales skills of sales representatives, in ways that (i) lead to greater insight and improvements in predicting future success, (ii) assist in guiding the training of sales representatives, to accelerate selling skill development, and actual improvements in sales performance across any industry.

Clearly, there is a need to transcend all previous metaphors and notions of Selling Intelligence, and develop a deeper, more objective understanding capable of supporting new and improved ways of quantitatively assessing and measuring this highly complex, multi-dimensional characteristic and capacity of any sales person, for corroboration against actual sales performance in a scientifically reliable manner.

Therefore, there is a great need for new and improved methods of and systems for assessing, developing and managing the selling competency and judgment skills, selling intelligence, and sales performance of individuals working in a field or industry, while avoiding the shortcomings and drawbacks of prior art systems, networks, devices and methodologies.

### OBJECTS AND SUMMARY OF THE PRESENT INVENTION

Accordingly, it is a primary object of the present invention to provide a new and improved methods of and apparatus for assessing, developing and managing the selling intelligence (SI) and sales performance (SP) of sales people in diverse end-user environments, while avoiding the shortcomings and drawbacks of prior art devices and methodologies.

Another object of the present invention is to provide a new and improved method of and system for measuring the selling intelligence of individual sales representatives, based on measured behavior assessments of the selling competency skills and selling judgment skills of the sales representatives, across diverse selling skill categories.

Another object of the present invention is to provide a new and improved method of and system for analyzing, developing, and managing selling intelligence measurements made on sales representatives within sales organizations and/or industries.

Another object of the present invention is to provide a new and improved system for and method of rationally assessing, measuring and developing the selling intelligence of salespeople, with predictive success and reliably.

Another object of the present invention is to provide a new and improved method of and system for evaluating and screening new sales representative candidates during the hiring process, and predicting the performance of those candidates having selling intelligence measurements exceeding team or industry benchmarks.

Another object of the present invention is to provide a new and improved method of and system for predicting the sales success of individual sales representatives based on measured selling intelligence and sales performance metrics.

Another object of the present invention is to provide a new and improved method of and system for determining the likelihood of success of sales representatives within a sales organization using selling intelligence measurements.

Another object of the present invention is to provide a new and improved method of and system for forecasting the sales performance of individual sales representatives based on selling intelligence measurements thereof.

Another object of the present invention is to provide a new and improved method of and system for developing the selling intelligence of individual sales representatives using personalized training plans employing gaming and virtual reality processes.

Another object of the present invention is to provide a new and improved method of and system for training of sales representatives using personalized training plans employing gaming and virtual reality processes.

Another object of the present invention is to provide a new and improved method of and system for supporting conversations with sales representatives to help improve and promote their selling behaviors including work ethic, confidence, assertiveness, and achievement drive and goal orientation.

Another object of the present invention is to provide a new and improved method of and system for simulating sales training processes designed for individual sales representatives.

Another object of the present invention is to provide a new and improved method of and system for generating action plans and simulations designed to develop the selling intelligence of particular sales representatives.

Another object of the present invention is to provide a new and improved decision support method of and system for hiring, promoting and terminating sales representatives using selling intelligence measurements, alone or in combination with sales performance data.

Another object of the present invention is to provide a new and improved human resources management system employing selling intelligence measurement, development and analytics modules during the employee management process.

Another object of the present invention is to provide a new and improved method of and system for measuring, collecting, publishing and distributing selling intelligence data across industries.

Another object of the present invention is to provide a new and improved method of and system for assessing the selling intelligence and sales performance of sales teams and establishing performance benchmarks for them.

Another object of the present invention is to provide a new and improved method of and system for generating and publishing sales performance ratings based on selling intelligence measurements, for the purpose of certifying sales representatives in a sales industry.

Another object of the present invention is to provide a new and improved method of and system for generating and publishing competitive performance metrics based on selling intelligence measurements for use in determining how ones sales team compares with other competitor sales teams in a particular industry.

Another object of the present invention is to provide a new and improved system for measuring and analyzing selling intelligence of a sales representative and predicting the likelihood of sales success thereof.

Another object of the present invention is to provide a new and improved Internet-based selling intelligence assessment, development and management system which immerses salespeople in real-world selling situations and experiences using automated, scalable, 3D simulations with virtual customers, without presenting any risk to a company's brand, sales representatives being tested, or their customers.

Another object of the present invention is to provide a new and improved selling intelligence assessment, development and management system capable of (i) collecting and processing volumes of data on a salesperson's experiences using diverse client systems, and (ii) generating selling intelligence (SI) measures and reports that provide executive sales leadership with the ability to more accurately understand the selling competencies and judgement of their team members.

Another object of the present invention is to provide a new and improved selling intelligence assessment, development and management system enabling sales leaders to create a profile on each salesperson, (i) providing insight into who has an effective set of skills to be successful at selling products and/or services, (ii) reducing the time to sales competency for those new to sales, and (iii) reinforcing fundamentals for those having more experience.

Another object of the present invention is to provide a new and improved selling intelligence assessment, development and management system that automatically provides management with the capacity to deliver coaching cues and prescriptions to sales representatives, tailored to solve the salesperson's problem areas.

Another object of the present invention is to provide a new and improved selling intelligence assessment, development and management system which is immersive and experiential to empower salespeople to practice in a safe, private, non-threatening simulated selling environment.

Another object of the present invention is to provide a new and improved selling intelligence assessment, development and management system for use by sales managers, sales trainers, and executive sales management, all throughout the lifecycle of the sales process.

Another object of the present invention is to provide a new and improved selling intelligence assessment, development and management system which supports (i) automated and scalable role plays, (ii) complex processes that predict the likelihood of sales success, and (iii) produce various selling performance improvement strategies for execution.

Another object of the present invention is to provide a new and improved selling intelligence assessment, measurement, development and management system, which allows any size company to address their complex recruitment challenges.

Another object of the present invention is to provide a new and improved selling intelligence measurement, development and management system that (i) accesses critical attributes of sales representatives as well as entire sales groups (i.e. teams), (ii) measures both selling competency skills and selling judgment skills, and (iii) processes assessed selling judgment and selling judgment measures to compute a selling intelligence quotient (SIQ) of each individual team member, for comparison against actual sales performance metrics of each salesperson.

Another object of the present invention is to provide a new and improved selling intelligence assessment, development and management system where sales leaders are able to assess sales skills of new hires and sales representatives, and identify where changes and reinforcements need to be made in such new hires and sales representatives.

Another object of the present invention is to provide a new and improved selling intelligence assessment, development and management system for providing automated role-play in 3-D virtual comprehensive sales performance environment, with integrated psychometric assessment tools that assess selling skills essential for measuring the selling intelligence quotient (SIQ) of individual sales representatives, ranked against other sale people competing in the industry.

Another object of the present invention is to provide a new and improved selling intelligence assessment, development and management system that has the capacity to measure emotions of sales representative, which are known to be a direct link to sales outcomes.

Another object of the present invention is to provide a new and improved selling intelligence assessment, development and management system that system is designed to expose new hires and sales representatives with customer-facing responsibilities, so as to assess certain behaviors and skills for the purpose of measuring sales intelligence.

Another object of the present invention is to provide a new and improved selling intelligence assessment, development and management system that functions as a sales growth stimulator by increasing the intelligence of sales representatives to sell products and services.

Another object of the present invention is to provide a new and improved selling intelligence assessment, development and management system that provides hiring executives with selling-intelligence-based performance attributes of the candidates which provides sales leadership with more confidence.

Another object of the present invention is to provide a new and improved selling intelligence assessment, development and management system that can be used as a pre-hire assessment tool, allowing sales leaders to establish a hiring profile based on the system results of the top performers on the sales team, thereby providing not just a profile of what it takes to be successful in sales.

Another object of the present invention is to provide a new and improved selling intelligence assessment, development and management system allowing sales leaders to make selling competency, selling judgment and selling intelligence measurements of individual sales representatives as a benchmark for comparison against potential hires (i.e. candidates) and determining which potential hires are a “right fit” for the organization, before they are hired.

Another object of the present invention is to provide a new and improved selling intelligence assessment, development and management system which uses VR-based simulations and game-based simulations to automatically assess the selling competency and selling judgment skills of sales representatives and new hires, and measure the selling intelligence of such assessed sales representatives and new hires.

Another object of the present invention is to provide a new and improved selling intelligence assessment, development and management system which collects data on key attributes relating to cognitive and sales-related skills for use in measuring the selling intelligence quotient of a sales representative in field or industry.

Another object of the present invention is to provide a new and improved selling intelligence assessment, development and management system supporting (i) a 3D avatar-based virtual reality (VR) gaming environment supporting simulations that challenge sales people and develop their sales skills, (ii) an automated scoreboard displaying selling intelligence quotient (SIQ) measured by the system and showing ones competitive standing among assessed sales representatives on a team, within a company or industry, as well as (iii) automated coaching/performance feedback and a dashboard and reporting tools to sales managers/leaders, designed to help them develop the selling intelligence of sales representatives and increase their sales productivity

Another object of the present invention is to provide a new and improved selling intelligence assessment, development and management system for automatically assessing entire sale representative teams, validating suspicions and providing insights into known team concerns, establishing performance benchmarks, and predicting representatives whose selling intelligence exceeded team benchmarks.

Another object of the present invention is to provide a new and improved selling intelligence assessment, development and management system that measures the selling intelligence quotient (SIQ) of individuals, and supports numerous applications including, for example: screening and hiring; determining likelihood of success during on-boarding; improving selling intelligence via personalized training/reinforcement plan; using selling intelligence to accelerate time to quota, during performance improvement; offering sales leaders coaching insights during sales training management; and providing decision support during termination.

Another object of the present invention is to provide a new and improved selling intelligence assessment, development and management system that measures the selling intelligence of sales representatives in diverse vertical markets such as, for example, consumer product goods, technology, financial services, advertising and marketing, engineering, medical, legal, etc.

Another object of the present invention is to provide a new and improved method of assessing the selling intelligence of sales representatives, and transforming the landscape of the sales industry.

Another object of the present invention is to provide a new and improved selling intelligence assessment, development and management system that delivers a suite of services for the entire sales lifecycle, including measuring and developing selling competency and judgement skills of individual sales representatives using game-based and VR-based simulations so as to measure and enhance the selling intelligence thereof.

Another object of the present invention is to provide a new and improved selling intelligence assessment, development and management system scalable big data collection and data science platform, supporting AI-based data processing routines for processing global anonymized data sets to generate reliable measures of selling intelligence (SI).

Another object of the present invention is to provide a new and improved selling intelligence assessment, development and management system that assesses and measures the selling judgment skills of a sales representative (i.e. how the representative applies his sales competency in selling situations that reps encounter on a daily basis) as an integral factor in determining the likelihood of sales success.

Another object of the present invention is to provide a new and improved method of measuring selling intelligence by immersing sales representatives in a simulated sales scenario with a 3D avatar customer, with many possible paths due to many possible combinations of action, where the sales representative must make decisions that ultimately lead to an outcome.

Another object of the present invention is to provide a new and improved selling intelligence assessment, development and management system configured to automatically (i) process and analyze collected behavioral assessment data relating to the selling competency and selling judgment of any sales representative, (ii) generate a selling intelligence measure for the assessed sales representative, and (iii) generate a custom-personalized development plan in the form of a selling-intelligence (SI) based training course program, designed to aid in the development and improvement of the selling intelligence of the sales representative.

Another object of the present invention is to provide a new and improved method of improving selling intelligence, wherein conversations are supported to help sales representatives improve various selling behaviors such as, work ethic, confidence, assertiveness, and achievement drive/goal orientation.

Another object of the present invention is to provide a new and improved selling intelligence assessment, development and management system supporting the analysis, comparison and reporting of selling intelligence and sales performance of sales representatives, for use by (i) chief-executive officers (CEOs) analyzing companies on a whole, (ii) managers analyzing users and teams to create training plans, and (iii) human-resource officers analyzing users to make hiring decisions.

Another object of the present invention is to provide a new and improved selling intelligence assessment, development and management system supporting automated analysis, comparison and reporting of the selling intelligence and sales performance of sales representatives.

Another object of the present invention is to provide a new and improved method of and system for assessing the selling intelligence (SI) of individual sales representatives or sales representative candidates comprising the steps of: (a) using a selling intelligence (SI) assessment, development and management system to assess the selling intelligence of an individual sales representative by (i) administering selling competency and judgement skill assessments designed to assess particular selling competency skill categories and particular selling judgement skill categories, (ii) collecting data results from such selling competency and judgement skill category assessments, and (iii) storing the collected assessment data results in a system database; (b) using the system to automatically (i) process collected assessment data, (ii) generate a selling competency category score for each selling competency skill category, (iv) generate a selling judgement category score for each selling judgement skill category, and (iv) store these skill category scores in the system database for the individual sale representative; and (c) using the system to automatically (i) process the selling competency skill category scores and the selling judgment skill category scores stored in the system database for the assessed sales representative, so as to determine the selling intelligence (SI) of the sales representative based on such selling skill category score factors, and then (ii) store the selling intelligence measurement in the system database.

Another object of the present invention is to provide a new and improved method of and system for assessing and measuring selling intelligence of an individual sales representative or candidate for use in supporting sales personnel hiring, development, management and termination processes, comprising the steps of: (a) using a selling intelligence (SI) assessment, development and management system to assess the selling intelligence of an individual sales representative for hire in an organization by (i) administering selling competency and judgement skill assessments designed to assess the sales representative in particular selling competency skill categories and in particular selling judgement skill categories, (ii) collecting data results from such selling competency and judgement skill category assessments, and (iii) storing the collected assessment data results in a system database of the system; (b) using the system to automatically (i) process collected assessment data, (ii) generate a selling competency category score for each selling competency category, and a selling judgement category score for each selling judgement category, and (iii) store these selling skill scores in the system database; (c) using the system to automatically (i) process the selling competency skill category scores and the selling judgment skill category scores for the assessed sales representative, (ii) determine the selling intelligence (SI) of the sales representative based on such selling skill category score factors, and (iii) store the selling intelligence measurement of the sales representative in the system database; (d) using the system to automatically (i) analyze the selling skill category score data and selling intelligence data relating to the sales representative candidate stored in the system database, (ii) determine the rank of the sales representative candidate as a potential employee for hire by the organization, and (iii) generate a user report containing selling skill score data and selling intelligence data on the sales representative candidate, along with the determined rank within the organization; (e) using the system and the selling intelligence measurement of the sales representative, to automatically generate a first selling intelligence development training course, through which the hired sales representative should be passed to improve his/her current selling intelligence, if hired by the organization; and (f) using the user report, and the first selling intelligence development training course, in support of any decision to hire the sales representative candidate within the organization.

Another object of the present invention is to provide a new and improved method of and system for assessing, developing, analyzing and managing sales intelligence of sales representatives, comprising the steps of (a) using a selling intelligence (SI) assessment, development and management system to (i) assess, at a first moment in time, the selling intelligence of a sales representative who is a candidate for hire by an organization at a first moment in time, (ii) produce selling skill competency and judgement skill category scores for the assessed sales representatives, (iii) process the selling skill competency and judgment category stores so as to factor a selling intelligence measurement, and (iv) store the selling skill scores and selling intelligence measurement in a system database of the system, (b) using the system to automatically generate a first prescribed selling intelligence training course based on the assessment made at the first moment in time, and administering the first prescribed selling intelligence training course at a second moment in time, (c) using the system to assess the selling intelligence of the sales representative at a third moment in time, after completing the first prescribed selling intelligence training course, and generating a second prescribed selling intelligence training course based on the assessment made at the third moment in time, (d) at a fourth moment in time, using the system to administer the second prescribed selling intelligence training course after the third moment in time, and (e) at a fifth moment in time, using the system to assess the selling intelligence of the sales representative after the third moment in time.

Another object of the present invention is to provide a new and improved method of and system for assessing sales representative candidates during hiring process, and generating user reports predicting sales performance using organization benchmarks based on selling intelligence assessments, comprising the steps of: (a) using a selling intelligence (SI) assessment, development and management system to (i) assess the selling intelligence of a sales representative who is a candidate for hire by an organization, (ii) produce selling competency and judgement skill category scores for the assessed sales representatives, (iii) process the selling skill competency and judgment skill category stores so as to factor a selling intelligence measurement for the sales representative, and (iv) store the selling skill category score data and selling intelligence data in a system database of the system containing selling skill category score data and selling intelligence data associated with other assessed sales representatives working within the organization; (b) using the system to automatically (i) analyze selling skill category scores and selling intelligence data within the system database, and (ii) determine selling intelligence benchmarks in the organization, based on selling intelligence assessments of sales representatives within the organization; (c) using the system and the selling intelligence benchmarks to automatically compare the skill category scores and selling intelligence factored for the sales representative candidate, against the selling intelligence benchmarks, to generate a user report with selling intelligence metrics predicting the sales representative candidate's likelihood of success in sales within the organization; and (d) using the system and the user report to support the hiring decision process for the sales representative candidate within the organization.

Another object of the present invention is to provide a new and improved method of and system for predicting sale performance success of a sales representative candidate in an organization based on automated selling intelligence data analysis, comprising the steps of: (a) using a selling intelligence (SI) assessment, development and management system to (i) assess the selling intelligence of a sales representative who is a candidate for hire by an organization, (ii) produce selling skill competency and judgement skill category scores for the assessed sales representatives, (iii) process the selling skill competency and judgment skill category stores so as to factor a selling intelligence measurement, and (iv) store the selling skill category score data and selling intelligence data in a system database containing selling skill category score data and selling intelligence data associated with other assessed sales representatives within the organization; (b) using the system to automatically (i) import sales performance data of the sales representative candidate, from a CRM or other external system, for storage in the system database; (c) using the system to automatically (i) analyze selling skill category score data, selling intelligence data, and sales performance data within the system database, and (ii) determine organization benchmarks relating to selling skill category scores, selling intelligence measurements, and/or sales performance data; (d) using the system and the organization benchmarks to automatically (i) compare skill category scores and factored selling intelligence measurement for the sales representative candidate, against the organization benchmarks, and (ii) generate a metric measuring how closely the assessed sales representative candidate meets or matches the requirements established by the organization benchmarks; and (e) using the system and the generated metric, to automatically predict the likelihood that the sales representative candidate will achieve sales performance goals set within the organization.

Another object of the present invention is to provide a new and improved method of and system for predicting the sales performance of individual sales representatives based on administering a series of selling intelligence assessments, comprising the steps of: (a) using a selling intelligence (SI) assessment, development and management system to automatically (i) assess, at a first moment in time, the selling competency and judgment skills and selling intelligence of a sales representative for hire by an organization, (ii) generate selling competency and judgement skill category scores and factored selling intelligence measurement, and (iii) store the selling competency and judgment skill category scores and the factored selling intelligence data in a system database; (b) using the system to assess, at second moment in time, to automatically (i) assess the selling competency and judgement skills and selling intelligence of the sales representative, and (ii) store the selling skill category scores and selling intelligence data in the system database; (c) using the SI system to (i) assess, at third moment in time, the selling skills and intelligence of the sales representative, and (ii) store the selling skill category scores and selling intelligence data in the system database; (d) using the system to automatically (i) analyze the time series of selling skill and intelligence assessments of the sales representative, taken over the first, second and third moments in time, and (ii) store the selling skill category score data and selling intelligence data; and (e) using the system to automatically predict the sales performance of the sales representative based on the analyzed time series of selling skill category scores and selling intelligence data taken over the first, second and third moments in time.

Another object of the present invention is to provide a new and improved method of and system for developing the selling intelligence of individual sales representatives using automatically-prescribed training courses guided by selling intelligence assessment, comprising the steps of (a) using a selling intelligence (SI) assessment, development and management system to (i) assess the selling competency skills, selling judgement skills and selling intelligence of a sales representative who is a candidate for hire by an organization at a first moment in time, (ii) generate selling competency skill categories scores, selling judgement skill category scores and selling intelligence, and (iii) store this selling skill score and intelligence data in a system database of the system, (b) using the system to automatically (i) analyze selling skill score and intelligence data in the system database, (ii) generate a first prescribed training course for the sales representative candidate, and (iii) administer the first prescribed training course at a second moment in time, (c) at a third moment in time, using the system to (i) assess the selling competency, selling judgement and selling intelligence of the sale representative, (ii) generate selling competency skill categories scores, selling judgement skill category scores and selling intelligence, and (iii) store this selling skill score and intelligence data in a system database of the system, and (d) using the system to automatically (i) analyze selling skill score and intelligence data in the system database, (ii) generate a second prescribed training course for the sales representative candidate, and (iii) administer the second prescribed training course at a third moment in time.

Another object of the present invention is to provide a new and improved method of and system for progressively developing the selling intelligence of individual sales representatives using a series of automatically-prescribed selling intelligence training courses, comprising the steps: (a) using a selling intelligence (SI) assessment, development and management system to (i) assess a sales representative at a first moment in time, and (ii) generate and store a first set of selling competency skill category scores, selling judgement skill category scores, and a factored selling intelligence measurement for the sales representative, within a system database; (b) using the system to automatically generate a first prescribed selling intelligence training course for the sales representative, based on the first set of selling skill category scores and selling intelligence data; (c) using the system to (i) assess the sales representative at a third moment in time, and (ii) generate and store a second set of selling competency skill category scores, selling judgement skill category scores, and a factored selling intelligence measurement for the sales representative, within the system database; (d) using the system to (i) assess the sales representative at a third moment in time, and (ii) generate and store a second set of selling competency skill category scores, selling judgement skill category scores, and a factored selling intelligence measurement for the sales representative, within the system database; and (e) using the system to generate, at a fourth moment in time, a second prescribed selling intelligence training course for the sales representative, based on the second set of selling skill category scores and selling intelligence data, and administer the second prescribed selling intelligence training course so as to further develop the selling intelligence of the sales representative.

Another object of the present invention is to provide a new and improved method of and system for developing selling judgement skills using machine-based selling intelligence assessment, and automated-generation of selling intelligence training courses and metric-based user reports, comprising the steps of: (a) using a selling intelligence (SI) assessment, development and management system to (i) assess, at first moment in time, a sales representative working in an organization in a specific industry, and (ii) generate and store a first set of selling competency skill category scores, selling judgement skill category scores, and a factored selling intelligence measure for the sales representative, within a system database; (b) using the system to automatically generate a first prescribed selling intelligence training course for the sales representative, based on the first set of selling skill category scores and selling intelligence data; (c) at a second moment in time, using the system to administer the first prescribed selling intelligence training course so as to develop the selling intelligence of the sales representative; (d) using the system to (i) assess the sales representative at a third moment in time, and (ii) generate and store a second set of selling competency skill category scores, selling judgement skill category scores, and a factored selling intelligence measure for the sales representative, within the system database; and (e) using the system to automatically analyze the second set of selling competency skill category scores, selling judgement skill category scores and selling intelligence measure against others in the organization, and generate a user report with metrics indicating how certain selling judgment skills in the sales representative have improved in response to the administration of the first prescribed selling intelligence training course.

Another object of the present invention is to provide a new and improved method of and system for generating prescriptive training courses designed to develop the selling intelligence of particular sales representatives, comprising the steps of: (a) using a selling intelligence (SI) assessment, development and management system to make a first assessment of a sales representative at a first moment in time, and produce and store a first set of selling competency skill category scores, selling judgement skill category scores, and a selling intelligence measurement, within a system database; (b) using the system to automatically (i) analyze the first set of selling competency skill category scores, selling judgement skill category scores and selling intelligence measurement, and (ii) generate a prescribed selling intelligence training course to develop the selling intelligence of the sales representative; (c) at a second moment in time, using the system to develop the selling intelligence of the sales representative by administering the first prescribed selling intelligence training course to the sales representative; (d) at a third moment in time, using the system to (i) make a second assessment of the selling intelligence of the sales representative, and (ii) generate and store a second set of selling competency skill category scores, selling judgement skill category scores, and selling intelligence measurement, within the system database; and (e) using the system to automatically analyze the second set of selling competency skill category scores, selling judgement skill category scores and selling intelligence measurement, so as to determine that the selling intelligence of the sales representative has been developed.

Another object of the present invention is to provide a new and improved method of and system for generating selling intelligence training courses for use in supporting the hiring and termination decisions of sales representative, comprising the steps of: (a) using a selling intelligence (SI) assessment, development and management system to automatically (i) assess the selling competency and judgement skills and selling intelligence of a sales representative candidate being considered for hire by an organization in particular industry, and (ii) generate and store selling skill category scores and factored selling intelligence measurement of the sales representative, within a system database; (b) using the SI system to generate a report the assessed selling skill category scores and selling intelligence of the sales representative candidate, against the measured selling intelligence of a group of sales representatives in the particular industry; (c) based on a comparison of measured selling intelligence of the sales representative, against the group of sales representatives in the industry, hiring the sales representative with the expectation the sales representative will reach a specific sales quota at the end of a specified sales assessment period; (d) using the system to automatically (i) analyze the skill category scores and selling intelligence measures and (ii) generate a first selling intelligence (SI) training course for the sales representative, and then (iii) administer the first training course to the sales representative; and (e) if the sales representative does not achieve the specific sales quota within the specified sales quota period, then either (i) terminate the employment of the sales representative, or (ii) reassess the sales representative's selling skills and intelligence, and then use the system to automatically regenerate a second selling intelligence training course, based on the reassessment data, and designed to develop the selling intelligence of the sales representative.

Another object of the present invention is to provide a new and improved method of and system for generating reports containing internally-generated selling intelligence data, externally-generated performance data, and management alignment metrics, comprising the steps of: (a) using a selling intelligence (SI) assessment, development and management system to (i) assess the selling intelligence of each sales representative considered for hire by an organization, and (ii) internally generate and store system data including, but not limited to, selling competency skill category scores, selling judgment skill category scores, and selling intelligence measurements of assessed sales representatives, within a system database; (b) collecting subjective data from manager surveys and providing this manager data to the system, to provide subjective data on the selling competency skill categories and selling judgement skill categories of the sales representative; (c) collecting objective data from externally-generated sources and providing this objective data to the system, to provide objective data on the user profile and selling performance of the sales representatives; (d) using the system to compare system data and the objective data together for display and comparison and review by managers; (e) using the system to automatically (i) compare system data and subjective data, and (ii) generate management alignment metrics (MAMS) for display, indicating how closely management's view of a sales representative matches empirically-measured selling intelligence and sales performance based on objective data; and (f) using the system to automatically (i) generate a report containing system data, subjective data, and objective data, along with management alignment metrics (MAMS).

Another object of the present invention is to provide a new and improved method of and system for method of automatically-generating scoreboards and achievements for sales representatives competing against other sales representatives in a sales organization, comprising the steps of: (a) using a selling intelligence (SI) assessment, development and management system to (i) assess the selling intelligence of one or more sales representatives competing in a sales group, organization or industry, and (ii) generate and store, the selling competency skill category scores, the selling judgment skill category scores, and selling intelligence measurements of each assessed sales representative, within a system database; (b) in response to a system user (i.e. sales representative) logging into the system and taking a selling intelligence assessment, using the system to automatically (i) analyze the selling competency skill category scores, the selling judgment skill category scores, and selling intelligence measurement of the assessed sales representative, and (ii) generate and display a scoreboard listing the selling intelligence, total selling competency skill score, or total selling judgement score, of all competing sales representatives, according to stored assessment data; (c) using the system to automatically (i) analyze the selling competency skill category scores, selling judgment skill category scores, and selling intelligence measurements of each assessed sales representative, and (ii) if a predetermined total score of a sales representative exceeds a predetermined threshold, then issue an achievement in the form of a badge (i.e. achievement) issued to the sales representative, and display the issued badge on the competition scoreboard; and (d) using the system to automatically (i) analyze the system database, and (ii) if the selling intelligence of any of the sales representatives in competition changes, then changing position of the sales representatives on the competition scoreboard, based on selling intelligence measurement.

Another object of the present invention is to provide a new and improved method of and system for generating prescriptions for sales representatives to develop their selling intelligence comprising the steps of: (a) using a selling intelligence (SI) assessment, development and management system to automatically (i) assess the selling intelligence of each sales representative in a sales organization, and (ii) internally generate and store, selling competency skill category scores, selling judgment skill category scores, and factored selling intelligence measurements based on the assessed sales representatives, within a system database; (b) a system user (i.e. the sales representative) logging into the system; (c) using the system to automatically (i) analyze the selling competency skill category scores, selling judgment skill category scores, and selling intelligence measurements of the logged-in sales representative, and (ii) if one or more of the selling competency skill category scores and/or one or more selling judgement category scores, fail to meet pre-specified thresholds/benchmarks, then automatically generate one or more prescriptions recommending the sales representative to read or learn certain selling skill category related materials stored in a system prescription library; and (d) using the system to automatically (i) send the sales representative the one or more generated prescriptions recommending the assessed sales representative to read and learn certain selling skill category related materials to improve certain selling competency and/or judgement skills, (ii) track the sale representative's access to the prescribed materials, and (iii) generate a user prescription compliance metric indicating how well the sale representative complied with the automated prescription.

Another object of the present invention is to provide a new and improved method of and system for automated method of generating prescriptions for sales leadership to develop the selling intelligence of sales representatives, comprising the steps of: (a) using a selling intelligence (SI) assessment, development and management system to automatically (i) assess the selling intelligence of each sales representative considered for hire by an organization, and (ii) internally generate and store selling competency skill category scores, selling judgment skill category scores, and selling intelligence measurements of assessed sales representatives, within a system database; (b) using the system to automatically import sales performance data from external (e.g. CRM) systems used by the sales representative and sales manager within the sales organization, into the system database; (c) using the system to automatically (i) analyze the log-in history of each sales representative working under a sales manager, and (ii) if a sales representative fails to log into the system sufficiently often, and the sales quota of the sales representative fails to exceed a predetermined sales quota, then automatically generate and send a notification to the corresponding sales manager with a prescription recommending how the sales representative might improve sales performance; and (d) using the system to encourage the sales manager to push the recommended prescription to the sales representative in effort to improve sales performance.

Another object of the present invention is to provide a new and improved method of and system for automatically-generating training courses for sales representatives based on assessed selling intelligence, for the purpose of certifying sales representatives in a sales industry, said method comprising the steps of: (a) using a selling intelligence (SI) assessment, development and management system to automatically (i) assess the selling intelligence of sales representatives considered for hire by an organization, and (ii) internally generate and store, the selling competency skill category scores, the selling judgment skill category scores, and the selling intelligence measurements of assessed sales representatives, within a system database; (b) a sales representative, or the sales manager of the sales representative, interacting with and initiating the system; (c) using the system to automatically (i) analyze the selling competency skill category scores, selling judgment skill category scores, and selling intelligence measurements of the sales representative, and (ii) if one or more of the selling competency skill category scores and/or one or more selling judgement category scores, fail to meet pre-specified thresholds, then automatically create one or more training courses designed to develop certain selling skill categories and the selling intelligence of the sales representative; and (d) using the system to automatically (i) deliver the training courses to the system user/sales representative to develop certain selling skill categories and the selling intelligence of the sales representative.

Another object of the present invention is to provide a new and improved method of and system for generating reports with metrics on the selling intelligence, skill category scores and sales performance of sales representatives working within specific industries, comprising the steps of: (a) using a selling intelligence (SI) assessment, development and management system to assess the selling intelligence (SI) of sales representatives working for a particular sales organization within a specific industry, based on factoring assessed selling competency skill category scores and selling judgement skill category scores, and storing the selling intelligence measurement data in a system database, along with all specified assessments used in assessing the selling intelligence and skills of the assessed sales representatives; (b) importing sales performance data of sales representatives, from CRM and other systems, into the database of the system, linking sales performance data with selling intelligence measurement data, and removing identification data of sales representatives; (c) using the system to automatically organize, within the system database, selling intelligence data, selling skill category scores and sales performance data, according to industry and other criteria; (d) using the system to automatically (i) analyze the selling skill category scores, selling intelligence measurement and sales performance data within the system database, and (ii) determine industry benchmarks for the specific industry; and (e) using the system to automatically (i) generate a report with metrics on the selling intelligence, skill category scores and sales performance of sales representatives working within the specific industry, as measured against industry benchmarks determined for the industry.

Another object of the present invention is to provide a new and improved method of and system for generating reports on the selling intelligence, skills and sales performance of sales teams, against sales team benchmarks, said comprising the steps of: (a) using a selling intelligence (SI) assessment, development and management system to automatically (i) assess the selling intelligence of sales representatives working on a particular sales team in a sales organization, and (ii) generate and store within a system database, selling competency skill category scores, selling judgement skill category scores, and factored selling intelligence measurement data; (b) using the system to periodically update and store the selling skill category scores and selling intelligence measurements of the sales representatives, within the system database; (c) importing sales performance data of sales representatives from CRM and other systems, into the system database, and linking sales performance data with the selling skill category scores and selling intelligence measurement data of corresponding sales representatives; (d) using the system to automatically (i) analyze the selling skill category scores, selling intelligence and sales performance data of sales representatives, and (ii) determine sales team benchmarks for the particular sales team; (e) using the system to automatically (i) generate a report containing the selling skill category scores, selling intelligence measurements and sales performance data of the particular sales team, with metrics measured against the determined benchmarks; and (f) distributing the generated report to sales team leadership/management members, subscribing to selling skill and performance reporting services supported by the system.

Another object of the present invention is to provide a new and improved method of and system for generating certified selling intelligence and skill reports on particular sales representatives working within a specific industry, said method comprising the steps of: (a) using a selling intelligence (SI) assessment, development and management system to automatically (i) assess the selling intelligence (SI) of sales representatives working for a particular sales organization within a specific industry, and (ii) generate and store within a system database, selling competency skill category scores, selling judgement skill category scores, and factored selling intelligence measurement data, along with all assessment data of other sales representatives within the specific industry; (b) using the system to automatically generate and administer one or more prescribed training courses recommended for developing the selling intelligence and skills of assessed sales representatives, based on selling intelligence assessment of the sales representative; (c) using the system to reassess the selling intelligence of sales representatives after administration of the one or more prescribed training courses, and updating selling skill scores and selling intelligence measurements in the system database for the sales representative; (d) using the system to automatically analyze the selling skill category scores and selling intelligence measurements within the system database, and determine selling skill category score and selling intelligence benchmarks for the specific industry; and (e) using system to generate a certified report indicating that a particular assessed sales representative received a specific set selling skill category scores and selling intelligence measurement, against industry benchmarks, and transmitting the certified report to the sales representative or other authorized recipient.

Another object of the present invention is to provide a new and improved method of and system for generating industry-specific selling intelligence, skill and performance reports with metrics comparing competing sales teams within a particular industry, comprising the steps of: (a) using a selling intelligence (SI) assessment, development and management system to automatically (i) assess the selling intelligence of sales representatives working on a particular sales team in a sales organization, and (ii) generate and store within a system database, selling competency skill category scores, selling judgement skill category scores, and factored selling intelligence measurement data; (b) using the system to conduct further assessments of the sales representative, and update selling skill category score and selling intelligence data within the system database; (c) using the system to import into the system database, sales performance data of sales representatives from CRM and other systems, linking imported sales performance data with the selling skill category scores and selling intelligence data of corresponding sales representatives, while removing identification data of all sale representatives; (d) using the system to automatically (i) analyze the selling skill category scores, selling intelligence data, and sales performance data of sales representatives, and (ii) determine industry benchmarks based on selling competency and judgement skill scores, selling intelligence measurements, and/or sales performance; (e) using the system to automatically generate an industry-specific report containing selling skill category scores, selling intelligence data and sales performance data, with metrics based on the determined industry benchmarks; and (f) distributing the generated report to subscribers of selling intelligence, skill and sales performance reporting services supported by the system.

Another object of the present invention is to provide a new and improved method of and system for creating new customized assessments designed to be administered on an automated selling intelligence assessment, development and management system, capable of capturing and processing user assessment data, to generate selling competency and judgement skill category score data, for processing and generation of selling intelligence measurements.

Another object of the present invention is to provide a new and improved selling intelligence assessment, measurement, development and management system for measuring, developing and managing the selling intelligence of sales representatives using plurality of client machines deployed on the system network, wherein each client machine may be realized as a mobile computing machine, a smartphone device (e.g. Apple iPhone, Samsung Android Galaxy, et al), a tablet computer (e.g. Apple iPad) or a desktop computer or workstation supporting a system user interface of the present invention.

These and other objects of invention will become apparent hereinafter and in the Claims to Invention appended hereto.

### BRIEF DESCRIPTION OF THE DRAWINGS

In order to more fully understand the objects of the present invention, the following detailed description of the illustrative embodiments should be read in conjunction with the accompanying figure Drawings in which:

FIGS. 1A and 1B, taken together, is a high-level schematic representation of the system network supporting the selling intelligence assessment, development and management system of the present invention illustrating (i) diverse kinds of client systems such as tablet, desktop computer, laptop, mobile devices, VR goggle, and other client systems, and (ii) enterprise-level computer system networks supporting client companies, sales industry and talent development partners (e.g. CRM partners, content developers, and resellers), social networks, and other users operably connected to the data center(s) of the present invention by way of the TCP/IP infrastructure of the Internet;

FIG. 1C is a system diagram illustrating the multi-tier system architecture of the data center component of the system network illustrated in FIGS. 1A and 1B supporting the selling intelligence assessment, development and management system of the present invention;

FIG. 1D is a system architecture diagram illustrating the exemplary system architecture of each client system (i.e. machine) deployed on the system of the present invention, and shown comprising numerous components arranged around one or more system buses well known in the art;

FIG. 2A is a schematic representation of a service map for the system of the illustrative embodiment of the present invention, describing the various services provided to leadership, employees and pre-hire members, supported by each of the primary subsystems (e.g. assessment module, reporting module and prescription module) supported on the system of the present invention using a diverse network of deployed client machines;

FIG. 2B is a high-level system block diagram illustrating the high-level system architecture of the system network of the present invention;

FIG. 2C is a schematic representation of the data hierarchy, data sources and data flow supported within the selling intelligence assessment and measurement system of the present invention shown;

FIG. 2D is a database schema for an exemplary database management system (DBMS) employed on the system network of the illustrative embodiment, specifying enterprise-level data objects and relationships among objects supported within the system;

FIG. 3A is a graphical representation of an exemplary graphical user interface (GUI) manager dashboard generated by the web servers within the data center supporting the selling intelligence assessment and measurement system of the present invention, for use by sales managers and like managers who use the dashboard to make learning cadence/course recommendations for particular salespeople from the prescription interface submodule of FIG. 6A, review scoreboard/leaderboard scores from the prescription interface submodule of FIG. 6A, team reports from the reporting interface submodule of FIG. 5A1, and other admin options;

FIG. 3B is a graphical representation of an exemplary graphical user interface (GUI) course dashboard generated by the web servers within the data center supporting the selling intelligence assessment and measurement system of the present invention, for use by sales representatives who use the dashboard to create a syllabus, edit a syllabus, view syllabus progress for users, and view user progress, wherein the view user progress GUI is selected and shown;

FIG. 3C is a graphical representation of an exemplary GUI pre-hire dashboard generated by the web servers within the data center supporting the selling intelligence assessment and measurement system of the present invention, for use by pre-hires who use the dashboard to log-into the system, and view all assessments to be taken for the job/position being pursued (e.g. in the form of a conversation map indicating areas of testing), along with all assessments that have been completed by the user on a particular date/time, recorded within the system;

FIG. 3D is a graphical representation of an exemplary GUI employee dashboard generated by the web servers within the data center supporting the selling intelligence assessment and measurement system of the present invention, for use by pre-hires and employees who use the dashboard to review (i) the conversation map indicating areas of testing, (ii) leaderboard/scoreboard from the prescription interface submodule of FIG. 6A showing the company and teams competing in particular competitions, (iii) user reports containing personal metrics relating to selling competencies and selling judgement from reporting interface submodule 5A1, (iv) achievements from the prescription interface submodule of FIG. 6A, (vi) recommendations by the system, (vii) learning material such as courses from prescription interface submodule of FIG. 6A, and (viii) coaching interface from prescription interface submodule of FIG. 6A;

FIG. 4A is a schematic representation of assessment interface submodule vehicles (e.g. multi-choice tests, conversation-based simulation, and game-based simulations) for use in (i) assessing and capturing assessment data from the testing, (ii) storing the assessed data in the assessment data storage submodule of FIG. 4D, and (iii) processing the stored assessment data to assess, by scoring, the selling competency and/or selling judgment of the sales representative, and ultimately computing a selling intelligence score for the sales representative based on such collected assessments;

FIG. 4B1 illustrates a first exemplary GUI screen supporting a multiple-choice test assessment, for assessing and measuring selling competency and/or selling judgment on the system network of the present invention, showing an exemplary multiple-choice question and possible answers thereto;

FIG. 4B2 illustrates a second exemplary GUI screen supporting a conversation-based assessment, for assessing and measuring selling competency and/or selling judgment on the system network of the present invention, showing an exemplary 3D VR-based simulation involving a sales representative engaging with two other virtual actors having parts in the simulated conversation;

FIG. 4B3 illustrates a third exemplary GUI screen supporting a game-based simulation assessment, for assessing and measuring selling competency and/or selling judgment on the system network of the present invention, showing an exemplary game environment, wherein the user being test is requested to match corresponding concepts by shooting/selecting objects in the scene that match the selected target object;

FIG. 4C is a schematic diagram describing the high-level functions supported within the assessment scoring submodule shown in FIG. 2B, comprising (i) the processing and scoring of assessments using any one or more assessment vehicles such as multiple-choice tests, conversation-based assessments and game-based simulations, (ii) producing selling competency scores and selling judgment scores from administered assessments, and (iii) subsequent computing of selling intelligence measurements for storage in the reporting data storage submodule accessed by the reporting and prescription submodules;

FIG. 4D is a schematic diagram describing the assessment data storage submodule shown in FIG. 2B, supporting the storage of (i) assessment vehicle content from selling competency and selling judgment assessment, and (ii) user storage containing user answers and activity for vehicle (user decisions in a conversation, time in a multiple choice test, activity in a game, etc.);

FIG. 4E1 is an exemplary skill category schema or tree structure (i.e. list of N number of skill categories) pertaining to selling competency assessed by the assessment scoring submodule of the system network, for the purpose of assessing and measuring selling competency skills, used in automated measurement and computation of selling intelligence;

FIG. 4E2 is an exemplary skill category schema or tree structure (i.e. list of M number of skill categories) pertaining to selling judgement assessed by the assessment scoring submodule of the system network, for the purpose of assessing and measuring selling judgement skills, used in automated measurement and computation of selling intelligence;

FIG. 4F is a flow chart describing the primary steps involved in the method and process of scoring conversation-based assessments supported by the selling intelligence assessment, development and management system of the present invention, comprising the steps of (a) starting with a user finishing a conversation-based assessment, (b) running the conversation-based scoring process shown in FIG. 4I, and (c) storing final conversation scores in the reporting data storage submodule of FIG. 5C1;

FIGS. 4G1, 4G2 and 4G3, taken together, provide a schematic representation of a three-part conversation-based scoring example, graphically illustrating (i) an exemplary conversation map structure containing various paths of a simulated conversation, with skill categories (e.g. skill category SC1, SC2, SC3, SC4 . . . ) represented at decision points along the paths, and (ii) the primary steps carried out in a scoring process used to assess and score a simulated conversation, as illustrated in FIG. 4I;

FIG. 4H is a schematic representation of the conversation-based data schema used when scoring conversations within the selling judgment module using the scoring process illustrated in FIG. 4I, indicating the organizational structure of a conversation and the manner in which the conversation is scored in the illustrative embodiment of the selling intelligence assessment, development and management system of the present invention;

FIG. 4I is a flow chart describing the primary steps involved in the conversation-based scoring process of the present invention illustrated in FIGS. 4G1, 4G2 and 4G3, supported and administered by the selling intelligence assessment, development and management system of the present invention;

FIG. 4J is a flow chart describing the primary steps involved in the process of scoring multiple-choice tests supported by the selling intelligence assessment, development and management system of the present invention, comprising the steps of (a) starting with a user finishing a multiple-choice test assessment registered with the system, (b) running the multiple-choice test scoring process shown in FIG. 4N to produce final multiple-choice test scores, and (c) storing final multiple-choice scores and new percentile ranking tables in the reporting data storage submodule of FIG. 5C1;

FIGS. 4K1 and 4K2, taken together, show a schematic representation graphically illustrating the primary stages of the multiple-choice test scoring process of FIG. 4N, showing (i) scoring the multiple choice tests taken by a group of users (e.g. pre-hires) to generate original raw scores, (ii) taking the original raw scores and counting their frequency, (iii) generating a percentile table using the multiple-choice percentile table generating process of FIG. 4M, (iv) generating a final percentile table for achievement drive, and (v) using the original raw scores table and the percentile table for achievement drive, so as to generate and assemble final scores ranked on the scores of all of the users in the group, using the selling intelligence assessment, development and management system;

FIG. 4L is a schematic representation of the multiple-choice test schema used when scoring multiple-choice test questions within the selling judgment module illustrated in FIG. 4C, indicating the organizational structure of a multiple-choice test and manner in which multiple-choice test questions are scored in terms of skill category scores by the selling intelligence assessment, development and management system of the present invention;

FIG. 4M is a flow chart describing the primary steps of the process used to generate multiple-choice percentile tables from multiple-choice test scores administered using the selling intelligence assessment, development and management system of the present invention;

FIG. 4N is a flow chart describing the primary steps involved in the multiple-choice scoring process of scoring skill categories assessed during multiple-choice tests administered by the selling intelligence assessment, development and management system of the present invention;

FIG. 4O is a flow chart describing the primary steps involved in the gaming-based simulation scoring process supported by the selling intelligence assessment, development and management system of the present invention, comprising the steps of (a) starting with a user finishing a game-based simulation assessment, (b) running the game-based simulation scoring process shown in FIG. 4P to generate final game-based simulation scores, and (c) storing final game-based simulation scores in the reporting data storage submodule of FIG. 5C1;

FIG. 4P is a schematic representation of the game-based simulation scoring process illustrating that the user takes a game-based assessment, and over time, the system automatically tracks the user's interactions including the user's decisions, the user's reaction time, other reactions, and the time user spent in the game simulation, and wherein skill categories of the selling judgment and competency type are assessed by scoring the user's interactions to produce scores for each assessed skill, and to generate a final game score by combining individual skill scores of the assessed user;

FIG. 4Q is a data flow chart describing the primary steps of the method of measuring selling intelligence (SI) using the selling competency scores and selling judgement scores given to sales representatives using the selling intelligence assessment, development and management system of the present invention;

FIG. 4R is a flow chart describing the primary steps carried out by the process for summing (i.e. adding) the selling competency skill category (SCSC) scores and/or selling judgment skill category scores of assessed sales representatives, using the selling intelligence assessment, development and management system of the present invention;

FIG. 4S is a flow chart describing the primary steps of the process used to computationally measure the selling intelligence quotient (SIQ) of assessed sales representatives using the selling intelligence assessment engine supported within the selling intelligence assessment, development and management system of the present invention;

FIG. 4T is a schematic representation of an exemplary selling intelligence (SI) data structure maintained by the system of the present invention for each and every system user (e.g. sales representatives, employees, new-hires, etc.), illustrating the many different types of data collected and maintained including, but not limited to, user data, selling competency skills data, selling judgment skills data, selling intelligence data, assessment history data, prescription history data, and other types of data related to the system user on the system network;

FIG. 4U is a schematic representation of the process of generating assessments (e.g. selling competency and judgement skill category assessments) using the automated method illustrated in FIG. 4V3;

FIG. 4V1 is a schematic representation of the assessment interface submodule of the system network, supporting the generation of various kinds of selling-intelligence assessments including (i) multiple-choice question based assessments, (ii) conversation-based assessments, (iii) game-based simulations, and (iv) mixed-vehicle assessments constructed on combinations of the above;

FIG. 4V2 is a flow chart describing the primary steps involved in the automated assessment schema used in the automated method of generating assessments of the present invention;

FIG. 4V3 is a flow chart describing the primary steps involved in the high-level process of generating and delivering assessments using the assessment module of the system of the present invention, and automated processes supported therein;

FIG. 4V4 is a flow chart describing the primary steps involved in the automated metric-driven assessment generation and delivery method, supported on the selling intelligence assessment, development and management system of the present invention;

FIG. 4V5 is a schematic representation of an internal assessment report (IAR) used to automatically generate and deliver assessments based on metrics generated by the system of the present invention;

FIG. 5A1 is schematic representation illustrating the reporting interface submodule supporting the generation and delivery of various kinds of selling-intelligence based reports for various users including, for example, industry reports for company administrators, company reports for company wide managers, group reports for regional managers, and user reports for hiring decision managers;

FIG. 5A2 is schematic representation of a GUI screen presenting an exemplary industry report for company administrators, generated by the reporting interface submodule of the system network of the present invention;

FIG. 5A3 is schematic representation of a GUI screen presenting an exemplary company report for company wide managers, generated by the reporting interface submodule of the system network of the present invention;

FIG. 5A4 is schematic representation of a GUI screen presenting an exemplary group report for regional managers, generated by the reporting interface submodule of the system network of the present invention;

FIG. 5A5 is schematic representation of a GUI screen presenting an exemplary user report for hiring decision managers, generated by the reporting interface submodule of the system network of the present invention;

FIG. 5B1 is a schematic representation illustrating the various kinds of selling-intelligence-based reports such as, for example, industry reports, company reports, group reports, and user reports, that are generated from diverse data sets, such as user performance data, scoring data, internal system data, and user tracking data stored in the reporting data storage submodule, processed by the reporting processing submodule, and augmented by metrics produced by automated methods for creating prescriptions illustrated in FIG. 6B6;

FIGS. 5B2 and 5B3, taken together, shows a schematic representation of a report configuration process involving (a) the selecting the report type, (b) selecting subjects of the report, (c) choosing skills display, (d) choosing metrics to display, and (e) choosing benchmarks for metrics;

FIG. 5C1 is a schematic representation illustrating the reporting data storage submodule supporting various classes of collected data including (i) user performance data from manager surveys manually input to the system, and external company data sources from CRM data, ERP data, APIs, external learning management data, company datasets, etc., (ii) internal system data from internal systems (performance data from companies registered with the system, (iii) scoring data (e.g. relating to selling competency, selling judgement, and selling intelligence) from the assessment scoring submodule, and (iv) user tracking data from user's data and user interactions with the system (e.g. user geo-location data, login history data, user demographic information, user timing data, user activity data, user data, and learning material activity data);

FIG. 5C2 is a schematic representation of the classes of data pertaining to a user's performance data stored in the reporting data storage submodule, and organized according to (i) objective information from a CRM or database (e.g. employment length, months supervising, percentage of quota achieved last year, percentage of quota achieved 2 years ago, percentage of quota achieved 3 years ago, estimate for quota achievement this year, close ratio), and (ii) subjective data gathered from leadership based on their opinion (hunter, farmer, self-starter, emotional intelligence, learning and applying knowledge, sales foundation, prospecting, discovery-needs analysis, presenting, objection management, closing/negotiating, and overall sales ability;

FIG. 5C3 is a schematic representation of the classes of data pertaining to a user's identity and activity (i.e. user's tracking) stored in the reporting data storage submodule, and organized according to (i) user demographic information (e.g. education, race, age, gender), (ii) user data (e.g. user's name, position/title, email address, time account was created, and user preferences), and (iii) user activity (e.g. login history, messages sent from user to user, length of time in assessment, length of time for each decision/answer, what learning material was read?, did the user skip anything?, did the user view the whole coaching?, how long did the user spend in the coaching, and how long did the user spend into the intro);

FIG. 5C4 is a schematic representation of the reporting interface submodule shown in FIG. 5A1, illustrating (i) the display of subjective data provided by manager surveys against system data from the system network of the present invention, (ii) the display of objective data provided by external sources (e.g. CRMs, ERPs, APIs, etc.) against system data collected and generated by the system network, and (iii) for review, analysis and comparison of subjective data and system data by supervisors and higher-level managers;

FIG. 5C5 is a schematic representation illustrating (i) collection and storage of subjective data collected from surveys taken by managers, and system data from user tracking, scoring data, and other internal systems, in the reporting data storage module of FIG. 5C1, and (ii) the automated comparison and factoring of this subjective data and system data so as to automatically generate a manager alignment metric (MAM) for display via the reporting interface submodule shown in FIG. 5A1;

FIG. 5D is a schematic illustration of the reports generation process supported by the reporting module of the selling intelligence assessment, development and management system of the present invention, wherein anonymity data filters are used to scrub (i.e. remove) user information from data streams and allow safe sharing of user reports without compromising confidentiality and like concerns of the system network users;

FIG. 5E is a schematic representation illustrating the primary steps carried out during the process supported by the reporting module of the selling intelligence assessment, development and management system, when generating a competitive user report employing data anonymity filters in accordance with the principles of the present invention;

FIG. 6A1 is a schematic representation of the prescription interface submodule of the system network of the present invention, supporting the generation and delivery of various kinds of selling-intelligence prescriptions comprising various interface types including (i) simulated competitions, (ii) learning cadence/training courses, and (iii) coaching efforts and feedback;

FIG. 6A2 is a schematic representation of the process for generating and delivering coaching and feedback in response to automated generation of prescriptions (e.g. coaching and feedback) using the automated method illustrated in FIG. 6B6;

FIG. 6B1 is a schematic representation of the prescription processing submodule, supporting the processing of various kinds of selling-intelligence prescriptions (e.g. simulated competitions, coaching and feedback, and learning cadence) for various system users including, for example, sales representatives, and sales leadership, including (i) automated prescription processing (i.e. based on a user's and external performance) supported by the assessment data storage submodule shown in FIG. 4D, the reporting data storage submodule shown in FIG. 5C1 and the prescription data storage submodule shown in FIG. 6C, and (ii) manual prescription processing where managers manually create prescriptions as illustrated in FIG. 6B6;

FIG. 6B2 is schematic representation of an exemplary automated prescription schema used in the automated method of generating and delivering prescriptions in accordance with the principles of the present invention;

FIG. 6B3 is a flow chart describing the primary steps involved in the automated process of generating and delivering prescriptions using the prescription module of the system of the present invention;

FIG. 6B4 is a flow chart describing the primary steps involved in the process of generating benchmarks for use during automated prescription generation processes of the present invention, involving the processing of selling skill category score data, selling intelligence measurement data, and sales performance data;

FIG. 6B5 is a flow chart describing the primary steps involved in the process of generating metrics for use during automated prescription generation processes, involving the processing of selling skill category score data, selling intelligence measurement data, and generated benchmarks;

FIG. 6B6 is a flow chart describing the primary steps involved in the automated metric-driven method of creating prescription (e.g. coaching, feedbacks, scoreboards, badges and cadence/courses) in accordance with the principles of the present invention;

FIG. 6B7 is a schematic representation of an exemplary internal prescription report (IPR) used during the automated generation and delivery of prescriptions based on metrics generated by the system of the present invention, according the process shown in FIG. 6B7;

FIG. 6B8 is a flow chart describing the primary steps involved in exemplary automated prescription processing methods supported on the prescription module of the system of the present invention, showing (i) various preconditions required for automated prescription processing and service delivery, (ii) particular triggers set will activate preconfigured prescription processes, and (iii) particular prescription processes that automatically run when corresponding triggers are activated on the system platform;

FIG. 6B9 is a schematic representation illustrating an implementation of the manual prescription processing methods supported on the prescription module of the system of the present invention;

FIG. 6C is a schematic representation of the prescription data storage submodule, describing the storage of various classes of data, and libraries of digital media resources, maintained within the prescription storage submodule such as, for example, (i) competition libraries including earned achievements and scoreboard/leaderboard data, (ii) coaching and feedback libraries including generated feedback and generated coaching, and (iii) learning cadence libraries including automated course creations from catalogued syllabi, and manager created courses for improving the selling competency and judgement skills of system users;

FIG. 7 is a flow chart describing a user interaction timeline of primary steps and workflow processes (e.g. outlining courses, assessments, conversations, selling competency and selling judgment scoring, selling intelligence score calculations, actions and reports) carried out on the selling intelligence assessment, development and management system of the present invention for different systems;

FIG. 8 is a flow chart describing the primary steps involved in carrying out the method of measuring the method of assessing the selling intelligence (SI) of individual sales representatives or sales representative candidates;

FIGS. 9A and 9B, taken together, provide a flow chart describing the primary steps involved in carrying out the method of assessing and measuring selling intelligence of an individual sales representative or candidate for use in supporting sales personnel hiring, development, management and termination processes;

FIG. 10 is a flow chart describing the primary steps involved in carrying out the method of assessing, developing, analyzing and managing sales intelligence of sales representatives;

FIG. 11 is a flow chart describing the primary steps involved in carrying out the method of assessing sales representative candidates during hiring process, and generating user reports predicting sales performance using organization benchmarks based on selling intelligence assessments;

FIG. 12 is a flow chart describing the primary steps involved in carrying out the method of predicting sale performance success of a sales representative candidate in an organization based on automated selling intelligence data analysis;

FIG. 13 is a flow chart describing the primary steps involved in carrying out the method of predicting the sales performance of individual sales representatives based on administering a series of selling intelligence assessments;

FIG. 14 is a flow chart describing the primary steps involved in carrying out the method of developing the selling intelligence of individual sales representatives using automatically-prescribed training courses guided by selling intelligence assessment;

FIG. 15 is a flow chart describing the primary steps involved in carrying out the method of progressively developing the selling intelligence of individual sales representatives using a series of automatically-prescribed selling intelligence training courses;

FIG. 16 is a flow chart describing the primary steps involved in carrying out the method of developing selling judgement skills using machine-based selling intelligence assessment, and automated-generation of selling intelligence training courses and metric-based user reports;

FIG. 17 is a flow chart describing the primary steps involved in carrying out the method of generating prescriptive training courses designed to develop the selling intelligence of particular sales representatives;

FIG. 18 is a flow chart describing the primary steps involved in carrying out the automated method of generating selling intelligence training courses for use in supporting the hiring and termination decisions of sales representative;

FIG. 19 is a flow chart describing the primary steps involved in carrying out the method of an automated method of generating reports containing internally-generated selling intelligence data, externally-generated performance data, and management alignment metrics;

FIG. 20 is a flow chart describing the primary steps involved in carrying out the method of method of automatically-generating scoreboards and achievements for sales representatives competing against other sales representatives in a sales organization;

FIG. 21 is a flow chart describing the primary steps involved in carrying out the method of automated method of generating prescriptions for sales representatives to develop their selling intelligence;

FIG. 22 is a flow chart describing the primary steps involved in carrying out the method of automated method of generating prescriptions for sales leadership to develop the selling intelligence of sales representatives;

FIG. 23 is a flow chart describing the primary steps involved in carrying out the method of automatically-generating training courses for sales representatives based on assessed selling intelligence, for the purpose of certifying sales representatives in a sales industry;

FIG. 24 is a flow chart describing the primary steps involved in carrying out the method of method of generating reports with metrics on the selling intelligence, skill category scores and sales performance of sales representatives working within specific industries;

FIG. 25 is a flow chart describing the primary steps involved in carrying out the method of method of generating reports on the selling intelligence, skills and sales performance of sales teams, against sales team benchmarks;

FIG. 26 is a flow chart describing the primary steps involved in carrying out the method of method of generating certified selling intelligence and skill reports on particular sales representatives working within a specific industry;

FIG. 27 is a flow chart describing the primary steps involved in carrying out the automated method of generating industry-specific selling intelligence, skill and performance reports with metrics comparing competing sales teams within a particular industry;

FIG. 28A is an exemplary skill category schema (i.e. list of skill categories) pertaining to engineering competency skills and behaviors assessed by the assessment scoring submodule of the system of the present invention, for the purpose of assessing and measuring engineering competency skills for use in automated measurement and computation of engineering intelligence (EI);

FIG. 28B is an exemplary skill category schema (i.e. list of skill categories) pertaining to engineering judgement skills assessed by the assessment scoring submodule of the system of the present invention, for the purpose of assessing and measuring engineering judgement skills for use in automated measurement and computation of engineering intelligence (EI);

FIG. 29A is an exemplary skill category schema (i.e. list of skill categories) pertaining to financial competency skills assessed by the assessment scoring submodule of the system, for the purpose of assessing and measuring financial competency skills for use in automated measurement and computation of financial intelligence (FI); and

FIG. 29B is an exemplary skill category schema (i.e. list of skill categories) pertaining to financial judgement skills assessed by the assessment scoring submodule of the system, for the purpose of assessing and measuring financial judgement skills for use in automated measurement and computation of financial intelligence (FI).

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

### Overview on the Selling Intelligence (SI) Assessment, Measurement, Development and Management System Deployed on the Enterprise-Level System Network of the Present Invention

In general, the present invention is directed to a new and improved field-specific human intelligence assessment, development and management system and methods that can be deployed across any industry for the purpose of assessing, developing and managing diverse kinds of field-specific human intelligence used in the pursuit of success in specific fields. While the present invention can be applied broadly to virtually any vocation or profession, which is addressed herein, the illustrative embodiment is shown applied for improving the performance of sales organizations.

For purposes of illustration only, the method, system and network of the present invention is illustrated while applied to the field of sales and selling, in which “selling intelligence (SI)” is an important multi-factor measure assessed, developed and managed by the system, and dependent upon a person's financial competency skills and financial judgement skills. However, it is understood that, with simple modifications and configurations, the method, system and network of the present invention can be applied to other specific fields as well, for the purpose of assessing, developing and managing other kinds of “field-specific intelligence”.

Examples of other kinds of “field-specific” human intelligence which may be assessed, developed and managed by the system and network of the present invention include, but are not limited to: military intelligence dependent upon a person's military competency skills and military judgement skills; financial intelligence dependent upon a person's financial competency skills and financial judgement skills; engineering intelligence dependent upon a person's engineering competency skills and engineering judgement skills; medical intelligence dependent upon a person's medical competency skills and medical judgement skills; marketing intelligence dependent upon a person's marketing competency skills and marketing judgement skills; legal intelligence dependent upon a person's legal competency skills and legal judgement skills; government intelligence dependent upon a person's government competency skills and government judgement skills; and investment intelligence dependent upon a person's investment competency skills and investment judgement skills.

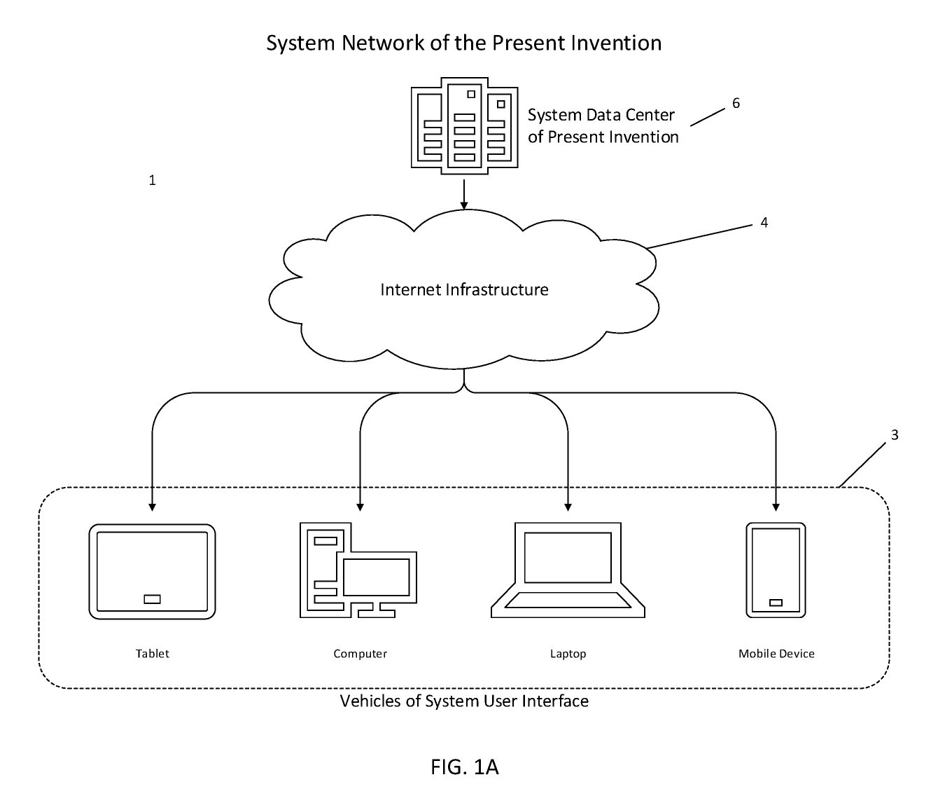

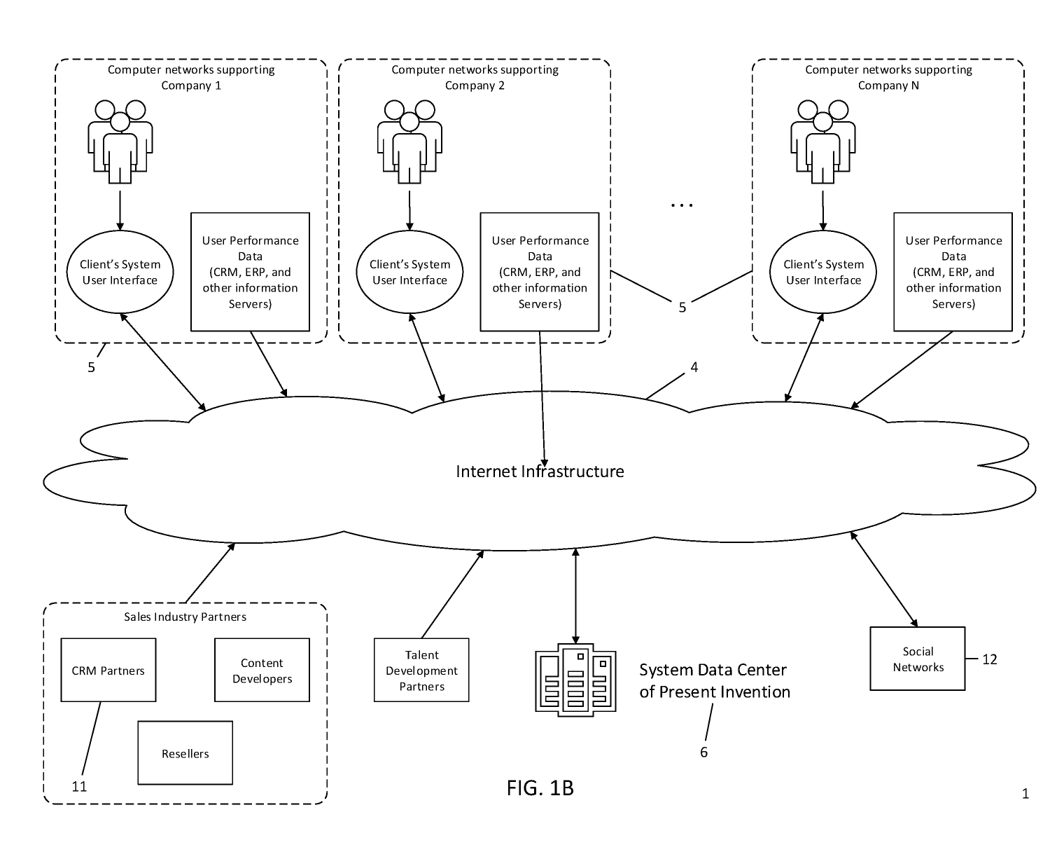

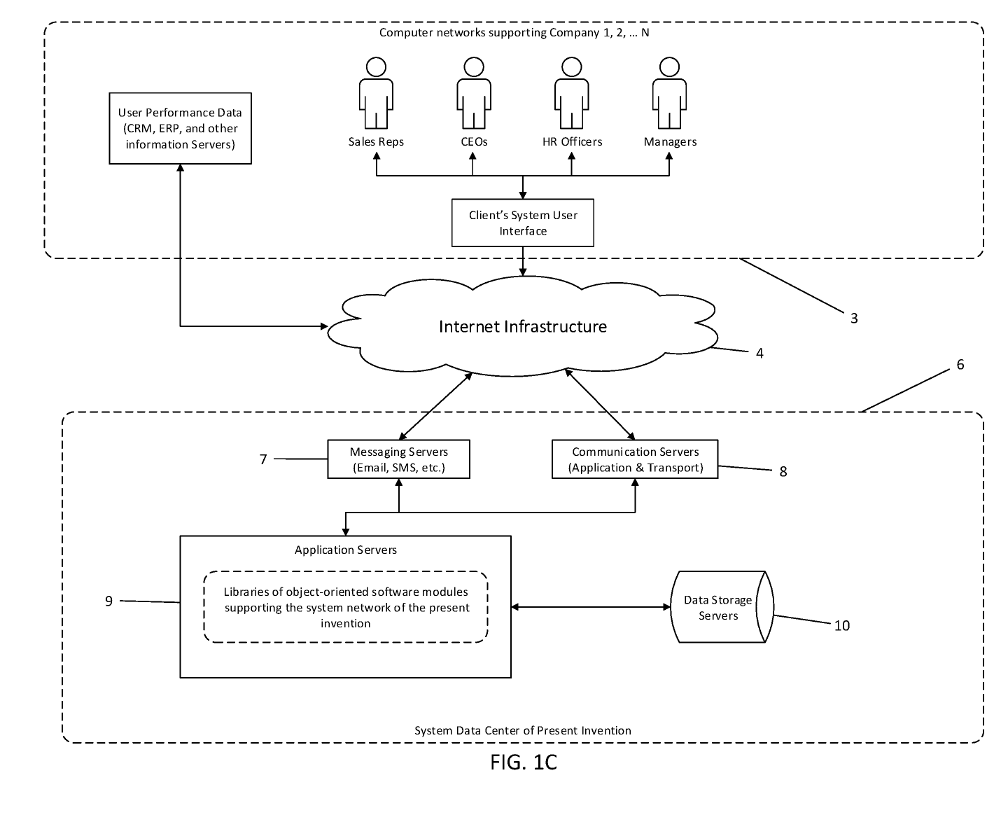

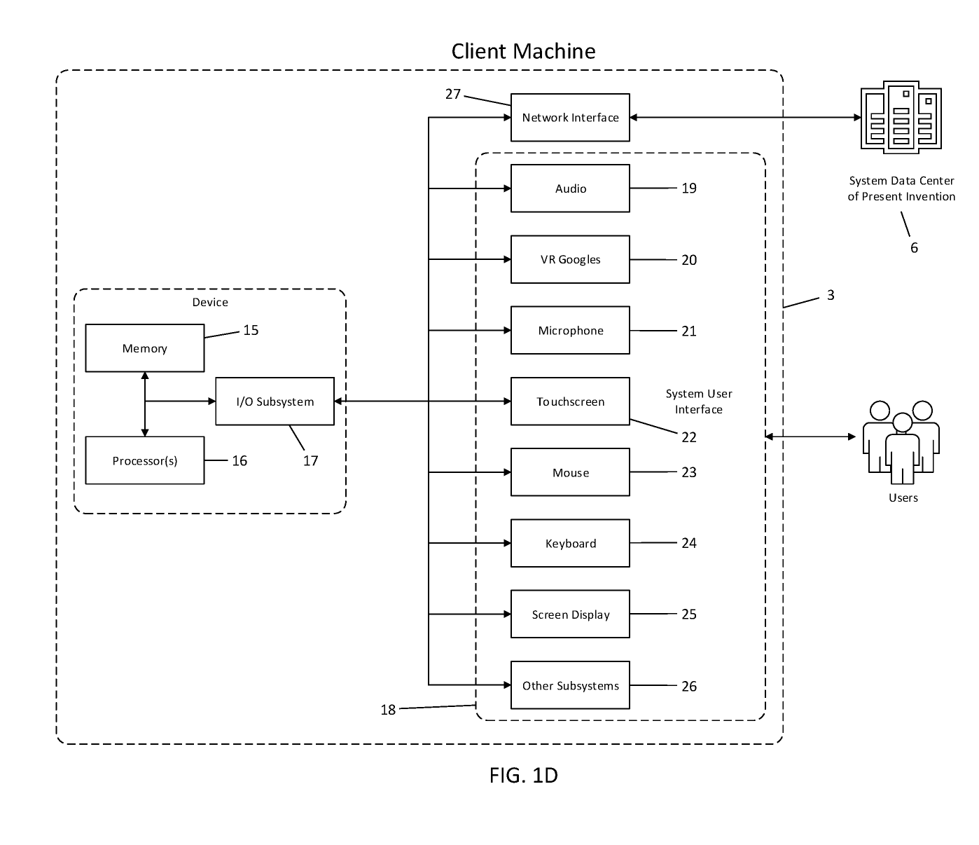

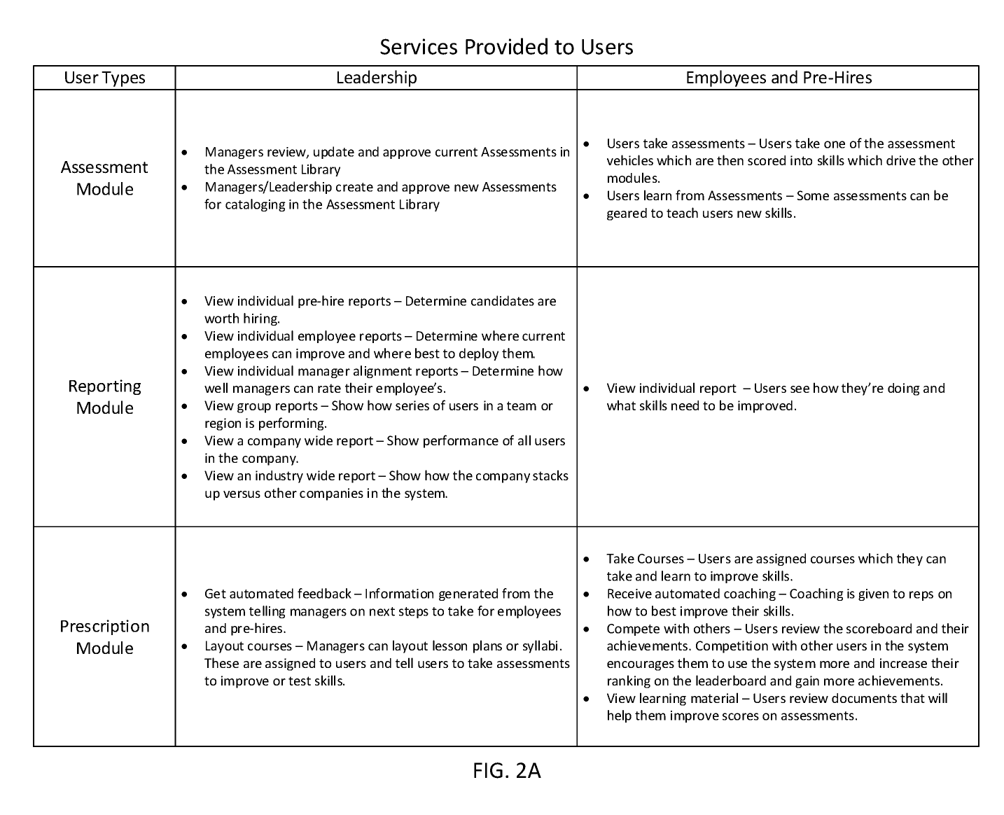

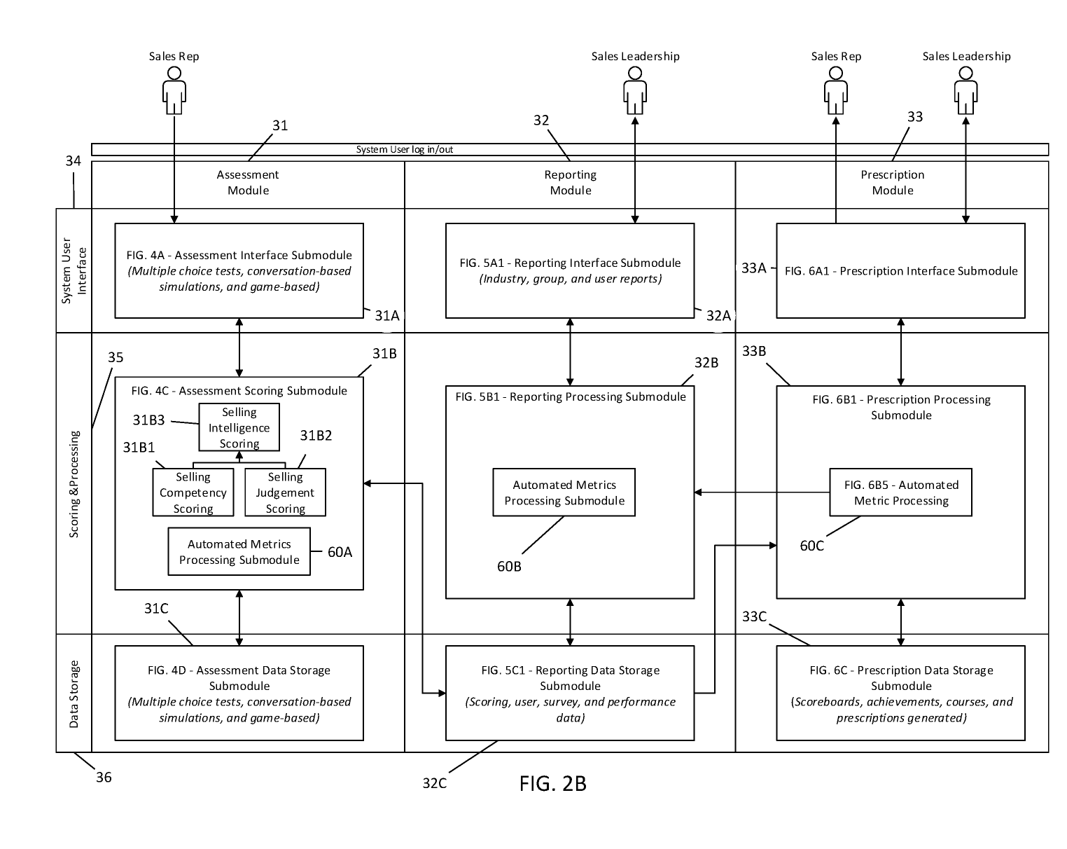

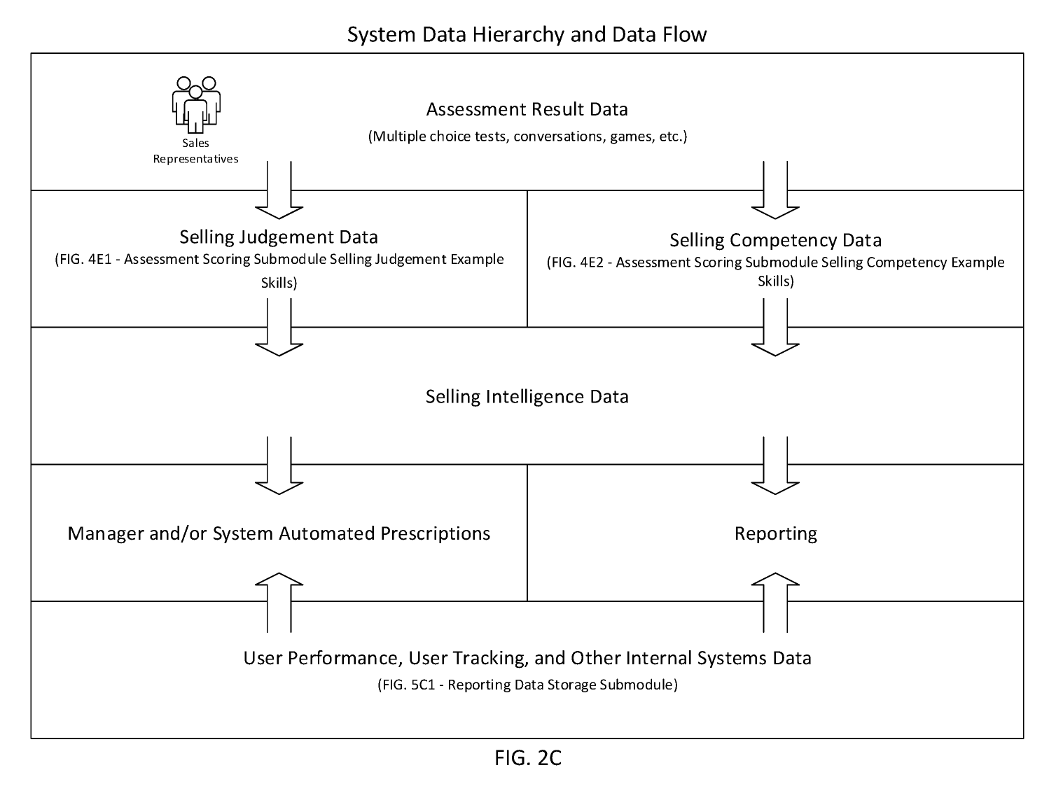

As shown in FIGS. 1A, 1B, 1C and 1D, the primary object of the present invention provides a novel enterprise-level system network 1 of industrial strength, for remotely delivering a network of Internet-based selling intelligence assessment, measurement, development and management systems 2, as illustrated in FIG. 2B, capable of assessing, measuring, developing and managing a human-aptitude called “selling intelligence”, as defined in technical detail hereinafter, and devised for purposes of improving the assessment, measurement, development and management of sales forces within companies and across industries.

As used and detailed hereinafter and in the Claims, the concept of “field-specific” human intelligence implies a combined measure of a person's field-specific competency skills over a predefined set of competency skill categories, and field-specific judgement skills over a predefined set of judgement skill categories, measured relative to a population of other individuals in the field, as defined and explained hereinafter.

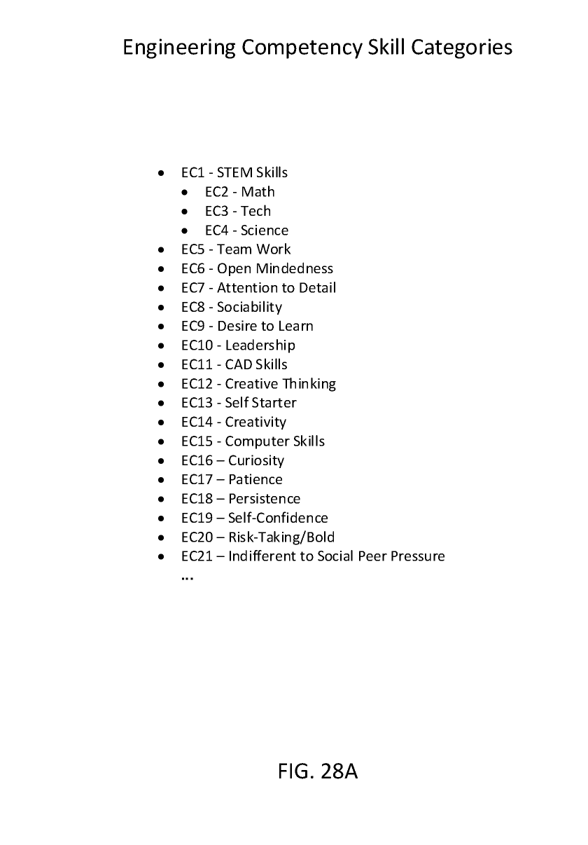

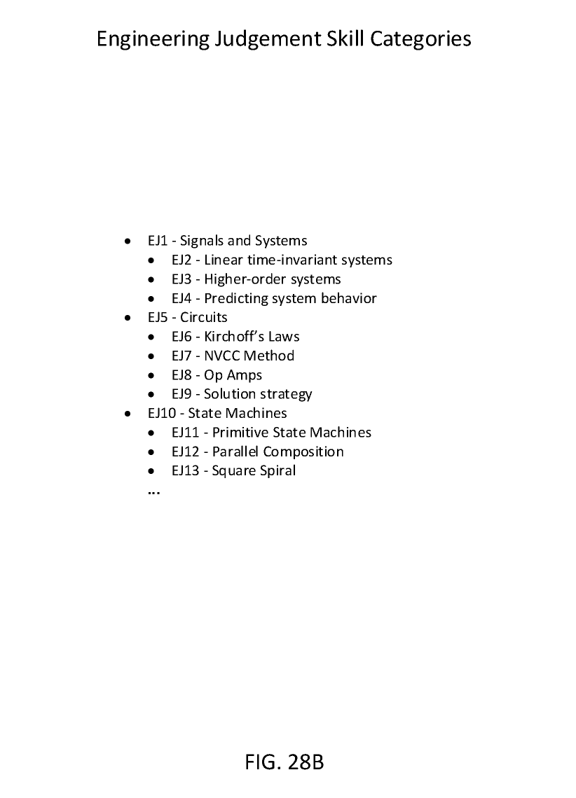

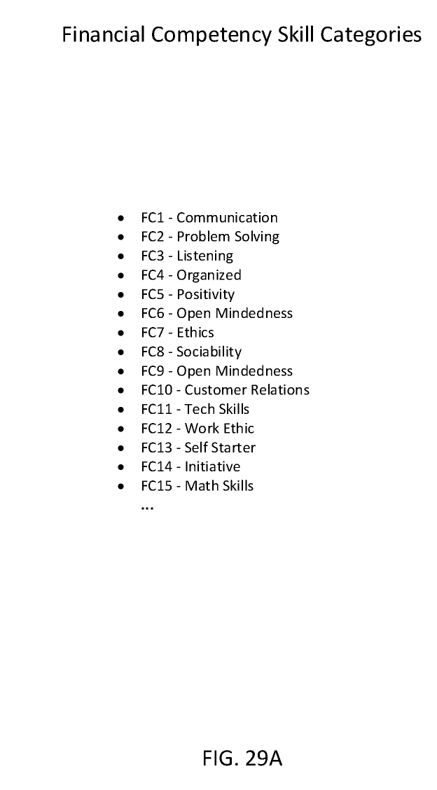

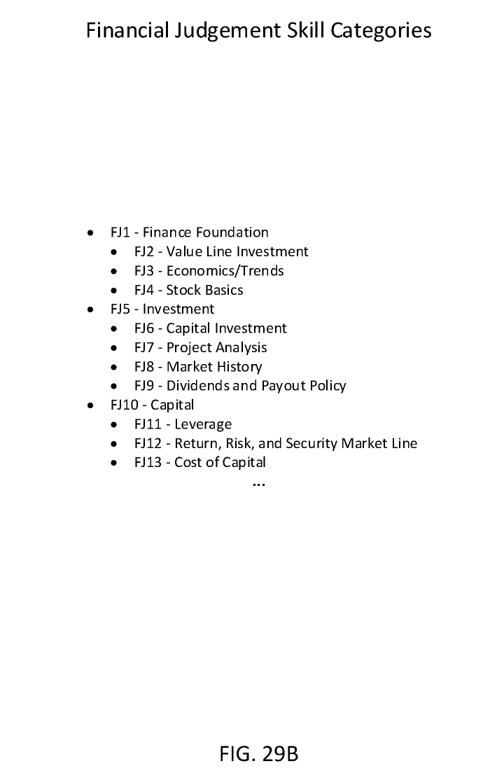

This unique concept of human intelligence quotient (HIQ) has been developed and defined through and after extensive research and development involving the scientific/objective assessment of cognitive and behavioral skills of sales representatives, employees, and pre-hire candidates interested in pursuing careers in sales. Therefore, while the preferred illustrative embodiment of the present invention detailed throughout the present Patent Specification is directed to the field of selling and sales, and the field-specific concept of human intelligence, it is understood that the system network 1 and selling intelligence assessment, development and management system 2 has applications in many different fields of human endeavor beyond sales and selling, as will be discussed hereinafter with reference to FIGS. 28A through 29B.

The selling intelligence assessment, development and management system 2 deployed on the system network 1 immerses salespeople in real-world selling situations and experiences using automated, scalable, 3D simulations with virtual customers, without presenting any risk to a company's brand, the sales representatives being tested, or their customers. In the illustrative embodiment, each system 2 functions as a sales intelligence assessment, measurement, development and management system which may be thought of as a next-generation sales simulation system with AI-based capabilities.

The system 2 is specially adapted for capturing, collecting and processing volumes of data on a salesperson's knowledge and experiences in the system's selling simulation environment, and automatically scoring administrated assessments taken on selling competency skills and selling judgement skills. Ultimately, using advanced data processing techniques, each system 2 makes selling intelligence (SI) measurements that provide executive sales leadership and managers with a reliable measure and means to understand the selling intelligence of their team members, in terms of assessments of their assessed selling competency skills and assessed selling judgement skills. The system 2 is adapted for recommending courses and training designed to help improve sales person's selling performance, and comparing scientifically-assessed measures of selling intelligence against actual sales performance figures for the individuals being managed by sales leaders and managers.

The system 2 provides sales leaders and managers with a selling intelligence profile on each salesperson, granting real insight into who has the necessary skills, behaviors and capacities to be successful in sales, thereby reducing the time to acquire sales competency for those new to sales (i.e. pre-hires), and reinforcing fundamental skills and competency for those possessing more sales experience.

The system 2 provides sales leadership and management with coaching, feedback cues and prescriptions that have been tailored to solve the salesperson's problem areas, advancing from a behavioral to a selling judgment perspective.

The system 2 is both immersive and experiential to empower salespeople to practice and training in a safe, private, non-threatening environment. Sales managers, sales trainers, and executive sales management, throughout the entire lifecycle of the sales process, design the selling simulation system 2 for use.

With automated and scalable role plays, the system 2 supports a combination of processes, methods and algorithms designed to do many different services from (i) predicting the likelihood of sales success, to (ii) producing various performance improvement strategies.

The system 2 employs on a complex set of psychometrics (i.e. measurements on knowledge, abilities, attitudes, and personality traits of a subject) that are designed to measure a representative's selling competency and selling judgment skills. The system does so by providing a set of evaluative services for assessing and measuring cognitive, behavioral, and sales skills of sales representatives and new hires, under selling competency skills assessment. These services aim to help managers and administrators address problems (e.g. deficiencies and inadequacies) in sales representatives and thereby more effectively and efficiently manage the sales process which companies rely upon for revenue generation and financial survival. The system 2 automatically produces recommendations to management for helping sales representatives to work around weaknesses and develop prescriptive reinforcements of these important selling competency skills.

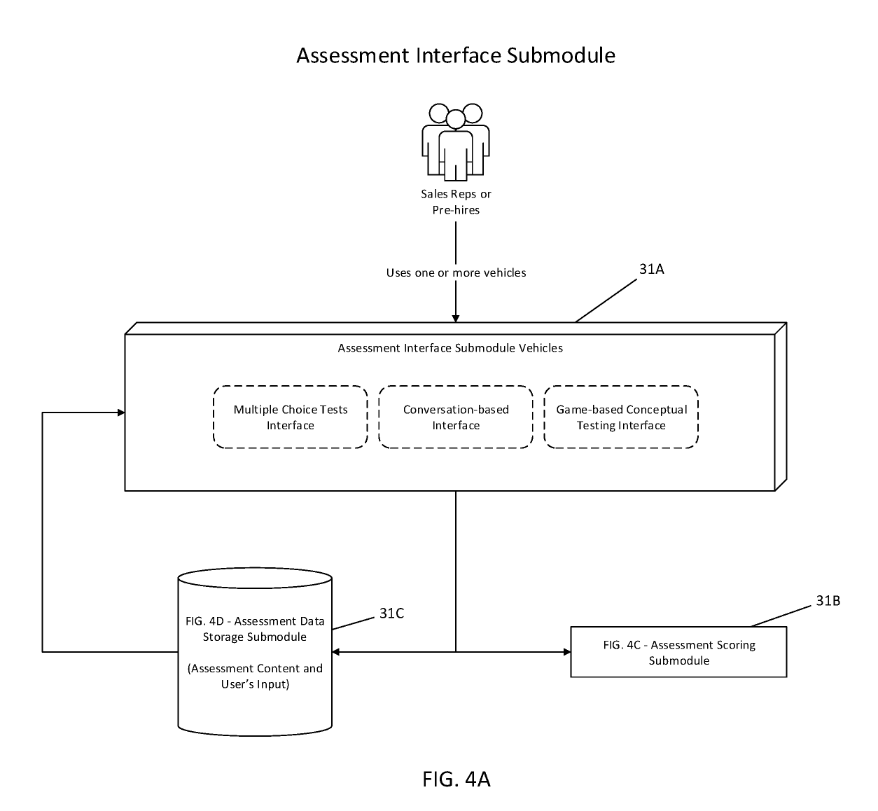

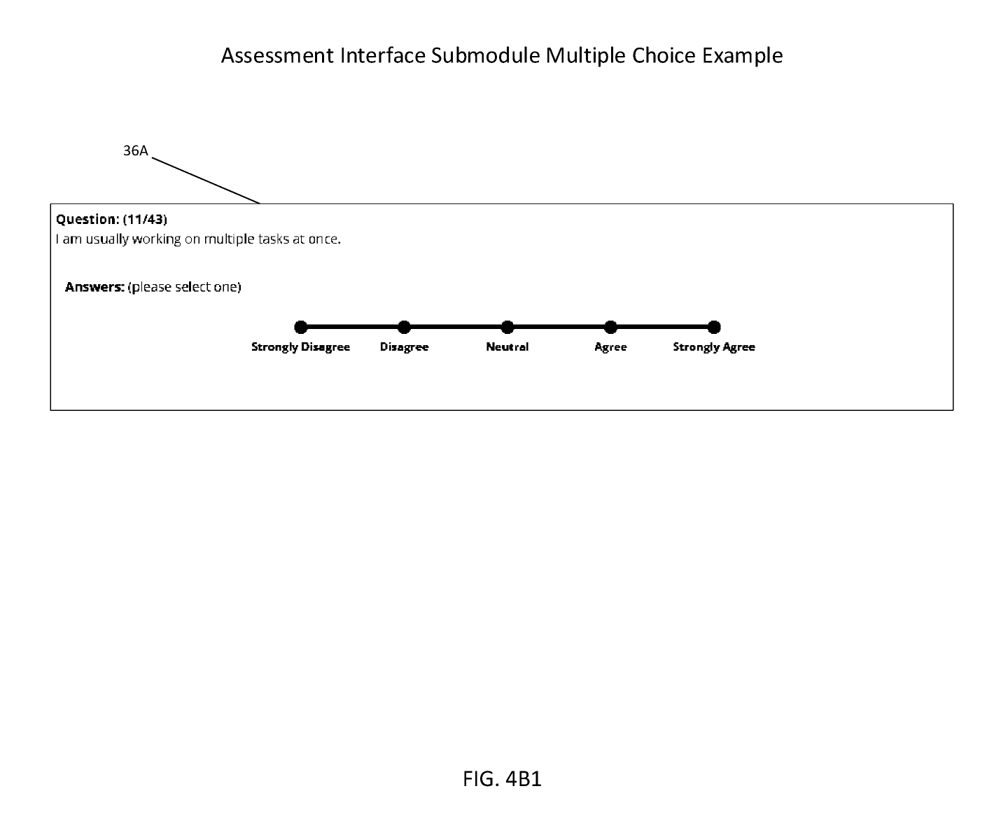

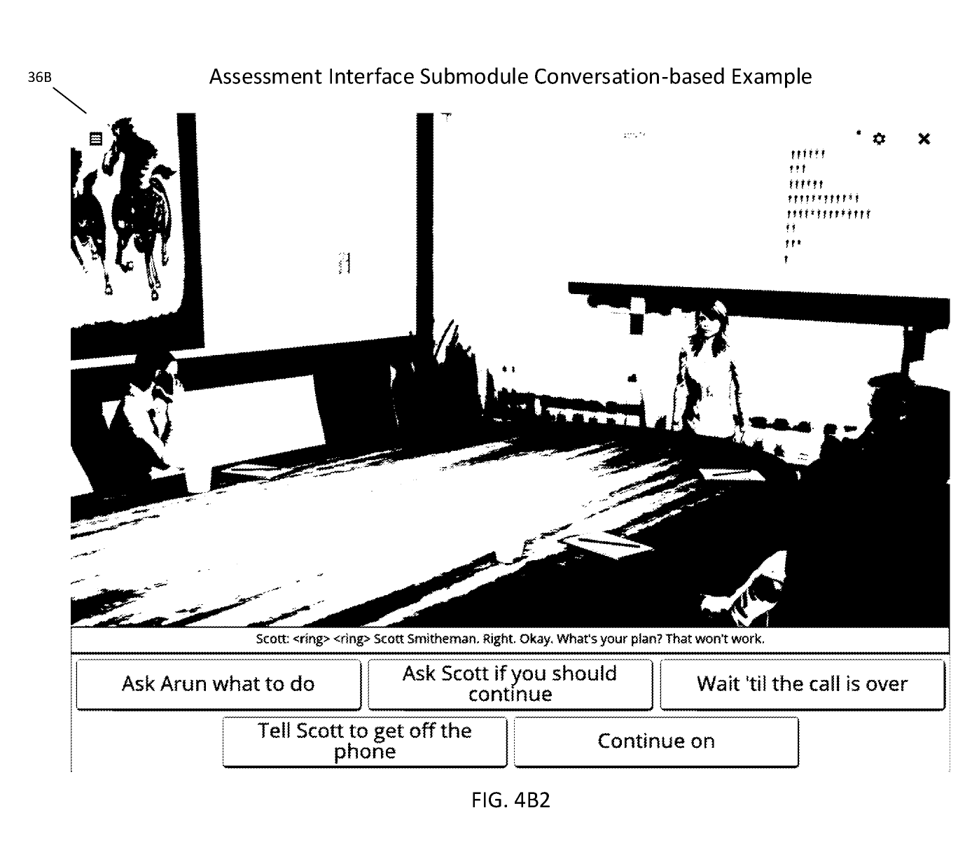

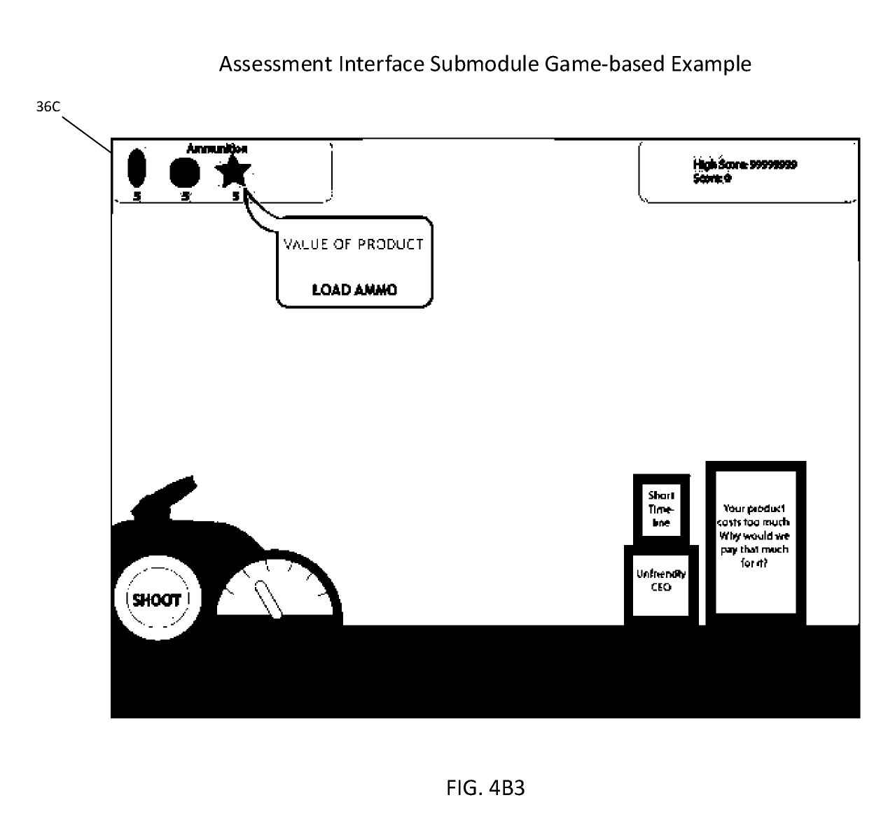

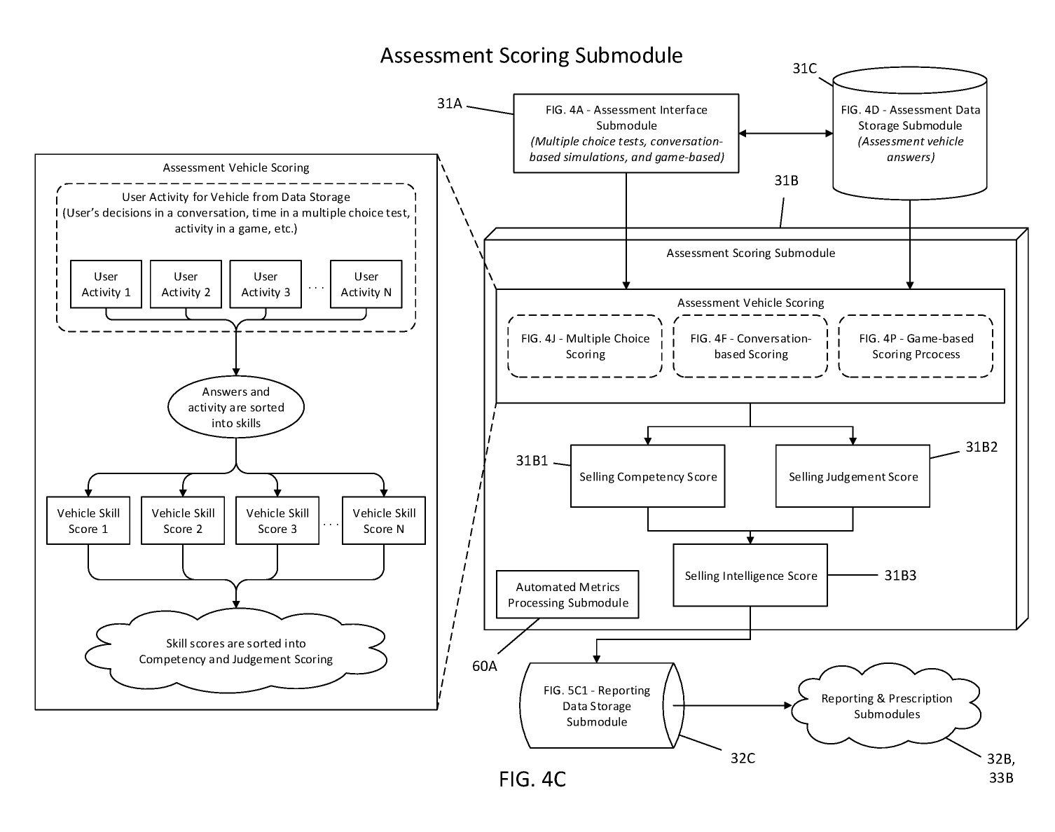

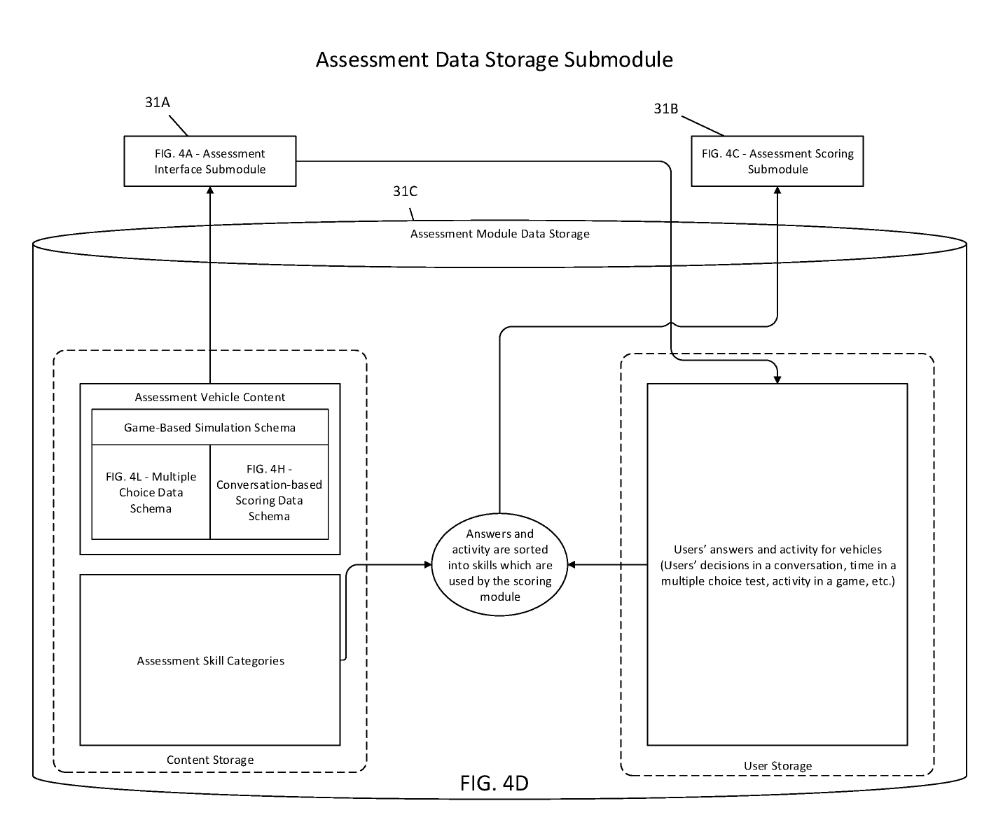

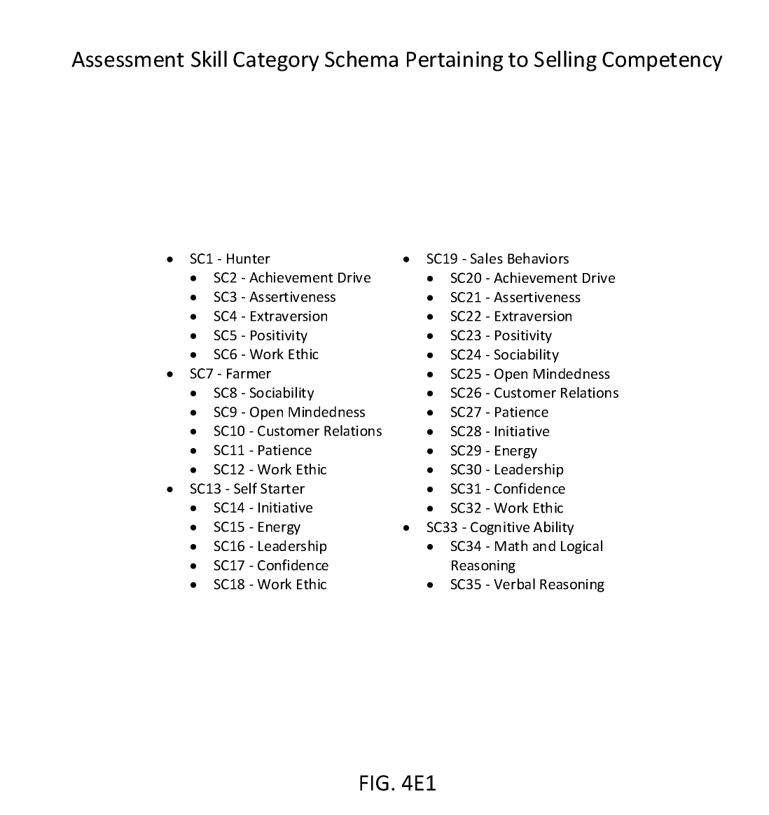

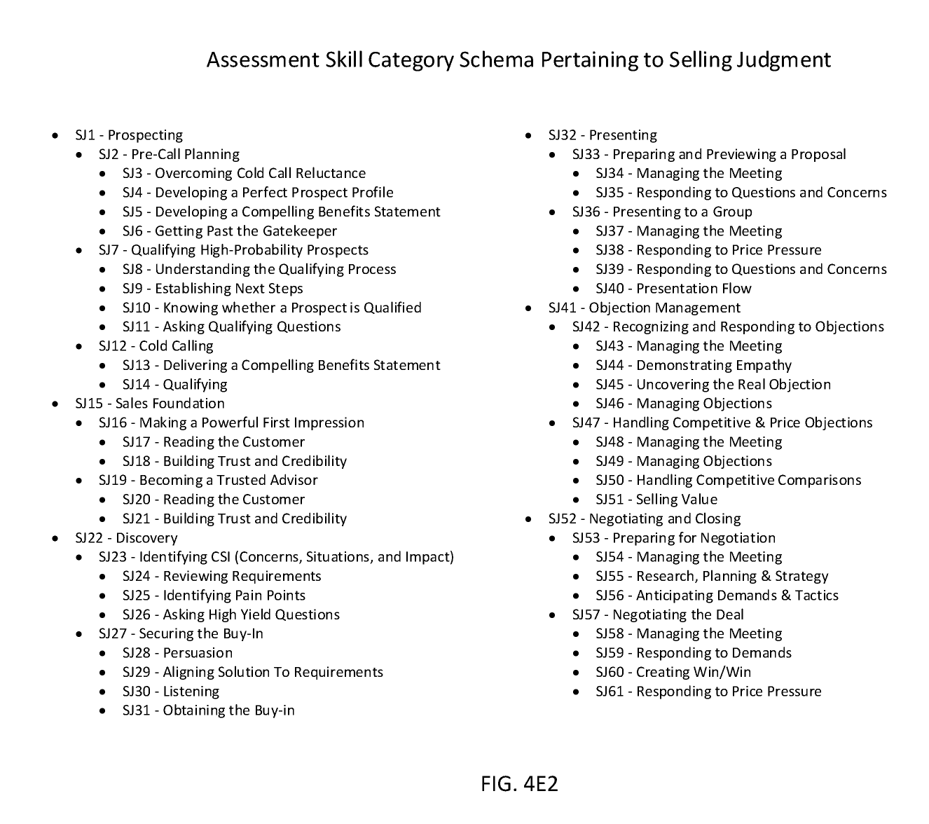

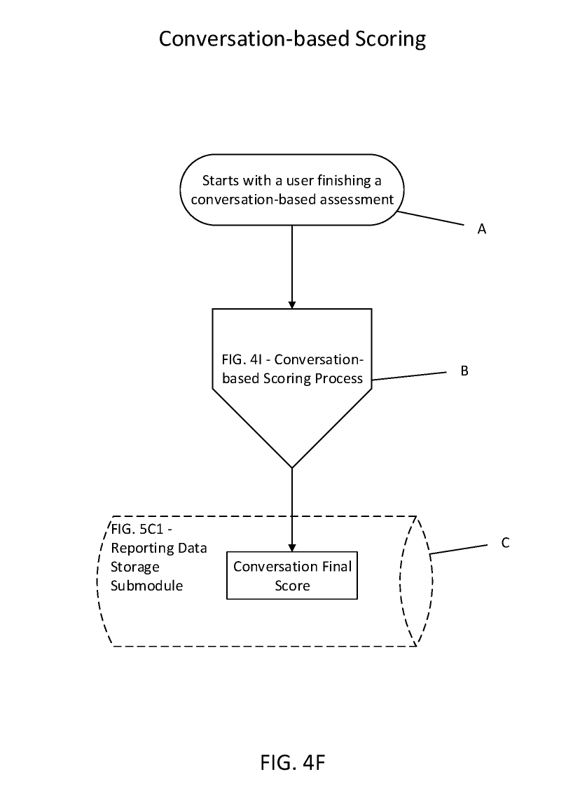

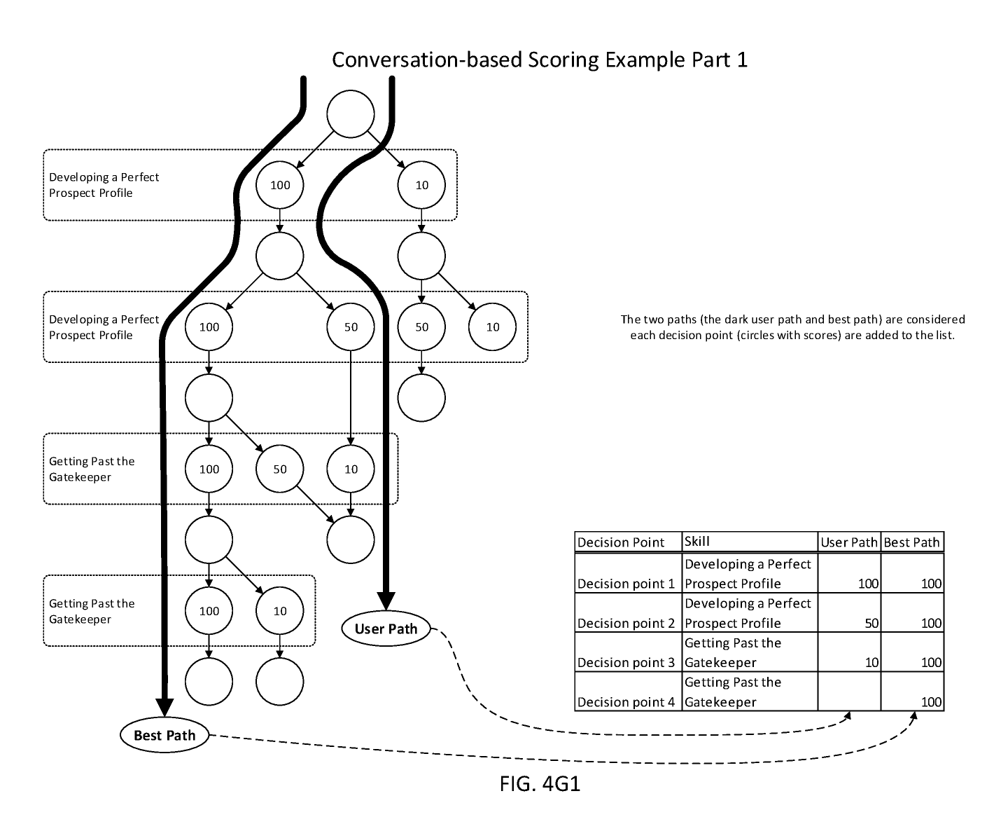

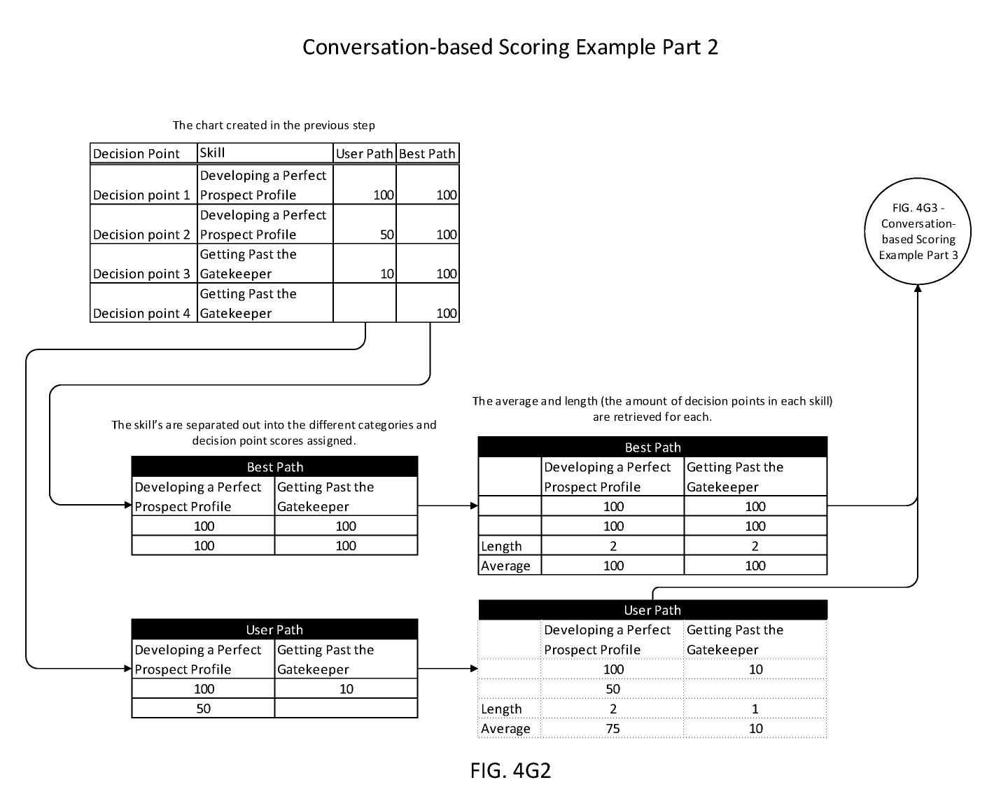

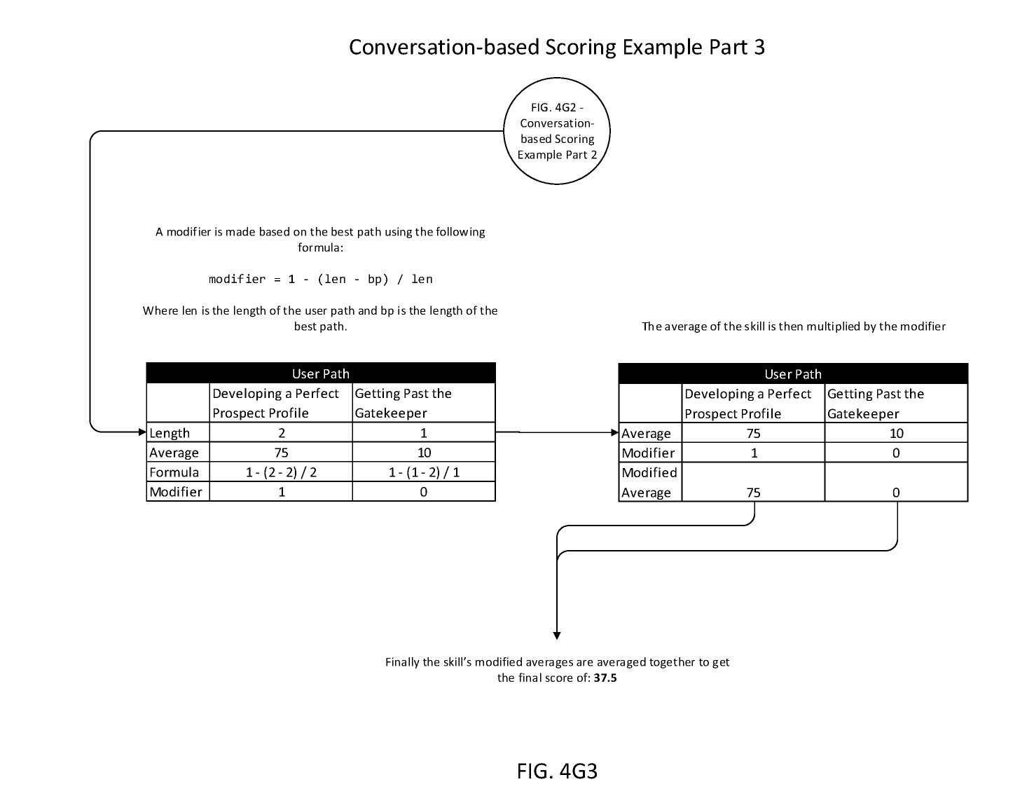

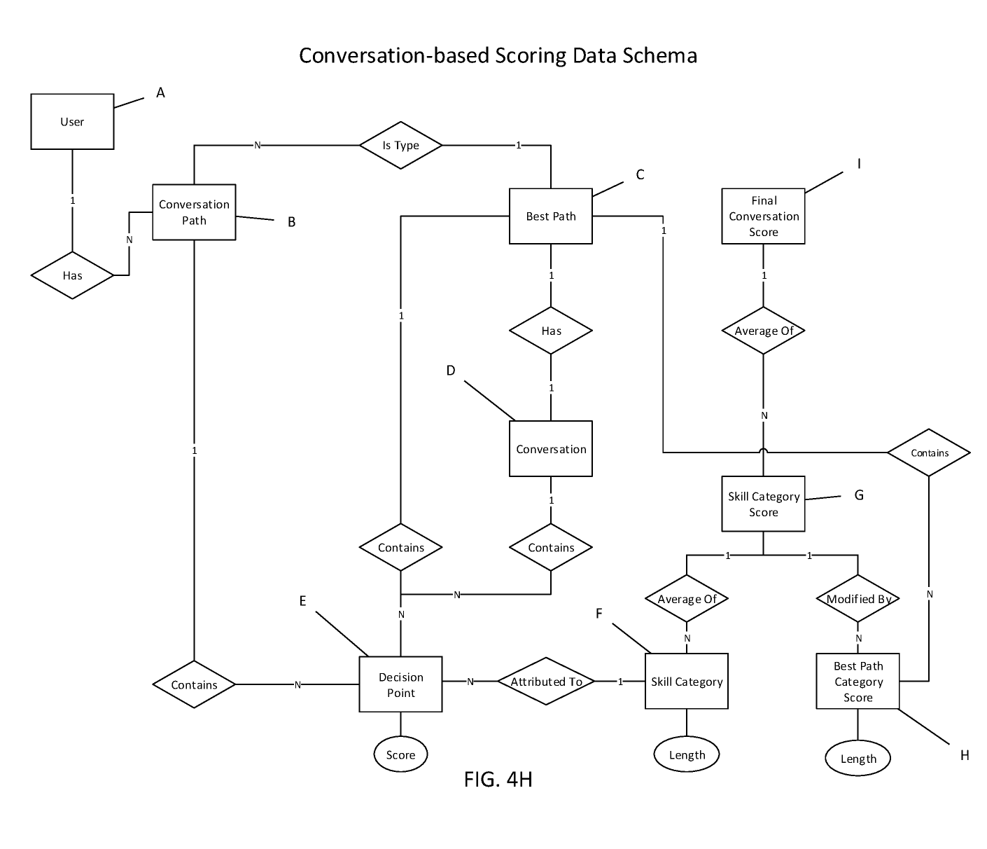

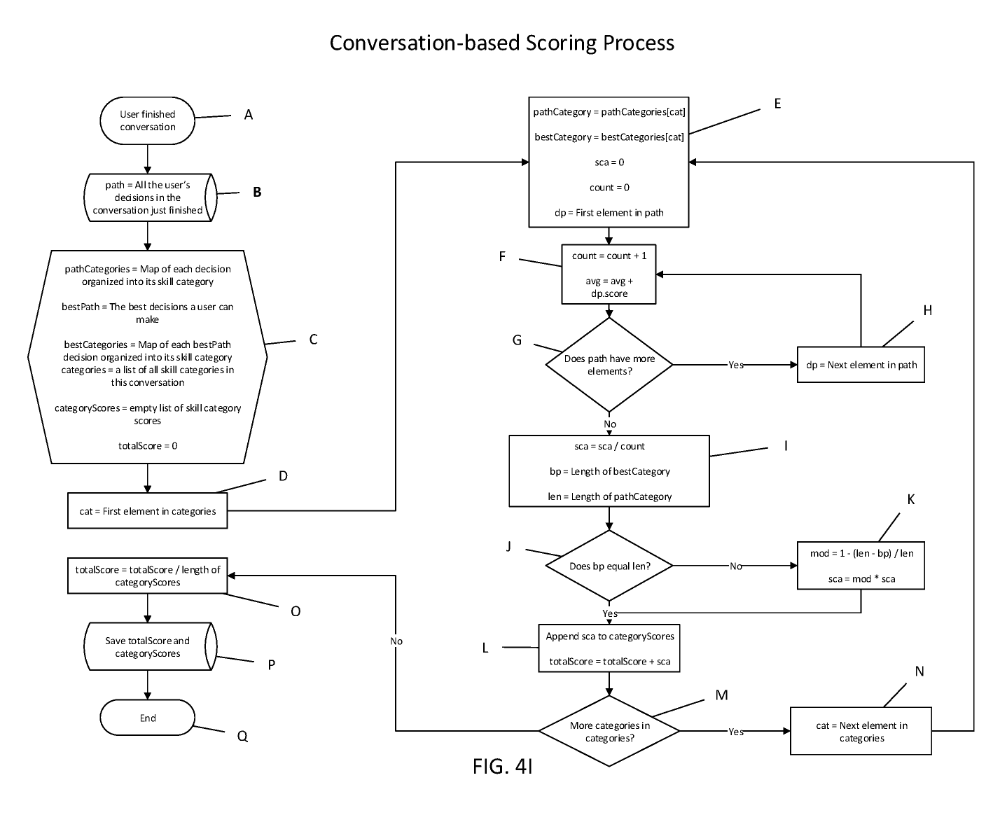

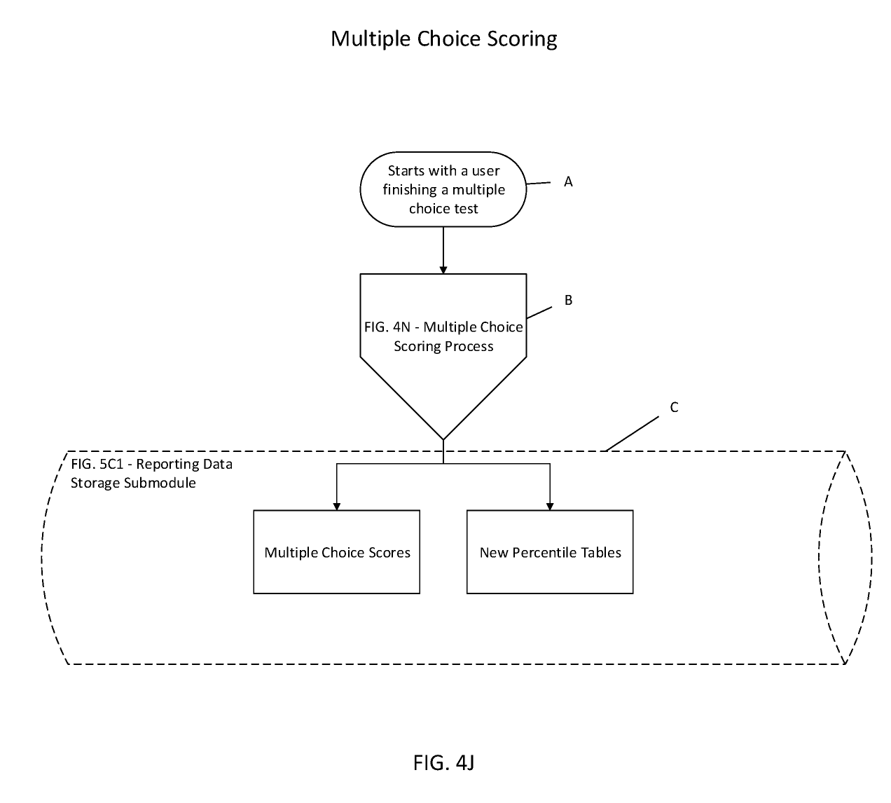

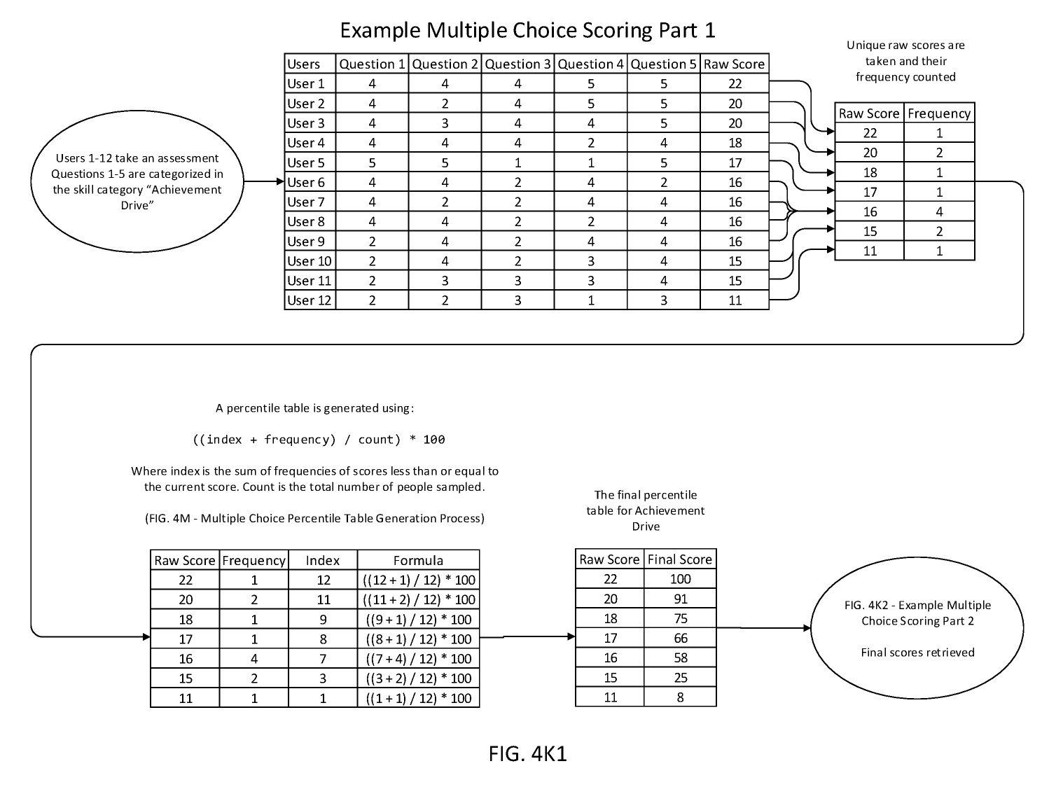

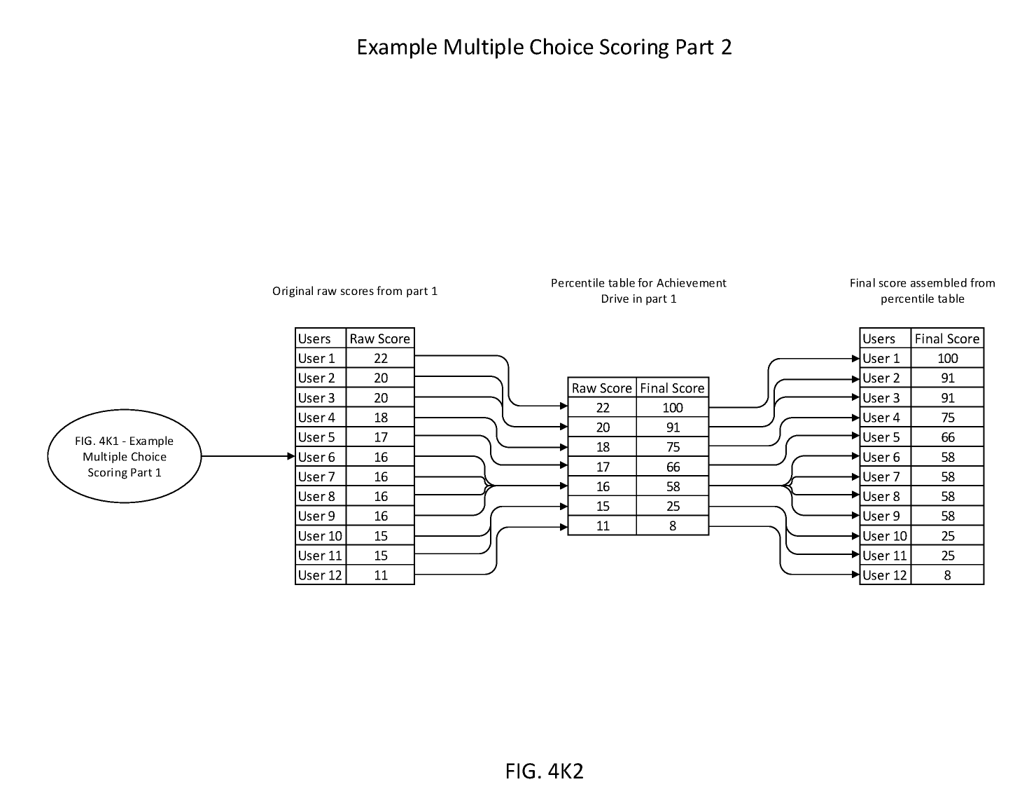

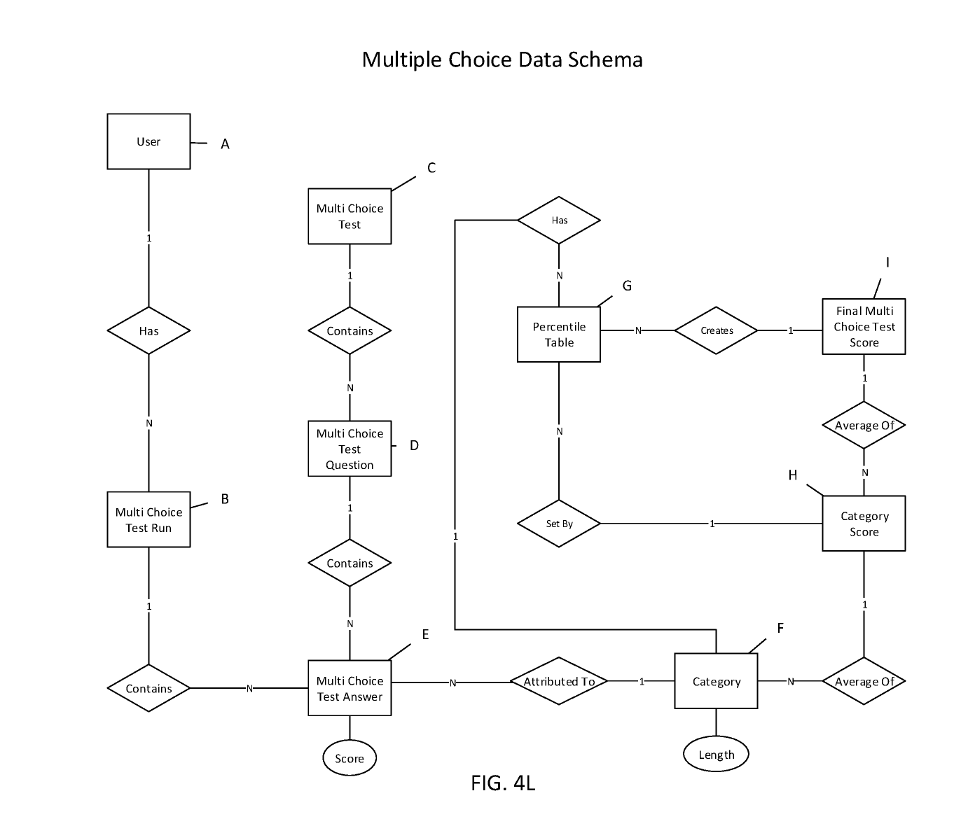

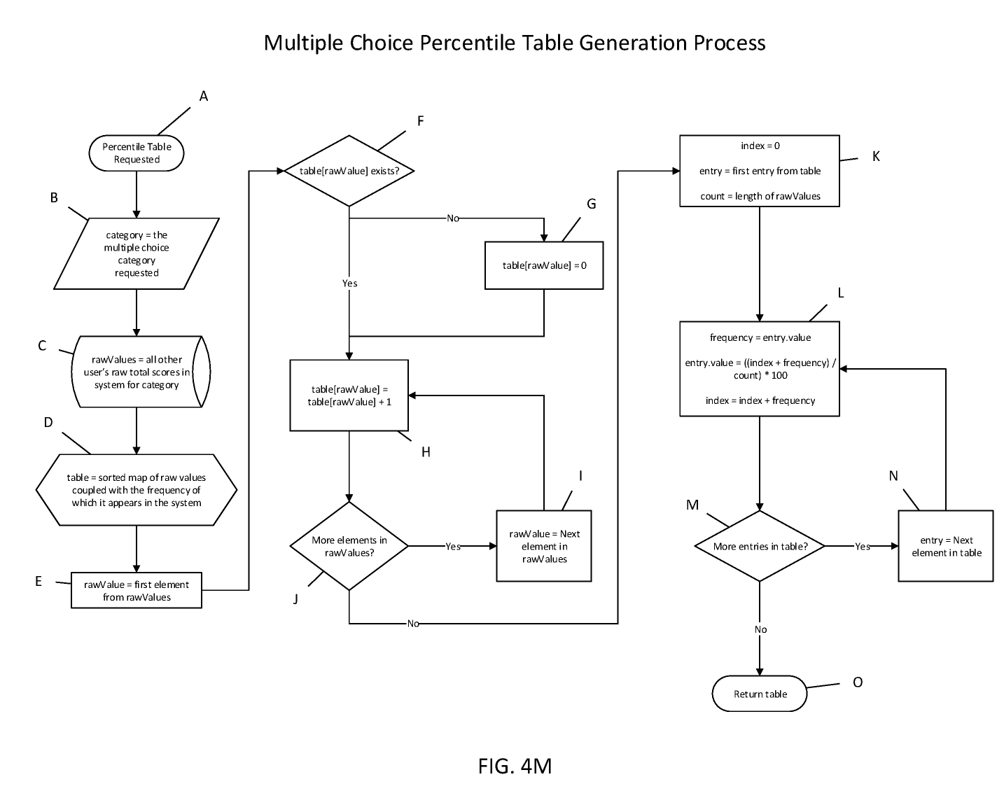

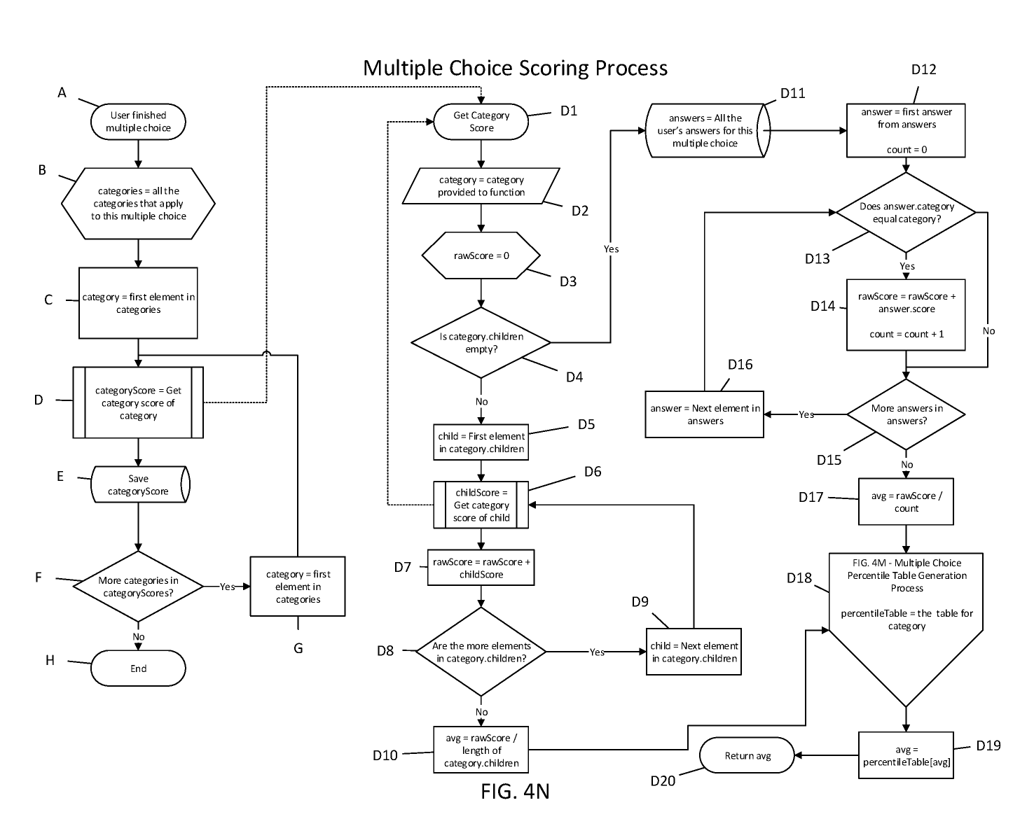

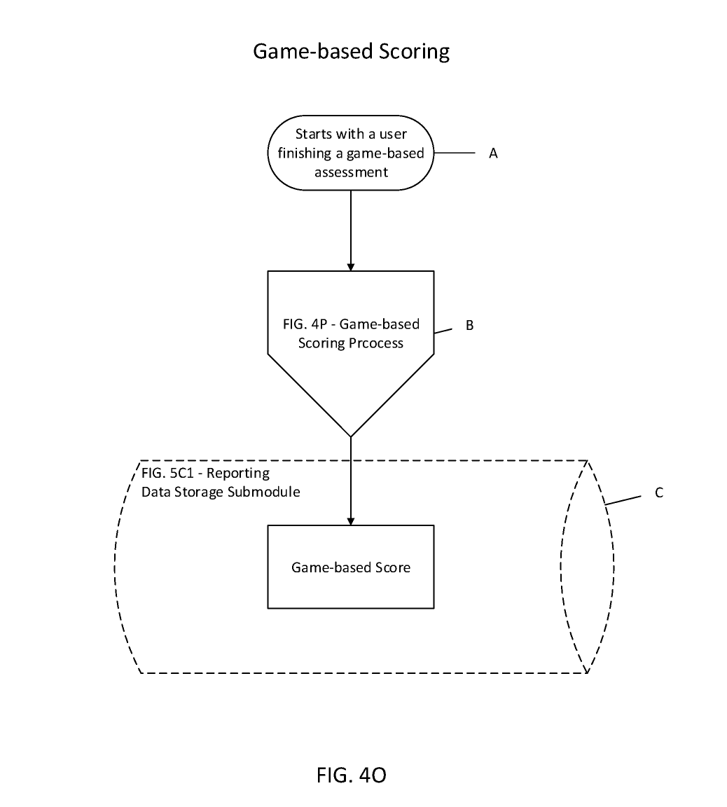

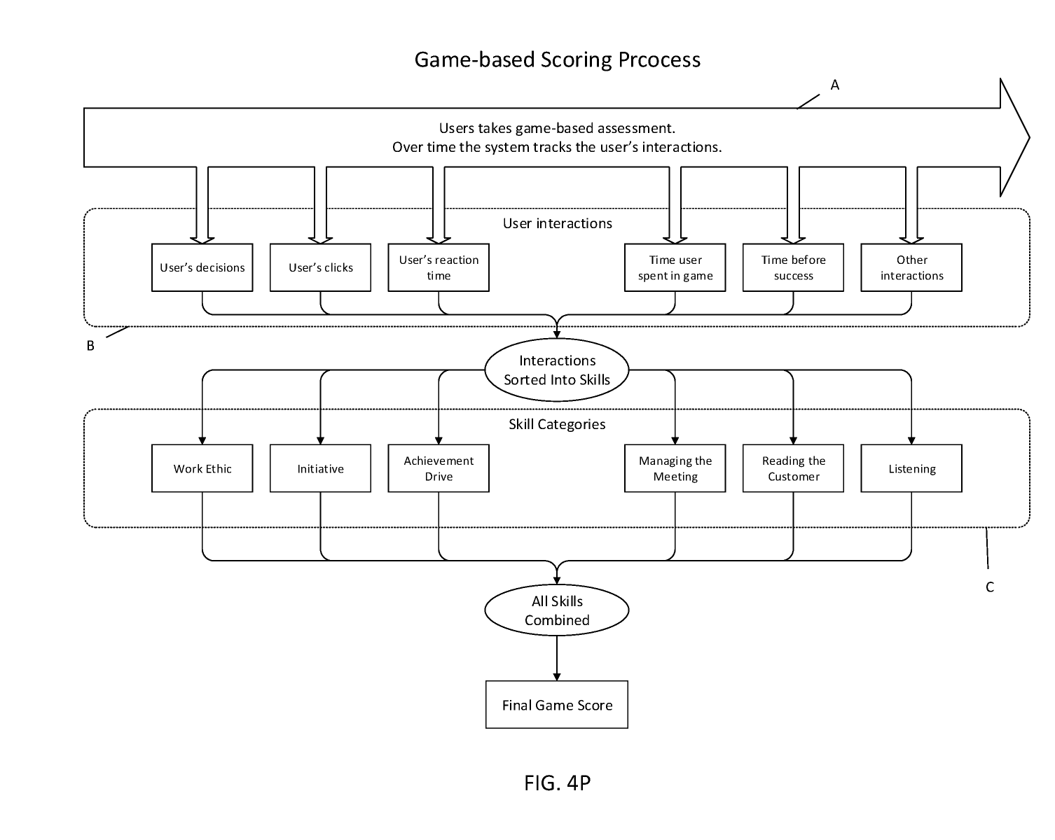

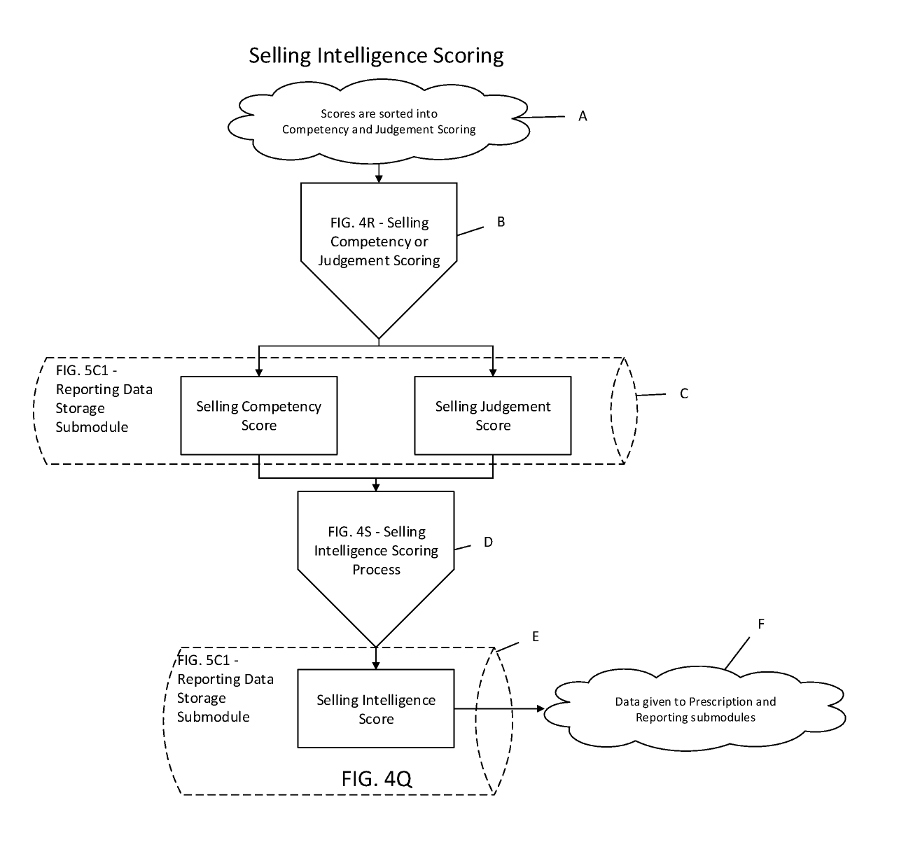

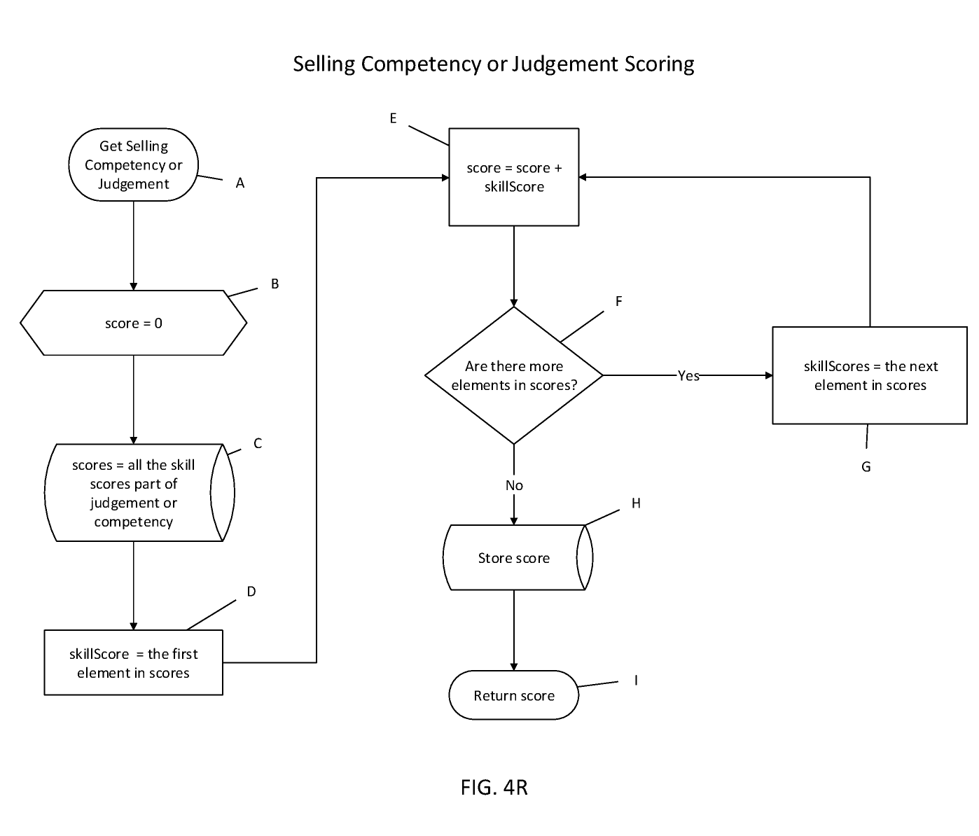

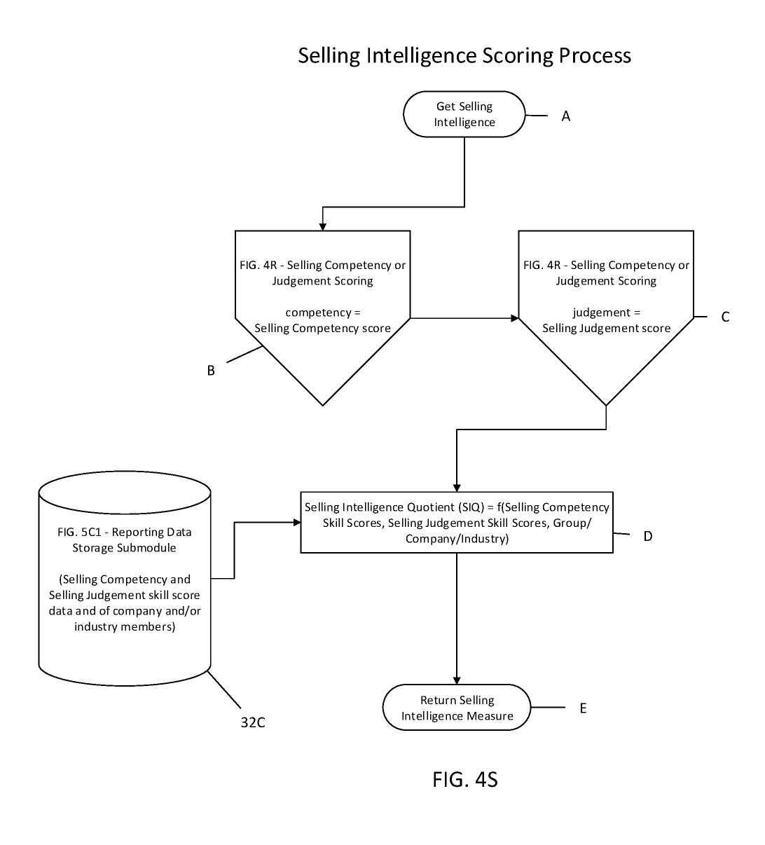

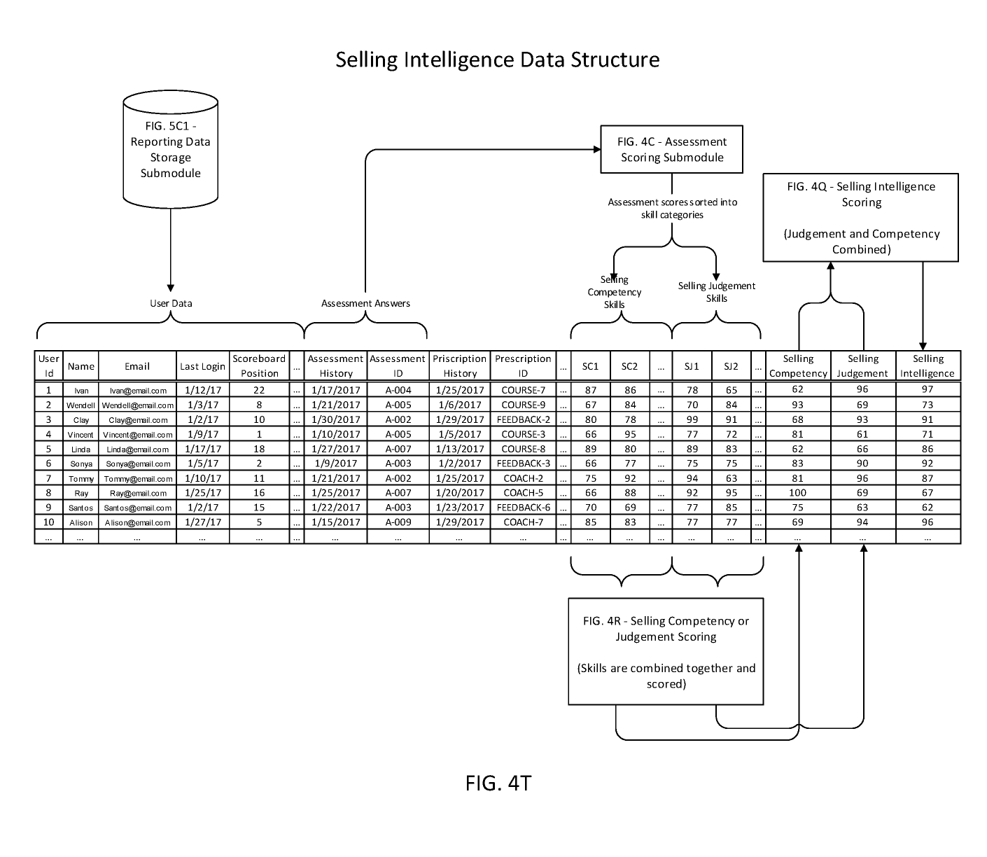

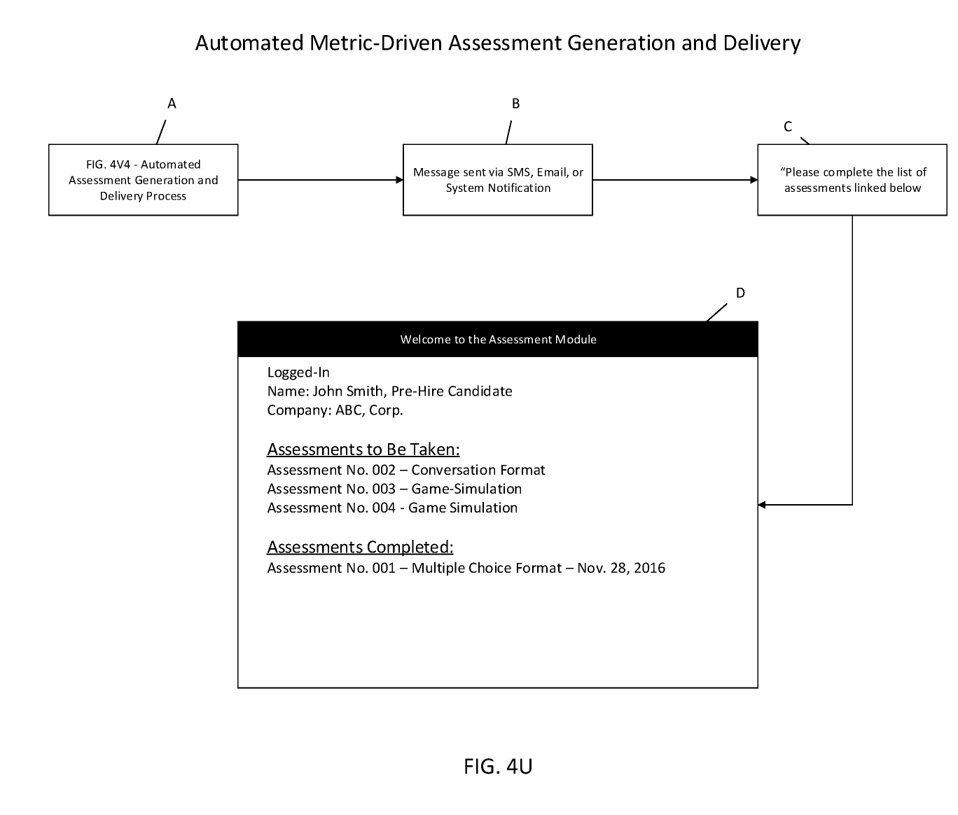

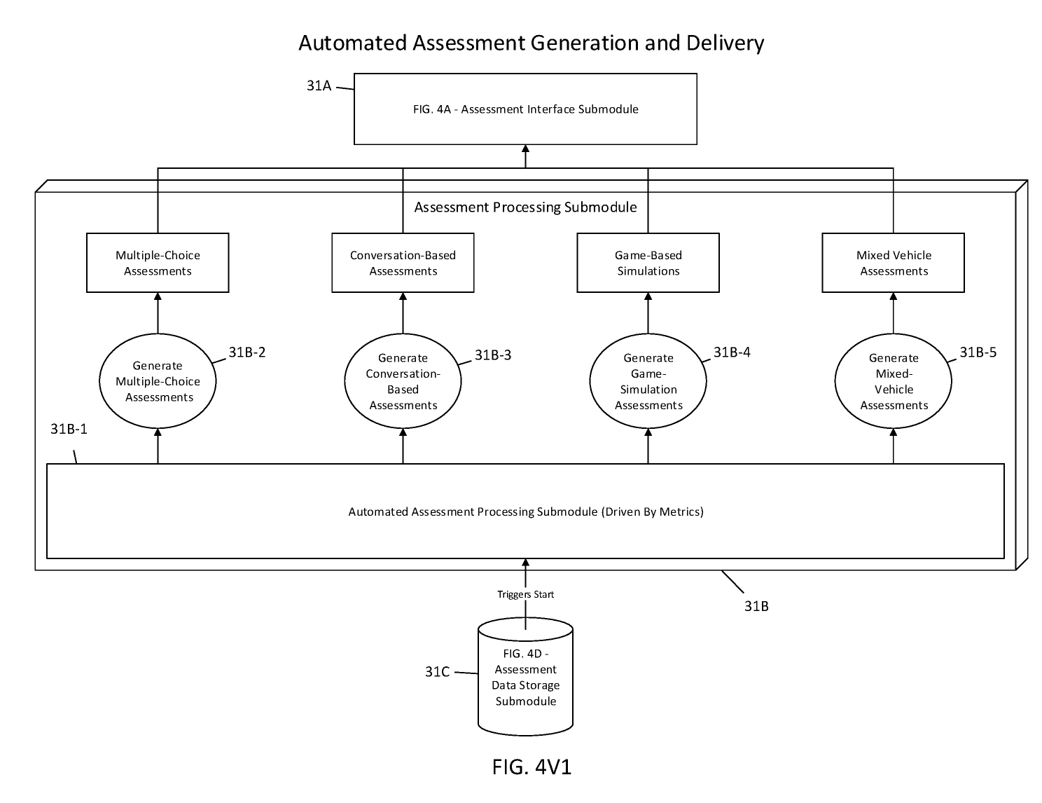

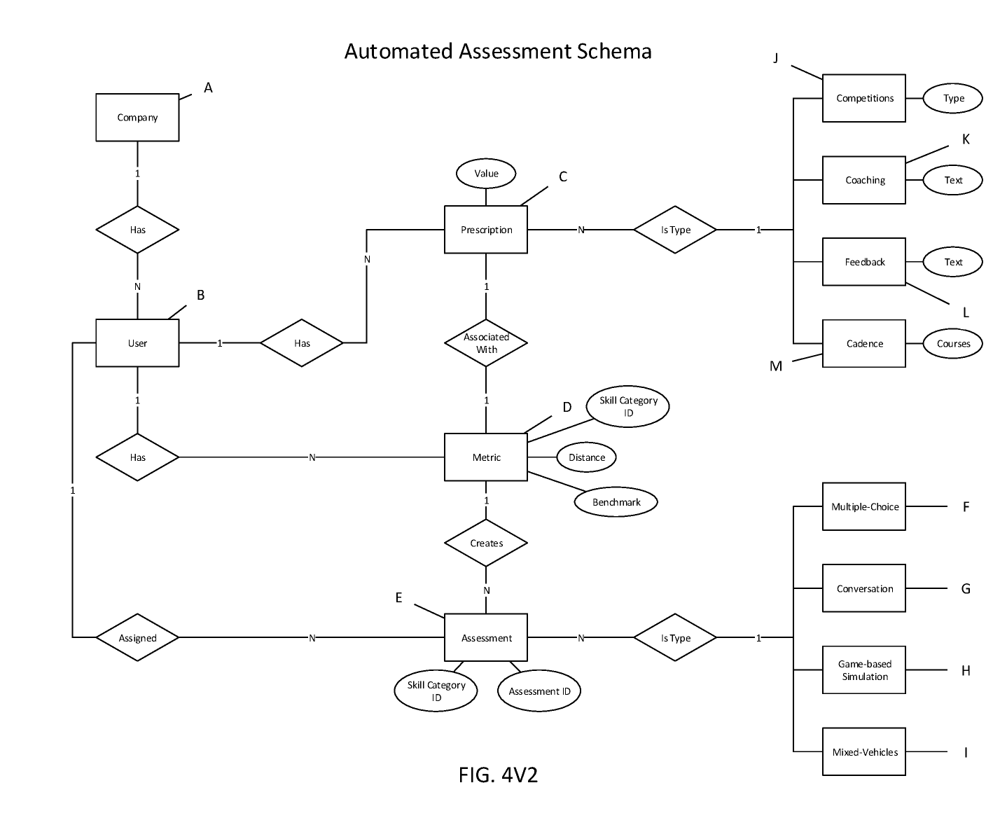

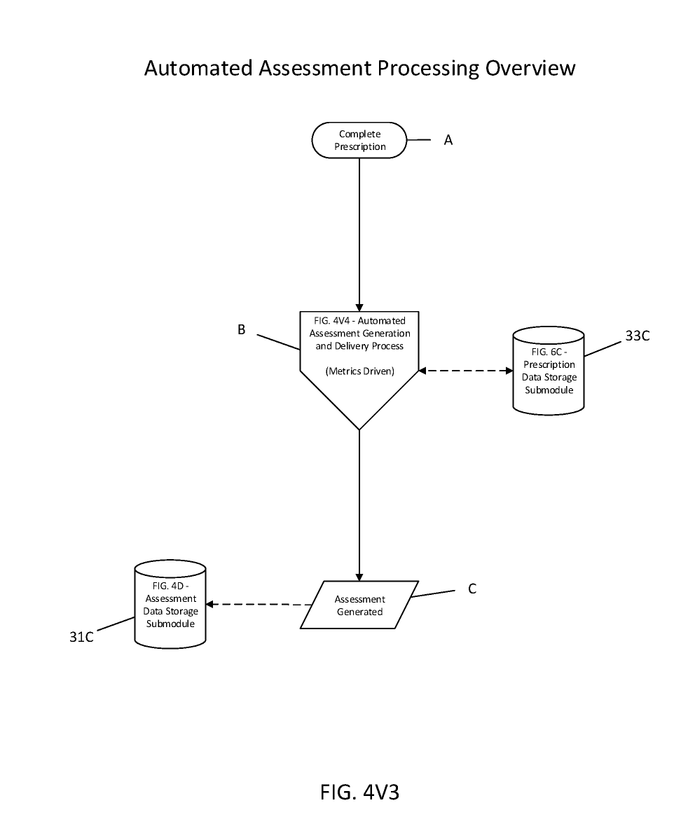

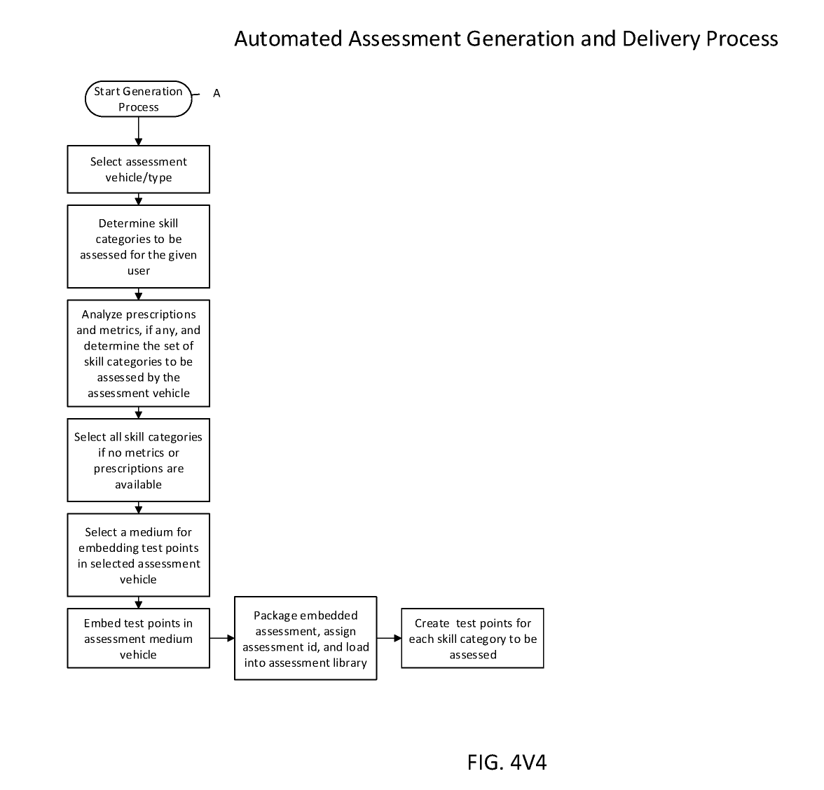

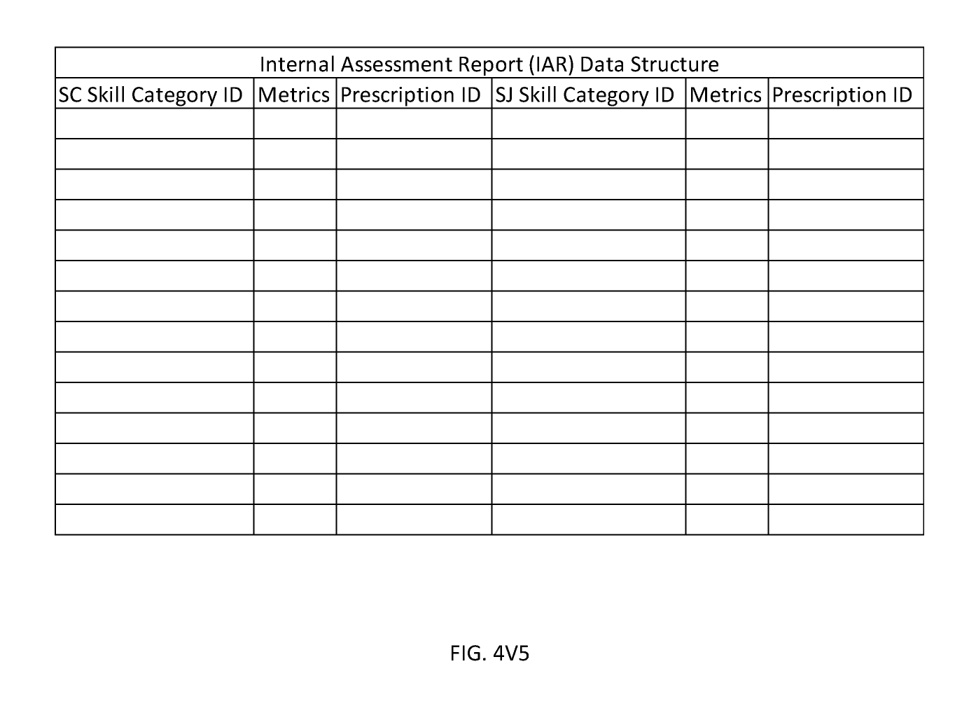

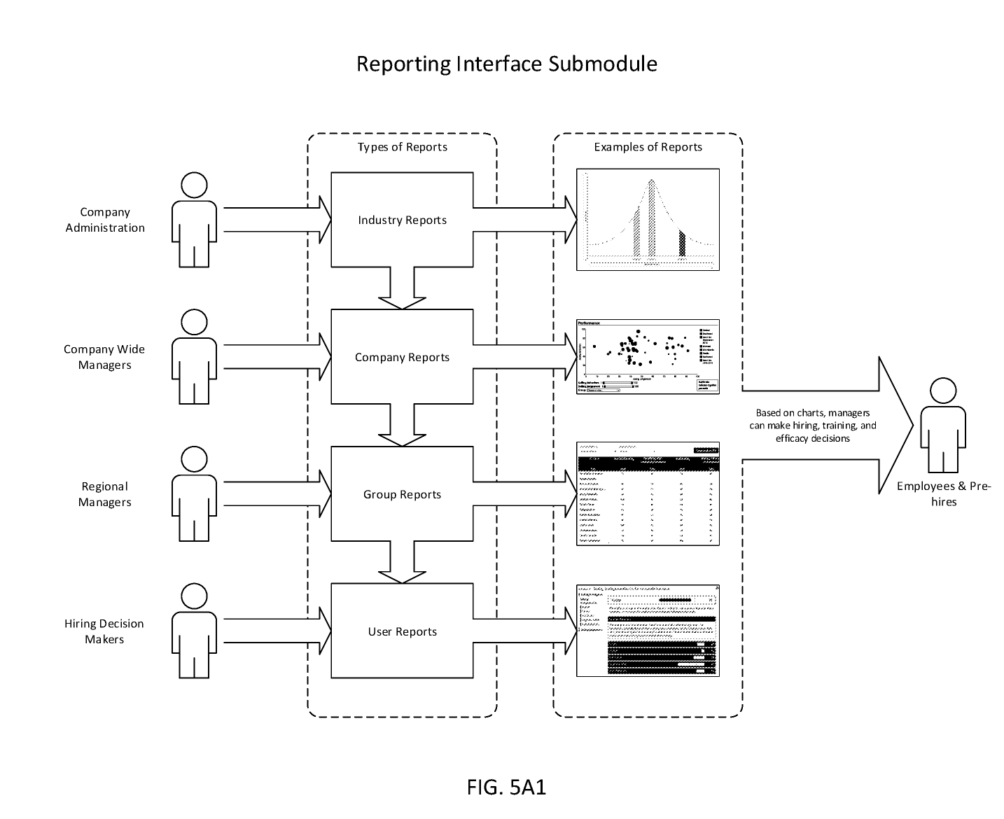

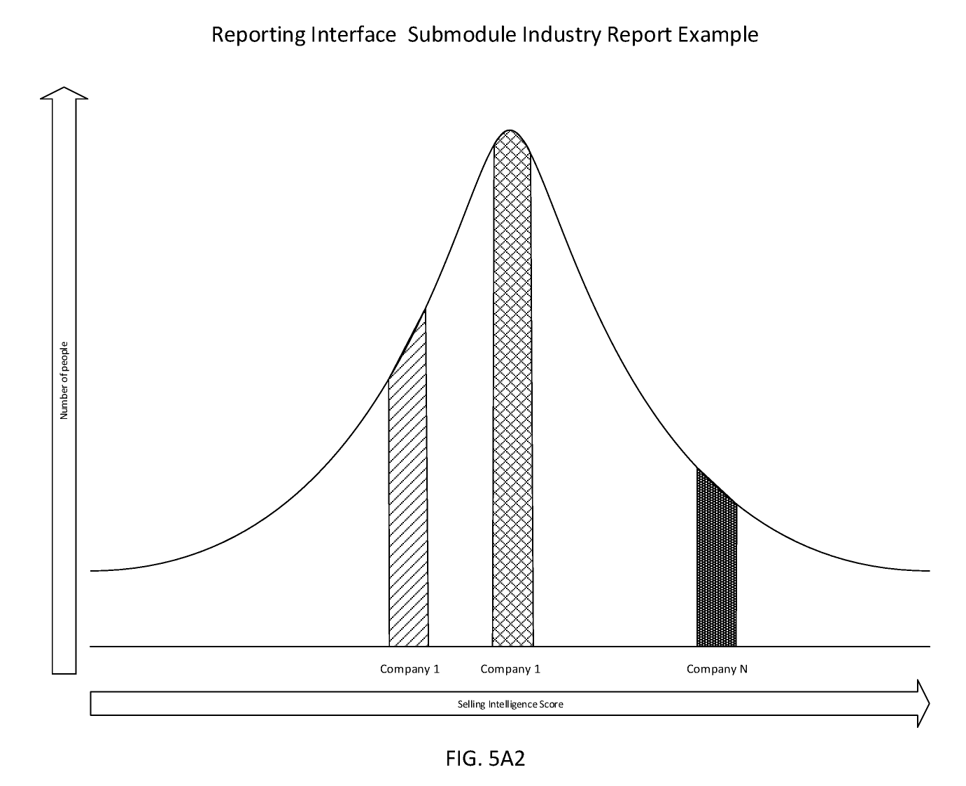

In the illustrative embodiment, the system 2 assesses the cognitive and behavioral skills that a salesperson uses to address and solve problems during the selling process. Such selling competency skills, described in the exemplary SCSC schema of FIG. 4E1, include N=30 lower-level selling competency skill categories (SCSCs), each SCSC indexed with a unique selling competency (SC) code. Notably, N is computed by summing all of the lower level SCSCs used in assessing the SCSC aspects of an individual, which construct and support the higher-level SCSCs, illustrated in FIG. 4E1.

The system 2 also assesses the cognitive skills that a salesperson applies in selling situations to successful close on a deal to solve problems during the selling process. Such selling judgment skills, described in the exemplary SJSC schema of FIG. 4E2, include M=43 lower-level selling judgement skill categories (SJSCs), each indexed with a unique selling judgement (SJ) code. Also, M is computed by summing all of the lower level SJSCs used in assessing the SJSC aspects of an individual, which construct and support the higher-level SJSCs, illustrated in FIG. 4E2.

As used herein and in the Claims, the term “selling judgement”, in contrast to “selling competency”, relates to an area of expertise which goes beyond selling competence. The most salient attributes of selling judgement would typically involve skills supporting an individual's capacity to make holistic and balanced decisions in situations of uncertainty and complexity, including the skills and capacities helpful in applying ones knowledge about a particular subject relating to a potential sale, successfully closing sales deals, and bringing about positive sales performance and results.

The system 2 automatically produces recommendations to management for helping sales representatives to work around weaknesses and develop prescriptive reinforcements of these important selling competency skills and selling judgement skills. Significantly, based on assessments of selling competency skills and selling judgment skills, the system 2 assesses, measures and determines the selling intelligence of an individual sales representative, pre-hire or employee, as the case may be, against other sales representatives who have been assessed by the system, and this unique selling intelligence (SI) measurement is used as a unique score and indicator of the salesperson's current success in a selling situation.

The system 2 can be used to address the complex recruitment challenges of any size company. For example, the system 2 can be used to assess the selling competency skills and selling judgment skills, and also the selling intelligence (SI) measure, of an entire sales team, among a variety of other critical attributes, so as to establish a view into the performance metrics of each salesperson and the company to which they belong.

Using the system 2 of the present invention, and selling intelligence measurements made thereby, sales leaders and manager alike are now able to more reliably and accurately identify where changes and reinforcements need to be made, and then administer courses of prescriptive training to improve the selling intelligence and sales performance of their salesforce members.

The selling intelligence assessment, development and management system 2 allows many different kinds of users to access various kinds of services, described in the service map of FIG. 2A, and supported by the enterprise-level system network 1. As will described and explained in great technical detail hereinafter, these services are used by the various stakeholders of any enterprise served by the system of the present invention.

### Specification of the Selling Intelligence Assessment, Development and Management System Supported on the System Network of the Present Invention

As shown in FIGS. 1A through 1D, the system network 1 comprises a number of components, namely: a plurality of client computing systems 3 operably connected to the TCP/IP infrastructure of the Internet 4; and a plurality of enterprise-level computer networks 5 supporting the various organizations (e.g. institutions, companies, groups and individuals) using and being served by the system network 1. As shown, these systems and networks are operably connected to the TCP/IP infrastructure of the Internet 4, and used by the various stakeholders of any enterprise served by the system network 1.

In the illustrative embodiment, the client computing systems 3 may include tablet computers, desktop computers, laptop computers, tablet computers, mobile devices, and VR game-based simulation systems with or without VR goggles. The enterprise-level computer networks 5 deployed by partners and users operably connected to the mirrored data center(s) comprise computer servers and client machines internetworked using firewalls, routers, switches, hubs and the like, over high-speed data communication mediums well known in the computer networking and security art.

FIG. 1C illustrates the multi-tier system architecture of the data center component 6 of the system network 1 illustrated in FIGS. 1A and 1B. As shown, the industrial-strength data centers 6 preferably mirrored with each other and running Border Gateway Protocol (BGP between its router gateways, comprises: a cluster of communication servers 8 (supporting http and other TCP/IP based communication protocols on the Internet and hosting Web sites) accessed by web-enabled clients (e.g. smart phones, wireless tablet computers, desktop computers, computer workstations, etc.) 3 used by individuals users, managers et al, through the infrastructure of the Internet; a cluster of application servers 9 for storing and executing modules of code in the many core and compositional object-oriented software modules supporting the system network of the present invention, and generating processes having a server-side and a client-side and supporting a graphical user interface (GUI) based environment available on the client-side and displayed on the client systems; a scalable, distributed computing and data storage system network 10, including a cluster of DBMS servers, based, for example on the Apache Hadoop(R) Java frameworks that enables applications to work with thousands of nodes and petabytes of data, and for using SQL to query and manage large datasets residing in such a distributed storage environment, to provide an information file storage and retrieval system including (i) a database server for organizing information files associated with information objects organized and managed in said communication system network, and (ii) information storage devices for storing the information files associated with the information objects; web-enabled client SMS gateway servers and a cluster of email processing servers 7 supporting integrated email and SMS messaging, handling and processing services that enable flexible messaging across the system network; a plurality of CRM, video and social media servers, 11 (e.g. Salesforce® CRM server network, SugarCRM® Server Network, Google Server Network, YouTube Server Network, Facebook Server Network, Vimeo Server Network, talent development/management servers, etc.) operably connected to the infrastructure of the Internet 4. All of these servers are operably connected to a high-speed local data communications network supporting TCP/IP. For technical details on TCP/IP, reference should be made to “THE TCP/IP GUIDE” by Charles M. Kozierok published by No Starch Press, Inc. San Francisco, Calif., incorporated herein by reference. http://www.tcpipguide.com/free/t_TheTCPIPGuideIntroductionandGuideToTheGuide.htm

As shown, many client computing systems and workstations 3 are deployed to access the data center 6 through the TCP/IP infrastructure 4, by users of the system network 1, such as sales representatives, CEOs, human resource officers, and managers; as well as administrators of companies who have subscribed to the services of the system network 1. These Web-enabled client machines 3A, 3B, and 3C (e.g. desktop computers, mobile computers such as iPad, and other Internet-enabled computing devices with graphics display capabilities, etc.) can run native mobile applications and/or mobile web browser applications supported modules, supporting client-side and server-side processes on the system network 1. These client systems 3 are operably connected to the infrastructure of the Internet 4, and each client subsystem 3 has a computing platform and a display screen for displaying graphical user interfaces (GUIs) associated with one or more programs executing on the computing platform, and supporting services for system users on the system network 1; wherein each client subsystem 3 supports the client-side of said processes generated by said one or more modules of object-oriented code executing on said one or object-oriented application servers 9; and wherein the application servers 9 and said modules are configured so that system users can receive the following enumerated services, through said GUI screens displayed on the display screen of each client system 3.

FIG. 1C illustrates the network architecture of the system network 1 for the case where the system 2 is implemented as a stand-alone platform designed to work independent from but alongside of one or more other information networks deployed on the Internet. The advantage of this particular standalone system network realization would be great freedom in implementing terms and conditions and privacy policies of the system network. Typically, all computing, storage and communication resources required by the system network 1 will be independent from other business networks 12 and media sharing systems, with which the system network 1 is seamlessly integrated.

Alternatively, the data center 6 can be integrated with the data centers of one or more enterprise-level CRM system networks, to provide the services of the present invention to all customers of these CRM platforms. The data center 6 may also be integrated with the data centers of other enterprise-level systems designed for developing talent, providing professional training, or other services.

In an illustrative embodiment, the system network 1 will be realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (DOSE) methods using UML-based modeling tools such as IBM® Rational ROSE® Enterprise by IBM, Inc. using an industry-standard Rational Unified Process (RUP) or Enterprise Unified Process (EUP), both well known in the art. Implementation programming languages can include C, Objective C, C⁻, Java, PHP, Python, Google's GO, and other computer programming languages known in the art. Preferably, the system network is deployed as a three-tier server architecture with a double-firewall, and appropriate network switching and routing technologies well known in the art. Deployment can be done in many different ways including, for example, using Amazon Web Services (AWS), CloudFoundary and other enterprise-level deployment environments well known in the art.

### Alternative Ways of and Means for Implementing the System and System Network of the Present Invention

In general, the system network 1 and system 2 of the present invention, shown in the Drawings and described in the present Patent Specification, can be implemented in various ways using diverse techniques and technologies. This may include, for example, using digital electronic circuits, analog electronic circuits, or a mix of digital and analog electronic circuits specially configured and programmed to realize the functions and modes of operation to be supported by the system. The digital integrated circuitry (IC) can include low-power and mixed (i.e. digital and analog) signal systems realized on a chip (i.e. system on a chip or SOC) implementation, fabricated in silicon, in a manner well known in the electronic circuitry art. Such implementations can also include the use of multi-CPUs and multi-GPUs, as may be required or desired for the particular product design based on the systems of the present invention. For details on such digital integrated circuit (ID) implementation, reference can be made to any number of companies and specialists in the field including Cadence Design Systems, Inc., Synopsis Inc., Mentor Graphics, Inc. and other electronic design automation firms.

As indicated above, the system network of the present invention can also be an implemented as rationally-developed object-oriented software-based system engineering project deployed on a system network supported by TCP/IP, employing a client-server networking architecture well known in the computer programming and networking arts.

For purpose of illustration, the digital circuitry implementation of the system can be an architecture of components configured around SOC or like digital integrated circuits. The system can comprise various components, such as: a SOC sub-architecture including a multi-core CPU, a multi-core GPU, program memory (DRAM), and a video memory (VRAM); a solid-state hard drive; a LCD/touch-screen display panel; a microphone/speaker; a keyboard; WIFI/Bluetooth network adapters; and power supply and distribution circuitry; all being integrated around a system bus architecture and supporting controller chips.

### Different Ways of Implementing the Client Machines and Devices Deployed on the System Network of the Present Invention

In one illustrative embodiment, the system network of the present invention 1 is realized as a suite of hosted services delivered to Web-based client subsystems using an application service provider (ASP) model. In this embodiment, the Web-enabled clients 3 can be realized using a web-browser application running on the operating system (OS) of a computing device (e.g. Linux, Application IOS, etc.) to support online modes of system operation, only. However, it is understood that some or all of the services provided by the system network can be accessed using Java clients, or a native client application running on the operating system of a client computing device, to support both online and limited off-line modes of system operation. In such embodiments, the native application would have access to local memory (e.g. a local database) supported on the client device, accessible during off-line modes of operation to enable consumers to use certain or many of the system functions supported by the system network during off-line/off-network modes of operation.

During such off-line modes of operation, supported by native application implemented client subsystems, the system users (e.g. consumers) can also perform certain system functions (i.e. receive certain services) such as, for examples, assessments, reports and prescriptions, with the understanding that the such operations will be completed, if and as necessary, when the client system, running the native application, goes back online, i.e. restores connectivity with the system data center 6 and synchronization between all clients and system servers has automatically taken place. Notably, mobile native application implemented client systems 3 are preferred over web-browser implemented client systems because the former offers off-line modes of operation which can be valuable when system users are located in remote regions, where network connectivity is not available, but when users have time to take preloaded assessments using various vehicles (e.g. multiple-choice questions, conversations, and game-based simulations) and preloaded prescriptions using recent data stored locally in the client machine's database and/or persistent data storage devices.

### Specification of System Architecture of an Exemplary Mobile Client System Deployed on the System Network of the Present Invention

FIG. 1D shows the system architecture of an exemplary client system 3 deployed on the system network 1 supporting the many services offered by its system network servers. As shown in FIG. 1D, the client device 3 can include a memory interface 15, one or more data processors 16, I/O subsystem 17, and a systems user interface 18 shown comprising numerous components (i.e. network interface, audio interface, 3D VR goggles/headsets, microphone, touchscreen, mouse/pointer, keyboard, screen display, and other subsystems) arranged around one or more system buses well known in the art.

The memory interface 15, the one or more processors 16 and/or the I/O subsystem 17 can be separate components or can be integrated in one or more integrated circuits. As shown, a network interface 27 is provided to interface the client system 3 to one or more communication networks including system network 1. Typically, network interface 27 will include radio frequency (RF) signal receivers and transmitters and/or optical (e.g., infrared) signal receivers and transmitters. The specific design and implementation of the network interface 27 can depend on the communication network(s) over which the client device 3 is intended to operate. For example, a wireless device 3 may include communication subsystems and network interfaces designed to operate over a GSM network, a GPRS network, an EDGE network, a Wi-Fi or WiMax network, and a Bluetooth™ network. In particular, wireless communication subsystems may include hosting protocols such that the device may be configured as a base station for other wireless devices. An audio subsystem 19 can be coupled to a speaker and a microphone 21 to facilitate voice-enabled functions, such as voice recognition, voice replication, digital recording, and telephony functions including VOIP services.

The system user interface 18, supported on the client system 3, can include a touch screen and touchscreen controller 22 and/or other input controller(s). The touch screen and touch screen controller 22 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 22. As shown, the system user interface 18 includes a keyboard 24, a screen display 25, a pointing mouse 23, and 3D VR goggles/headsets 20.

Other subsystems 26 within the client machine 3 can include controllers for VR gaming, speech recognition, eye-tracking, heart-rate sensing, bio-sensing, and touch-screen graphical interface objects, touched and controlled by the system user, and sensors, devices, and subsystems that can be coupled to the system user interface to facilitate multiple functionalities. For example, a motion sensor, a light sensor, and a proximity sensor can be coupled to the system users interface 22 to facilitate the orientation, lighting, and proximity functions. Other sensors can also be connected to the system user interface 18, such as a positioning system (e.g., GPS receiver), a temperature sensor, a biometric sensor, a gyroscope, or other sensing device, to facilitate related functionalities. A camera subsystem and an optical sensor, e.g., a charged coupled device (CCD) or a complementary metal-oxide semiconductor (CMOS) optical sensor, can be utilized to facilitate camera functions, such as recording photographs and video clips. Additional features of client computing machine 3 can be found in U.S. Pat. No. 8,631,358 incorporated herein by reference in its entirety.

In the illustrative embodiment, client systems 3 have a GUI-based operating system, running client software applications, including web browsers, to communicate with servers in the data center 6 so that system users can remotely access, support and receive client services supported on the system network of the present invention.

### Specification of Services Supported on the System Network of the Illustrative Embodiment of the Present Invention

FIG. 2A shows a services map that describes the various services delivered to various users (e.g. leadership/managers and employees and pre-hires) using diverse client machines 3 deployed on the system network 1. As shown in FIG. 2A, the services provided by the system 2 are organized in two ways: (i) by the primary module that supports the service; and (ii) by the class of users who may access the service on the service platform.

As shown, the assessment module 31 delivers the following services to leadership: (i) managers review, update and approve current assessments in the Assessment Library; and (i) managers/leadership create and approve new assessments for cataloguing in the Assessments Library.

As shown, the assessment module 31 delivers the following services to employees and pre-hires: (i) users take assessments—i.e. users take one of the assessment vehicles which are then scored into skills which drive the other modules; and (ii) users learn from assessments—i.e. some assessments can be geared to teach users new skills.

As shown, the reporting module 32 delivers the following services to leadership: (i) view individual pre-hire reports—that determine which candidates are worth hiring; (ii) view individual employee reports—determine where current employees can improve and where best to deploy them; (iii) view group reports—that show how series of users in a team or region is performing; (iv) view a company wide report—that show performance of all users in the company; and (v) view an industry wide report—that shows how the company stacks up versus other companies registered in the system.

As shown in FIG. 2A, the reporting module 32 delivers the following services to employees and pre-hires: (i) view individual reports—that allow users to see how they are doing and what skills need to be improved.

As shown in FIG. 2A, the prescription module 33 delivers the following services to leadership: (i) receive automated feedback—information generated from the system telling managers on the next steps to take for employees and pre-hires; (ii) layout courses—where managers can layout lesson plans or syllabi. These are assigned to users and tell users to take assessments to improve or test skills.

As shown in FIG. 2A, the prescription module 33 delivers the following services to employees and pre-hires: (i) take courses where users are assigned courses which they can take and learn to improve their selling competency and judgement skills; (ii) receive automated coaching—where the coaching is given to representatives on how to best improve their skills; (iii) compete with others—by allowing users to revise the scoreboard and their achievements, so that competition with other users in the system encourages them to use the system more and increase their ranking on the leaderboard and gain more achievements; and (iv) view learning material—users review documents that will help them improve scores on administered assessments.

### Specification of the System Architecture for the System Network of the Illustrative Embodiment of the Present Invention

FIG. 2B illustrates that the system 2 comprises three system layers, namely: a system user interface layer 34, a scoring and processing layer 35, and a data storage layer 36. Also, the system network comprises three system modules, namely: an assessment module 31; a reporting module 32; and a prescription module 33.

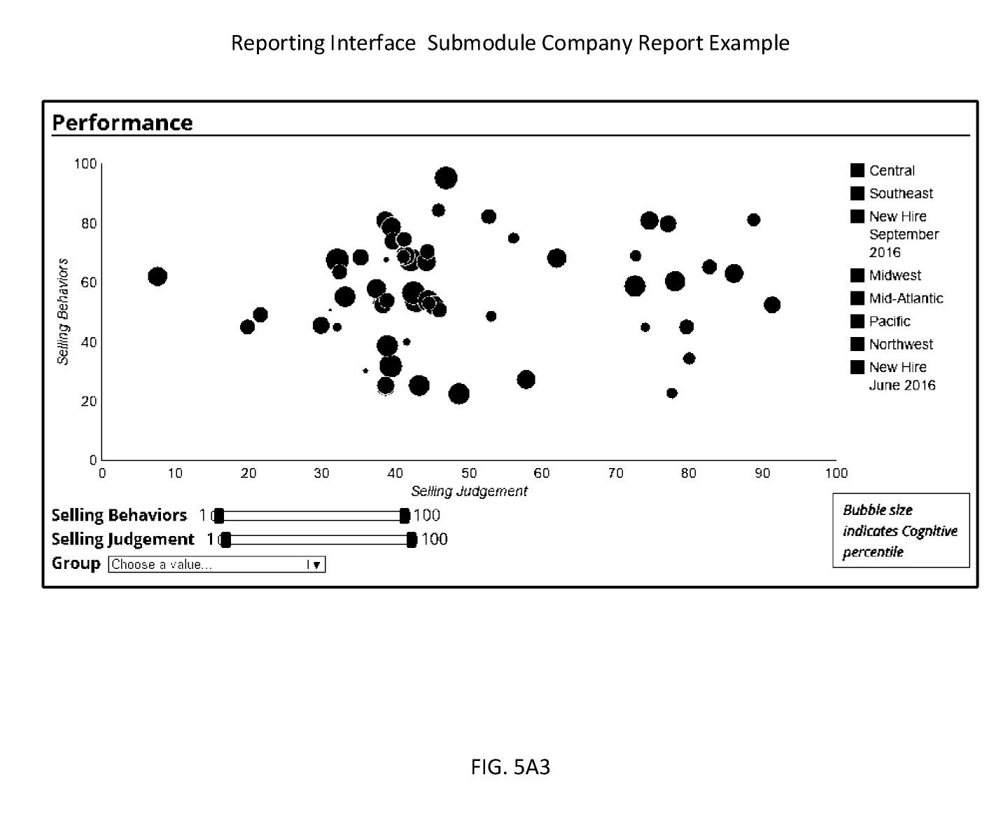

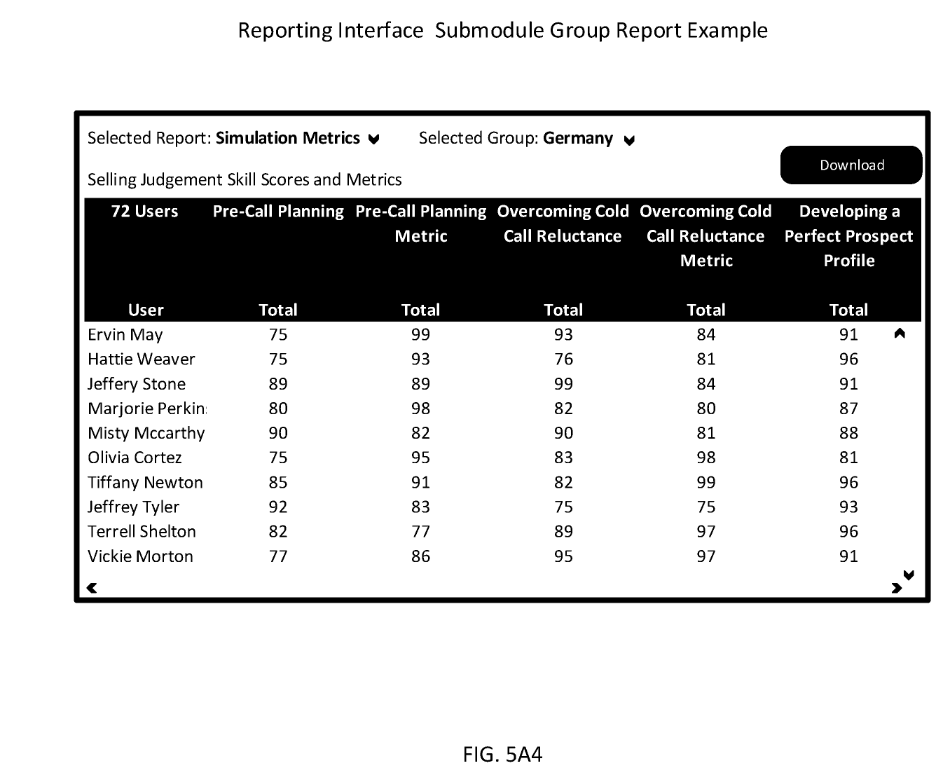

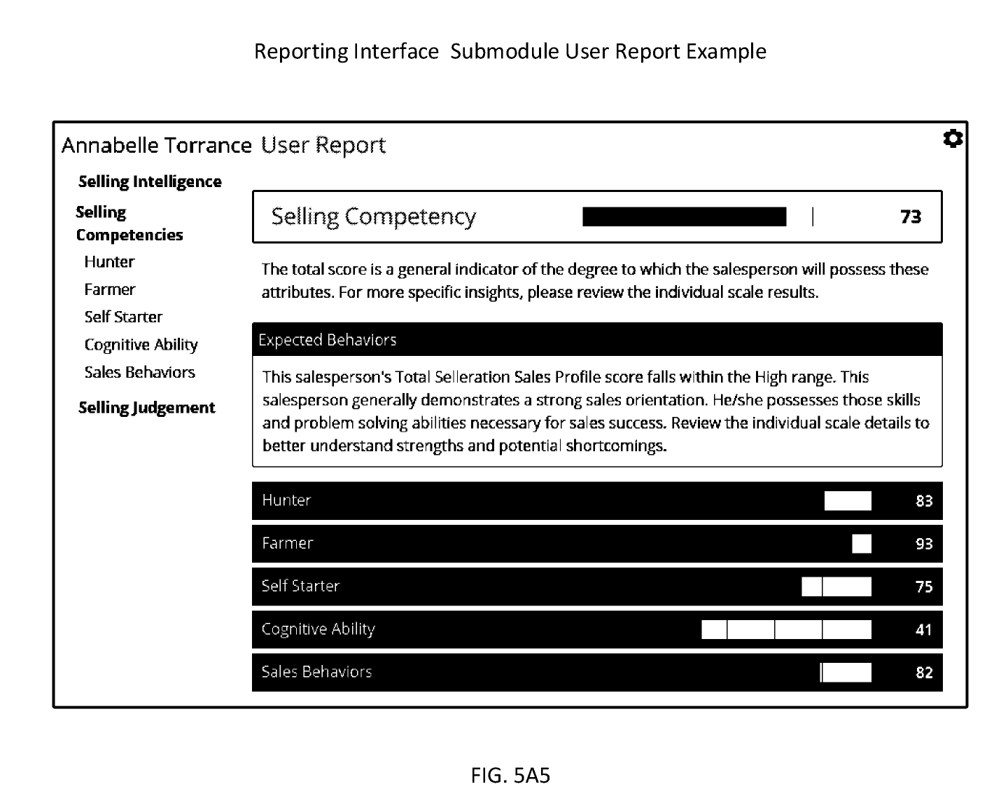

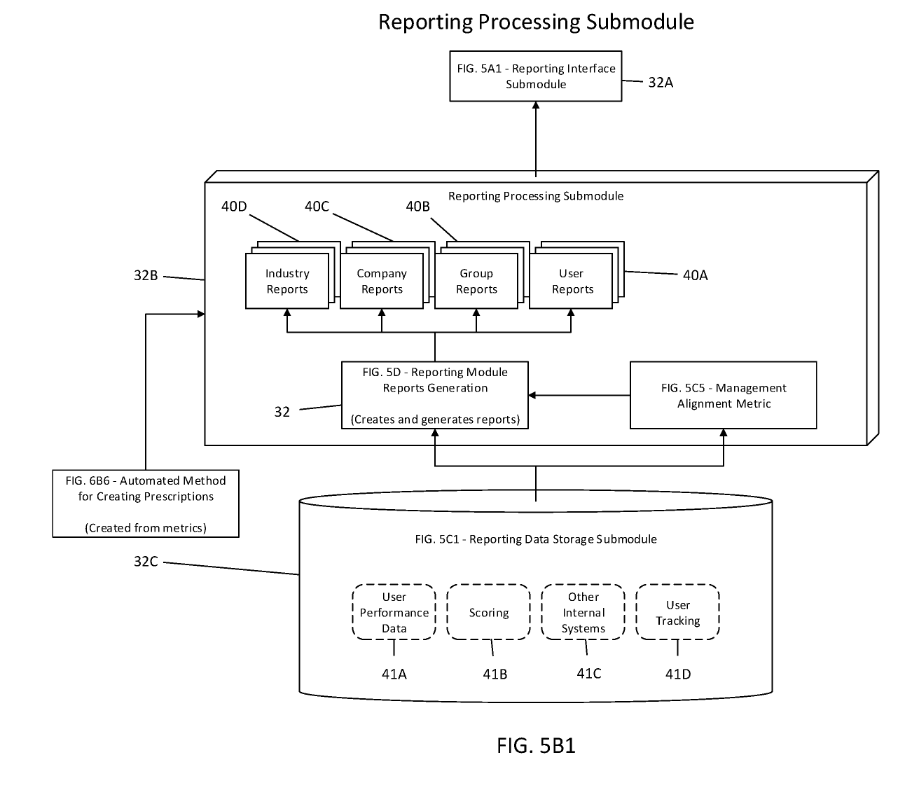

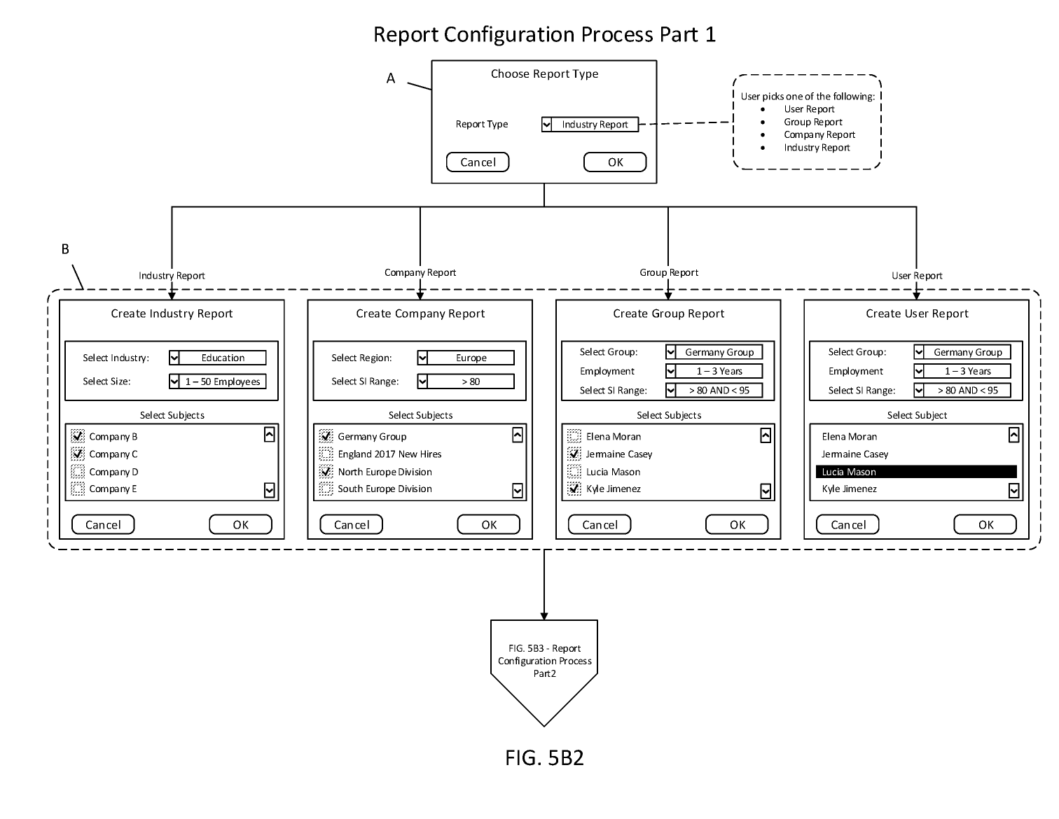

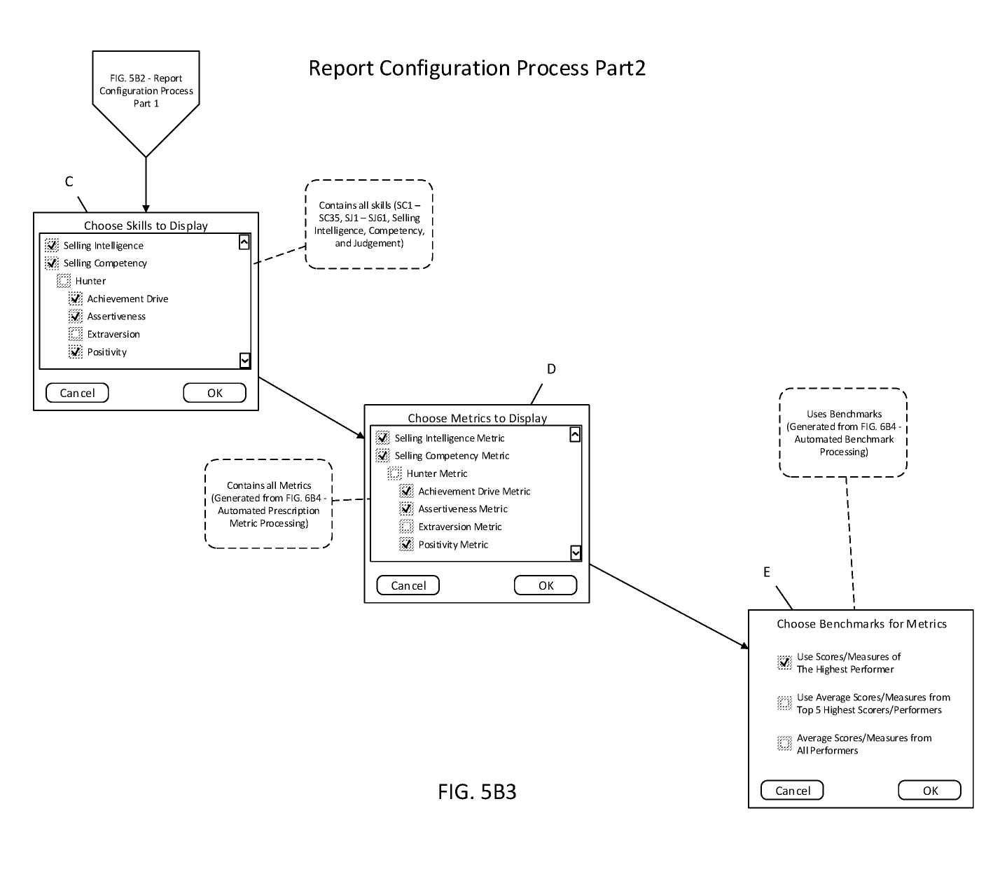

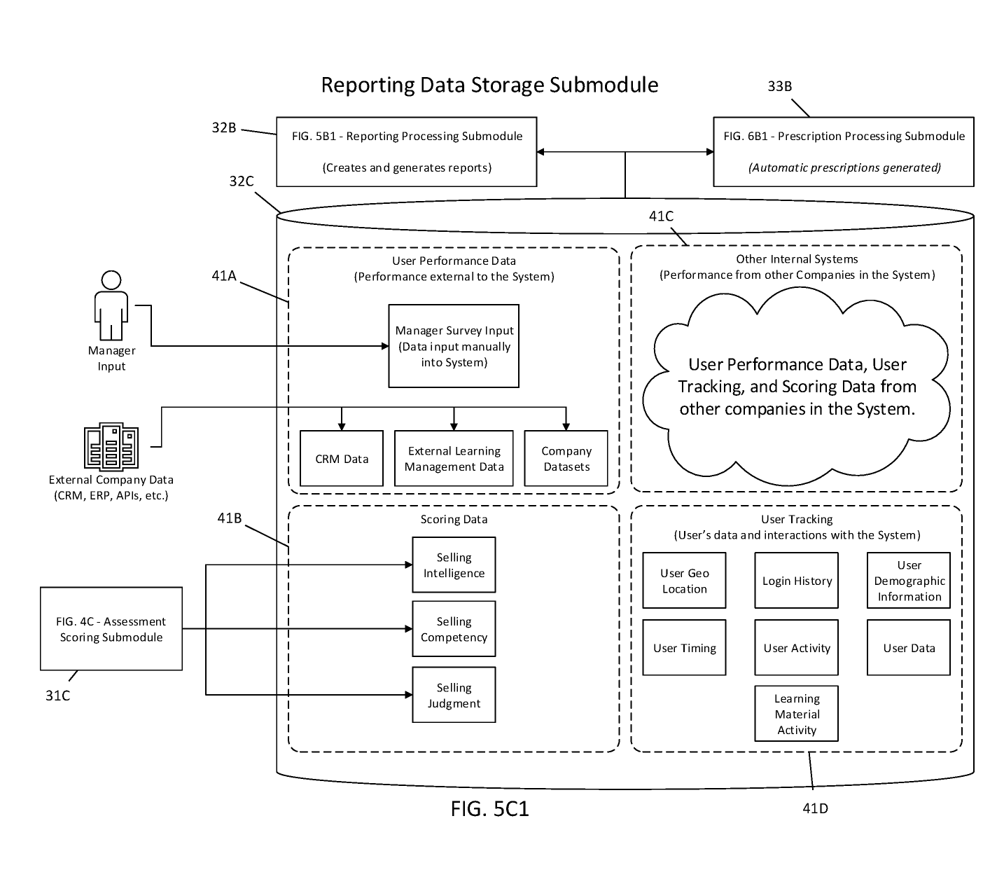

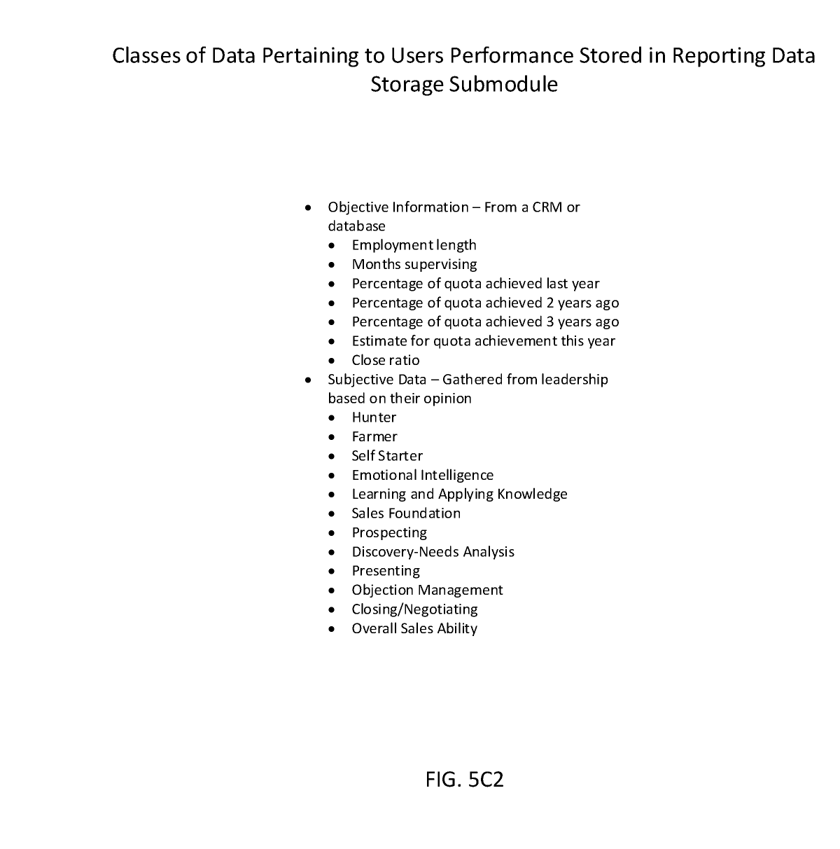

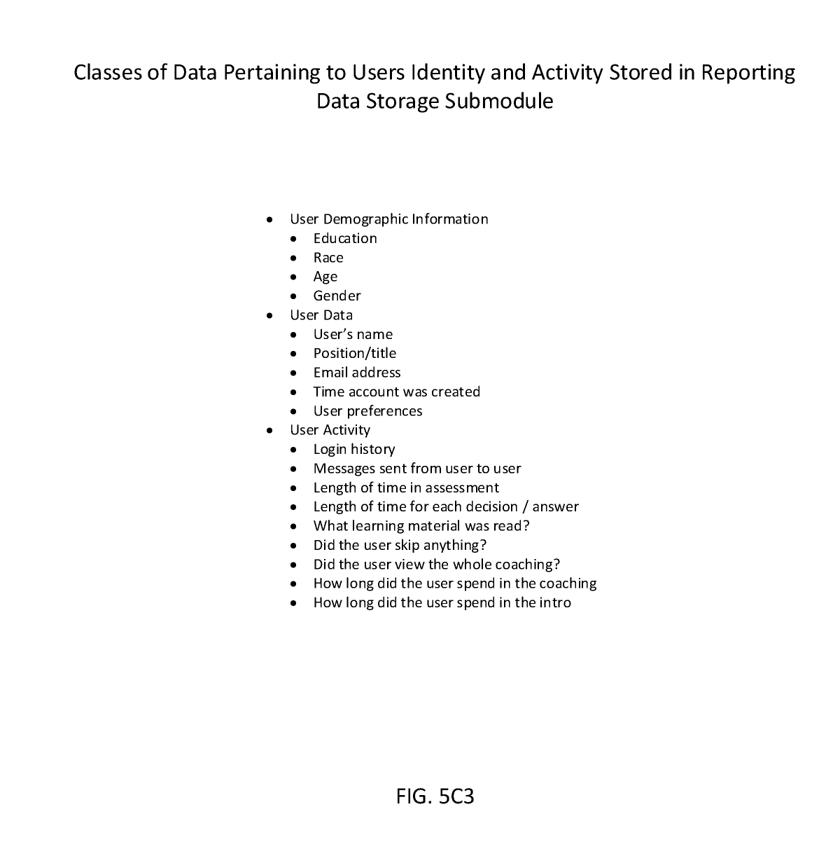

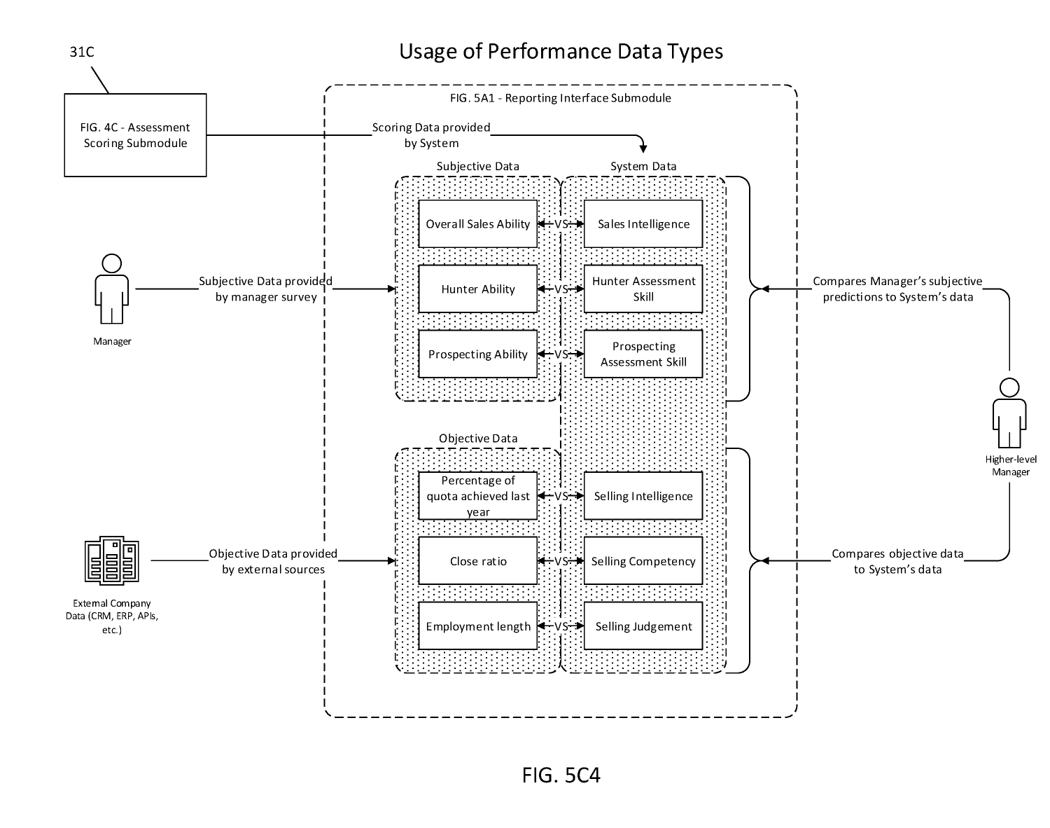

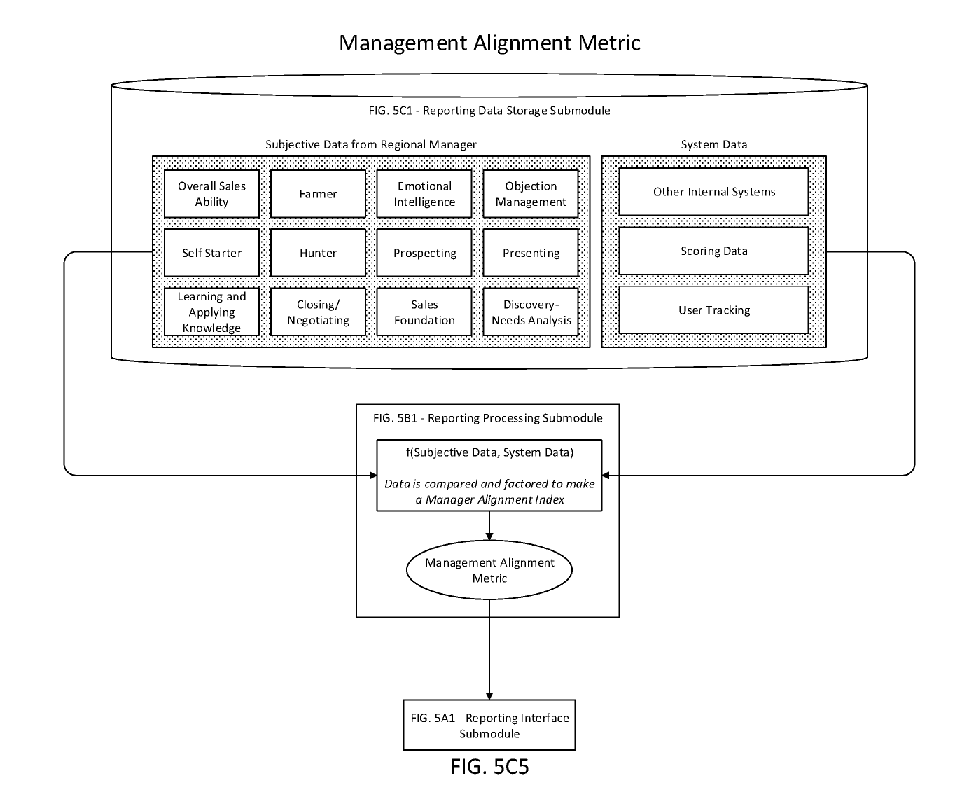

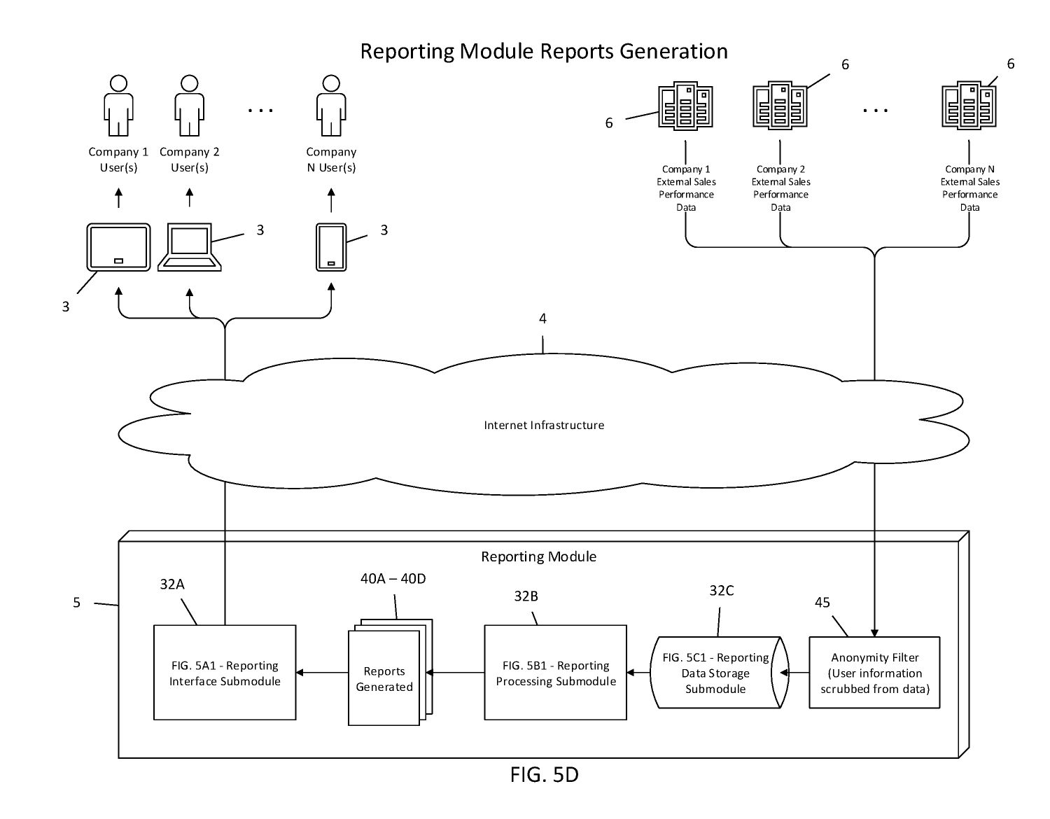

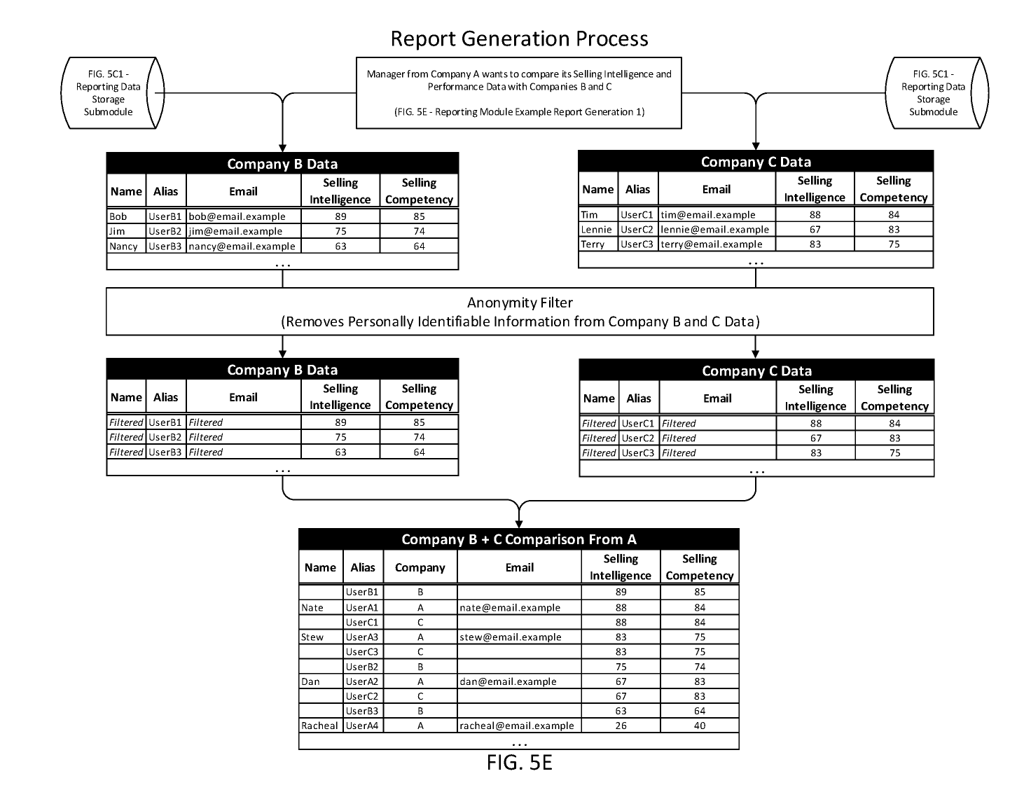

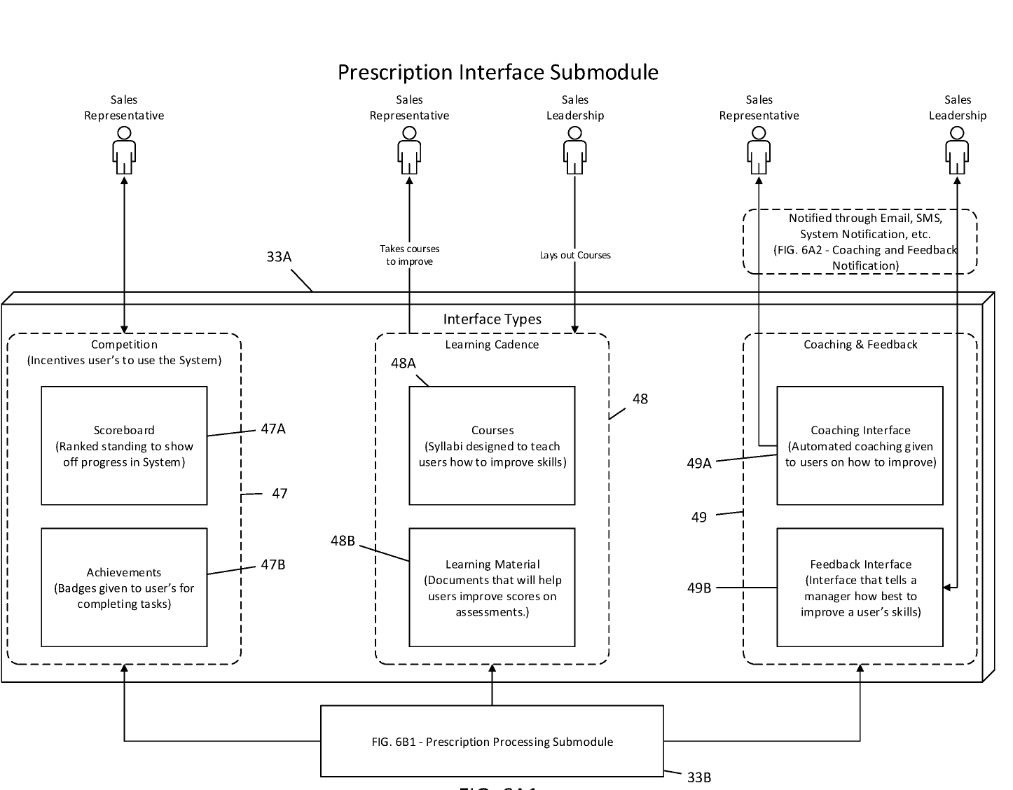

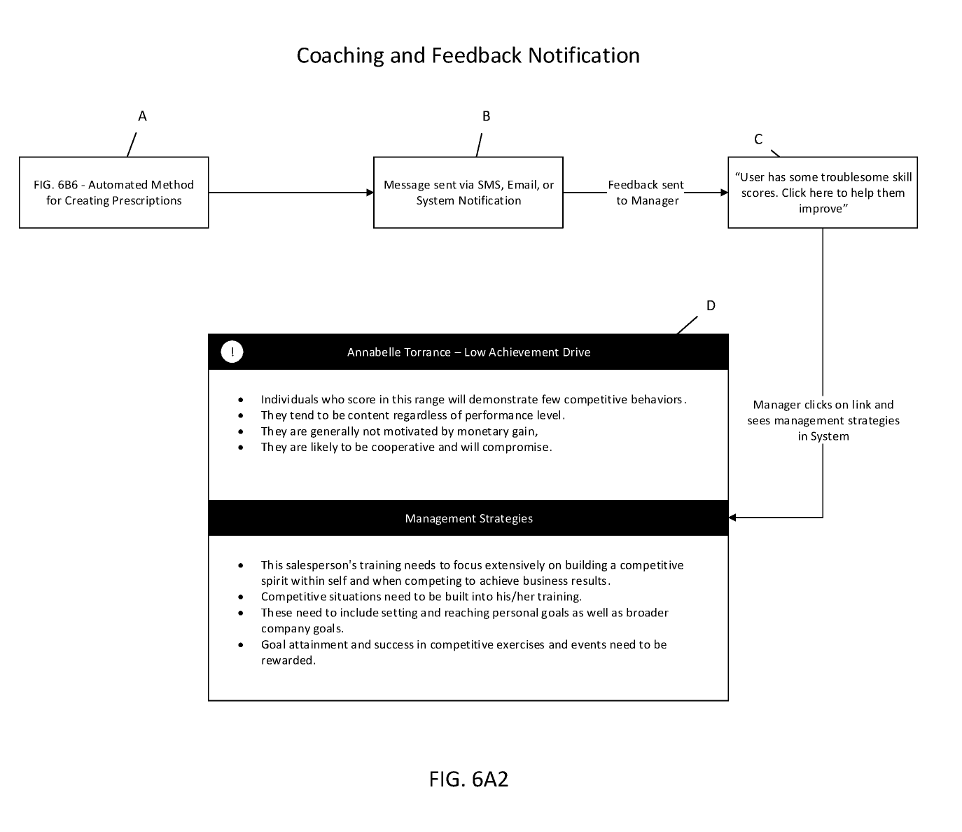

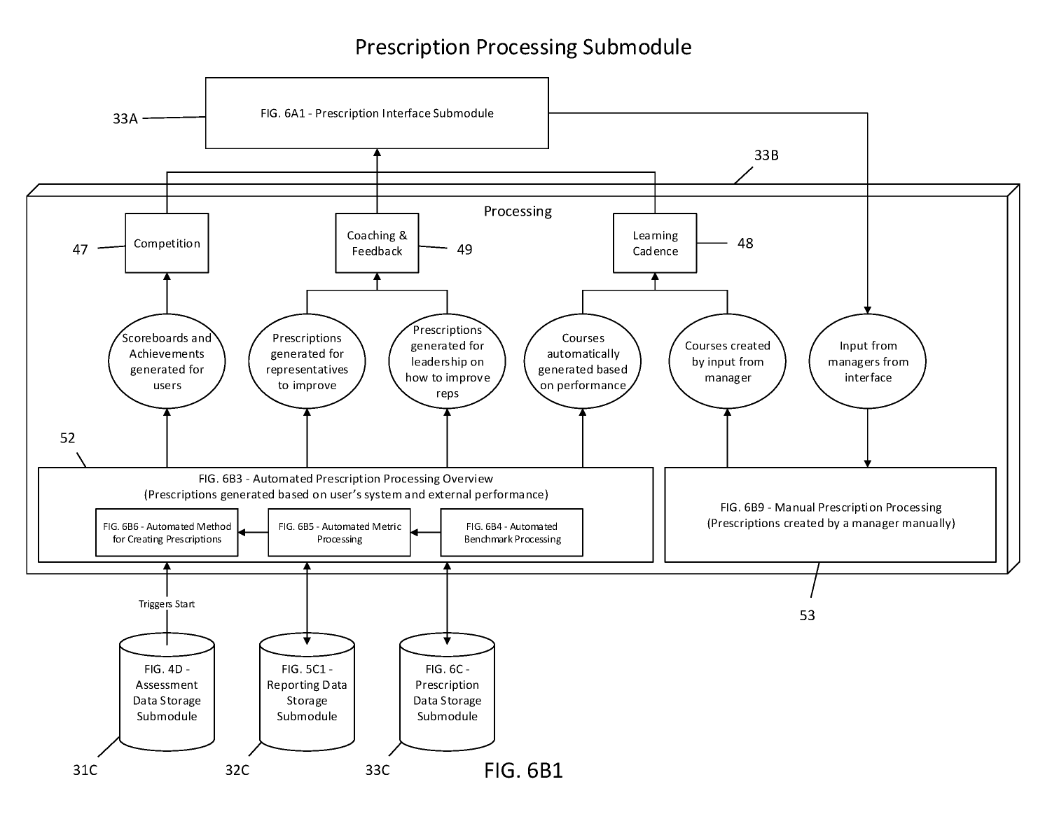

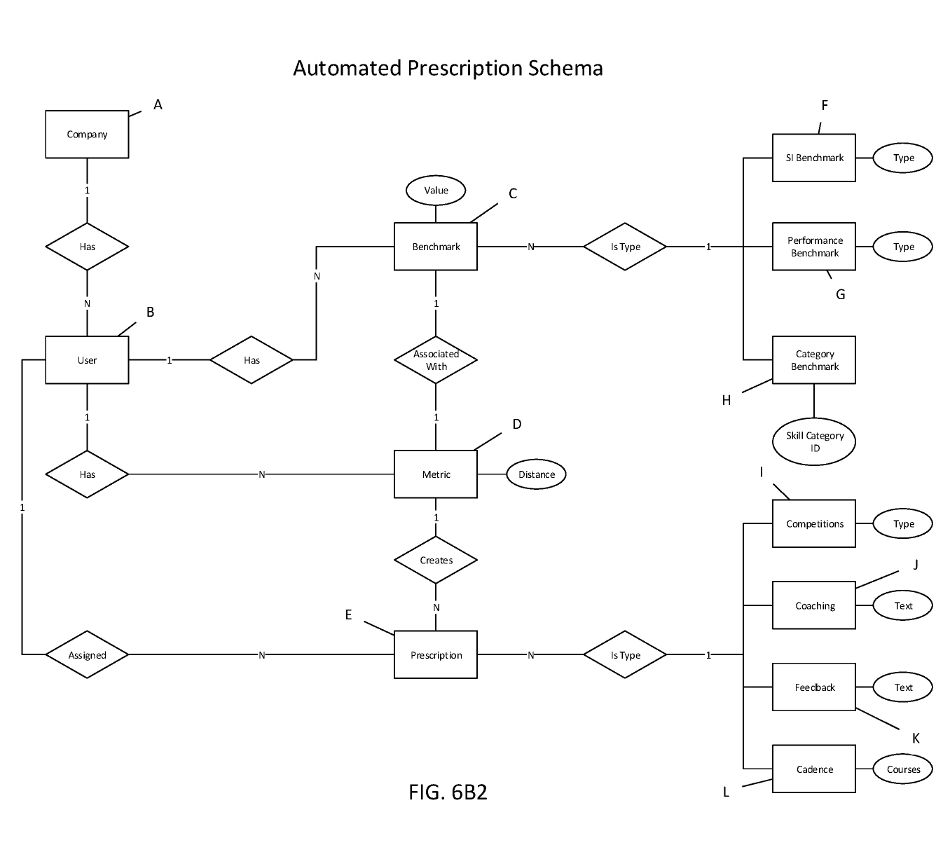

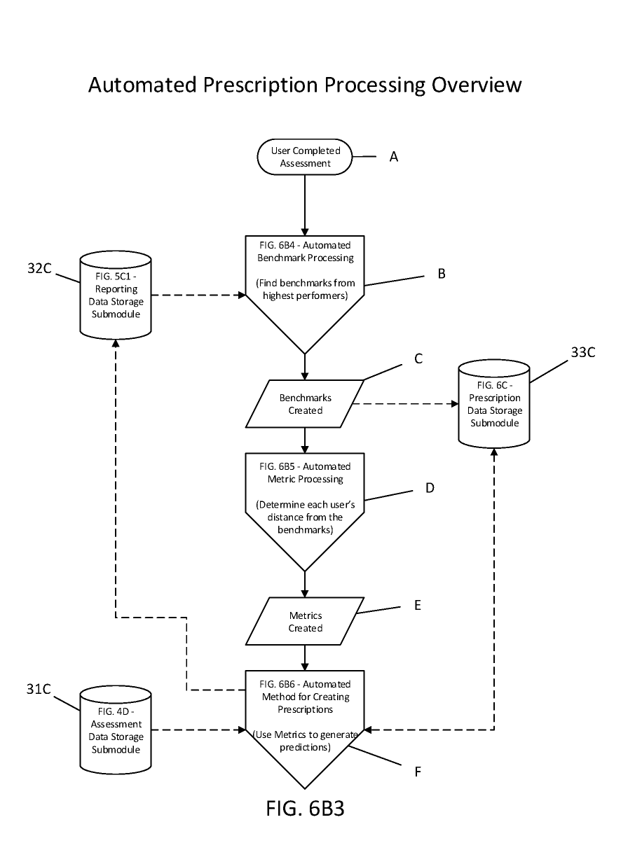

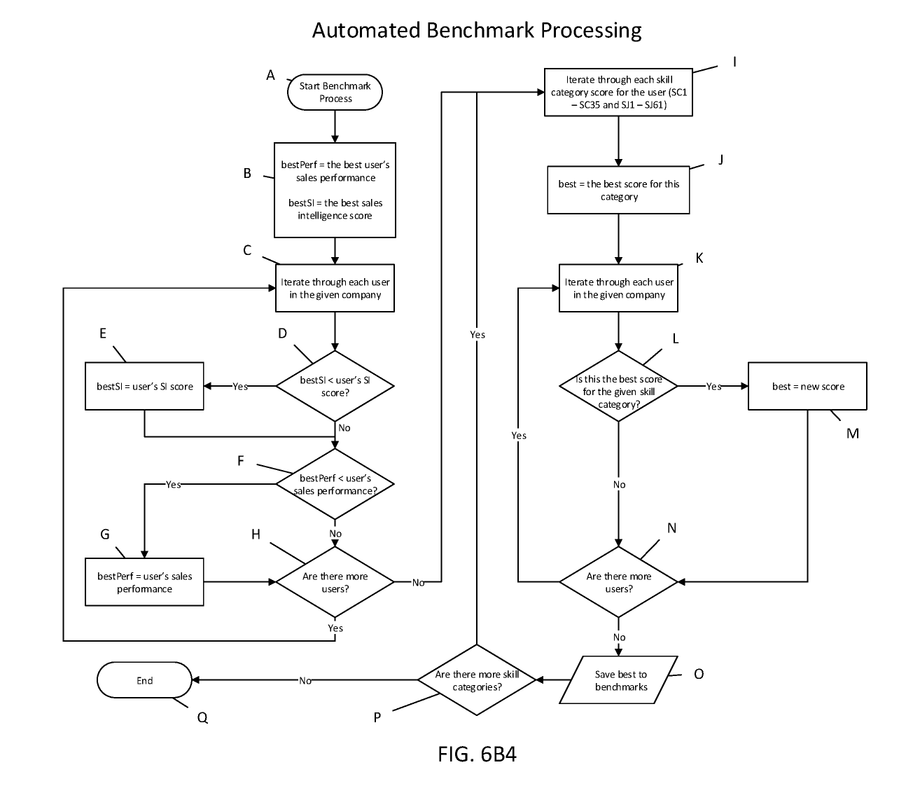

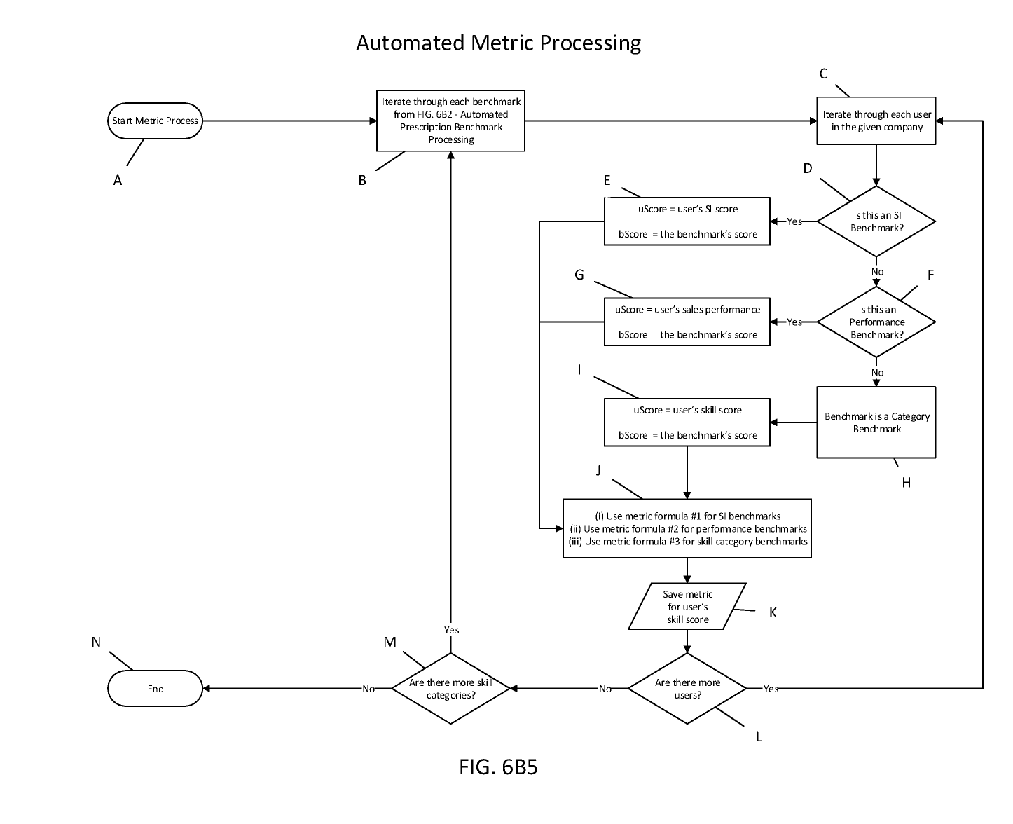

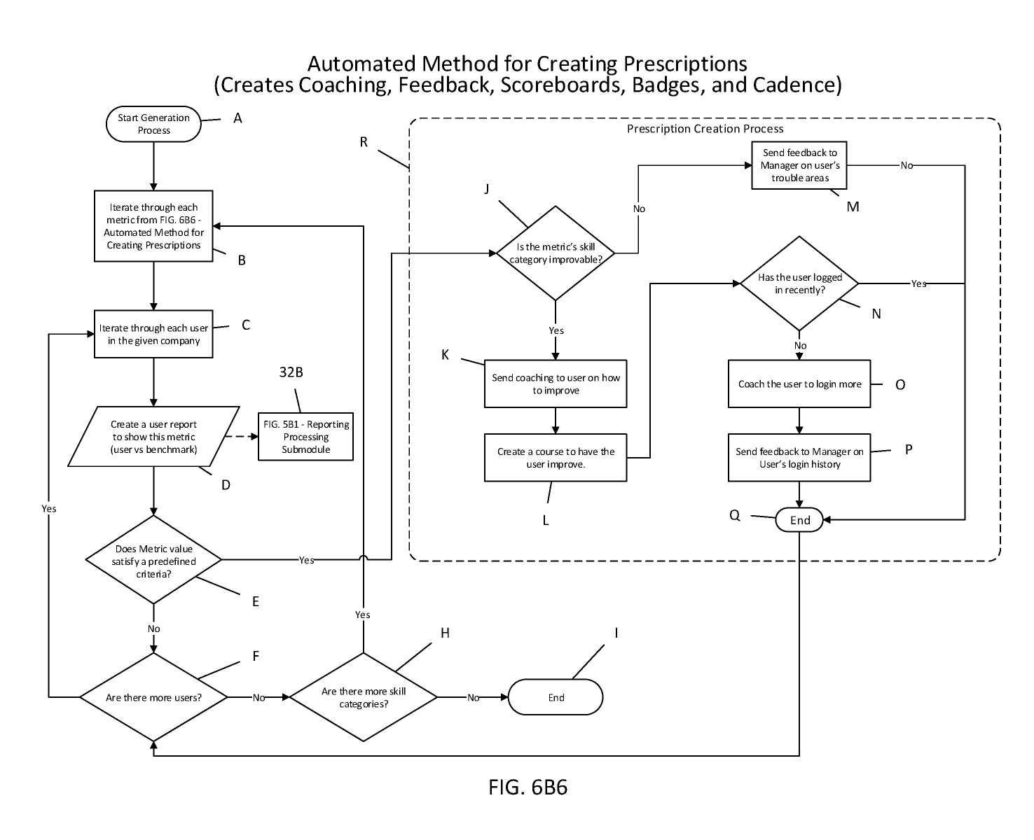

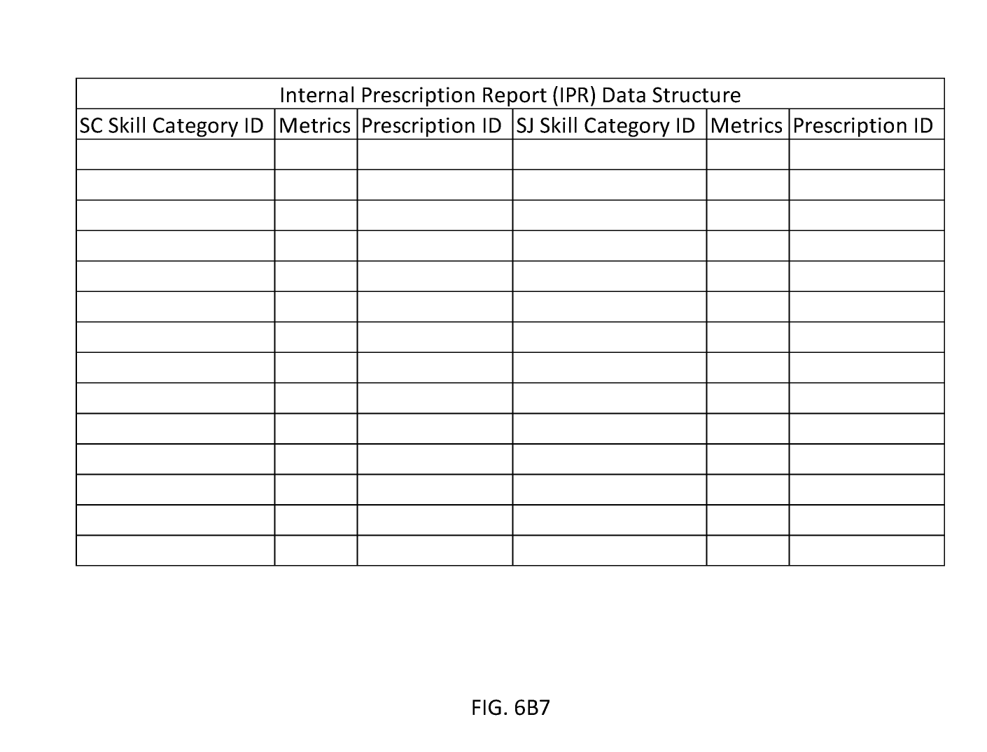

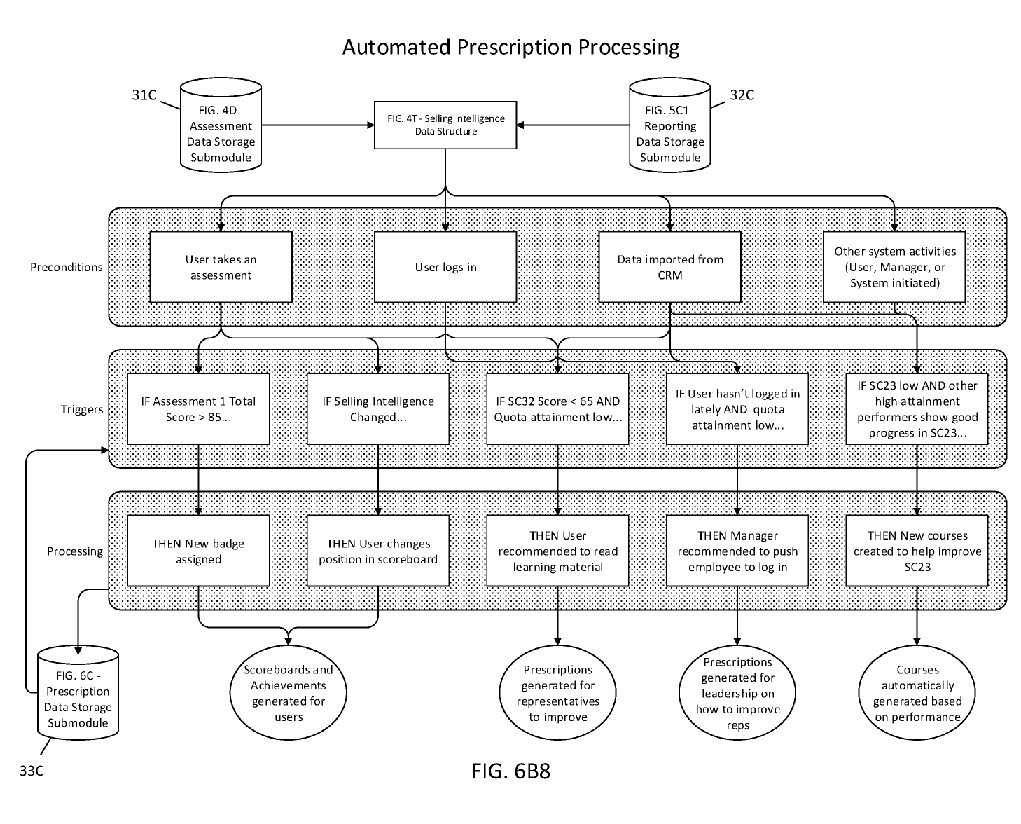

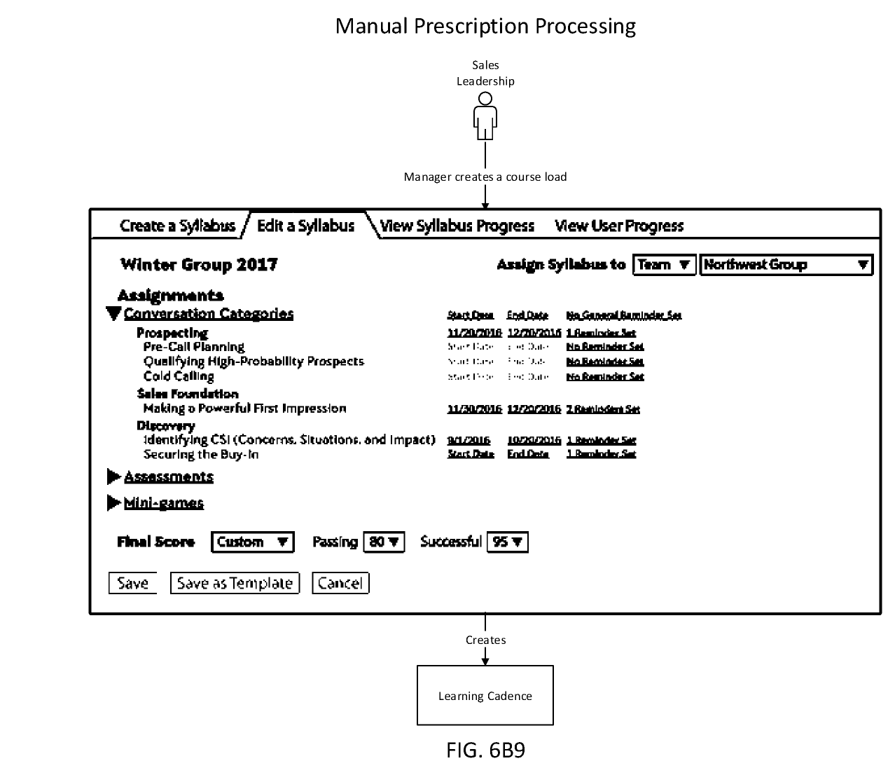

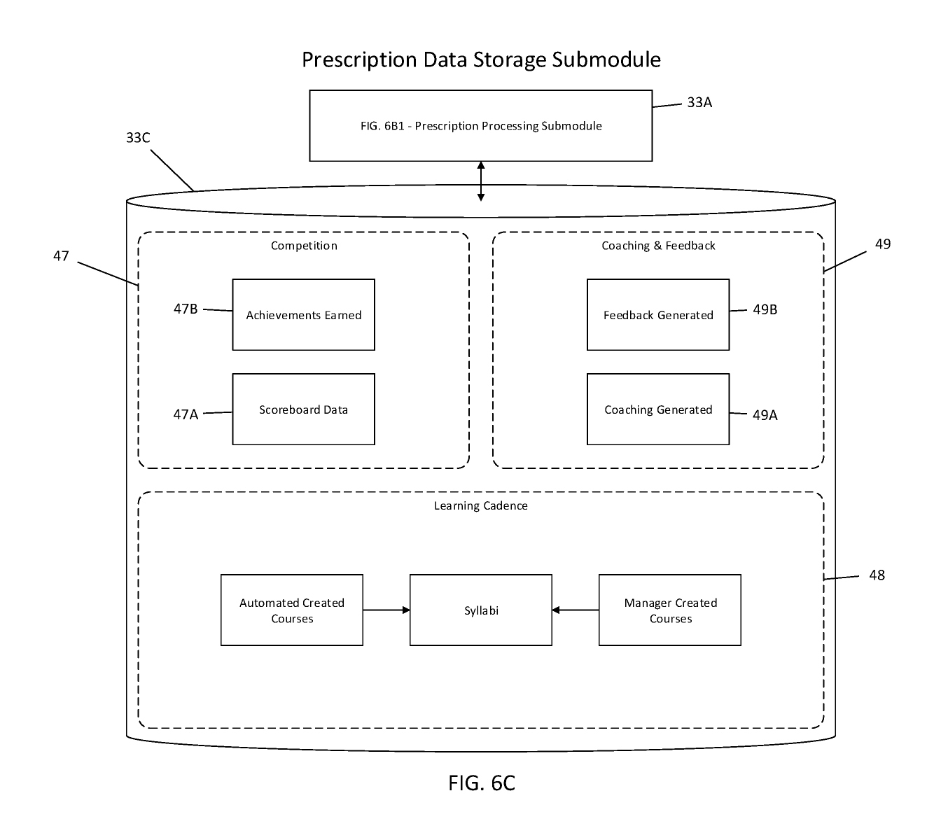

As shown, the system user interface layer 34 supports: the assessment interface submodule 31A for supporting the generation, design and administration of assessment vehicles such as, for example, multiple choice tests, conversation-based simulations, and game-based simulations as illustrated in FIGS. 4A, 4B1, 4B2 and 4B3; the reporting interface submodule 32A for supporting the configuration, generation and delivery of industry, group, and user reports as illustrated in FIGS. 5A1, 5A2, 5A3, 5A4 and 5A5; and the prescription interface submodule 33A for supporting the generation and delivery various kinds of selling intelligence prescriptions, as illustrated in FIGS. 6A, 6B1, and 6B10.

As shown, the scoring and processing layer 35 supports: the assessments scoring submodule 31B, reporting processing submodule 32B, and prescription processing submodule 33B. As shown, the assessment scoring submodule 31B comprises the selling competency submodule 31B1, the selling judgment scoring submodule 31B2, and the selling intelligence submodule 31B3.

As shown, the data storage layer 36 supports: the assessment data storage submodule 31C for storing multiple choice tests, conversation-based simulations, and game-based simulations; reporting data storage submodule 32C for storing scoring, user, survey and performance data; and prescription data storage submodule 33C for storing scoreboards, achievements, courses, and prescriptions generated. The data storage 10 can be realized in various ways using any one or more data storage technologies such as, for example, database management system (DBMS), relational and non-relational data storage systems, cache memory storage, and other technologies well known in the art.

As shown in FIG. 2B, the assessment module 31 comprises: an assessment interface submodule 31A shown in FIG. 4A; an assessment scoring submodule 31B shown in FIG. 4C (including selling competency scoring submodule 31B1, selling judgment scoring submodule 31B2 and selling intelligence scoring submodule 31B3); and an assessment data storage submodule 31C shown in FIGS. 2B and 4D.

As shown in FIG. 2B, the reporting module 32 comprises: a reporting interface submodule 31A shown in FIG. 5A; a reporting processing submodule 32B shown in FIG. 5B; and a reporting data storage submodule 32C shown in FIGS. 2B and 5B.

As shown in FIG. 2B, the prescription module 33 comprises: a prescription interface submodule 33A shown in FIG. 6A; a prescription processing submodule 33B shown in FIG. 6B; and prescription data storage submodule 33C shown in FIGS. 2B and 6C.

Each of these modules and submodules will be described in greater technical detail hereinafter.

### Specification of the Data Flow Hierarchy Supported by the System of the Illustrative Embodiment of the Present Invention

FIG. 2C shows the data hierarchy, data sources and data flow supported within the selling intelligence assessment, development and management system 2 of the present invention. As shown, the data hierarchy comprises five (5) different layers characterized as follows: (i) assessment result data collected from multiple choice tests, conversations, games, etc. involving sales representatives; (ii) selling judgement (skills) data illustrated in FIG. 4E1, and selling competency (skills) data illustrated in FIG. 4E2, both data types being derived from collected assessment result data; (iii) selling intelligence data derived from processing of selling judgment data and selling competency data; (iv) manager reinforcement data and/or system automated prescriptions based on computed selling intelligence data; (v) report data supplied from selling intelligence data and user performance user tracking and other internal systems data; and (vi) user performance data, user tracking and other internal systems data, and user data stored in the reporting data storage submodule 32C shown in FIG. 5C1.

### Specification of an Exemplary Database Schema for the DBMS Supported by the System of the Illustrative Embodiment of the Present Invention

FIG. 2D illustrates an exemplary database schema for the database management system (DBMS) 10 employed in the system 2 of the illustrative embodiment. As shown, the database schema specifies enterprise-level data objects and relationships among objects supported within the system comprising, for example: (i) company data; (ii) users data (e.g. sales representatives, employees, pre-hires, et al); (iii) assessment data consisting of assessment skills data, user answers and activity data, and assessment vehicle content data; (iv) reporting data consisting of user performance data, scoring data, internal system data, and user tracking data; and (v) prescription data consisting of learning cadence data, coaching and feedback data, and competition data.

During the design and development of the system 2, a data schema along the lines shown in FIG. 2D can be created for the object-oriented system-engineered (DOSE) software component thereof, for execution on a client-server architecture. In general, the software component of the system 2 will consist of classes, organized into frameworks or libraries that (i) support the generation of graphical interface objects within GUI screens, (ii) control objects within the application or middle layer of the enterprise-level application, and (iii) manage enterprise or database objects represented within the system database 1. Preferably, the database 10 will be structured according to a database schema shown in FIG. 2D, along with many other data objects used to model the many different aspects of the system being developed and deployed. Theses objects and the database schema will be used and reflected in a set of object-oriented software modules developed for the system 2. Each software module contains classes (written in an object-oriented programming language) supporting the system network 1 of the present invention including, the many modules supporting the selling intelligence related services supported on the system network 1.

### Specification of Graphical User Interfaces (GUIs) Supported by the System of the Present Invention for Providing Platform Services to Sales Manager

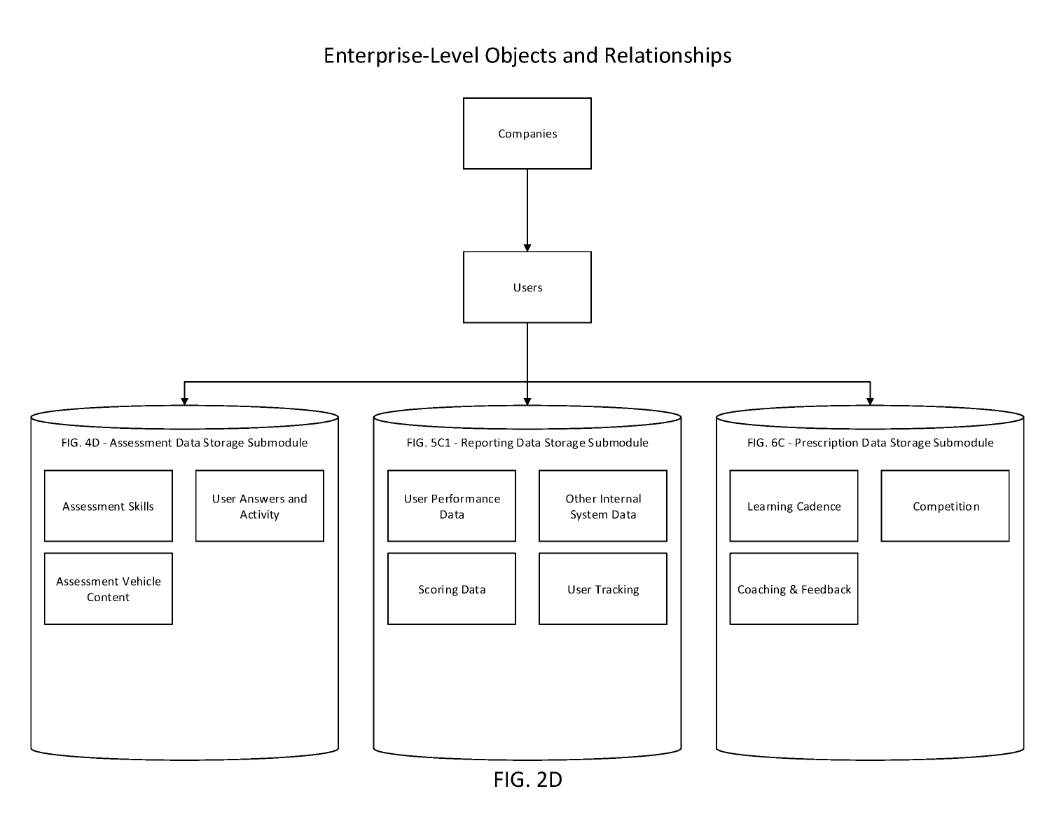

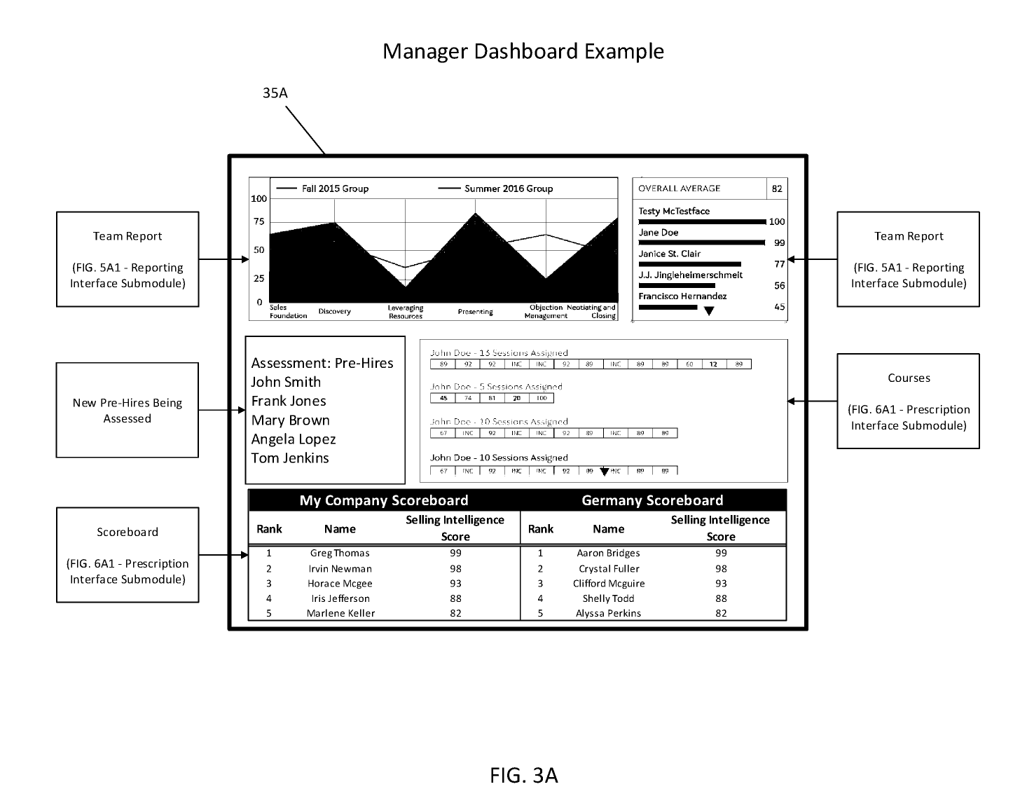

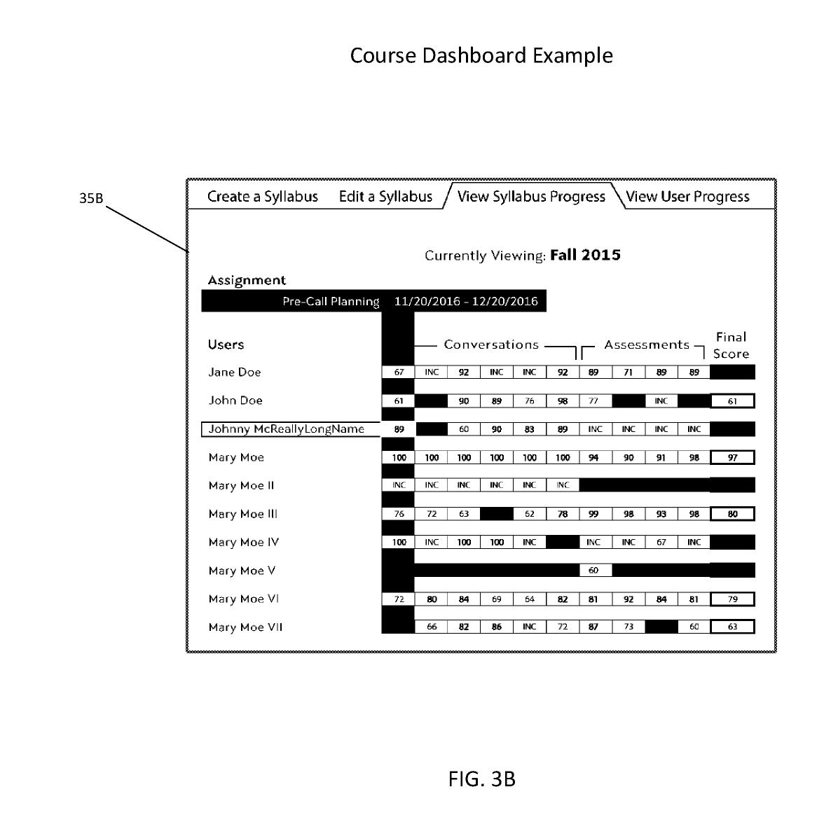

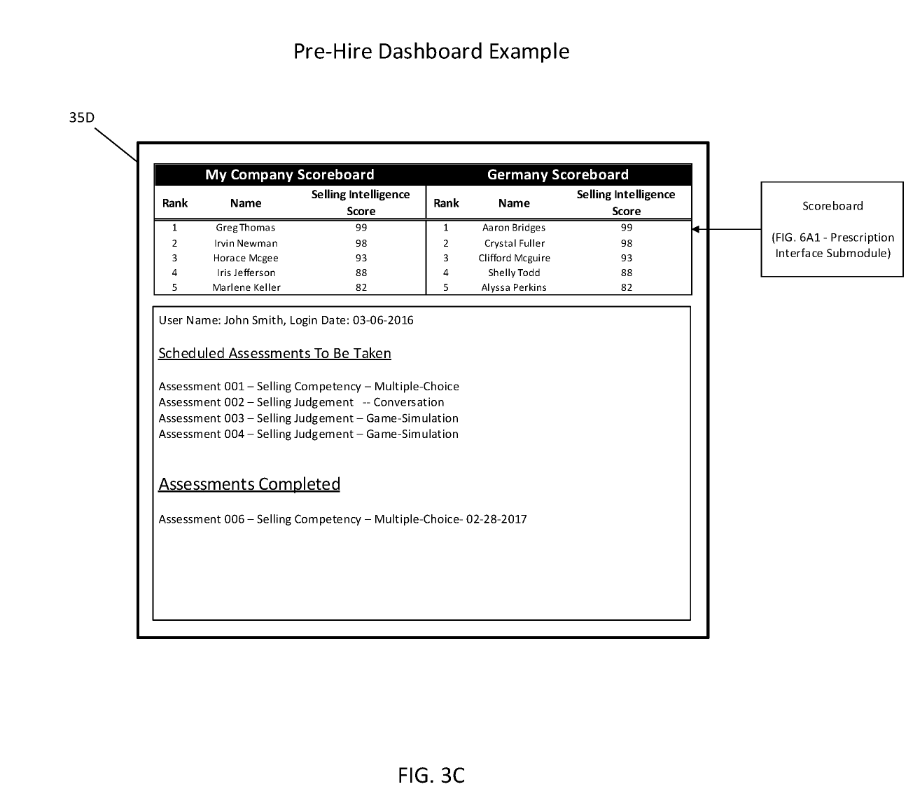

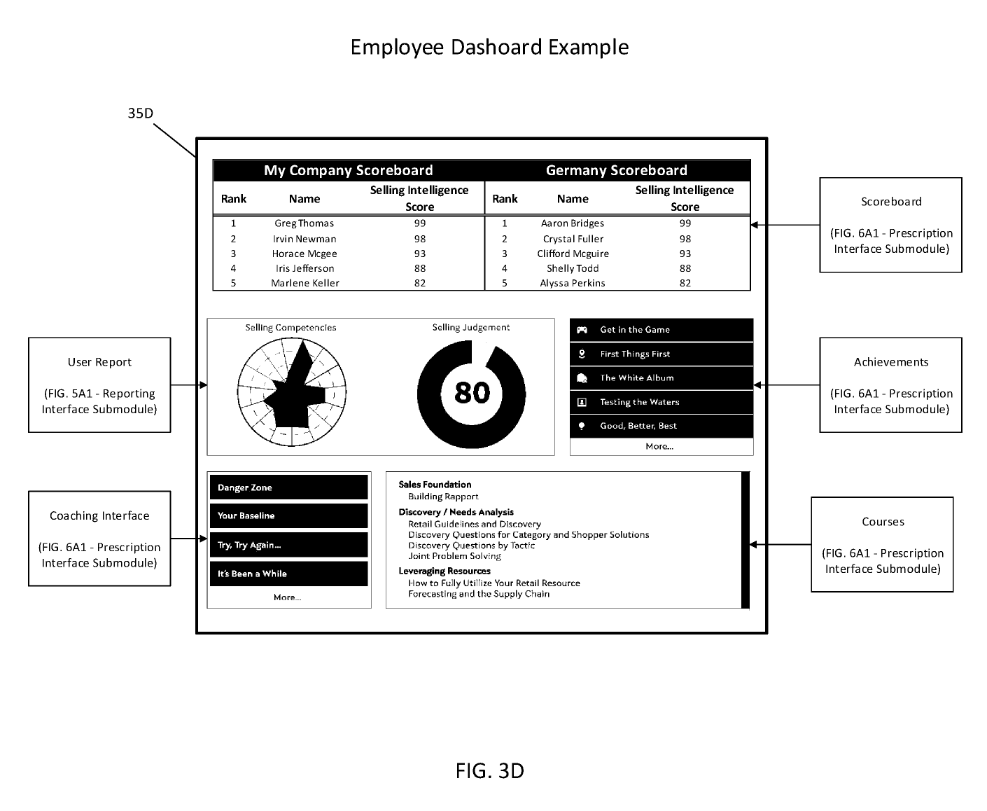

FIG. 3A shows a first exemplary GUI dashboard for use by a manager generated by the web servers 8 within the data center 6 supporting the system 2. As shown, this GUI is configured for use by sales and like managers who use the dashboard for various services: (i) to review team reports delivered by the reporting interface submodule shown in FIG. 5A1; (ii) review new pre-hires being assessed by the system; (iii) review scoreboard/leaderboard for my team and company and see how well each sales representative is performing in competitions; (iv) make learning course recommendations for particular salespeople to improve their selling intelligence and related skills as shown in FIG. 6A; (v) review selling skill category scores of sales representatives under management; and (vi) enjoy other administrative services and options. As shown in FIGS. 1A through 1D, sales managers use the browser-enabled client systems 3 to access and receive the above-described services described in FIG. 2A and delivered over the system network of the present invention.

### Specification of Graphical User Interfaces (GUIs) Supported by the System of the Present Invention for Providing Platform Services to Sales Managers/Leadership

FIG. 3B shows a second exemplary GUI dashboard generated by the web servers 8 within the data center 6 supporting the system 2. As shown, the GUI dashboard is for use by sales managers/leaders who use the dashboard to create a syllabus (course of study or curriculum), edit a syllabus, view syllabus progress, and view user progress, wherein the view user progress GUI is selected and shown. As shown in FIGS. 1A through 1D, sales managers/leaders use the browser-enabled client systems 3 to access and receive the above-described services described in FIG. 2A and delivered over the system network of the present invention.

### Specification of Graphical User Interfaces (GUIs) Supported by the System of the Present Invention for Providing Platform Services to Pre-Hire Candidates

FIG. 3C shows a third exemplary GUI dashboard generated by the web servers 8 within the data center 6 supporting the system 2. As shown, this GUI is configured for use by pre-hire candidates who use the dashboard to log-into the system, and view all assessments to be taken for the job/position being pursued, along with all assessments that have been completed by the user on a particular date/time, recorded within the system. Specifically, the GUI dashboard enables the pre-hire candidates to access the follow services: (i) log into the system and the system's user account, to view a complete list of selling intelligence (SI) assessments designed to assessed a wide range of selling competency and judgement skills, and each identified by its assessment ID number; (ii) review a list of all assessments which have been administered and completed by the pre-hire candidate (or sales representative), on a specified date/time, with an indication of the selling skills that have been assessed by each completed assessment. As shown in FIGS. 1A through 1D, pre-hires use the browser-enabled client systems 3 to access and receive the above-described services described in FIG. 2A and delivered over the system network of the present invention.

### Specification of Graphical User Interfaces (GUIs) Supported by the System of the Present Invention for Providing Platform Services to Sales Representatives/Employees

FIG. 3D shows a fourth exemplary GUI dashboard generated by the web servers 8 within the data center 6 supporting the system 2. As shown, this GUI is configured for use by sales representative and employees who use the dashboard for various services: (i) review users reports containing personal scores and metrics relating to selling competency skills and selling judgement skills, and selling intelligence of the user, as shown in FIG. 5A1; (ii) review a coaching interface with a conversation map indicating areas of testing, generated from the prescription interface submodule as shown in FIG. 6A; (iii) review a leaderboard/scoreboard showing the company and teams competing in particular competitions, as supported by the prescription interface submodule as shown in FIG. 6A; (iv) achievements (e.g. badges) awarded to the user and supported by the prescription interface submodule shown in FIG. 6A; and (v) courses that have been prescribed to the user by the system as supported by prescription interface submodule of FIG. 6A. As shown in FIGS. 1A through 1D, sales representatives/employees use the browser-enabled client systems 3 to access and receive the above-described services described in FIG. 2A and delivered over the system network of the present invention.

### Specification of the Assessment Interface Submodule Employed in the System of the Present Invention

FIG. 4A shows three assessment interface submodule vehicles 31A (e.g. multi-choice tests, conversation-based simulation, and game-based simulations) for use in making assessments of selling competency skills illustrated in FIG. 4E2, and selling judgement skills illustrated in FIG. 4E1. This assessment interface submodule enables assessing and capturing assessment data from the testing, for storing in the assessment data storage submodule of FIG. 4D, and processing to assess, by scoring, the selling competency and/or selling judgment of the sales representative, and ultimately computing a selling intelligence score for the sales representative based on such collected assessments.

As shown in FIG. 4A, the assessment interface submodule 31A comprises the following components: the assessment interface submodule vehicles 31A illustrated in FIGS. 4B1, 4B2 and 4B3, and configured for assessing and capturing assessment data during testing of human subjects for selling competency, selling judgment and selling intelligence; assessment data storage submodule 31C shown in FIGS. 2B and 4D for storing the assessed data in the assessment data storage submodule 31C; and assessment scoring submodule 31B shown in FIGS. 2B and 4C for scoring processing stored assessment data to assess the selling competency skills and/or selling judgment skills of the sales representative, and ultimately computing a selling intelligence score for the sales representative based on such collected assessments.

These submodules 31A, 31B and 31C cooperate together in response to requests made by client systems 3 to allow system users to access and receive the services described in FIG. 2A and delivered by the system network of the present invention.

### Specification of the Assessment Interface Submodule Employed in the System of the Present Invention

FIG. 4B1 illustrates a first exemplary GUI screen supporting a multiple-choice test assessment, for assessing and measuring selling competency and/or selling judgment on the system network of the present invention, showing an exemplary multiple-choice question and possible answers thereto.

FIG. 4B2 illustrates a second exemplary GUI screen supporting a conversation-based assessment, for assessing and measuring selling competency and/or selling judgment on the system network of the present invention, showing an exemplary 3D VR-based simulation involving a sales representative engaging with two other virtual actors having parts in the simulated conversation.

FIG. 4B3 illustrates a third exemplary GUI screen supporting a game-based simulation assessment, for assessing and measuring selling competency and/or selling judgment on the system network of the present invention, showing an exemplary game environment. As shown, the user being tested/assessed is requested to match corresponding concepts by shooting/selecting objects in the scene that match the selected target object.

As shown in FIGS. 1A through 1D, sales representatives and candidates use the browser-enabled client systems 3 to access and receive the above-described services described in FIG. 2A and delivered over the system network of the present invention.

### Specification of the Assessment Scoring Submodule Employed in the System of the Present Invention

In general, the assessment scoring submodule 31B shown in FIGS. 2B and 4C is configured to perform the following basic functions: (i) the processing and scoring of assessments, which may include multiple-choice tests, conversation-based assessments and game-based simulations; (ii) producing selling competency scores and selling judgment scores; and (iii) subsequent computing of selling intelligence measurements for storage in the reporting data storage submodule 32C accessed by the reporting and prescription submodules 32B and 33B, illustrated in FIG. 4B.

As shown in FIG. 4C, the assessment scoring submodule 31B also supports the following functions: (i) the collection of assessment data in the assessment data storage submodule 31C illustrated in FIG. 4D, obtained from multiple-choice tests, conversation-based simulations, and game-based simulations supported by the assessment interface submodule 31A illustrated in FIG. 4A; (ii) the scoring of assessment vehicles within the assessment scoring submodule 31B (e.g. scoring multiple choice tests using the method illustrated in FIG. 4J, scoring conversations using the method illustrated in FIG. 4F, and scoring of game-based simulations using similar methods) to produce various assessment vehicle scores; and (iii) the generation and processing of selling competency scores and selling judgment scores, so as to produce selling intelligence scores for sales representatives, to be stored in the reporting data storage submodule 32C illustrated in FIG. 5C. As shown, the assessment scoring submodule 31B includes an automated metrics processing module 60A, for automatically processing skill category score data, generating metrics using the process specified in FIG. 4V5, and generating metric-based assessments designed to improve the skills and intelligence of sales representatives.

In general, the services and functions performed by the assessment scoring submodule 31B are carried out in a user-transparent manner, when other user services are explicitly requested and delivered over the system network 1. If necessary, system users can direct access to these skill scoring and selling intelligence computing services, for generating and displaying such measures as required when managing selling and sales processes.

### Specification of the Assessment Data Storage Submodule Employed in the System of the Present Invention

FIG. 4D describes the assessment data storage submodule 31C shown in FIG. 2B. As shown, this submodule 31C supports the storage, maintenance and retrieval of the following data elements: (i) the content storage of assessment vehicle content from selling competency and selling judgment assessments, organized the multiple-choice data schema shown in FIG. 4L, and conversation-based scoring data schema shown in FIG. 4H; and (ii) user storage of user answers and activity for the assessment vehicles (e.g. user decisions in a conversation, answers and time in a multiple-choice test, activity in a game, etc.). A shown, the answers and activity of users are sorted into skills which are used by the scoring module 31B.

### Assessment Data Pertaining to Each Assessment on Selling Competency Skills and Selling Judgement Skills

In general, the following data is stored for each assessment, regardless of whether or not realized as multiple-choice question assessments, conversation-based assessments and/or game-based simulations:
Length of time of assessment
Length of time for answer
   Details of these different assessment vehicles will be described below.

### Multiple-Choice Test Question Assessment Information

A multiple-choice-question-based assessment comprises a set of multiple-choice questions, each structured with specific decision points, where the candidate is requested for a response. The response at each decision point in the multiple-choice is structured to test a particular selling competency skill category. Each multiple choice question will be designed and structured to test a user's level of knowledge in a specific selling competency skill category, or selling judgement skill category, as the case may be.

### Conversation-Based Assessment Information

A conversation-based assessment comprises a set of conversations, each structured with specific decision points, where the candidate is requested for a response. The response at each decision point in the multiple-choice is structured to test a particular selling competency skill category. Each decision point in a conversation will be designed and structured to test a user's level of knowledge in a specific selling competency skill category, or selling judgement skill category, as the case may be. For each conversation, the following data elements are stored:
Length of time in conversation
Length of time for decision
What resources in the account planning were read?
Did the user watch the intro?
Did the user view the whole coaching?
How long did the user spend in the coaching?
How long did the user spend in the intro?
Did the user view the learning material?

### Game-Based Concept-Testing Assessment Information

A game-based assessment comprises a set of branches, each structured with specific decision points, where the candidate is requested for a response. The response at each decision point at each branch in the game is structured to test a user's level of knowledge in a particular selling competency skill category, or selling judgement skill category, as the case may be. For each use of a game-based assessment, the following data elements are stored:
Length of time in game-simulation
Length of time for decision
What resources in the account planning were read?
Did the user watch the intro?
Did the user view the whole coaching?
How long did the user spend in the coaching?
How long did the user spend in the intro?
Did the user view the learning material?

### Specification of an Exemplary Skill Category Schema Pertaining to Selling Competency Skill Categories (SCSC) Assessed and Reinforced by the System of the Present Invention

FIG. 4E1 shows an exemplary skill category schema pertaining to selling competency skills assessed by the assessment scoring submodule of the system 2. The purpose of the selling competency skill category (SCSC) schema is to assess and measure the N number of selling competency skill categories (SCSC) used in automated measurement and computation of selling intelligence. Each decision point in either a conversation, each question into a multiple-choice question test, and each branch in a game-based simulation, is sorted or classified into one or more of these skill categories.

During scoring operations of “selling competency” skill categories (SCSCs), each decision point in a conversation, each question in a multiple-choice question test, and each branch in a game-based simulation is (i) sorted or classified into one or more of selling-competency skill categories, defined by the skill category schema, and then (ii) scored in accordance with principles of the present invention.

Details of this selling competency skill category (SCSC) schema, indexed using selling competency codes (SC#), corresponding to N number of selling competency skill categories (SCSCs), are described below. Notably, this SCSC schema can be viewed as a selling competency skill category (SCSC) tree structure having lower-level “child” skill categories that make up and support higher-level “parent” skill categories. In the illustrative embodiment, index N, representative of the total number of lower-level selling competency skill categories (SCSCs), is 30 in the illustrative embodiment. However, it is understood that the SCSC index N can be greater and lesser than this number in different illustrative embodiments of the present invention. Also in most embodiments, the size of indices N and M will not be equal in number.

### SC1—Hunter

Achievement Drive
Assertiveness
Extraversion
Positivity
Work Ethic

### SC7—Farmer

Sociability
Open Mindedness
Customer Relations
Patience
Work Ethic

### SC13—Self Starter

Initiative
Energy
Leadership
Confidence
Work Ethic

### SC19—Sales Behaviors

Achievement Drive
Assertiveness
Extraversion
Positivity
Sociability
Open Mindedness
Customer Relations
Patience
Initiative
Energy
Leadership
Confidence
Work Ethic

### SC-33—Cognitive Ability

Math and Logical Reasoning
Verbal Reasoning

After using the selling competency skill category (SCSC) schema to sort or classify the decision points, questions and branches to generate classified skills data, this classified skills data is then scored using the scoring methods of the present invention disclosed and taught herein.

### Specification of Exemplary Selling Judgement Skill Categories (SJSC) Assessed and Reinforced by the System of the Present Invention

FIG. 4E2 shows an exemplary skill category schema pertaining to selling judgement skills assessed by the assessment scoring submodule 31B, for the purpose of assessing and measuring the M number of selling judgment skill categories (SJSC), used in automated measurement and computation of selling intelligence.

As shown in the illustrative embodiment, the schema of scored selling judgement skill categories (SJSCs) bearing on a person's selling judgement is organized according to the following categories:

(i) prospecting—pre-call planning, qualifying high-probability prospects, cold-calling;

(ii) sales foundation—making a powerful first impression, and becoming a trusted advisor;

(iii) discovery—identifying concerns, situations and impact (CSI), and securing the buy-in;

(iv) presenting—preparing and previewing a proposal, and presenting to a group;

(v) objection management—recognizing and responding to objections, and handling competitive and price objections; and

(vi) negotiating and closing—preparation for negotiation and negotiating the deal.

As shown in FIG. 4E2, pre-call planning comprises: overcoming cold call reluctance; developing a perfect prospect profile; developing a compelling benefits statement; and getting past the gatekeeper.

During scoring operations of “selling judgement” skill categories, each decision point in a conversation, each question in a multiple-choice question test, and each branch in a game-based simulation, is (i) sorted or classified into one or more of selling-judgment skill categories, defined by the skill category schema, and then (ii) scored in accordance with principles of the present invention.

Details of this selling judgment skill schema, indexed using selling judgement codes (SJ#), corresponding to N number of selling competency skill categories (SJSCs), are described below. Notably, this SJSC schema can be viewed as a selling judgement skill category (SJSC) tree structure having lower-level “child” skill categories that make up and support higher-level “parent” skill categories. In the illustrative embodiment, index M, representative of the total number of lower-level selling judgement skill categories (SJSCs), is 43. However, it is understood that the SCSC index N can be greater and lesser than this number in different illustrative embodiments of the present invention.

### SJ1—Prospecting

### PreCall Planning

Overcoming Cold Call Reluctance
Developing a Perfect Prospect Profile
Developing a Compelling Benefits Statement
Getting Past the Gatekeeper

### Qualifying High Probability Prospects

Understanding the Qualifying Process
Establishing Next Steps
Knowing whether a Prospect is Qualified
Asking Qualifying Questions

### Cold Calling

Delivering a Compelling Benefits Statement
Qualifying

### SJ15—Sales Foundation

### Making a Powerful First Impression

Reading the Customer
Building Trust and Credibility

### Becoming a Trusted Advisor

Reading the Customer
Building Trust and Credibility

### SJ15—Discovery

### Identifying CSI (Concerns, Situations, and Impact)

Reviewing Requirements
Identifying Pain Points
Asking High Yield Questions

### Securing the BuyIn

Persuasion
Aligning Solution To Requirements
Listening
Obtaining the Buyin

### SJ32—Presenting

### Preparing and Previewing a Proposal

Managing the Meeting
Responding to Questions and Concerns

### Presenting to a Group

Managing the Meeting
Responding to Price Pressure
Responding to Questions and Concerns
Presentation Flow

### SJ41—Objection Management

### Recognizing and Responding to Objections

Managing the Meeting
Demonstrating Empathy
Uncovering the Real Objection
Managing Objections

### Handling Competitive & Price Objections

Managing the Meeting
Managing Objections
Handling Competitive Comparisons
Selling Value

### SJ52—Negotiating and Closing

### Preparing for Negotiation

Managing the Meeting
Research, Planning & Strategy
Anticipating Demands & Tactics

### Negotiating the Deal

Managing the Meeting
Responding to Demands
Creating Win/Win
Responding to Price Pressure

After using the selling judgment skill category (SJSC) schema to sort or classify the decision points, questions and branches to generate classified skills data, this classified skills data is then scored using the scoring methods of the present invention disclosed and taught herein.

Overview On Computing the Selling Intelligence Quotient (SIQ) Measurement of the Present Invention by Processing the Selling Competency Skill Category Scores (SCSC) and Selling Judgement Skill Scores (SJSC) of the Individual Being Assessed and a Population of Individuals Against Whom the Individual May Compete

In accordance with the principles of the present invention, the selling intelligence quotient (SIQ) measurement method of the present invention comprises:

(i) assessing the selling competency and judgement skills of an i-th individual whose SIQ is being measured, and storing this selling skill assessment data in the system database;

(ii) using a scoring method to process the corresponding selling skill assessment data so as to produce each n-th Selling Competency Skill Category score (SCSCₙ) or each m-th Selling Judgement Skill Category score (SCSCₘ) as the case may be:
(a) using conversation-based scoring method of FIG. 4I to produce each n-th Selling Competency Skill Category score (SCSCₙ) or m-th Selling Judgement Skill Category score (SCSCₘ);
(b) using multiple-choice question scoring method of FIG. 4N to produce each n-th Selling Competency Skill Category score (SCSCₙ) or m-th Selling Judgement Skill Category score (SCSCₘ); and
(c) using the game-based scoring method of FIG. 4P to produce each n-th Selling Competency Skill Category score (SCSCₙ) or m-th Selling Judgement Skill Category score (SCSCₘ));

(iii) storing N types of selling competency skill category scores (SCSC) for the i-th individual, in the system database, along with SCSC values and SJSC values for numerous other assessed individuals within a field, an organization or an industry;

(iv) storing M types of selling judgement skill category scores (SJSC) for the i-th individual, in the system database, along with SCSC values and SJSC values for numerous other assessed individuals within the field, the organization or the industry;

(v) summing N types of selling competency skill category scores (SCSC for the i-th individual to produce a Total Selling Competency Skill Category Score (SCSC_{T,i}):

SCSC_{T,i}=Σₙ₌₁^{n=N}SCSCₙ

(vi) summing M types of selling judgement skill category scores (SJSC) for the i-th individual to produce a Total Selling Judgement Skill Category Score (SJSC_{T,i}):

SCSC_{T}=Σₘ₌₁^{m=M}SCSCₘ

(vii) multiplying Total Selling Competency Skill Category Score (SCSC_{T,i}) and the Total Selling Judgement Skill Category Score (SJSC_{T,i}) to produce a Total Selling Skill Category Product:

SCSC_{T,i}·SJSC_{T,i}

(viii) producing a normalization divisor by computing an Average Total Selling Skill Category Product based on the Total Selling Skill Category Score Product of each j-th individual in the population of J number of humans used to normalize the i-th individual's Total Selling Skill Category Score Product, per the following formula:

$$\frac{{\sum }_{j = 1}^{j = J} {SCSC}_{T , j} \cdot {SJSC}_{T , j}}{J}$$

(ix) dividing the Total Selling Skill Category Product for the i-th individual being assessed, by the normalization divisor, and then multiplying the resulting quotient by 100, to produce the Selling Intelligent Quotient (SIQᵢ) of the i-th individual according to the following formula:

$${SIQ}_{i} = \frac{{SCSC}_{T , i} \cdot {SJSC}_{T , i}}{\frac{{\sum }_{j = 1}^{j = J} {SCSC}_{T , j} \cdot {SJSC}_{T , j}}{J}} \cdot 100$$

According to this preferred Selling Intelligence Quotient (SIQ) formula, an SIQ score of 100 indicates a performance at exactly the normal level for the sales group, team, company, or industry used to compute the normalization factor.

An SIQ score above 100 indicates performance above the normal level in the sales representative's group, team, company or industry as the case may be.

An SIQ score below 100 indicates performance below the normal level in the sales representative's group, team, company or industry as the case may be.

### Specification of the Method and Process of Scoring User Conversations Supported by the Selling Intelligence Assessment, Development and Management System of the Present Invention

FIG. 4F describes the primary steps involved in the method and process of scoring user conversations supported by the selling intelligence assessment, development and management system 2. As shown, the method comprises the steps of: (a) starting with a user finishing a conversation-based assessment; (b) running the conversation-based scoring process shown in FIG. 4I; and (c) storing final conversation scores in the reporting data storage submodule 32C shown in FIG. 5C1, where conversation scores are sorted into selling competency skill scores, and selling judgment skill scores.

As shown in FIG. 4I, the conservation-based scoring process involves using the conversation map shown in FIGS. 4G1, 4G2 and 4G3, and the conversation schema shown in FIG. 4H, and described in detail hereinbelow. The output from this scoring process is a selling competency skill score for each selling competency skill category being assessed by the, or a selling judgement score, as the case may be, and these score values are thereafter used by the processes described in FIGS. 4J, 4K1, 4K2, 4L, 4M, and 4N.

### Specification of Conversation Map Supported by the Selling Intelligence Assessment, Development and Management System of the Present Invention

FIGS. 4G1, 4G2 and 4G3, taken together, graphically illustrate (i) an exemplary conversation map structure containing various paths of a simulated conversation, with skill categories (e.g. skill category SC1, SC2, SC3, SC4 . . . ) are represented at decision points along the paths, and (ii) the primary steps of a scoring process used to assess and score a simulated conversation, as illustrated in FIG. 4I.

As shown in FIG. 4G1, the exemplary conversation map comprises: several pathways indexed as “Best Path (bp)” and “User Path”; two exemplary Skill Categories (sc) indexed as 1 “Developing a Perfect Prospect Profile”) and 2 “Getting Past The Gatekeeper”); and indexed Decision Points (dp) 1, 2, 3 and 4, at which Skill Category Scores (scs) are made and tallied for the User Path, and the Best Path through the conversation map. As shown, the two paths (dark user path and best user path) are considered, and at each decision point, the scores are added to the list as shown with the Skill Category, User Path and Best Path.

As shown in FIG. 4G1, the conversation-based scoring process illustrated in FIG. 4I involves several stages of processing and computation, organized according to User Paths, and Best Paths (bp) comprising: (i) computation of average score for each path; (ii) the length of each path; (iii) modifier phase; (iv) modified averages; and (v) final score.

As shown in FIG. 4G2, the chart created in FIG. 4G1 is shown, and from this chart, the skills are separated out into the different skill categories and decision point scores assigned. This results in charts for Best Path and User Path. Then the average and length (i.e. amount of decision points in each skill) are retrieved for each.

As shown in FIG. 4G3, the third part of the process involves making a modifier based on the best path using the formula shown, and then the average score of the skill is modified by the modifier, and finally the skill's modified averages.

### Specification of Conversation Schema Supported by the Selling Intelligence Assessment, Development and Management System of the Present Invention

FIG. 4H shows the conversation-based data schema used when scoring conversations within the selling judgment module using the process illustrated in FIG. 4I. As shown, the data schema indicates the organizational structure of a conversation, and the manner in which the conversation is scored in the illustrative embodiment of the selling intelligence assessment, development and management system of the present invention.

FIG. 4H shows the conversation schema used when scoring conversations within the selling judgment module illustrated in FIG. 4A1. As shown, this exemplary schema indicates the components of a conversation and manner in which the conversation is scored in the illustrative embodiment of the selling intelligence assessment, development and management system 2. As shown, these conversation components comprise: a Conversation by a User; Conversation Path having a Best Path (bp) and containing Decision Points (dp) attributed to a Skills Category (sc); a Skills Category Score modified by a Best Path Category Score; and a Final Conversation Score computed as an average of skill category score.

As shown in FIG. 4H, the schema illustrates how to score skill categories at the decision points in a conversation with a user, as illustrated in FIG. 4G, to provide a final conversation score for each path through the conversation supported on the system 2.

### Specification of the Method of Scoring of Skill Categories Assessed During Conversations Supported and Administered by the Selling Intelligence Assessment, Development and Management System of the Present Invention

FIG. 4I describes the primary steps involved in the conversation-based scoring process of the present invention illustrated in FIGS. 4G1, 4G2 and 4G3, supported and administered by the selling intelligence assessment, development and management system of the present invention.

As indicated at Block A in FIG. 4I, the method of scoring skill categories begins after a user finishes a conversation supported by the system 2. At Block B, the process checks to determine whether or not the path “all users decisions in the conversation” are finished, and when it has, then the process advances to the Block C.

At Block C, using the conversation map of FIG. 4G and conversation schema of FIG. 4H, the scoring process initializes as follows:

(i) “pathCategories” are set equal to “the map of each decision organized into its skill category”

(ii) “best path” is set to equal to “the best decisions a user can make”

(iii) “bestcategories” is set equal to “the map of each bestPath decision organized into its skill category”

(iv) “categories” is set to equal to “a list of all skill categories in the current conversion being scored”

(v) “categoryScores” is set to equal to “the empty list of skill category scores”

(vi) “totalscore” is set to equal to 0

After defining and initializing the above parameters, the process is prepared to score the completed conversation loaded into the submodule.

As indicated at Block D in FIG. 4I, the process sets “Cat” equal to the “First element in the categories”.

Then the process advances to Block E, where (i) pathCategory is set equal to pathCategories (cat); bestCatgory is set equal to bestCategories (cat): sca is set equal to 0; count is set equal to 0; and dp is set equal to First element in path.

Then at Block F in FIG. 4I, the process increments the count=count+1 and average (avg) will be set to avg.+dp. score.

Then at Block G in FIG. 4I, the process determines whether or not the path has more elements for processing. In the event that there are more elements to process along the conversation path, then the process at Block H and sets the dp to equal the Next element in the path and returns to Block F.

In the event there are no more data elements to process, the process advances to Block I in FIG. 4I and performs the following operations: (i) recomputes sca to sca/count; (ii) sets “bp” (bestPath) to equal the “length of bestCategory”; and (iii) sets “len” (length) to equal the length of pathCategory.

At Block J in FIG. 4I, the process determines if bp best path equals len, and if so, appends sca (skill category average) to the categoryScores, and sets totalScore equal to totalScore+sca.

At Block J in FIG. 4I, if the bp best path does not equal len, then the process advances to Block K and the parameter “mod” is computed as 1−(len−bp)/len and parameter sca is set to equal mod*sca.

Thereafter, the process advances to Block L, where sca is appended to categoryScores, and totalScore=totalScore+sca.

At Block M in FIG. 4I, the process determines whether or not there are more skill categories in the list of categories. If so, then the process advances to Block N and parameter cat is set equal to Next elements in categories, and returns to Block E. If not, then the process advances to Block O where the parameter totalScore is set to equal totalScore/length of category Scores.

Then at Block P in FIG. 4I, the total Score and categoryScores are saved, and the process is terminated at Block Q.

In summary, this conversation-based scoring method produces (i) an average selling competency skill category (SCSC) score for each selling competency skill category (SCSC) being assessed at one or more decision points in the conversation, as well as (ii) an average selling judgement skill category (SJSC) score for each selling judgement skill category (SJSC) being assessed at one or more decision points in the conversation. Some conversations might be designed to contain multiple decision points configured to assess a particular selling (competency or judgement) skill category with an average score value. Regarding design choice, any

Specification of a Method for Scoring Multiple-Choice Tests Used for Assessing the Selling Competency and/or the Selling Judgement of a Sales Representative

FIG. 4J describes the primary steps involved in the process of scoring multiple-choice tests supported by the selling intelligence assessment, development and management system 2. As shown, the process comprises the steps of:

(a) starting with a user finishing a multiple-choice test assessment registered with the system;

(b) running the multiple-choice test scoring process shown in FIG. 4N to produce final multiple-choice test scores; and

(c) storing final multiple-choice scores and new percentile ranking tables in the reporting data storage submodule of FIG. 5C1;

As indicated at Block A in FIG. 4J, the process starts with a user finishing a multiple-choice question test designed to assess particular selling competency skills and/or selling judgement skills of a particular user (e.g. sales representative, individual, pre-hire), as illustrated in FIGS. 4E1 and 4E2.

Then at Block B in FIG. 4J, the process calls the multiple-choice scoring process illustrated in FIG. 4N. This step involves employing the multiple-choice scoring process shown in FIG. 4N to produce percentile ranking tables for skill categories, based on user rankings in the system and the data schema shown in FIG. 4L and using the percentile table generation process shown in FIG. 4M. This step produces ranked test score data, in the form of percentile ranking tables for tested skill categories, as shown in FIG. 4K, for subsequent use in multiple-choice test scoring.

As indicated at Block C in FIG. 4J, multiple choice scores and new percentile ranking tables generated by the process of FIG. 4N are stored in the reporting data storage submodule 32C shown in FIG. 5C.

### Specification of Exemplary Process for Scoring Skill Categories Based on Multiple Choice Answer Tests Administered by the Selling Intelligence Assessment, Development and Management System

FIGS. 4K1 and 4K2 graphically illustrate the primary stages of the scoring process of FIG. 4N supported by the selling intelligence assessment, development and management system 2. As illustrated in FIGS. 4K1 and 4K2, the process comprises:

(i) scoring the multiple choice tests taken by a group of users (e.g. pre-hires) to generate original raw scores;

(ii) taking the original raw scores and counting their frequency;

(iii) generating a percentile table using the multiple choice percentile table generating process of FIG. 4M;

(iv) generating a final percentile table for achievement drive; and

(v) using the original raw scores table and the percentile table for achievement drive, so as to generate and assemble final scores ranked on the scores of all of the users in the group, using the selling intelligence assessment, development and management system.

Specification of the Multiple Choice Test Schema Used when Scoring Multiple-Choice Test Questions within the Selling Judgment Module

FIG. 4L is a schematic representation of the multiple-choice test schema used when scoring multiple-choice test questions within the selling judgment module illustrated in FIG. 4B, indicating the organizational structure of a multiple-choice test and manner in which multiple-choice test questions are scored in terms of skill category scores by the selling intelligence assessment, development and management system of the present invention.

Specification of Process and Method Used to Generate User Percentile Ranking Tables from Multiple Choice Tests Administered Using the Selling Intelligence Assessment, Development and Management System

FIG. 4M describes the primary steps of the process used to generate multiple choice percentile tables from multiple-choice test scores administered using the selling intelligence assessment, development and management system 2.

As indicated at Block A in FIG. 4M, the process requests a percentile table as input, and at Block B, sets the parameter “category” to equal “the multiple choice requested”.

As indicated at Block C in FIG. 4M, the parameter rawValues is set to all other user's raw total scores in the system for category.

As indicated at Block D in FIG. 4M, the parameter table is set to the sorted map of raw values coupled with the frequency of which it appears in the system.

As indicated at Block E in FIG. 4M, the parameter rawValue is set to the first element from rawValues.

As indicated in Block F in FIG. 4M, the process determines whether or not the parameter table[rawValue] exists, and if not, then at Block G sets the parameter table[rawValue] to 0. If yes, then at Block H the process sets the parameter table[rawValue] equal to table[rawValue]+1.

Thereafter, at Block I, the process determines whether or not there are more elements in the rawValues, and if so, then at Block J the process sets the parameter rawValus equal to Next element in rawValues, and returns to Block H, as shown. If, at Block I, there are no more elements in rawValues, then the process proceeds to Block K, and sets the parameter index=0, the parameter entry=first entry from the table, and count=length of rawValues.

Thereafter, at Block L in FIG. 4M, the process sets frequency=entry value, entry value=(index+frequency)/count*100, and index=index+frequency.

At Block M in FIG. 4M, the process determines whether or not there are more entries in the table, and if so, then at Block N the process sets the parameter entry to Next element in the table, and thereafter returns to Block L, as shown.

If at Block M in FIG. 4M there are no more entries in the table, then the process advances to Block O, and terminates and returns the table as output.

### Specification of the Process of Scoring Skill Categories Assessed During Multiple-Choice Tests Administered by the Selling Intelligence Assessment, Development and Management System of the Present Invention

FIG. 4N describes the primary steps involved in the process of scoring skill categories assessed during multiple-choice tests administered by the selling intelligence assessment, development and management system of the present invention.

As indicated at Block A in FIG. 4N, the user finishes a multiple choice question test, and then advances to Block B.

As indicated at Block B, the process sets the parameter “categories” equal to “all the categories that apply to this multiple choice”, and advances to Block C.

As indicated at Block C, the process sets the parameter “category” equal to “the first element in categories”.

As indicated at Block D, the process sets the parameter “categorySource” equal to “Get category score of category”.

As indicated at Block E, the process saves the parameter “category Score”.

As indicated at Block F, the process determines whether or not there are more categories in “categoryScore”, and if so, then at Block G, the process sets the parameter “category” equal to “first element in categories,” and returns to Block D. If there are more categories in “categoryScore,” then the process terminates at Block H.

As indicated at Block D, the process branches to Block D1 where the process runs the get Category Score routine which returns an average Category Score, as recited in Blocks D1 through D20. To do this, this process carries out the routine recited at Blocks D1-D20.

As indicated at Block D1, the process gets the Category Score by performing Blocks D2-D20, with its various control threads.

As indicated at Block D2, the process sets parameter “category” equal to category provided to function, and then proceeds to Block D3 and sets rawScore equal to 0.

As indicated at Block D4, the process then determines whether or not the set “category.children” is empty (i.e. indicating a skill category is a low level skill category in the skill category tree of FIG. 4E1 or 4E2), and if not, proceeds to Block D5 where the parameter “child” is set equal to the “first element in category.children”.

As indicated at Block D6, the process sets the parameter “childScore” equal to Get category score of child, and proceeds to Block D7, where “rawScore” is set equal to “rawScore+childScore”.

As indicated at Block D8, the process determines whether or not there are more elements in the category.children, and if not, then the process proceeds to Block D10 where the process sets “avg” equals “rawScore/length of category.children”, and then proceeds to Block D11.

As indicated at Block D4, if the process determines that the category.children is empty, then the process advances to Block D11 where the process sets the parameter “answers” equal to “all the user's answers for this multiple choice question”, and then advances to Block D12.

As indicated at Block D12, the process sets the parameter “answer” equal to “first answer from answers”, and then sets “count” equal to 0 and proceeds to Block D13.

As indicated at Block D13, the process determines whether or not the answer category equal the category, and if yes, then proceeds to Block D14, where “rawScore” is set equal to “rawScore+answer.Score”, and the parameter “count” is set equal to “count+1”, and then advances to Block D15.

As indicated at Block D15, the process determines whether or not there are more answers in the answers set, and if yes, then at Block D16, the process sets the parameter “answer” to “next element in answers” and returns to Block D13, where the process determines if answer.category equals category.

If at Block D15, the process determines that there are no more answers in the answers queue, then the process proceeds to Block D17, where the parameter “avg” is set equal to “rawScore/count”. Then the process proceeds to Block D18 where the multiple-choice percentile table generation process, described in FIG. 4M, is executed and then the process sets the parameter “percentileTable” equal to “the table for category” and proceeds to Block D19.

As indicated at Block D19, the process sets the parameter “avg” to “percentileTable[avg]” and then returns this score at Block D20, and terminates the process.

Notably, similar to the scoring process of FIG. 4I, the multiple-choice question process of FIG. 4N produces (i) an average selling competency skill category (SCSC) score for each selling competency skill category (SCSC) being assessed at one or more questions in the multiple-choice question assessment, as well as (ii) an average selling judgement skill category (SJSC) score for each selling judgement skill category (SJSC) being assessed at one or more multiple-choice questions in the assessment. By design, a multiple-choice question assessment might be designed to contain multiple multiple-choice questions configured to assess a particular selling (competency or judgement) skill category, with an average score value assigned to this specific selling (competency or judgement) skill category skill category.

### Specification of the Process of Scoring of Gaming-Based Simulations Supported by the Selling Intelligence Assessment, Development and Management System of the Present Invention

FIG. 4O describes the primary steps involved in the process of scoring of gaming-based simulations supported by the selling intelligence assessment, development and management system 2. As shown in FIG. 4O, the process comprises the steps of:

At Block A, starting with a user finishing a game-based simulation assessment and providing the raw data results from the game-based assessment of the user(s);

At Block B, running the game-based simulation scoring process shown in FIG. 4P, using the raw data results collected during the game-based assessment, to generate final game-based simulation score; and

At Block C, storing the final game-based simulation score in the reporting data storage submodule illustrated in FIG. 5C1.

The details of this process will be described below with reference to FIG. 4P.

### Specification of the Game-Based Scoring Process of the Illustrative Embodiment

FIG. 4P illustrates the game-based scoring process of the illustrative embodiment. As shown in FIG. 4P, the user takes a game-based assessment, and over time, and the system automatically tracks the user's interactions which includes the following: (i) the user's decisions; (ii) the user's reaction time; (iii) other reactions; and (iv) the time user spent in the game simulation. As shown, the skill categories of the selling judgment and competency type are assessed by scoring the user's interactions to produce scores for each assessed skill, and to generate a final game score by combining individual skill scores of the assessed user.

As shown in FIG. 4P, data collected on user interactions during the game-based process is used to measure specific skill categories relating to selling competency and selling judgement. Specifically, skill categories for selling competency and selling judgment are assessed by scoring the user's interactions to produce scores for each assessed skill category, and then to generate a final game score by combining individual skill category scores of the assessed user.

As shown in FIG. 4P, a score for the skill category “achievement drive” is obtained using data collected on the user's decisions and user's reaction time. The skill category “managing the meeting” is scored using data collected from other interactions (e.g. the time it took to achieve a task; what object a user selected/click-on during an assessment session; etc.) during the game-based process, and the skill category “listening” is scored using data collected on the time user's spent in the game. This data collection and scoring process occurs for each skill category in the selling competency schema and selling judgment schema employed by the system, and then these individual skill category scores are stored for future processing and also combined together to produce a final game score for purposes of competitive scoreboard display.

Notably this game-base process produces a selling competency skill category (SCSC) score for each n-th selling competency skill category being assessed by the game-based simulation assessment, and also a selling judgement skill category (SJSC) score for each m-th selling judgement skill category being assessed by the game-based simulation assessment, as the case may be. Depending on design choice, any game-based assessment can be designed to include user-interactions configured to test one or more selling competency skill categories (SCSC) and/or selling judgement skill categories (SJSC). In some game-based assessments, a select subset of SCSCs and a select subset of SJSCs will be assessed as part of a particular gam-based assessment, whereas in other game-based assessments, a different subset of SCSCs and/or SJSCs will be targeted to achieve specific assessment goals and strategies of sales leadership in an organization.

### Specification of the Method of Measuring the Selling Intelligence of Sales Representatives Using the Selling Competency Scores and Selling Judgement Scores Given to Sales Representatives Assessed by the System of the Present Invention

FIG. 4Q describes the primary steps of the method of measuring “selling intelligence” (SI) of an i-th sales representative in a population of J number of people (where j=1,2, . . . J), as selling intelligence quotient (SIQ) measure, expressed in terms of the expression SIQᵢ=Numerator/Denominator×100, wherein:

(i) the Numerator is formed by factoring (e.g. multiplying) (a) the Total Selling Competency Skill Category (SCSC_{T}) score for the i-th individual sales representative summed up over N number of SCSCs illustrated in FIG. 4E1, and the (b) Total Selling Judgement Skill Category (SJSC_{T}) score for the i-th individual sales representative summed up over M number of SJSCs illustrated in FIG. 4E2; and

(ii) the Denominator (normalization factor) is formed by factoring (e.g. multiplying) (a) the Total Selling Competency Skill Category (SCSC_{T}) score summed up over N number of SCSCs illustrated in FIG. 4E1, and the (b) Total Selling Judgement Skill Category (SJSC_{T}) score summed up over M number of SJSCs illustrated in FIG. 4E2.

However, it is understood that the factoring steps used in forming the Numerator and Denominator elements could involve using other mathematical operations, other than multiplying, such as squaring or taking the square root of the SCSC_{T} and SJSC, or using logarithmic or exponential functions; what is important that the factoring functions used in the Numerator and Denominator are the same so that normalization occurs in the quotient, and that the ratio of Numerator/Denominator results in 1.0 when the i-th individual is normal against the population of J assessed individuals. The scaling of this ratio or quotient by 100 simply puts the SIQ value in a scale ranging about 100 being the point of normal SIQ.

The preferred method of measuring an i-th sales representative's selling intelligence quotient (SIQ) will be described in detail hereinafter in a step-wise manner.

As indicated at Block A in FIG. 4Q, the scores collected from the assessment vehicles for the i-th indiviudal sales representative are sorted into Selling Competency Categories/Classes as illustrated in the schema of FIG. 4E1, and into Selling Judgement Categories/Classes as illustrated in the schema of FIG. 4E2.

As indicated at Block B in FIG. 4Q, the scoring process involves carrying out the selling competency and judgment scoring process illustrated in FIG. 4R, to generate selling competency skill category (SCSC) scores for the N number of SCSCs supported by the system (and its SIQ standards), and also the selling judgment skill category (SJSC) scores for the M number of SJSCs supported by the system (and its SIQ standards).

As indicated at Block C in FIG. 4Q, the generated selling competency skill category (SCSC) scores and selling judgment skill category (SJSC) scores are stored for the i-th sales representative, and all other J number of individual in the normalization population of individuals, in the reporting data storage submodule 32C of FIG. 5C1.

As indicated at Block D in FIG. 4Q, the selling intelligence quotient (SIQ) computation-based scoring process of FIG. 4S is executed to generate a selling intelligence quotient (SIQ) score for the i-th sales representative or pre-hire, as the case may be, normalized against a population of similarly-assessed individuals who typically are in competition with the i-th individual being assessed. In the preferred illustrative embodiment, this step D involves computing the Numerator and Denominator, as described hereinabove, then taking the ratio of these figures and scaling by 100 to produce the i-th individual's SIQ score.

As indicated at Block E, the generated selling intelligence intelligence (SIQ) score is stored in the reporting data storage submodule 32C of FIG. 5C1, and provided to prescription and reporting submodules. SI data structure illustrated in FIG. 4T is automatically updated for the i-th individual, and used in supporting the numerous automated-services services supported on the service network of the present invention.

Details relating to subprocesses employed in the method described above, will be described below.

### Specification of the Scoring of Selling Competency and Judgment Skill Categories Assessed During Assessments Administered by the Selling Intelligence Assessment, Development and Management System

FIG. 4R describes the primary steps of the process used to score the N number of selling competency skill categories and the M number of selling judgment skill categories to be assessed for sales representatives, as the case may be, using the selling intelligence assessment, development and management system 2 of the present invention.

As indicated at Block A, the process starts by receiving a request to get selling competency or judgement.

As indicated at Block B, the process sets parameter “score” to zero, and then advances to Block C and sets the parameter “scores” equal to “all the skill scores part of judgment or competency”.

As indicated at Block D, the process sets the parameter “skillScore” equal to “the first elements in scores” and then advances to Block E.

As indicated at Block E, the process sets the parameter “score” equal to “score+skillScore” and then advances to Block F and determines whether or not there are any more elements in the “scores” queue. If there are some elements remaining in the “scores” queue, at Block G, the process sets the parameter “skillScore” to “the next element in scores” and returns to Block E, as shown where the parameter “score” is incremented by “skillScore”.

When there are no more elements in the “scores” queue at Block F, then the process advances to Block H and computes the “score” by the formula “score/length of scores”, and then at Block I returns the completed total “score” for selling competency skill category, or the total score for the selling judgement skill category, as the case may be. These SCSC scores and SJSC scores are then stored in the system database.

Notably, the scoring methods and processes used to process conversation-based assessments, multiple-choice question assessments and game-based simulation assessments will different, and scores produced will differ as well. For example, the scoring process used to score SCSCs and SJSCs tested in multiple-choice questions will produce average scores for each SCSC and SJSC, as the case may be used. The scoring process used to score SCSCs and SJSCs tested in conversation will produce weighed average scores for each SCSC and SJSC, as the case may be used. Also, the scoring process used to score SCSCs and SJSCs tested in game-based assessments will produce best scores for each SCSC and SJSC, based on user-activity.

### Specification of Method of Measuring Selling Intelligence (SI) Using the Selling Competency (SC) and Selling Judgement (SJ) Scores of Sales Representatives

FIG. 4S describes the steps of the process used to computationally measure the selling intelligence quotient (SIQ) of an i-th assessed sales representative in a population of J number of assessed individuals, in accordance with the illustrative embodiment of the present invention, using the selling intelligence assessment engine 31B3 of FIG. 2B, supported on the selling intelligence assessment, development and management system 2 of the present invention.

As indicated at Block A in FIG. 4S, a request is made to measure and store the selling intelligence quotient for an i-th individual in a population of J number of individuals in given field or industry.

As indicated at Block B, the process uses the method of FIG. 4R to sum up the N types of selling competency skill category scores (SCSC for the i-th individual to produce a Total Selling Competency Skill Category Score (SCSC_{T,i}):

SCSC_{T,i}=Σₙ₌₁^{n=N}SCSCₙ

As indicated at Block C, the process uses the method of FIG. 4R to sum up the M types of selling judgement skill category scores (SJSC) for the i-th individual to produce a Total Selling Judgement Skill Category Score (SJSC_{T,i}):

SCSC_{T}=Σₘ₌₁^{m=M}SCSCₘ

These Total Selling Competency and Judgement Skill Category Scores are then stored in system memory.

As indicated at Block D, the process computes a selling intelligence quotient (SIQ) measure for the i-th individual as a function of the total selling competency and judgement skill category scores of the i-th individual, as well as the total selling competency and judgement skill category scores of the J number of assessed individuals, supported by the system of the present invention, which may be part of the individuals group, team, company or industry, as the case may be.

In the illustrative embodiment, the process carries out Block D by a multi-step process involving:

(a) multiplying (i) Total Selling Competency Skill Category Score (SCSC_{T,i}), and (ii) the Total Selling Judgement Skill Category Score (SJSC_{T,i}) to produce a Total Selling Skill Category Product:

SCSC_{T,i}·SJSC_{T,j}

(b) producing a normalization divisor by computing an Average Total Selling Skill Category Product based on the Total Selling Skill Category Score Product of each j-th individual in the population of J number of humans used to normalize the i-th individual's Total Selling Skill Category Score Product, per the following formula:

$$\frac{{\sum }_{j = 1}^{j = J} {SCSC}_{T , j} \cdot {SJSC}_{T , j}}{J}$$

(c) dividing the Total Selling Skill Category Product for the i-th individual being assessed, by the normalization divisor; and

(d) then multiplying the resulting quotient by 100, to produce the Selling Intelligent Quotient (SIQᵢ) of the i-th individual according to the following formula:

$${SIQ}_{i} = \frac{{SCSC}_{T , i} \cdot {SJSC}_{T , i}}{\frac{{\sum }_{j = 1}^{j = J} {SCSC}_{T , j} \cdot {SJSC}_{T , j}}{J}} \cdot 100$$

According to this preferred Selling Intelligence Quotient (SIQ) formula, an SIQ score of 100 indicates a performance at exactly the normal level for the sales group, team, company, or industry used to compute the normalization factor.

An SIQ score above 100 indicates performance above the normal level in the sales representative's group, team, company or industry as the case may be.

An SIQ score below 100 indicates performance below the normal level in the sales representative's group, team, company or industry as the case may be.

Using the above described SIQ calculation method, sales managers and leadership now have a rational handle on how well a sales representative measures relative to other competing sales people on ones's group, team or company, or within one's industry. What is important, for comparision purposes, is to establish and maintain standards when administering SIQ testing policies and procedures carried out by the system of the present invention. In general, it will be helpful and wise to determine and specify the set of N number of Selling Competency Skill Categories used during SCSC assessment and scoring, and also, determine, and specify the set of M number of Selling Judgement Skill Categories used during SJSC assessment and scoring. Such standards can be identified by the N×M factor, so that sales representatives participating in SIQ assessment and testing know that they were assessed using a common superset of selling skill categories, so SIQ scores of different sales representatives will be based on common or like normalization procedures.

As selling intelligence is a complex attribute or property of a human being, in a specific field of human activity, based on many social variables, it is understood that selling intelligence of a person can and will change over time with proper training/education and experience. As such, it is a primary object of the system and methods of the present invention to provide automated methods and technology to assess, develop and management the selling intelligence of individuals, and groups of individuals, for the purpose of increasing their effectiveness in diverse forms of human competition and achievement.

### Specification of the Selling Intelligence (SI) Data Structure Maintained by the System

FIG. 4T shows the selling intelligence (SI) data structure maintained by the system for each and every system user (e.g. sales representatives, employees, new-hires, etc.). As shown, the data structure illustrates the many different types of data collected and maintained including, but not limited to, for example: user data supplied by the reporting data storage submodule shown in FIG. 5C1; selling competency skills data, and selling judgment skills data supplied by the assessment scoring submodule shown in FIG. 4c; selling intelligence data computed by the selling intelligence scoring submodule shown in FIG. 4Q; assessment history data including assessment history and assessment ID data; prescription history data including prescription ID data; and other types of data related to the system user on the system network. The SI data structure is maintained for each system user registered on the system, for whom the selling intelligence (SI) is assessed, developed and managed in accordance with the principles of the present invention. Notably, most automated methods supported on the system of the present invention will make use of the data maintained within the SI data structure of FIG. 4T. In practice, this SI data table can be realized in any one of many possible ways. Preferably, when using a DBMS as a system database, the SI data structure can be realized as a number of relational tables with the DBMS. Other methods will come to mind by those skilled in the computer programming and database design arts.

For system users (e.g. sales managers, leadership, HR managers and CEOs), whose selling intelligence (SI) capacity will not be managed by the system of the present invention, there will be no need for the system to manage an SI data structure as shown in FIG. 4T. However, there can and most likely will be other data structures maintained for such system users by the system.

### Specification of the Automated Metric-Driven Assessment Generation and Delivery Method of the Present Invention

FIG. 4U illustrates the primary steps of the process of generating and delivering assessments in response to automated generation of assessment (e.g. selling competency and judgement skill assessments) using the automated method illustrated in FIG. 4V3. As shown at Block A, the automated method illustrated in FIG. 4V6 is used to create assessments for the pre-hire candidate or sales representative, based on the skill category metrics generated for any prescriptions administered to the sales representatives. As indicated at Block B, the system sends a message to the pre-hire candidate (via SMS, email or system notification) indicating the list of assessments that the pre-hire/sales representative should complete for assessing the selling intelligence of the pre-hire/sales representatives. As shown in FIG. 4U, the list of assessments is displayed in GUI screen produced by a link contained in the transmitted message. This automated method is designed for automated-generation of selling intelligence assessments during the entire life cycle of a sales representative, whose selling intelligence is being periodically assessed and developed with metric-driven prescriptions delivered over the system of the present invention.

### Specification of the Assessment Interface Submodule of the System, Supporting the Generation and Delivery of Various Kinds of Selling-Intelligence Assessments

FIG. 4V1 shows the assessment interface submodule 31A supporting the generation and delivery of various kinds of selling-intelligence assessments including (i) multiple-choice question based assessments, (ii) conversation-based assessments, (iii) game-based simulations, and (iv) mixed-vehicle assessments constructed on combinations of the above.

As shown in FIG. 4V1, the automated assessment processing submodule 31B-1 driven by metrics generated during prescriptions, when available, supports four different automated assessment generation and delivery processes: (i) the generation and delivery of multiple-choice question assessments 31B-2; (ii) the generation and delivery of conversation-based assessments 31B-3; (iii) the generation and delivery of game-simulation assessments 31B-4; and (iv) the automated generation and delivery of mixed vehicle assessments 31B-5. Each of these processes is triggered by the occurrence of a sales manager (i) logging into the system using a manager dashboard GUI as shown in FIG. 3A, (ii) entering the name, address and contact information of a pre-hire candidate, and (iii) requesting that the pre-hire candidate be automatically for selling intelligence and sales skills using the system 2 of the present invention.

Once registered with the system, the pre-hire candidate is given a system user account on the system network 1, and login credentials so they can login and be presented a pre-hire dashboard as illustrated in FIG. 3C. After the pre-hire candidate has been fully assessed by taking all required assessments as illustrated in FIG. 4U, the system 2 automatically generates a selling intelligence measurement for the candidate. Sales managers reviews the candidate and his or her SI assessments, and if the managers like the candidate and his or her assessed capacities and potential, then they will hire the candidate as an employee, working as sales representative. At the same time, the system 2 can automatically generate a course syllabus for developing the candidate's selling skills and intelligence. Alternatively, such development can be achieved by the sales manger using the dashboard as shown in FIG. 3B and manually creating a syllabus of courses. After being hired, the sales representative uses an employee dashboard as illustrated in FIG. 3D.

As shown in FIG. 4V1, assessment generators 31B-2, 31B-3, 31B-4 and 31B-5 generate multiple-choice assessments, conversation-based assessments, game-based simulations and mixed-vehicle assessments which are delivered to the assessment interface submodule 31A of the system interface of the system, for pre-hire candidates and sales representative employees to review and engage with during selling intelligence assessment on the system of the present invention.

### Specification of the Assessment Schema Used in the Automated Method of Generating Assessments of the Present Invention

FIG. 4V2 describes the primary steps involved in the automated assessment schema used in the automated method of generating assessments of the present invention. As indicated at Blocks, A, B and C in FIG. 4V2, “Company” has a “User”, and each “User” is assigned a “Prescription” as indicated at Block E. As indicated at Block D, each User has a “Metric” which is used to create the “Prescription”, and also has a “Metric” which is associated with a “Prescription”. Each Metric has a “Distance” value, skill category, and benchmark, associated with it. As indicated at Blocks, T, G and H, each “Benchmark” can be one of three possible types: “SI Benchmark” “Performance Benchmark” or “Category Benchmark” specified by a “Skill Category ID”. As shown in at Block E, each User is assigned an “Assessment,” having an “Assessment ID”, which is created by the “Metric”. As shown, each Assessment can be one of four possible types: “Competition”; “Coaching”; “Feedback”; and “Cadence”. Also, as shown at Blocks J, K, L, and M each Prescription can be one of four possible types: “Competition”, “Coaching”, “Feedback”, or “Cadence”. As shown, “Competition” has a “Type”, “Coaching” has “Text”, “Feedback” has “Text” and “Cadence” has “Courses.”

### Specification of the Method of Automatically Generating Assessments Using the Assessment Module of the System

FIG. 4V3 describes the primary steps involved in the process of generating assessments using the assessment module of the system of the present invention. As indicated at Block A, when the user completed his/her prescription”, the system proceeds to Block B where the automated assessment generation shown in FIG. 4V4 is carried in an automated or semi-automated manner, using metrics associated with the user provided from the prescription data storage submodule 22C, shown in FIG. 6C As indicated at Block C, assessments are created, and are stored in the assessment data storage submodule 31C shown in FIG. 4C.

### Specification of the Method of Automated Metric-Driven Assessment Generation and Delivery According to the Present Invention

FIG. 4V4 describes the primary steps involved in the method of automated metric-driven assessment generation and delivery according to the present invention.

As shown in FIG. 4V4, the assessment generation process begins at Block A. At Block B, the process determines what an assessment vehicle or type (e.g. multiple-choice question assessment, conversation-based assessment, game-simulation based assessment, or mixed-vehicle assessment) has been selected by the system administrator or sales manager. In some cases, the system can be programmed with assessment vehicle types based on several possible criteria including, for example, (i) assessment preferences set by system administrators, as well as (ii) selling competency skill categories or selling judgement skill categories involved in previous prescriptions.

As shown at Block C in FIG. 4V4, the process determines the skill categories to be assessed. At Block D, this determination can be made by analyzing prescriptions and metrics, if any exist at this stage of assessment generation, and determine the set of selling skill categories that require assessment by the system to improve the selling intelligence of the user (e.g. sales representative, pre-hire, et al).

At Block E in FIG. 4V4, the process selects all selling skill categories if no metrics or prescriptions are available for the given user.

At Block F in FIG. 4V4, the process creates test points for each skill category to be assessed.

At Block G in FIG. 4V4, the process selects a particular medium (e.g. a four-choice format if multiple-choice test assessment vehicle has been selected) for embedding test points in selected assessment vehicle.

At Block H in FIG. 4V4, the process embeds test points in the assessment medium vehicle.

At Block in FIG. 4V4, the process packages the embedded assessment, assigns an assessment ID to the generated assessment vehicle, and loads the assessment into the assessment library maintained within the assessment data storage submodule.

### Specification of the Internal Assessment Report (IAR) Used to Automatically Generate and Deliver Assessments Based on Metrics Generated by the System of the Present Invention

FIG. 4V5 shows an Internal Assessment Report (IAR) data structure used to automatically generate and deliver assessments based on metrics generated by the system of the present invention. As shown, the IAR data structure may be realized as a table structure maintained for each user on the system of the present invention, and containing data fields for selling competency (SC) skill category scores, selling judgement (SJ) skill category scores, metrics relating to skill category scores, and prescription IDs related to any prescriptions taken by the user. Data for this user-specific data structure is provided from the prescription data storage module 33C and the reporting data storage submodule 32C, and used during the automated method shown in FIG. 4V4.

### Specification of the Reporting Interface Submodule Supporting the Delivery of Various Kinds of Selling-Intelligence Based Reports for Various Users

FIG. 5A1 shows the reporting interface submodule 32A supporting the generation and delivery of various kinds of selling-intelligence based reports for various users including, for example: (i) industry reports for company administrators; (ii) company reports for company wide managers; (iii) group reports for regional managers; and (iv) user reports for hiring decision managers. These reports can be electronically displayed as HTML5 webpages, as pdf, or Xcel, or other formatted documents in a manner well known in the art. Based on these reports and charts, managers can make hiring, training, and efficacy decisions as needed to advance sales quota and sales forces goals of the company.

FIG. 5A2 shows a GUI screen presenting an exemplary industry report for company administrators, generated by the reporting interface submodule 32A of the system 2, showing how a plurality of competing companies rank against each other in terms of the selling intelligence, selling competency and selling judgment of its sales force.

FIG. 5A3 shows a GUI screen presenting an exemplary company industry report for company wide managers, generated by the reporting interface submodule of the system 2, showing how various sales representatives and employees in a company rank among each other in terms of the selling intelligence, selling competency and selling judgment.

FIG. 5A4 shows a GUI screen presenting an exemplary group report for regional managers, generated by the reporting interface submodule of the system 2, showing how various sales representatives and employees in a group rank among each other in terms of the selling intelligence, selling competency and selling judgment.

FIG. 5A5 shows a GUI screen presenting an exemplary user report for hiring decision managers, generated by the reporting interface submodule 32A of the system 2, selling showing how a particular individual sales representative or employee in a company performed in terms of the selling intelligence, selling competency and selling judgment.

### Specification of the Reporting Processing Submodule of the System of the Present Invention, Shown Supporting the Creation and Generation of Various Kinds of Selling-Intelligence-Based Reports

FIG. 5B illustrates the various kinds of data stored in the reporting processing submodule 32B of the system 2. As shown, the reporting processing submodule 32B supports the creation and generation of various kinds of selling-intelligence-based reports such as, for example: industry reports 40A; company reports 40B; group reports 40C; and user reports 40D. These reports are generated using various kinds of data (e.g. user performance data 41A, scoring data 41B, internal system data 41C, and user tracking data 41D) stored in and supplied by the prescription data storage submodule 33C illustrated in FIGS. 5C1.

### Specification of the Reporting Data Storage Submodule Supporting User Performance Data, Scoring Data, User Tracking Data and Other Internal System Data

FIG. 5C1 illustrates the reporting data storage submodule 32C supporting various classes of collected data from various sources. For example, the reporting data storage submodule 32C stores various classes of collected data comprising: (i) user performance data 41A from manager surveys manually input to the system, and external company data sources from CRM data, ERP data, APIs, external learning management data, company datasets, etc.; (ii) internal system data 41C from internal systems (performance data from companies registered with the system; (iii) scoring data 41B (e.g. relating to selling competency, selling judgement, and selling intelligence) from the assessment scoring submodule 31B shown in FIG. 4C; and (iv) user tracking data 41D from user's data and user interactions with the system (e.g. user geo-location data, login history data, user demographic information, user timing data, user activity data, and user data).

### Specification of the User Performance Data Stored in the Reporting Data Storage Submodule of the System of the Present Invention

FIG. 5C2 shows the classes of data pertaining to a user's performance data stored in the reporting data storage submodule 32C, and organized into data categories: (i) objective data collected by objective rational assessment techniques supported by the assessment interface submodule 31A; and (ii) subjective data collected in the form of opinions, judgements and experiences of leadership and managers.

The objective data is gathered from a customer relationship management (CRM) system (e.g. Salesforce, etc.) or database containing data such as, for example, employment length, months supervising, percentage of quota achieved last year, percentage of quota achieved 2 years ago, percentage of quota achieved 3 years ago, estimate for quota achievement this year, close ratio).

The subjective data is gathered from sales leadership based on their opinion on the sales representative's or new hire's sales competency skills: hunter, farmer, self-starter, emotional intelligence, learning and applying knowledge, sales foundation, prospecting, discovery-needs analysis, presenting, objection management, closing/negotiating, and overall sales ability.

Objective Information—Gathered from a CRM System or Database and Stored in the Reporting Storage Submodule

### Manager Survey Filled Out by a User's Manager

Employment length
Months supervising
Percentage of sales quota achieved last year
Percentage of sales quota achieved 2 years ago
Percentage of sale quota achieved 3 years ago
Estimate for sales quota achievement this year
Close ratio
   Subjective Management Data—Gathered from Leadership Based on their Opinion and Stored in the Reporting Storage Submodule
Hunter
Farmer
Self Starter
Emotional Intelligence
Learning and Applying Knowledge
Sales Foundation
Prospecting
Discovery Needs Analysis
Presenting
Objection Management
Closing/Negotiating
Overall Sales Ability

### Specification of the User Tracking Data Stored in the Reporting Data Storage Submodule of the System 7 of the Present Invention

FIG. 5C3 shows various classes of data pertaining to a user's identity and activity (i.e. user's tracking) stored in the reporting data storage submodule 32C, and organized according to the following categories:

(i) user demographic information collected by surveys filled out by users on first entry of the system (e.g. education, race, age, gender, position/title, length of time with manager);

(ii) user data (e.g. user's name, position/title, email address, time account was created, and user preferences); and

(iii) user activity (e.g. login history, messages sent from user to user, length of time in assessment, length of time for each decision/answer, what learning material was read?, did the user skip anything?, did the user view the whole coaching?, how long did the user spend in the coaching, and how long did the user spend into the intro).

### Specification of the Reporting Interface Submodule Displaying Performance Data Types for Comparison and Analysis

As shown in FIG. 5C4, the reporting interface submodule 32A illustrates: (i) the display of subjective data provided by manager surveys against system data from the system network of the present invention; (ii) the display of objective data provided by external sources (e.g. CRMs, ERPs, APIs, etc.) against system data collected and generated by the system network; and (iii) review, analysis and comparison of such displayed data, by supervisors and higher-level managers.

### Specification of the Reporting Data Storage Submodule and Reporting Processing Submodule Supporting Automated Generation of Manager Alignment Indices

FIG. 5C5 illustrates the collection and storage of subjective data collected from surveys taken by managers, and system data from user tracking, scoring data, and other internal systems, in the reporting data storage module 32C of FIG. 5C1.

FIG. 5C5 also illustrates the automated comparison and factoring of this subjective data and system data so as to automatically generate a manager alignment index for display via the reporting interface submodule 32A shown in FIG. 5A1.

### Specification of the Reports Generation Process Supported by the Reporting Module of the Selling Intelligence Assessment, Development and Management System of the Present Invention

FIG. 5D illustrates the reports generation process supported by the reporting module 32 within the system 2. As shown, the reporting module 32 comprises: anonymity data filters 45 for receiving external sales performance data streams from the computer networks and storage servers maintained at numerous companies (company 1, 2, 3, . . . N), and automatically scrubbing (i.e. removing) user information from data streams and allowing safe sharing of user reports without compromising confidentiality and like concerns of the system network users; the reporting data storage submodule 32C shown in FIG. 5C1 for storing reporting data; the reporting processing submodule 32B shown in FIG. 5B for generating reports 40A through 40D; the reporting interface submodule 32A shown in FIG. 5A1 for enabling users from various companies (companies 1, 2, 3 . . . N) using web-enabled client machines 3.

### Specification of the Primary Steps Carried Out During the Process Supported by the Reporting Module of the Selling Intelligence Assessment, Development and Management System

FIGS. 5E and 5F illustrate the process supported by the reporting module 32 of the system 2. As shown in the example, a competitive user report is generated employing the data anonymity filters 45 shown in FIG. 5D, in accordance with the principles of the present invention.

As shown in FIG. 5E, the first phase of the report generation process involves a manager from Company A desiring to compare its selling intelligence and performance data with Companies B and C.

As shown in FIG. 5E, the second phase of the report generation process involves accessing company A data and company B data from the reporting data storage submodule 32C in FIG. 5C1, and then using the anonymity data filter 45 to automatically remove personally identifiable information from Company B and C so that the resulting competitive reports do not contain personally-identifiable information. As shown, at the last stage of the filtering process, the company report contains data from company A and company B, but all user identifying data is removed and replaced with an “alias” name as shown.

### Specification of the Prescription Interface Submodule Supporting the Generation and Delivery of Various Kinds of Selling-Intelligence Prescriptions for Various Users

FIG. 6A1 shows the prescription interface submodule 33 of the system network, supporting the generation and delivery of various kinds of selling-intelligence prescriptions comprising various interface types. For example, such interface types include: (i) simulated competitions (i.e. scoreboard showing ranked standing to show off progress in the system, and achievements showing badges given to users when completing tasks) to incentivize user's to use the system, (ii) learning cadence/training courses (i.e. courses—syllabi designed to teach user's how to improve selling skills, and learning material including documents that will help users improve scores on assessments), and (iii) coaching efforts and feedback (i.e. coaching interface—supporting automated coaching given to users on how to improve, and feedback interface—informing a manager how best to improve a user's skills) for various users including, for example, sales representatives, and sales leadership.

As shown, the prescription processing submodule 33B is interfaced with the prescription interface submodule 33A and receives and processes the data collected from such various user interfaces supported by the prescription interface submodule 33A. Different users have access to different interfaces and receive different services supported by the system network of the present invention.

As shown in FIG. 6A1, the sales representative has access to the competition interface supported by the prescription interface submodule 33A, including the scoreboard 47A showing ranked standing of users to show off progress in the system 2; and achievement 47B showing badges given to user's completing tasks.

As shown in FIG. 6A1, the sales leadership lays out and prescribes courses to improve selling intelligence skills, by the learning cadence interfaces 48 presenting courses 48A from syllabi designed to teach user's how to improve skills.

As shown in FIG. 6A1, the sales representative takes courses to improve selling intelligence skills, by the learning cadence interfaces 48 presenting courses 48A from syllabi designed to teach user's how to improve skills.

As shown in FIG. 6A1, the sales representatives uses a coaching interface 49A to receive automated coaching on how to improve their selling and sales skills.

As shown in FIG. 6A1, the sales leadership uses the feedback interface 49B that advises a manager how to best improve the users' selling and sales skills.

Specification of the Process of Generating and Delivering Coaching and Feedback in Response to Automated Generation of Prescriptions (e.g. Coaching and Feedback) Using the Automated Metric-Driven Prescription Generation and Delivery Method of the Present Invention

FIG. 6A2 shows the process of generating and delivering coaching and feedback in response to automated generation of prescriptions (e.g. coaching and feedback) using the automated method illustrated in FIG. 6B6.

As shown at Block A in FIG. 6A2, the automated method illustrated in FIG. 6B6 is used to create prescriptions (e.g. coaching and feedback) for sales managers, based on the metrics generated for the skill scores received by the pre-hire/sales representatives working under the sales manager.

As indicated at Block B in FIG. 6A2, the system sends a feedback message to the sales manager (via SMS, email or system notification) indicating at Block C that the “User has some troublesome skill scores. Click here to help them improve.” As shown in FIG. 6A2, the list of assessments is displayed in GUI screen produced by a link contained in the message.

As indicated at Block D in FIG. 6A2, the system has automatically assessed an exemplary sales representative as having “low achievement drive”, and states: “Individuals who score in this range will demonstrate few competitive behaviors. They tend to be content regardless of performance level. They are not motivated by monetary gain. They are likely to be cooperative and will compromise,” and when the system automatically generated and prescribed the following management strategies—“This salesperson's training needs to focus extensively on building a competitive spirit within self and when competing to achieve business results. Competitive situations need to be built into his/her training. These need to include setting and reaching personal goals as well as broader company goals. Goal attainment and success in competitive exercises and events need to be rewarded”.

### Specification of the Prescription Processing Submodule Supporting the Processing of Various Kinds of Selling-Intelligence Prescriptions

FIG. 6B1 shows the prescription processing submodule 33B interfaced with the prescription interface submodule 33A shown in FIG. 6A1, and driven by data from the reporting data storage submodule shown in FIG. 5C1 and prescription data storage submodule 33C shown in FIG. 6C.

As shown in FIG. 6B1, the prescription processing submodule 33B supports the processing of various kinds of selling-intelligence prescriptions (e.g. simulated competitions, training courses/training cadence, coaching efforts and feedback) for various users, such as, for example, sales representatives, and sales leadership. Such skills prescriptions include, include: (i) automated prescription processing 52 (i.e. prescriptions generated based on a user's and external performance) supported by the reporting data storage submodule 32C; and (ii) manual prescription processing module 53 (i.e. prescriptions created by a manager manually) supported by the prescription data storage submodule 33C.

As shown in FIG. 6B1, the assessment data storage submodule 31C, the reporting data storage submodule 32C and prescription data storage submodule 33C are interfaced with the prescription processing submodule 33B to support (i) the automated method of creating prescriptions shown in FIG. 6B6, (ii) the automated metric processing shown in FIG. 6B5, and (iii) the automated benchmark processing shown in FIG. 6C.

As shown in FIG. 6B1, the automated prescriptions processing module 52 generates and supports a number of prescriptions relating to the competition, and coaching & feedback services suite. The automated prescriptions processing module 52 and the manual prescription processing module 53 generates and supports learn the cadence/skills training services suite.

As shown in FIG. 6B1, the automated prescriptions processing module 52 supports the generation of GUIs and processes supporting the following services: scoreboards and achievements, generated for users to encourage them to compete and progress among individuals in competition; prescriptions generated for representatives to improve skills and performance, and prescriptions generated for leadership on how to improve sales representatives, as part of the suite of coaching and feedback services provided by the system; and courses automatically generated based on performance supporting the learning cadence suite.

As shown in FIG. 6B1, the manual prescriptions processing module 53 supports the following services: creates courses by input from sales managers to support learning cadence supported by prescriptions interface submodule of FIG. 6A1.

### Specification of the Assessment Schema Used in the Automated Method of Generating and Delivering Assessments of the Present Invention

FIG. 6B2 describes the primary steps involved in the automated assessment schema used in the automated method of generating and delivering assessments of the present invention. As indicated at Blocks, A, B and C in FIG. 6B2, “Company” has a “User”, and each “User” is assigned a “Prescription” as indicated at Block E. As indicated at Block D, each User has a “Metric” which is used to create the “Prescription”, and also has a “Benchmark” which is associated with a “Metric”. Each Metric has a “Distance” value associated with it. As indicated at Blocks, T, G and H, each “Benchmark” can be one of three possible types: “SI Benchmark” “Performance Benchmark” or “Category Benchmark” specified by a “Skill Category ID”. Also, as shown at Blocks I, J, K and L, each Prescription can be one of four possible types: “Competition”, “Coaching”, “Feedback”, or “Cadence”. As shown, “Competition” has a “Type” attribute/feature, “Coaching” has “Text” attribute, “Feedback” has “Text” attribute, and “Cadence” has a “Courses” attribute.

### Specification of Automated Method of Generating and Delivering Prescriptions Using the Prescription Module of the System of the Present Invention

FIG. 6B3 describes a process of generating and delivering prescriptions in response to automated generation of prescriptions using the prescription module within the system 2 of the present invention.

As indicated at Block A in FIG. 6B3, when the user completed his/her assessment, the system proceeds to Block B where the automated benchmark processing method shown in FIG. 6B3 is carried out to find benchmarks from highest performers. Notably, highest performer may be defined and identified in various ways including, for example, in terms of (i) sales performance data, (ii) selling competency/judgement skill category scores, and/or (iii) selling intelligence (SI) measurement data.

As indicated at Block C in FIG. 6B3, benchmarks are created and then stored in the metrics and benchmarks data store of the prescription data storage submodule shown in FIG. 6C.

At Block D in FIG. 6B3, the automated metrics processing method shown in FIG. 6B3 uses the benchmarks created, and determines each user's distance from the benchmarks, and creates metrics at Block E. As used hereinafter and the in the Claims, the term “distance” can be the Euclidian distance or Euclidean metric, or any other mathematical distance, or similarity measures, well known in the art.

The Euclidian metric is an “ordinary” (i.e. straight-line) distance between two points in Euclidean space. With this distance, Euclidean space becomes a metric space.

$$\begin{matrix}d ( p , q ) = d ( q , p ) = \sqrt{{( {q}_{1} - {p}_{1} )}^{2} + {( {q}_{2} - {p}_{2} )}^{2} + ⋯ + {( {q}_{n} - {p}_{n} )}^{2}} \\ = \sqrt{{\sum }_{i = 1}^{n} {( {q}_{i} - {p}_{i} )}^{2}} .\end{matrix}$$

The position of a point in a Euclidean n-space is a Euclidian vector. So, p and q are Euclidean vectors, starting from the origin of the space, and their tips indicate two points. The Euclidian norm, or Euclidean length, or magnitude of a vector, measures the length of the vector:

∥P∥=\sqrt{p₁²+p₂²+ . . . +pₙ²},

Different measures of distance or similarity will be useful performing different types of data analysis when practicing the various aspects of the present invention. Reference is made to Wolfram® MathWorld™ as a mathematical resource on distance metrics: http://mathworld.wolfram.com/Distance.html

As indicated at Block F in FIG. 6B3, the automated method shown in FIG. 6B3 uses the created metrics to generate prescriptions based on the metrics, and these prescriptions are stored in the prescription storage submodule shown in FIG. 6C.

### Specification of the Process of Generating Benchmarks for Use in the Metrics Used in Internal Prescription Reports (IPR) Generated During Automated Prescription Generation

FIG. 6B4 describes the process of generating benchmarks for use in the metrics used in internal prescription reports (IPR) generated during automated prescription generation, involving the processing of selling skill category score data and selling intelligence measurement data. As used hereinafter, “benchmarks” are understood to mean a criterion by which to measure something; a standard; or a reference point. In connection with measuring and developing selling intelligence and selling skills using the system, network and methods of the present invention, it is understood that “benchmarks” can be (i) numbers associated with selling skill category scores expressed as dimensionless numbers, (ii) numbers associated with selling intelligence (SI) measurements expressed as dimensionless numbers, and (iii) numbers associated with sales performance quotas expressed in financial currency units (e.g. US Dollars $, etc).

As indicated at Block A in FIG. 6B4, the benchmark process is started. At Block B, the bestPerf parameter is set equal to the best user's sales performance. The bestSI parameter is set equal to the best sales intelligence score.

At Block C in FIG. 6B4, the process integrates through each user in the given company.

At Block D, the process determines if best SI is less than the user's SI score, and if so, then at Block E, the process sets bestSI parameter to the user's SI score and advances to Block F. If not, then the process advances to Block F, at which the process determines whether the bestPerf is less than the user's sales performance, and if so, then advances to Block G.

At Block Gin FIG. 6B4, the bestPerf parameter is set to the user's sales performance. If not, then the process advances to Block H, where the process determines whether or not there are more users. If so, the process returns to Block C and processes the score and performance data of the next user, through Blocks D through H. If not, then the process advances to Block I, where the process interates through each skill category score for the user (SC1-SC35 and SJ1-SJ61).

At Block J in FIG. 6B4, the process sets the best parameter to the best score for the category. At Block K, the process integrates through each user in the given company. At Block L, the process determines whether or not this is the best score for the given skill category, and if so, then the process advances to Block M, where the best parameter is set to the new score. If not at Block F, then the process advances to Block N where the process determines if there are more users to process. If yes, then the process returns to Block K, and continues processing through Blocks L, M and N. If there are no more users to process, then the process advances to Block O, where the process saves the best parameter value to benchmarks, and then determines at Block P if there are more skill categories to process. If so at Block P, then the process returns to Block I, and processes the skill category through Blocks I through O. If there are no more skill categories to process, then the process advances to Block Q, and terminates the process.

### Specification of the Automated Method of Generating Metrics During Automated Prescription Generation

FIG. 6B5 describes the process of generating metrics during automated prescription generation, involving the processing of selling skill category score data, selling intelligence measurement data, and generated benchmarks.

As indicated at Block A in FIG. 6B5, there metrics computation process begins. At Block B, the process interates through each benchmark generated by the automated assessment benchmark process, and then advances to Block C, where the process interates through each user in the given company.

At Block D in FIG. 6B5, the process determines whether or not there is an SI benchmark, and if so, then at Block E, the process sets uScore parameter to the user's SI score, and bScore is set to the benchmark's score, and advances to Block J. If at Block D, there is an SI benchmark, then the process advances to Block F, where the process determines if there is a performance benchmark, and if so, then the process advances to Block G where the process sets the uScore parameter to the user's sales performance, and the bScore is set to the benchmark's score. If at Block F, the process determines there are no benchmarks to process, then the process advances to Block H where the process advances to Block I, and sets the uScore parameter to the user's skill score and the bScore to the benchmark's score.

At Block J in FIG. 6B5, then process computes the metric by formula recite at Block J, in the illustrated embodiment. There are three metrics cases to consider depending on whether the benchmark is an SI Benchmark, a Sales Performance Benchmark, or a Skill Category Benchmark.

If a SI Benchmark is used, then Metrics Formula #1 is used at Block J, for computing a metric for the user's SI score, involving: (i) computing the difference between the SI Benchmark and user's SI score; (ii) squaring the difference; (iii) taking the square root of the squared figure, then (iv) dividing by the SI Benchmark to compute a normalized user metric value for his or her SI score. For small metric values computed, this figure indicates that the user's SI score falls close to the SI Benchmark, and need for SI development prescriptions is low; for large metric values computed, this figure indicates that the user's SI score falls far from the SI Benchmark, and need for SI development prescriptions is great. Thresholds can be set for SI metrics based on experience with actual datasets within a particular company, and system administrators will know how to set these SI metric thresholds.

If a Performance Benchmark is used, then Metrics Formula #2 is used at Block J, for computing a metric for the user's Sales Quota Performance score, involving: (i) computing the difference between the Performance Benchmark and user's sales quota; (ii) squaring the difference; (iii) taking the square root of the squared figure; then (iv) dividing by the Performance Benchmark to compute a normalized user metric value for his or her performance score. For small metric values computed, this figure indicates that the user's sales performance falls close to the Performance Benchmark, and need for SI development prescriptions is low; for large metric values computed, this figure indicates that the user's sales performance falls far from the Performance Benchmark, and need for SI development prescriptions is great. Thresholds can be set for performance metrics based on experience with actual datasets within a particular company, and system administrators will know how to set these performance metric thresholds

If a Skill Category Benchmark is used, then Metrics Formula #3 is used at Block J, for computing a metric for the user's Selling Competency (or Selling Judgement) Skill Category (SC) score, involving: (i) computing the difference between the SC (Skill Category) Benchmark and user's SC score; (ii) squaring the difference; (iii) taking the square root of the squared figure, then (iv) dividing by the SC Benchmark to compute a normalized user metric value for his or her SC score. For small metric values computed, this figure indicates that the user's SC score falls close to the SC Benchmark, and need for SC development prescriptions is low; for large metric values computed, this figure indicates that the user's SC score falls far from the SC Benchmark, and need for SI development prescriptions is great. Thresholds can be set for SC metrics based on experience with actual datasets within a particular company, and system administrators will know how to set these SI metric thresholds.

The metrics described above, and referenced in Block J of FIG. 6B5, are merely exemplary. Different mathematical metrics can be devised and used to perform the functions required by the automated method of prescription generation to enable automation of human-training using the advanced computational machinery of the present invention.

In general, a primary objective of the system of the present invention will be to provide powerful tools for automating the following functions:

(a) measuring the distance between (i) a particular user's score on a particular skill category, factored selling intelligence measurement, or actual sales performance, and (ii) a selected benchmark for the particular skill category, factored selling intelligence measurement, or actual sales performance, respectively;

(b) generating one or more prescriptions designed to close the gap presented by this determined distance;

(c) reassessing the user on selling intelligence development; and

(d) regenerating a new set of prescriptions adapted to further and progressively advance selling intelligence and sales performance of the user, while working in a competitive environment maintained by the system of the present invention within the user's company, in a given industry.

Specification of the Automated Metric-Driven Method of Creating and Delivering Prescriptions (e.g. Coaching, Feedbacks, Scoreboards, Badges and Cadence/Courses) Across an Enterprise

FIG. 6B6 describes the automated metric-driven method of creating prescription (e.g. coaching, feedbacks, scoreboards, badges and cadence/courses) across enterprises, whereby benchmarks and metrics described above are integrated to automatically generate one or more specified prescriptions to improve the selling skills of pre-hire/sales representative(s).

As shown in FIG. 6B6, the process begins at Block A where the prescription generation process commences. As indicated at Block B, the process reinterates through each metric using the automated method of creating prescription, and then advances to Block C, where the process/system interates through each user in the given company.

At Block D in FIG. 6B6, the process creates a user report showing this metric, and provides to the reporting processing submodule as shown in FIG. 5B1, and advances to Block E. As indicated at Block E, the process determines whether or not the metric is greater than an acceptable amount, and if not, then the process advances to Block F, at which the process determines if there are more users to be process.

If at Block F in FIG. 6B6, there are more users to process, then the process returns to Block C, and processes through Blocks D-F. If there are no more users to process, then the process advances to Block H, where the process determines if there are more skill categories to process.

If there are more skill categories to process, then the process advances to Block B, and proceeds through Block B, C, D, E and F, as shown.

If there are no more skill categories to process, then the process proceeds to Block I and terminates. If at Block E the process determines that the metric is greater than an acceptable amount, then the process advances to the prescription creation process shown in Blocks J through Q in FIG. 6B7, described below.

As indicated at Block J in FIG. 6B6, the process determines whether or not the metrics skill category is improvable, and if yes, then the process proceeds to Block K where the process sends a coaching message to the user describing how to improve a particular selling skill, and then advances to Block L.

At Block L, the process creates a course designed to improve the user's skill category which indicates need for improvement. At Block N, the process determines whether or not the user has logged-into the system recently. If the process determines that the user has logged into the system recently, then the process returns to Block F to determine if there are more users to process.

In the event the user has not logged-into the system recently (e.g. within a predetermined time period) at determined at Block N, then the process advances to Block O and sends a notification or message coaching (e.g. encouraging) the user to log-into the system more often, and then proceeds to Block P.

At Block P in FIG. 6B6, the process sends feedback to the sales manager on the user's login-history on the system network, and then returns to Block F to determine if there are more users to process.

### Specification of an Internal Prescription Report (IAPR) Used During the Automated Generation and Delivery of Prescriptions Based on Metrics Generated by the System of the Present Invention

FIG. 6B7 is a schematic representation of an internal assessment report (IAR) used during the automated generation and delivery of prescriptions based on metrics generated by the system of the present invention, according the process shown in FIG. 6B6.

FIG. 6B7 shows an Internal Prescription Report (IPR) data structure used to automatically generate and deliver prescriptions based on user-based metrics generated by the system of the present invention. As shown, the IPR data structure may be realized as a table structure maintained for each user on the system of the present invention, and containing data fields for selling competency (SC) skill category scores, selling judgement (SJ) skill category scores, metrics relating to skill category scores, and prescription IDs related to any prescriptions taken by the user. Data for this user-specific data structure is provided from the prescription data storage module 33C and the reporting data storage submodule 32C, and used during the automated method shown in FIG. 6B6.

### Specification of Exemplary Automated Prescription Processing Methods Supported on the Prescription Module of the System of the Present Invention

FIG. 6B8 is a flow chart describing the primary steps involved in exemplary automated prescription processing methods supported on the prescription module 33 of the present invention, showing (i) various preconditions required for automated prescription processing and service delivery, (ii) particular triggers which will trigger preconfigured prescription processes, and (iii) particular prescription processes that are run when corresponding triggers are activated on the system platform. As shown, these methods use the selling intelligence (SI) data structure illustrated in FIG. 4T, which is maintained by data provided from the assessment data storage submodule 31C shown in FIG. 4D and the reporting data storage submodule 32C shown in FIG. 5C1.

As shown in FIG. 6B8, various automated prescription-based processes are generated in response to the occurrence of particular preconditions or events, on the system: (i) when a user takes an assessment, there are three (3) different prescriptions automatically generated on the system; (ii) when a user logs into the system, a manager feedback prescription is automatically generated on the system; (iii) when data is imported from a CRM system, there are three (3) different prescriptions automatically generated on the system; and (iv) when other system activities occur (e.g. user, manager, or system initiated), manager and sales representative prescriptions are automatically generated on the system. Examples of these automated prescription generation processes will be described below with reference to the three-tier system model illustrated in FIG. 6B8.

As shown in FIG. 6B8, when a user taken an assessment, three prescription-based processes can be generated. The first prescription process relates to the generation of badges on a scoreboard: if the total score assigned to the user-taken assessment (e.g. Assessment 1) exceeds a threshold of 85, then the system (i.e. process) automatically assigns a new badge of achievement to the user for posting on the competition scoreboard. The second prescription process relates to updating scoreboard position: if the selling intelligence (SI) of the user is changed, then the system automatically changes the position of the user on the competition scoreboard. The third prescription process relating to recommending learning material to read in the system library: if a particular skill category (SC) score is less than a threshold of 65 and the sales quota attainment is low, then the system (i.e. process) automatically recommends certain learning material to read and learn.

As shown in FIG. 6B8, whenever a user logs into the system, a prescription-based process is generated. The prescription process relates to sending leadership prescriptions on how to improve the sales representative's SI and performance: if the user has not logged into the system lately and sales quota level is low, then the system sends the manager a message recommending the employee to log into the system, and other suggestions on how to help the sales representative.

As shown in FIG. 6B8, whenever data is imported into the system from a CRM system, several prescription-based process are generated. The first prescription process relates to recommending learning material to the sales representative, described above. The second prescription process relates to generating a prescription for leadership to help the sales representative and encourage the sales representative to log into the system, described above. The third prescription process relates to automatically generating courses to help develop selling intelligence, based on assessed performance: if a user's skill category score is low and others show high attainment in this skill category, then the system creates new courses to help improve the particular selling skill category on which the user scored low.

As shown in FIG. 6B8, whenever other system activities (e.g. user, manager or system initiated) occur, the system automatically creates new courses to help improve the particular selling skill category on which the user scored low, as described above.

The “If X, Then Y” conditions shown in the trigger/processing tiers of FIG. 6B8 are merely exemplary for illustrative purposes, and virtually any set of logical conditions can be programmed to generate and deliver automated prescriptions from the system of the present invention. The triggers can contain conditions relating to selling competency (SC) skill scores, selling judgement (SJ) skill scores, selling intelligence (SI), and/or sales performance figures, to cover situations where it makes good sense to automatically generate and deliver various kinds of prescriptions (e.g. coaching, feedbacks, scoreboards, badges and cadence/courses) from the selling intelligence assessment, delivery and management system of the present invention.

### Specification of Manual Prescription Processing Methods Supported on the Prescription Module of the System of the Present Invention

FIG. 6B9 illustrates manual prescription processing methods supported on the prescription module of the system of the present invention. Typically, a sales manager who desires to manually create a prescription such as a course syllabus, will log into his or her user account and launch the managers dashboard as illustrated in FIGS. 3A and 3B, and access the “Edit A Syllabus” GUI screen as shown in FIG. 6B9, allowing the manager to assign specific courses for developing selling skill categories, in which the sales representative scored poorly (i.e. below a benchmark threshold). As shown in FIG. 6B9, the sales leadership (e.g. manage, creates a course load for a particular sales representative). Using the create syllabus dashboard, the manager creates a learning cadence for the sales representative, and the system generates a message (e.g. email, SMS or system notification) that is sent to the sales representative, with instructions to take the courses in a specific order.

Specification of the Prescription Data Storage Submodule Employed within the Selling Intelligence Assessment, Development and Management System of the Present Invention

FIG. 6C shows the prescription data storage submodule 33C, describing the storage of various classes of data by the prescription storage submodule 33C directed to application classes. As shown, the submodule 33C stores at least the following datasets: (i) a competition simulation dataset including achievements earned and scoreboard data; (ii) a coaching and feedback dataset including feedback generated and coaching generated; (iii) a learning cadence/skills training dataset including course syllabi with courses that are automatically created, and courses that are created by sales managers; and (iv) a metrics and benchmarks dataset, including metrics and benchmarks for all selling skill category scores, selling intelligence scores and sales performance figures of all system users, generated within the prescription module 33 of the system of the present invention.

### Specification of the User Interaction Timeline Showing Primary Steps and Processes Carried Out on the Selling Intelligence Assessment, Development and Management System of the Present Invention

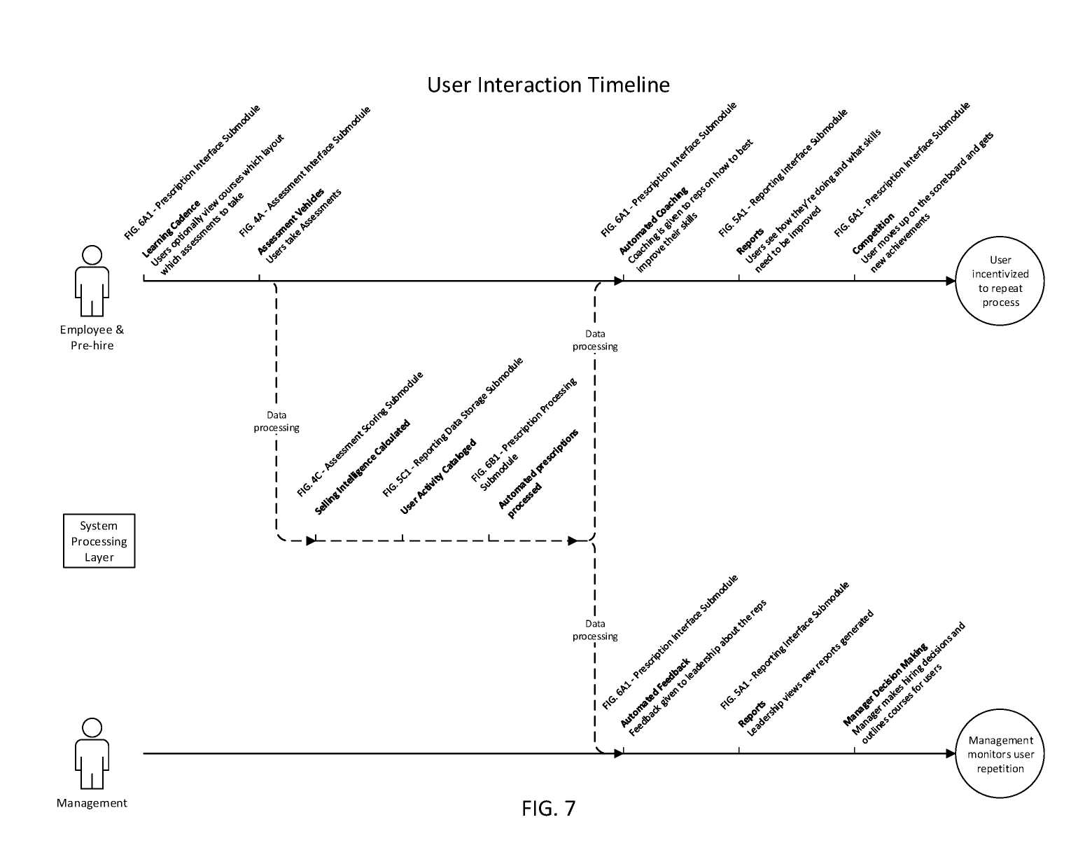

FIG. 7 describes a user interaction timeline comprising primary steps and processes (e.g. outlining courses, assessments, conversations, selling competency and selling judgment scoring, selling intelligence score calculations, actions and reports) carried out on the selling intelligence assessment, development and management system of the present invention for different users including “pre-hire” users, “employee” users, and “CEO, HR, officer an Manager” users.

As shown in FIG. 7, the workflow of the pre-hire or employee (i.e. sales representatives) comprises the steps: (a) the pre-hire or employee (i.e. sales representatives) uses the prescription interface submodule of FIG. 6A to view courses which layout which assessments to take as part of the learning cadence; (b) the pre-hire or employee uses the assessment interface submodule of FIG. 4A to take assessments using recommended assessment vehicles (e.g. multiple choice tests, conversations, games, etc.); (c) the system processing layer (i) uses the assessment scoring submodule of FIG. 4C to transparently calculate the selling intelligence of the system user, as well as selling competency skill scores and selling judgment skill scores, (ii) uses the reporting data storage submodule of FIG. 5C1 to catalogue system user activity, and then (iii) uses the prescription processing submodule of FIG. 6B for supporting automated prescription processing for the assessed system user; (d) the pre-hire or employee uses the prescription interface submodule of FIG. 6A to provide automated coaching to representatives on how best to improve their selling competency and judgement skills; (e) the pre-hire or employee uses the reporting interface submodule of FIG. 5A1 to generate and display reports to see how they are perform on the system and what skills require improvement by performing what prescriptions and recommendations; (f) the pre-hire or employee using the prescription interface submodule of FIG. 6A to engage in competitions on the system to complete, learn and move up the scoreboard/leaderboard and acquire new achievements for progress gained during such competitions; and (g) the pre-hire and employee is incentivized to repeat the workflow process to improve their computed selling competency, judgement and intelligence and sales performance.

As shown in FIG. 7, the leadership and manager workflow comprises the steps: (a) leadership and managers using the prescription interface submodule of FIG. 6A to receive automated feedback from the system about the assessment, performance and recommended prescriptions for system users; (b) the leadership and managers using the reporting interface submodule of FIG. 5A1 to generate and view new reports for leadership to view new reports generated and learn who needs what skills improved; (c) the leadership and managers making hiring decisions and using the prescription interface submodule of FIG. 6A to make course outlines for new-hires (or employees) to support hiring decisions, and advance the skills of such employees; and (d) the leadership and managers monitoring user repetition to track selling skill advancement.

### Specification of the Automated Service Supported on the System of the Present Invention for Assessing and Measuring the Selling Intelligence of Individuals Among a Population of Individuals Potentially Competing Against Each Other in a Field

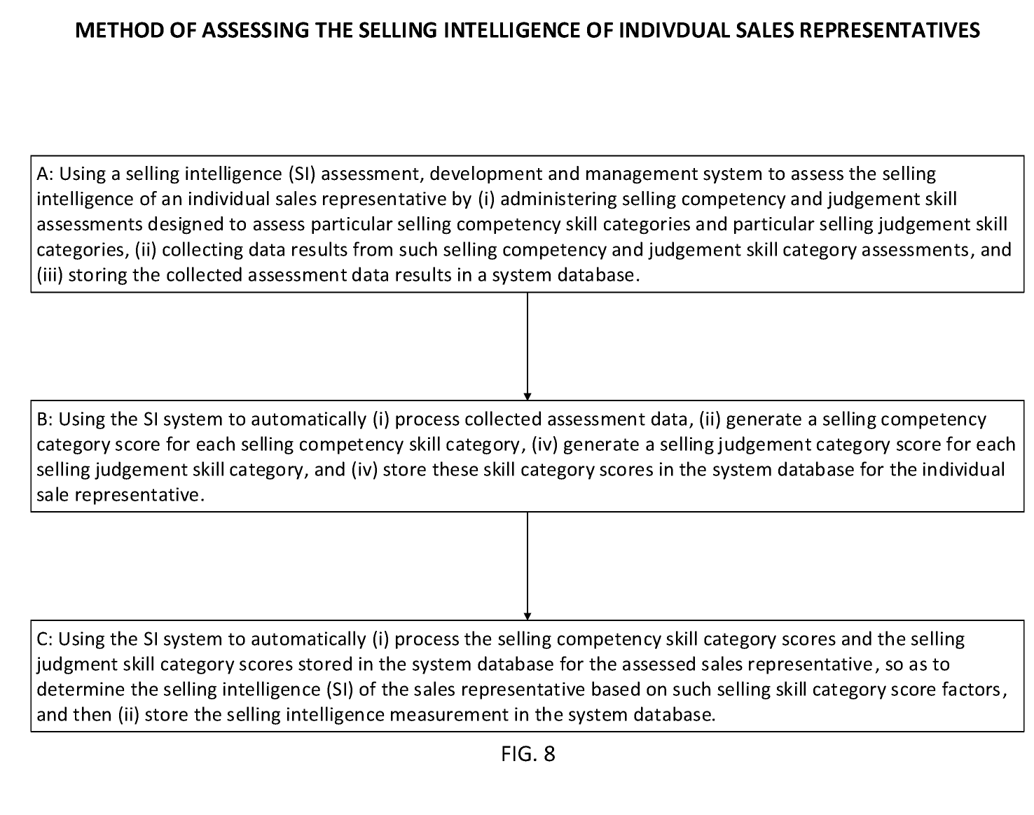

In FIG. 8, a novel suite of services is described for measuring and assessing the selling intelligence (SI) of individual sales representatives (e.g. employees, pre-hires, etc.) and related selling skills using the system network 1 shown in FIGS. 1A, 1B, 1C, 1D, 2A, 2B and 2C. The delivery of this service method will be described below with reference to FIG. 8.

In general, this service method is carried out transparently within the system 2 to perform scientific measurements as to an individual's selling competency (SC), selling judgement (SJ) and selling intelligence (SI). These rationally generated psychometric measurements are stored as data elements in the system database, and used to generate reports that are presented to various kinds of users in accordance with the principles of the present invention. The underlying process used to generate this service is described in FIG. 8 described below.

As shown in FIG. 8, the method of assessing the selling intelligence (SI) of individual sales representatives or sales representative candidates comprising the steps of:

(a) using a selling intelligence (SI) assessment, development and management system to assess the selling intelligence of an individual sales representative by (i) administering selling competency and judgement skill assessments designed to assess particular selling competency skill categories and particular selling judgement skill categories, (ii) collecting data results from such selling competency and judgement skill category assessments, and (iii) storing the collected assessment data results in a system database 10.

(b) using the system to automatically (i) process collected assessment data, (ii) generate a selling competency category score for each selling competency skill category, (iv) generate a selling judgement category score for each selling judgement skill category, and (iv) store these skill category scores in the system database for the individual sale representative; and

(c) using the system to automatically (i) process the selling competency skill category scores and the selling judgment skill category scores stored in the system database for the assessed sales representative, so as to determine the selling intelligence (SI) of the sales representative based on such selling skill category score factors, and then (ii) store the selling intelligence measurement in the system database 10.

The automated method described above is carried out in an automated manner substantially transparent to system users to produce SCSC scores, SJSC scores and SI measures, and support the various services delivered on the service network of the present invention in accordance with the principles of the present invention.

### Specification of Method of Assessing the Selling Intelligence of an Individual Sales Representatives for Use in Supporting Hiring, Management and Termination Processes

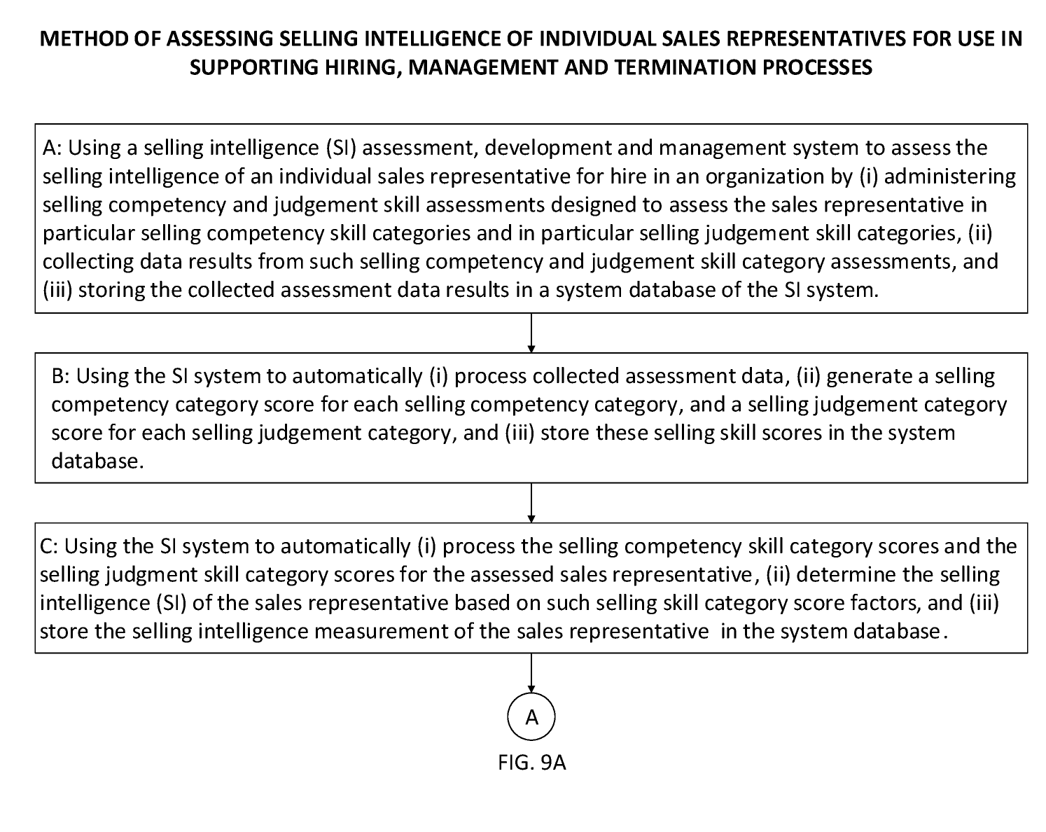

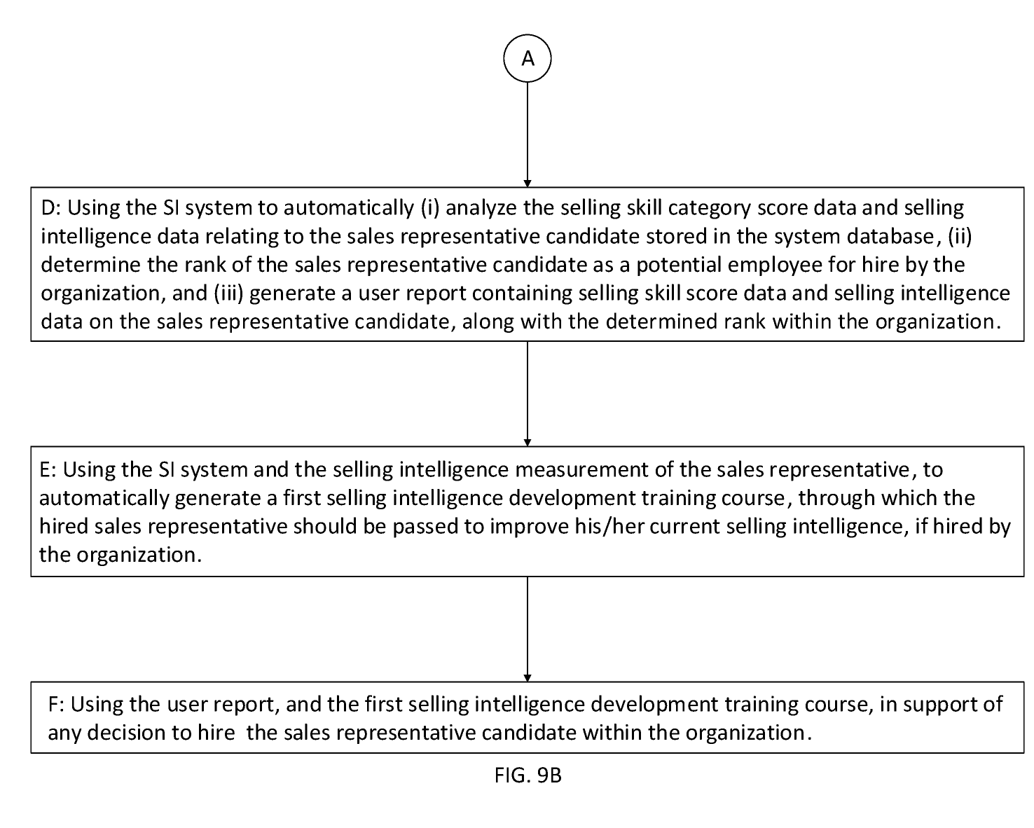

In FIGS. 9A and 9B, a novel suite of services is described for measuring the selling intelligence of individual sales representatives (e.g. employees, pre-hires, etc.) in the context of supporting sales personnel hiring, developing, management and termination processes, to improve the sales representative's selling intelligence and related selling skills, using the system network shown in FIGS. 1A, 1B, 1C, 1D, 2A, 2B and 2C. The delivery of this method will be described below with reference to FIGS. 9A and 9B.

FIGS. 9A and 9B show the steps in the method of assessing and measuring selling intelligence of an individual sales representative or candidate for use in supporting sales personnel hiring, development, management and termination processes. As shown, the method comprises the steps of:

(a) using a selling intelligence (SI) assessment, development and management system to assess the selling intelligence of an individual sales representative for hire in an organization by (i) administering selling competency and judgement skill assessments designed to assess the sales representative in particular selling competency skill categories and in particular selling judgement skill categories, (ii) collecting data results from such selling competency and judgement skill category assessments, and (iii) storing the collected assessment data results in a system database 10;

(b) using the system to automatically (i) process collected assessment data, (ii) generate a selling competency category score for each selling competency category, and a selling judgement category score for each selling judgement category, and (iii) store these selling skill scores in the system database 10;

(c) using the system to automatically (i) process the selling competency skill category scores and the selling judgment skill category scores for the assessed sales representative, (ii) determine the selling intelligence (SI) of the sales representative based on such selling skill category score factors, and (iii) store the selling intelligence measurement of the sales representative in the system database 10;

(d) using the system to automatically (i) analyze the selling skill category score data and selling intelligence data relating to the sales representative candidate stored in the system database, (ii) determine the rank of the sales representative candidate as a potential employee for hire by the organization, and (iii) generate a user report containing selling skill score data and selling intelligence data on the sales representative candidate, along with the determined rank within the organization;

(e) using the system and the selling intelligence measurement of the sales representative, to automatically generate a first selling intelligence development training course, through which the hired sales representative should be passed to improve his/her current selling intelligence, if hired by the organization; and

(f) using the user report, and the first selling intelligence development training course, in support of any decision to hire the sales representative candidate within the organization.

Using this automated method supported on the system of the present invention, sales personnel hiring, development, management and termination processes can be supported by assessing and measuring selling intelligence of the individual sales representative or candidate being hired, developed, managed or terminated, as the case may be.

The automated method described above is carried out by individual sales representatives (e.g. employees, pre-hires, etc.) using client systems 3 deployed in the service network, to access and receive the various services delivered by the method on the service network of the present invention. Variations of this particular selling intelligence based method will occur to others in view of the present invention disclosure.

### Specification of the Method of Assessing and Developing the Sales Intelligence of Sales Representatives Using Selling Intelligence Training Courses Based on Selling Intelligence Assessments

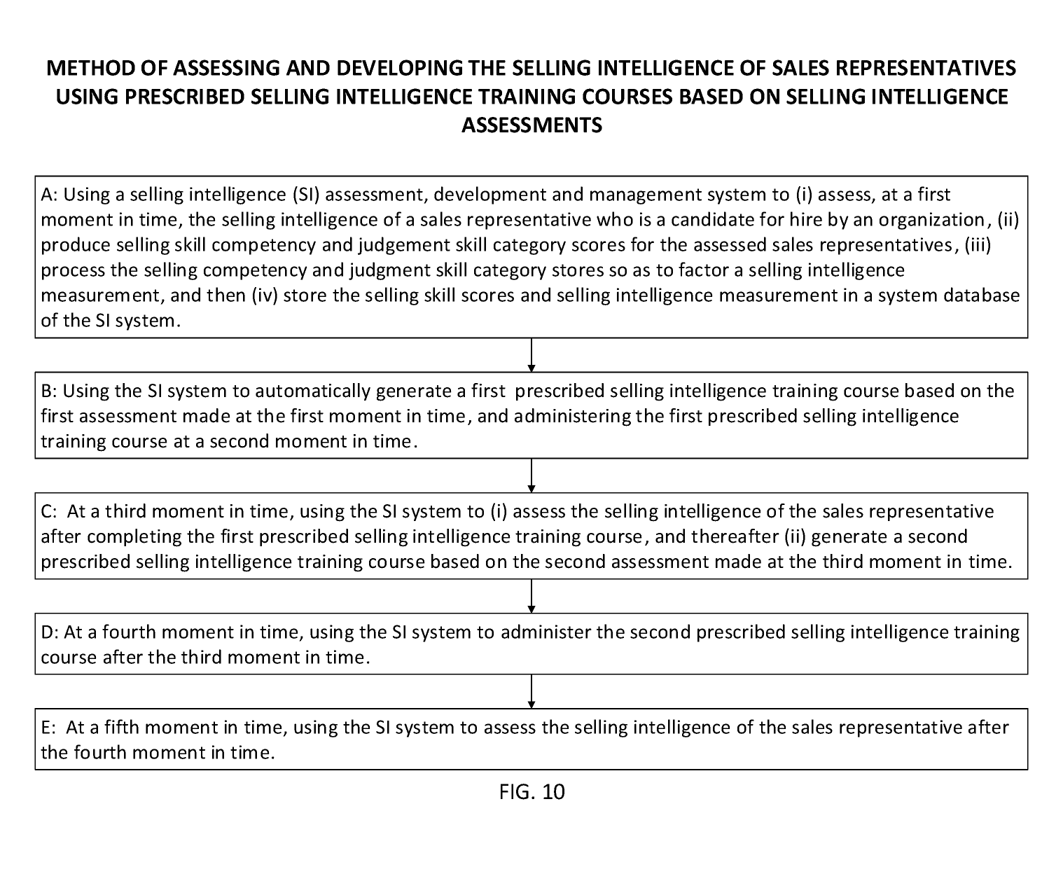

In FIG. 10, a novel suite of services is described for assessing, developing, analyzing and managing sales intelligence of sales representatives, using the system network shown in FIGS. 1A, 1B, 1C, 1D, 2A, 2B and 2C. The delivery of this service method will be described below with reference to FIG. 10.

FIG. 10 describes the steps involved in carrying out the method of developing, analyzing and managing sales intelligence measurements made on sales representatives using prescribed selling intelligence training courses based on selling intelligence assessments. As shown, the method comprises the steps of:

(a) using a selling intelligence (SI) assessment, development and management system to (i) assess, at a first moment in time, the selling intelligence of a sales representative who is a candidate for hire by an organization, (ii) produce selling skill competency and judgement skill category scores for the assessed sales representatives, (iii) process the selling competency and judgment skill category stores so as to factor a selling intelligence measurement, and then (iv) store the selling skill scores and selling intelligence measurement in a system database of the system;

(b) using the system to automatically generate a first prescribed selling intelligence training course based on the first assessment made at the first moment in time, and administering the first prescribed selling intelligence training course at a second moment in time;

(c) at a third moment in time, using the system to (i) assess the selling intelligence of the sales representative after completing the first prescribed selling intelligence training course, and thereafter (ii) generate a second prescribed selling intelligence training course based on the second assessment made at the third moment in time;

(d) at a fourth moment in time, using the system to administer the second prescribed selling intelligence training course after the third moment in time; and

(e) at a fifth moment in time, using the system to assess the selling intelligence of the sales representative after the fourth moment in time.

Using this automated method supported by the system of the present invention, the selling intelligence of a sales representative within an organization, or a sales representative working independent from any organization, can be developed by administering one or more prescribed selling intelligence training courses, based on selling intelligence assessments made on the sales representative.

The automated method described above is carried out by individual sales representatives using client systems 3 deployed in the service network, to access and receive the various services delivered by the method on the service network of the present invention. Variations of this particular selling intelligence based method will occur to others in view of the present invention disclosure.

### Specification of the Automated Method of Assessing Sales Representative Candidates During Hiring Process, and Generating User Reports Predicting Sales Performance Using Organization Benchmarks Based on Selling Intelligence Assessments

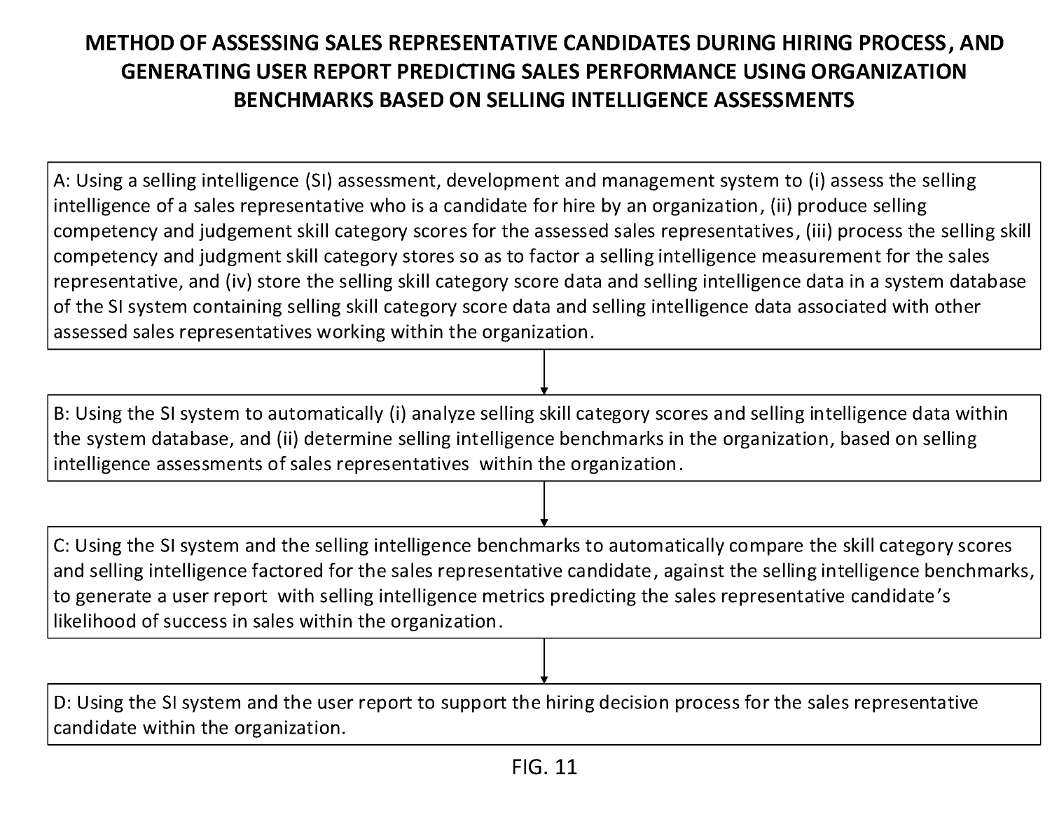

In FIG. 11, a novel suite of services is described for assessing sales representative candidates during hiring process, and generating user reports predicting sales performance using organization benchmarks based on selling intelligence assessments, using the system network shown in FIGS. 1A, 1B, 1C, 1D, 2A, 2B and 2C. The delivery of this service method will be described below with reference to FIG. 11.

FIG. 11 describes the primary steps involved in carrying out the method comprising the steps of:

(a) using a selling intelligence (SI) assessment, development and management system to (i) assess the selling intelligence of a sales representative who is a candidate for hire by an organization, (ii) produce selling competency and judgement skill category scores for the assessed sales representatives, (iii) process the selling skill competency and judgment skill category stores so as to factor a selling intelligence measurement for the sales representative, and (iv) store the selling skill category score data and selling intelligence data in a system database 10 containing selling skill category score data and selling intelligence data associated with other assessed sales representatives working within the organization;

(b) using the system to automatically (i) analyze selling skill category scores and selling intelligence data within the system database, and (ii) determine selling intelligence benchmarks in the organization, based on selling intelligence assessments of sales representatives within the organization;

(c) using the system and the selling intelligence benchmarks to automatically compare the skill category scores and selling intelligence factored for the sales representative candidate, against the selling intelligence benchmarks, to generate a user report with selling intelligence metrics predicting the sales representative candidate's likelihood of success in sales within the organization; and

(d) using the system and the user report to support the hiring decision process for the sales representative candidate within the organization.

Using this automated method supported on the system of the present invention, the sales performance of sales representative candidates can be predicted during the hiring process by assessing sales representative candidates, and generating user reports on the sales representative candidates using organization benchmarks.

The automated method described above is carried out by individual sales representative candidates (e.g. pre-hires, etc.) using client systems 3 deployed in the service network, to access and receive the various services delivered by the method on the service network of the present invention. Variations of this particular selling intelligence based method will occur to others in view of the present invention disclosure.

### Specification of Method of Predicting Sale Performance Success of a Sales Representative Candidate in an Organization Based on Automated Selling Intelligence Data Analysis

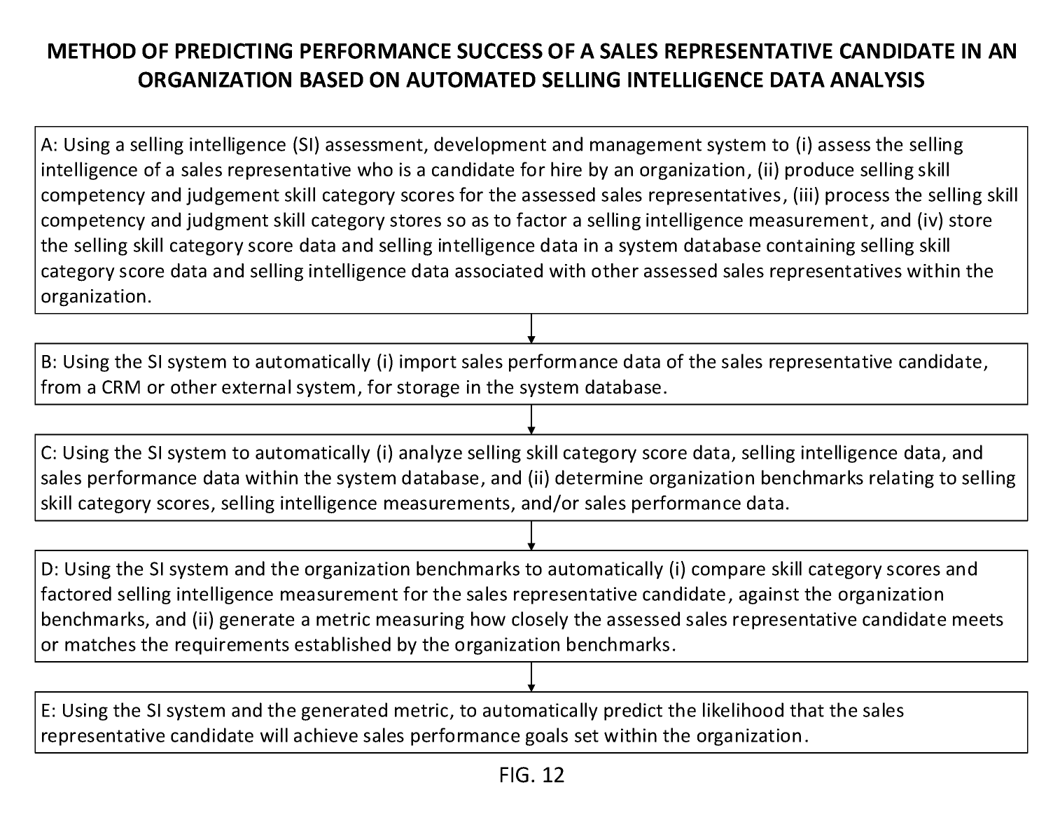

In FIG. 12, a novel suite of services is described for predicting sale performance success of a sales representative candidate in an organization based on automated selling intelligence data analysis, using the system network shown in FIGS. 1A, 1B, 1C, 1D, 2A, 2B and 2C. The delivery of this service method will be described below with reference to FIG. 12.

FIG. 12 describes the primary steps involved in carrying out the method comprising the steps of:

(a) using a selling intelligence (SI) assessment, development and management system to (i) assess the selling intelligence of a sales representative who is a candidate for hire by an organization, (ii) produce selling skill competency and judgement skill category scores for the assessed sales representatives, (iii) process the selling skill competency and judgment skill category stores so as to factor a selling intelligence measurement, and (iv) store the selling skill category score data and selling intelligence data in a system database containing selling skill category score data and selling intelligence data associated with other assessed sales representatives within the organization;

(b) using the system to automatically (i) import sales performance data of the sales representative candidate, from a CRM or other external system, for storage in the system database;

(c) using the system to automatically (i) analyze selling skill category score data, selling intelligence data, and sales performance data within the system database, and (ii) determine organization benchmarks relating to selling skill category scores, selling intelligence measurements, and/or sales performance data;

(d) using the system and the organization benchmarks to automatically (i) compare skill category scores and factored selling intelligence measurement for the sales representative candidate, against the organization benchmarks, and (ii) generate a metric measuring how closely the assessed sales representative candidate meets or matches the requirements established by the organization benchmarks; and

(e) using the system and the generated metric, to automatically predict the likelihood that the sales representative candidate will achieve sales performance goals set within the organization.

Using this automated method supported on the system of the present invention, the sale performance success of a sales representative candidate in an organization can be predicted through automated selling intelligence data analysis involving comparing skill category scores and factored selling intelligence measurement for the sales representative candidate, against the organization benchmarks, and generating a metric measuring how closely the assessed sales representative candidate meets or matches the requirements established by the organization benchmarks.

The automated method described above is carried out by individual sales representatives and sales managers alike using client systems 3 deployed in the service network, to access and receive the various services delivered by the method on the service network of the present invention. Variations of this particular selling intelligence based method will occur to others in view of the present invention disclosure.

### Specification of Method of Predicting the Sales Performance of Individual Sales Representatives Based on Administering a Series of Selling Intelligence Assessments

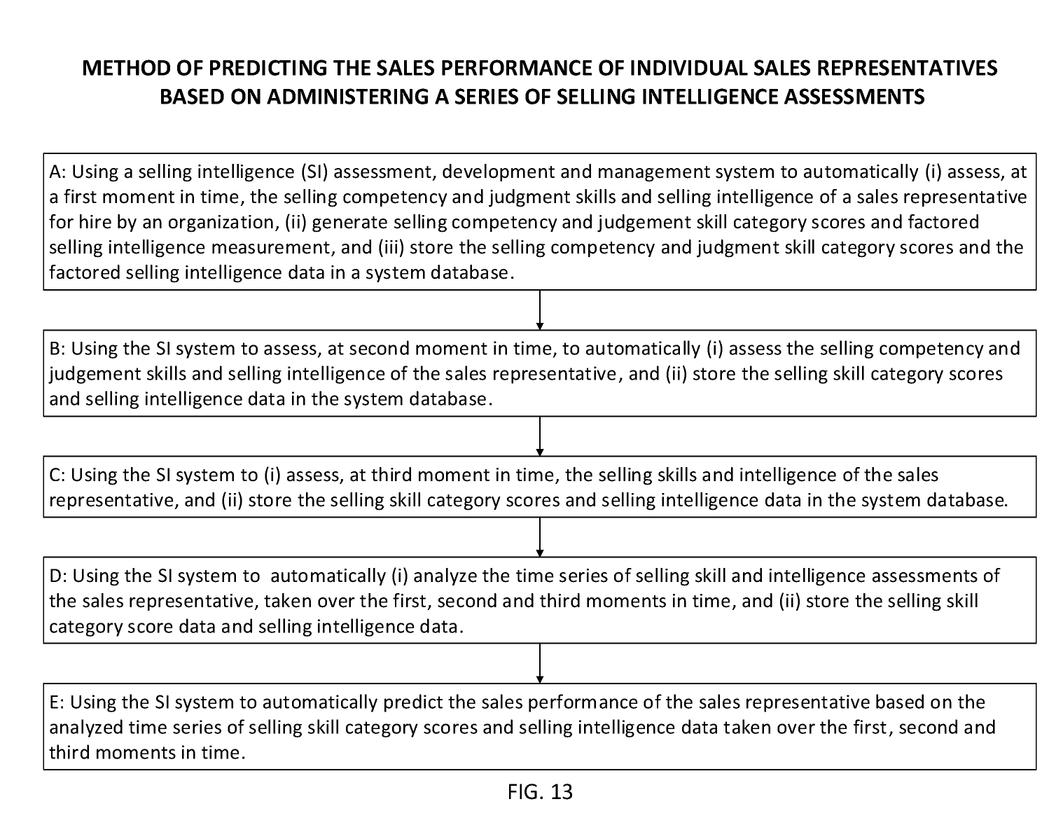

In FIG. 13, a novel suite of services is described for predicting the sales performance of individual sales representatives based on administering a series of selling intelligence assessments, using the system network shown in FIGS. 1A, 1B, 1C, 1D, 2A, 2B and 2C. The delivery of this service method will be described below with reference to FIG. 13.

FIG. 13 describes the primary steps involved in carrying out the method comprising the steps of:

(a) using a selling intelligence (SI) assessment, development and management system to automatically (i) assess, at a first moment in time, the selling competency and judgment skills and selling intelligence of a sales representative for hire by an organization, (ii) generate selling competency and judgement skill category scores and factored selling intelligence measurement, and (iii) store the selling competency and judgment skill category scores and the factored selling intelligence data in a system database;

(b) using the system to assess, at second moment in time, to automatically (i) assess the selling competency and judgement skills and selling intelligence of the sales representative, and (ii) store the selling skill category scores and selling intelligence data in the system database;

(c) using the system to (i) assess, at third moment in time, the selling skills and intelligence of the sales representative, and (ii) store the selling skill category scores and selling intelligence data in the system database;

(d) using the system to automatically (i) analyze the time series of selling skill and intelligence assessments of the sales representative, taken over the first, second and third moments in time, and (ii) store the selling skill category score data and selling intelligence data; and

(e) using the system to automatically predict the sales performance of the sales representative based on the analyzed time series of selling skill category scores and selling intelligence data taken over the first, second and third moments in time.

Using this automated method supported on the system of the present invention, the sales performance of individual sales representatives can be predicted by administering a series of selling intelligence assessments.

The automated method described above is carried out by individual sales representatives and sales managers alike using client systems 3 deployed in the service network, to access and receive the various services delivered by the method on the service network of the present invention. Variations of this particular selling intelligence based method will occur to others in view of the present invention disclosure.

### Specification of Method of Developing the Selling Intelligence of Individual Sales Representatives Using Automatically-Prescribed Training Courses Guided by Selling Intelligence Assessment Assessments

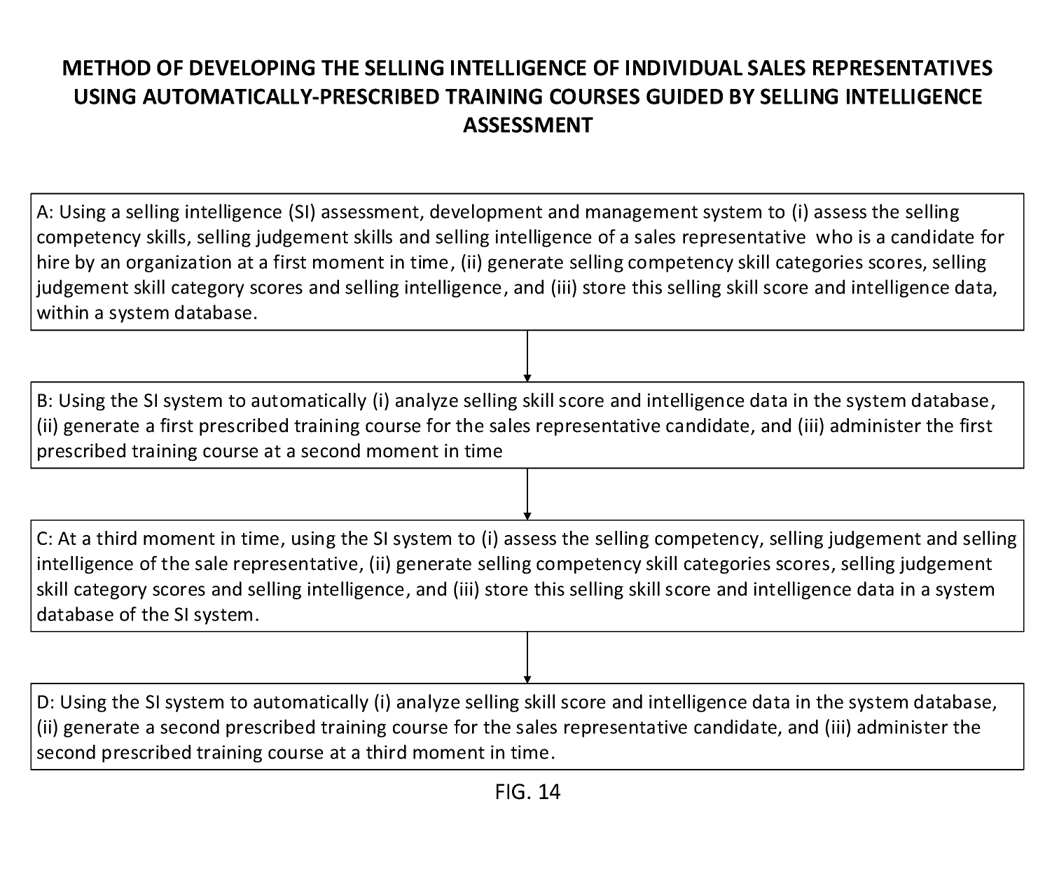

In FIG. 14, a novel suite of services is described for developing the selling intelligence of individual sales representatives using automatically-prescribed training course guided by selling intelligence assessment, using the system network shown in FIGS. 1A, 1B, 1C, 1D, 2A, 2B and 2C. The delivery of this service method will be described below with reference to FIG. 14.

FIG. 14 describes the primary steps involved in carrying out the method comprising the steps of:

(a) using a selling intelligence (SI) assessment, development and management system to (i) assess the selling competency skills, selling judgement skills and selling intelligence of a sales representative who is a candidate for hire by an organization at a first moment in time, (ii) generate selling competency skill categories scores, selling judgement skill category scores and selling intelligence, and (iii) store this selling skill score and intelligence data, within a system database;

(b) using the system to automatically (i) analyze selling skill score and intelligence data in the system database, (ii) generate a first prescribed training course for the sales representative candidate, and (iii) administer the first prescribed training course at a second moment in time;

(c) at a third moment in time, using the system to (i) assess the selling competency, selling judgement and selling intelligence of the sale representative, (ii) generate selling competency skill categories scores, selling judgement skill category scores and selling intelligence, and (iii) store this selling skill score and intelligence data in a system database of the system; and

(d) using the system to automatically (i) analyze selling skill score and intelligence data in the system database, (ii) generate a second prescribed training course for the sales representative candidate, and (iii) administer the second prescribed training course at a third moment in time.

Using this automated method supported by the system of the present invention, the selling intelligence of individual sales representatives can be developed using automatically-prescribed training course guided by selling intelligence assessment.

The automated method described above is carried out by individual sales representatives (e.g. employees, pre-hires, etc.) using client systems 3 deployed in the service network, to access and receive the various services delivered by the method on the service network of the present invention. Variations of this particular selling intelligence based method will occur to others in view of the present invention disclosure.

### Specification of Method of Progressively Developing the Selling Intelligence of Individual Sales Representatives Using a Time Series of Automatically-Prescribed Selling Intelligence Training Courses

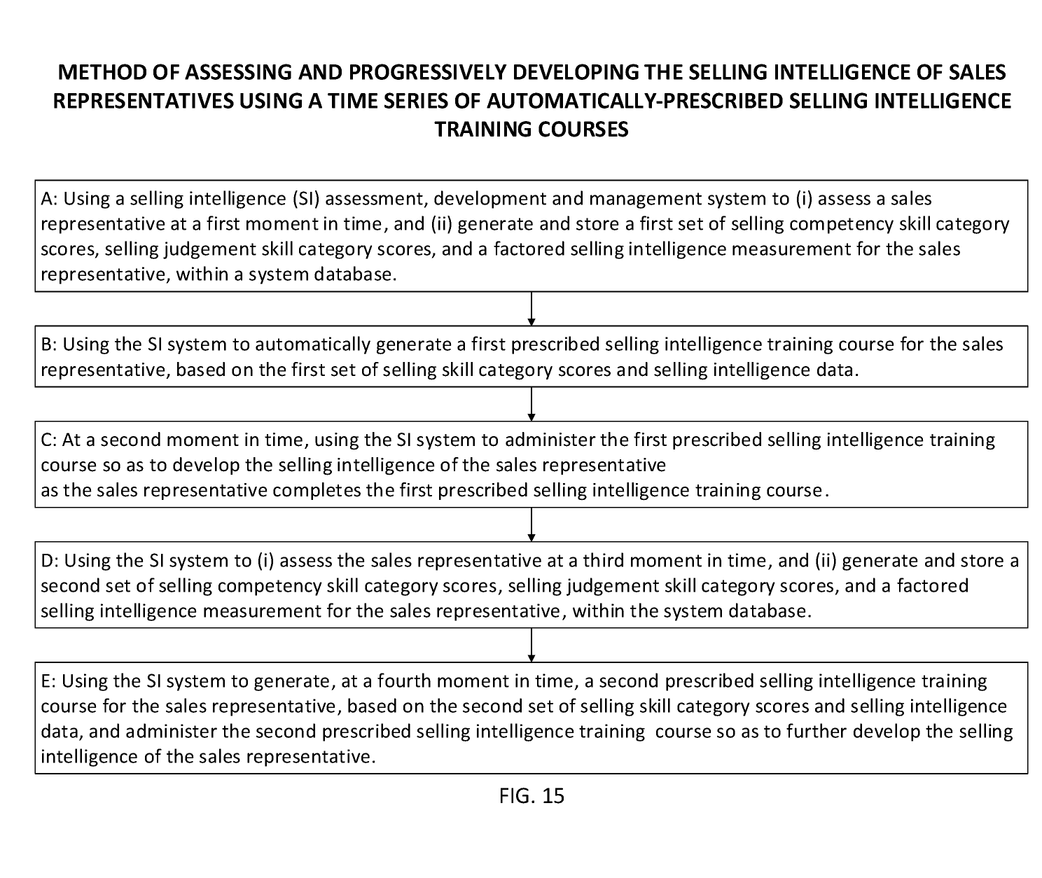

In FIG. 15, a novel suite of services is described for progressively developing the selling intelligence of individual sales representatives using a series of automatically-prescribed selling intelligence training courses, using the system network shown in FIGS. 1A, 1B, 1C, 1D, 2A, 2B and 2C. The delivery of this service method will be described below with reference to FIG. 15.

FIG. 15 describes the primary steps involved in carrying out the method comprising the steps:

(a) using a selling intelligence (SI) assessment, development and management system to (i) assess a sales representative at a first moment in time, and (ii) generate and store a first set of selling competency skill category scores, selling judgement skill category scores, and a factored selling intelligence measurement for the sales representative, within a system database;

(b) using the system to automatically generate a first prescribed selling intelligence training course for the sales representative, based on the first set of selling skill category scores and selling intelligence data;

(c) using the system to (i) assess the sales representative at a third moment in time, and (ii) generate and store a second set of selling competency skill category scores, selling judgement skill category scores, and a factored selling intelligence measurement for the sales representative, within the system database;

(d) using the system to (i) assess the sales representative at a third moment in time, and (ii) generate and store a second set of selling competency skill category scores, selling judgement skill category scores, and a factored selling intelligence measurement for the sales representative, within the system database; and

(e) using the system to generate, at a fourth moment in time, a second prescribed selling intelligence training course for the sales representative, based on the second set of selling skill category scores and selling intelligence data, and administer the second prescribed selling intelligence training course so as to further develop the selling intelligence of the sales representative.

By using this automated method supported on the system of the present invention, the selling intelligence of individual sales representatives can be progressively developed using a series of automatically-prescribed selling intelligence training courses administered by the system.

The automated method described above is carried out by individual sales representatives (e.g. employees, pre-hires, etc.) using client systems 3 deployed in the service network, to access and receive the various services delivered by the method on the service network of the present invention. Variations of this particular selling intelligence based method will occur to others in view of the present invention disclosure.

### Specification of Automated Method of Developing Selling Judgement Skills Using Machine-Based Selling Intelligence Assessment, Automated-Generation of Selling Intelligence Courses and Metric-Based User Reports

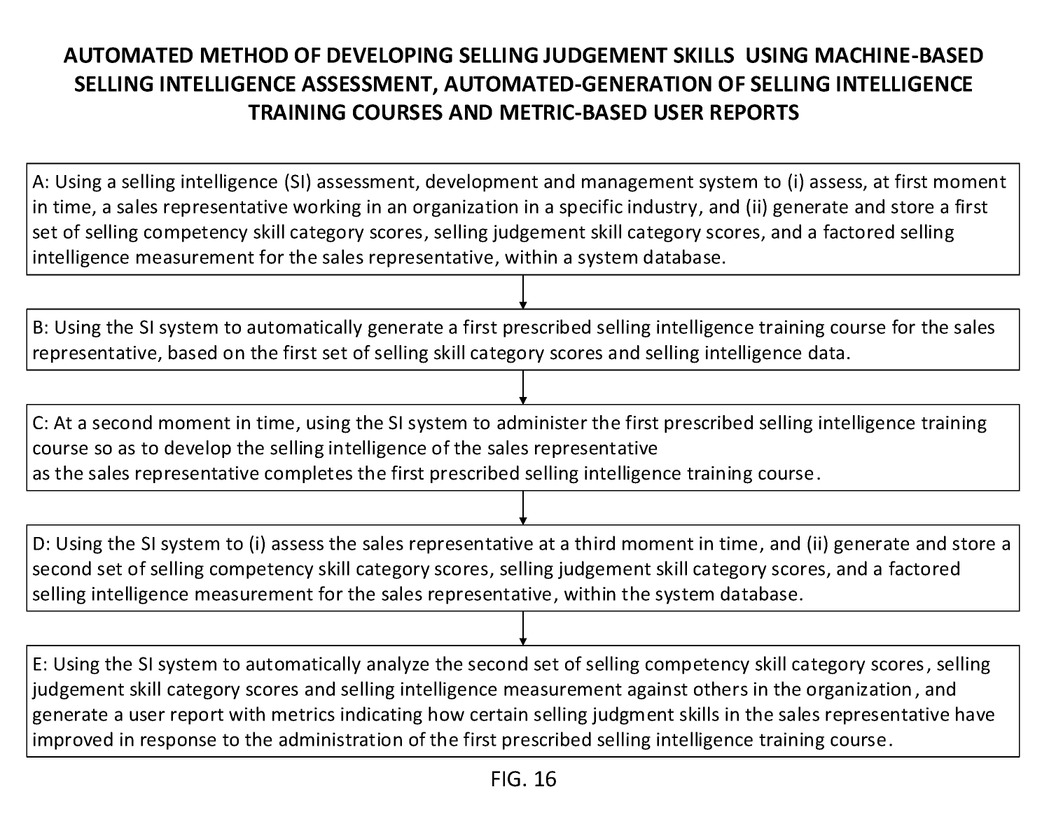

In FIG. 16, a novel suite of services is described for developing selling judgement skills using machine-based selling intelligence assessment, and automated-generation of selling intelligence training courses and metric-based user reports, using the system network shown in FIGS. 1A, 1B, 1C, 1D, 2A, 2B and 2C. The delivery of this service method will be described below with reference to FIG. 16.

FIG. 16 describes the primary steps involved in carrying out the method comprising the steps of:

(a) using a selling intelligence (SI) assessment, development and management system to (i) assess, at first moment in time, a sales representative working in an organization in a specific industry, and (ii) generate and store a first set of selling competency skill category scores, selling judgement skill category scores, and a factored selling intelligence measurement for the sales representative, within a system database;

(b) using the system to automatically generate a first prescribed selling intelligence training course for the sales representative, based on the first set of selling skill category scores and selling intelligence data;

(c) at a second moment in time, using the system to administer the first prescribed selling intelligence training course so as to develop the selling intelligence of the sales representative;

(d) using the system to (i) assess the sales representative at a third moment in time, and (ii) generate and store a second set of selling competency skill category scores, selling judgement skill category scores, and a factored selling intelligence measurement for the sales representative, within the system database; and

(e) using the system to automatically analyze the second set of selling competency skill category scores, selling judgement skill category scores and selling intelligence measurement against others in the organization, and generate a user report with metrics indicating how certain selling judgment skills in the sales representative have improved in response to the administration of the first prescribed selling intelligence training course.

By using this automated method supported on the system of the present invention, the selling skills of sales representatives can be developed by assessing the selling intelligence of the sales representative, and generating selling intelligence-based training courses and metric-based user reports.

The automated method described above is carried out by individual sales representatives (e.g. employees, pre-hires, etc.) and sales managers alike using client systems 3 deployed in the service network, to access and receive the various services delivered by the method on the service network of the present invention. Variations of this particular selling intelligence based method will occur to others in view of the present invention disclosure.

### Specification of Automated Method of Generating Prescriptive Training Courses Designed to Develop the Selling Intelligence of Particular Sales Representatives

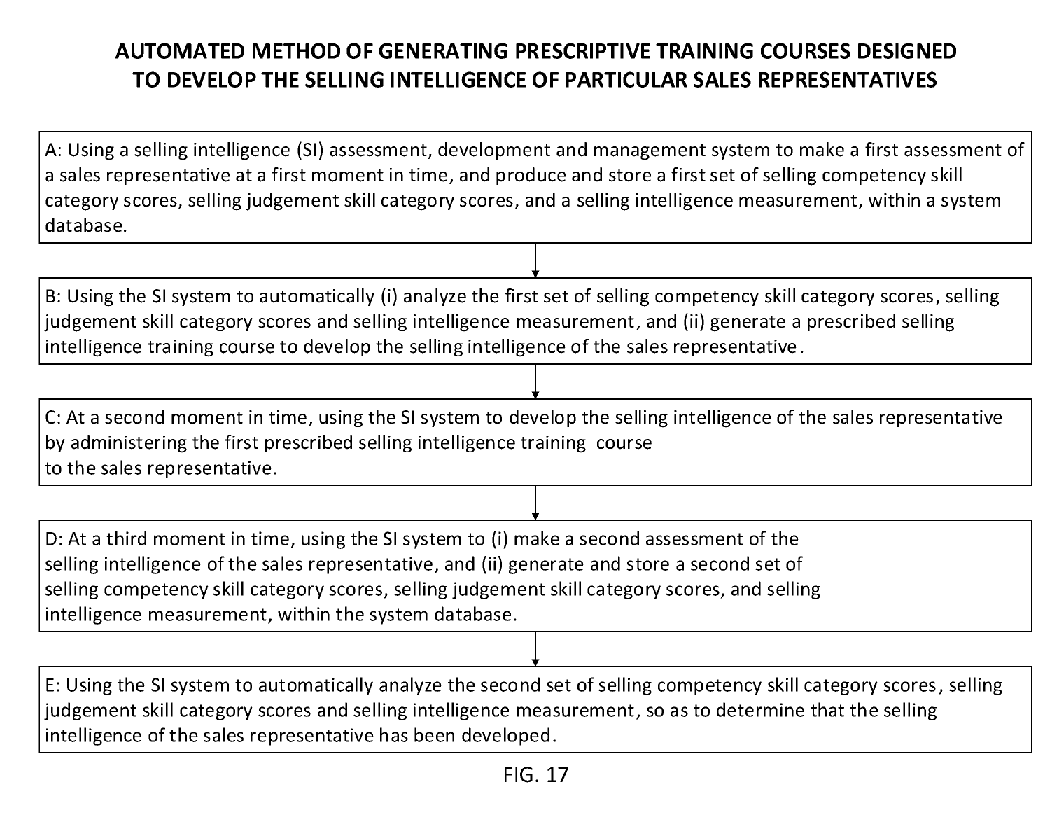

In FIG. 17, a novel suite of services is described for automatically generating prescriptive training courses designed to develop the selling intelligence of particular sales representatives, using the system network shown in FIGS. 1A, 1B, 1C, 1D, 2A, 2B and 2C. The delivery of this service method will be described below with reference to FIG. 17.

FIG. 17 describes the primary steps involved in carrying out the method comprising the steps of:

(a) using a selling intelligence (SI) assessment, development and management system to make a first assessment of a sales representative at a first moment in time, and produce and store a first set of selling competency skill category scores, selling judgement skill category scores, and a selling intelligence measurement, within a system database;

(b) using the system to automatically (i) analyze the first set of selling competency skill category scores, selling judgement skill category scores and selling intelligence measurement, and (ii) generate a prescribed selling intelligence training course to develop the selling intelligence of the sales representative;

(c) at a second moment in time, using the system to develop the selling intelligence of the sales representative by administering the first prescribed selling intelligence training course to the sales representative;

(d) at a third moment in time, using the SI system to (i) make a second assessment of the selling intelligence of the sales representative, and (ii) generate and store a second set of selling competency skill category scores, selling judgement skill category scores, and selling intelligence measurement, within the system database; and

(e) using the system to automatically analyze the second set of selling competency skill category scores, selling judgement skill category scores and selling intelligence measurement, so as to determine that the selling intelligence of the sales representative has been developed.

Using this automated method supported on the system of the present invention, the selling intelligence of particular sales representatives can be developed using automatically generating prescriptive training courses administered on the system.

The automated method described above is carried out by individual sales representatives (e.g. employees, pre-hires, etc.) and sales managers alike using client systems 3 deployed in the service network, to access and receive the various services delivered by the method on the service network of the present invention. Variations of this particular selling intelligence based method will occur to others in view of the present invention disclosure.

### Specification of Automated-Method of Generating Selling Intelligence Training Courses for Use In Supporting the Hiring and Termination Decisions of Sales Representative

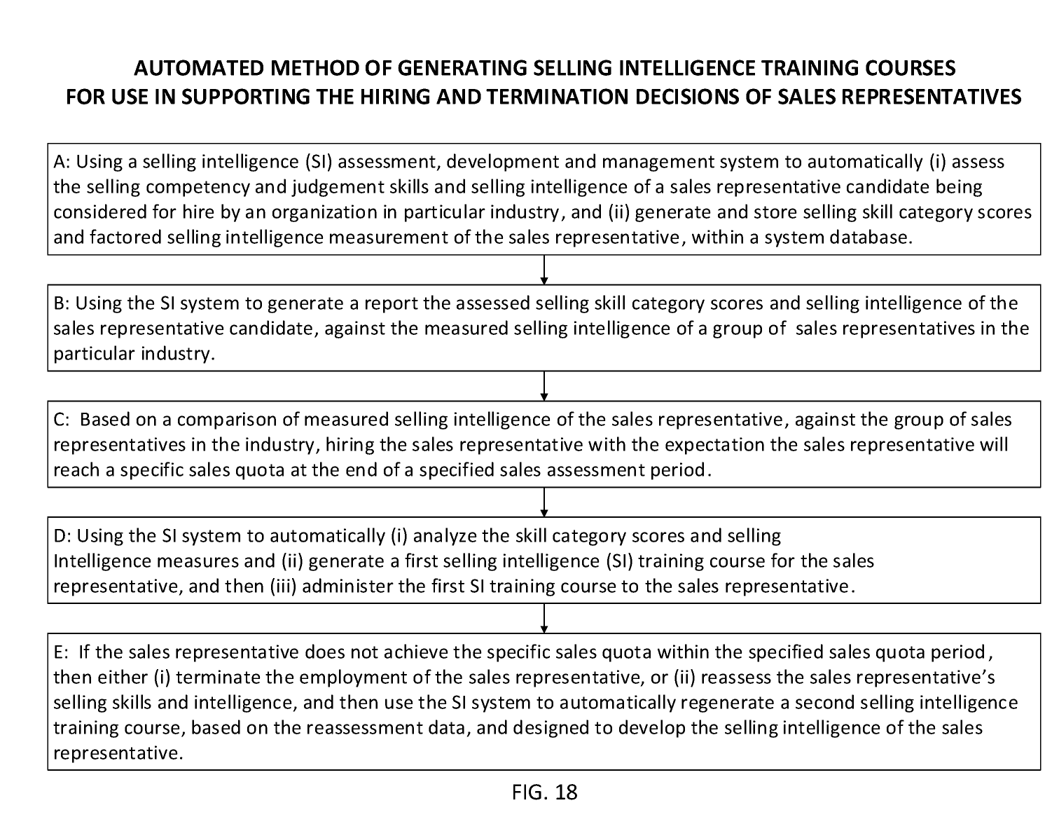

In FIG. 18, a novel suite of services is described for automatically-generating selling intelligence training courses for use in supporting the hiring and termination decisions of sales representative, using the system network shown in FIGS. 1A, 1B, 1C, 1D, 2A, 2B and 2C. The delivery of this service method will be described below with reference to FIG. 18.

FIG. 18 describes the primary steps involved in carrying out the method comprising the steps of:

(a) using a selling intelligence (SI) assessment, development and management system to automatically (i) assess the selling competency and judgement skills and selling intelligence of a sales representative candidate being considered for hire by an organization in particular industry, and (ii) generate and store selling skill category scores and factored selling intelligence measurement of the sales representative, within a system database;

(b) using the system to generate a report the assessed selling skill category scores and selling intelligence of the sales representative candidate, against the measured selling intelligence of a group of sales representatives in the particular industry;

(c) based on a comparison of measured selling intelligence of the sales representative, against the group of sales representatives in the industry, hiring the sales representative with the expectation the sales representative will reach a specific sales quota at the end of a specified sales assessment period;

(d) using the system to automatically (i) analyze the skill category scores and selling intelligence measures and (ii) generate a first selling intelligence (SI) training course for the sales representative, and then (iii) administer the first SI training course to the sales representative; and

(e) if the sales representative does not achieve the specific sales quota within the specified sales quota period, then either (i) terminate the employment of the sales representative, or (ii) reassess the sales representative's selling skills and intelligence, and then use the system to automatically regenerate a second selling intelligence training course, based on the reassessment data, and designed to develop the selling intelligence of the sales representative.

Using this automated method supported on the system of the present invention, the hiring and termination decisions of sales representatives can be supported by comparing the measured selling intelligence of the sales representative, against the group of sales representatives in the industry, with the expectation the sales representative will reach a specific sales quota at the end of a specified sales assessment period, after taking automatically-generated selling intelligence training courses based on measured selling intelligence.

The automated method described above is carried out by individual sales representatives (e.g. employees, pre-hires, etc.) and sales managers alike using client systems 3 deployed in the service network, to access and receive the various services delivered by the method on the service network of the present invention. Variations of this particular selling intelligence based method will occur to others in view of the present invention disclosure.

### Specification of the Automated-Method of Generating Reports Containing Internally-Generated Selling Intelligence Data, Externally-Generated Performance Data, and Management Alignment Metrics

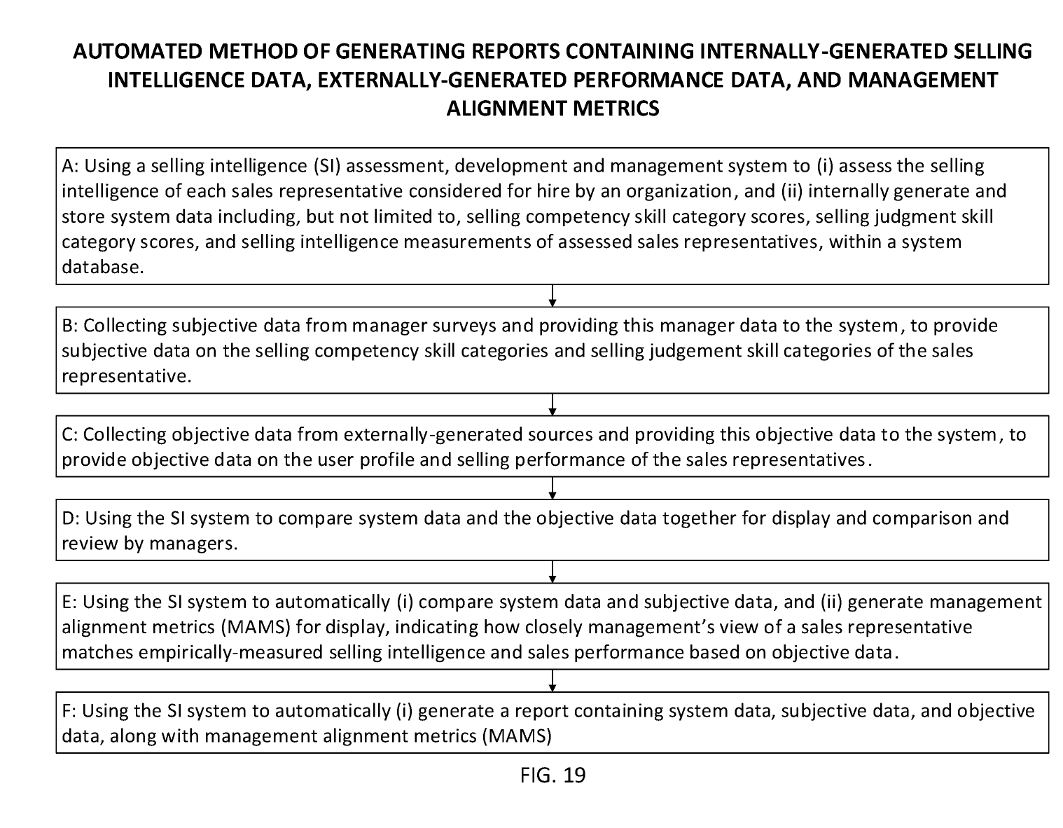

In FIG. 19, a suite of services is described for generating reports containing internally-generated selling intelligence data, externally-generated performance data, and management alignment metrics, using the system network shown in FIGS. 1A, 1B, 1C, 1D, 2A, 2B and 2C. The delivery of this service method will be described below with reference to FIG. 19.

FIG. 19 describes the primary steps involved in carrying out the method comprising the steps of:

(a) using a selling intelligence (SI) assessment, development and management system to (i) assess the selling intelligence of each sales representative considered for hire by an organization, and (ii) internally generate and store system data including, but not limited to, selling competency skill category scores, selling judgment skill category scores, and selling intelligence measurements of assessed sales representatives, within a system database;

(b) collecting subjective data from manager surveys and providing this manager data to the system, to provide subjective data on the selling competency skill categories and selling judgement skill categories of the sales representative;

(c) collecting objective data from externally-generated sources and providing this objective data to the system, to provide objective data on the user profile and selling performance of the sales representatives;

(d) using the system to compare system data and the objective data together for display and comparison and review by managers;

(e) using the system to automatically (i) compare system data and subjective data, and (ii) generate management alignment metrics (MAMS) for display, indicating how closely management's view of a sales representative matches empirically-measured selling intelligence and sales performance based on objective data; and

(f) using the system to automatically (i) generate a report containing system data, subjective data, and objective data, along with management alignment metrics (MAMS).

Using the automated method supported on the system of the present invention, reports containing internally-generated selling intelligence data, externally-generated performance data, and management alignment metrics, can be automatically generated using the system.

The automated method described above is carried out sales managers and leadership alike using client systems 3 deployed in the service network, to access and receive the various services delivered by the method on the service network of the present invention. Variations of this particular selling intelligence based method will occur to others in view of the present invention disclosure.

### Specification of Method of Automatically-Generating Scoreboards and Achievements for Sales Representatives Competing Against Other Sales Representatives in a Sales Organization

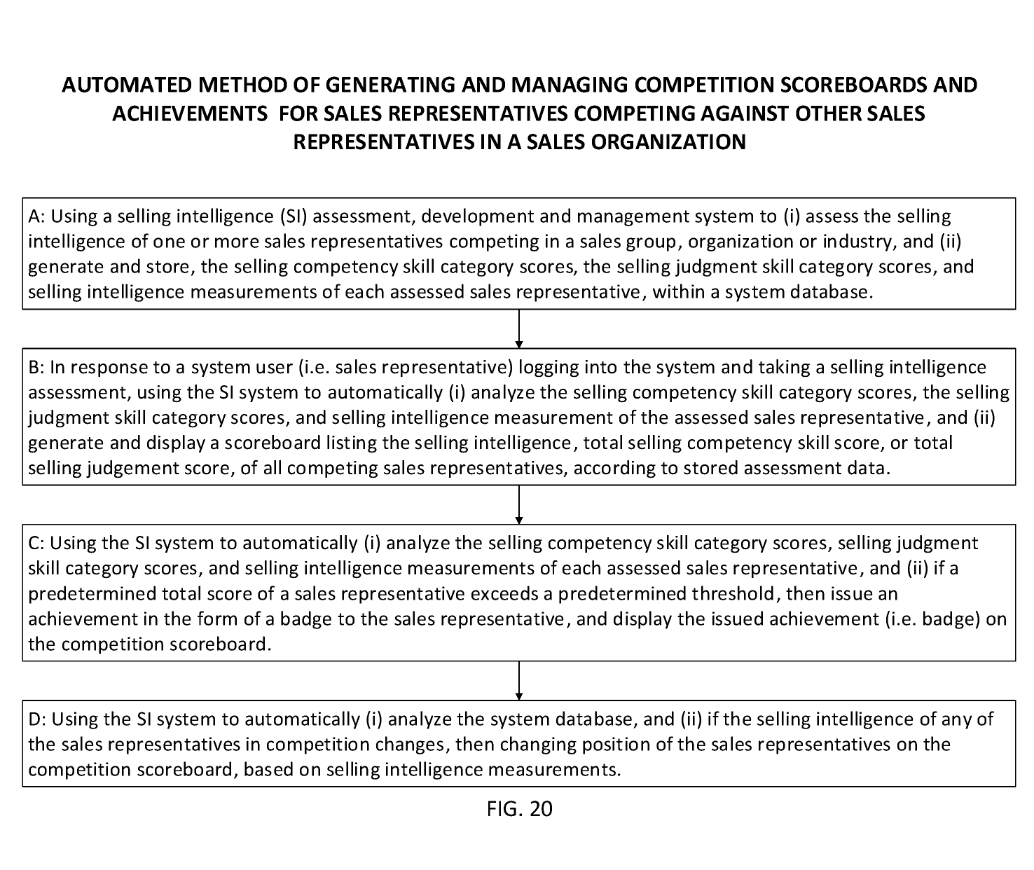

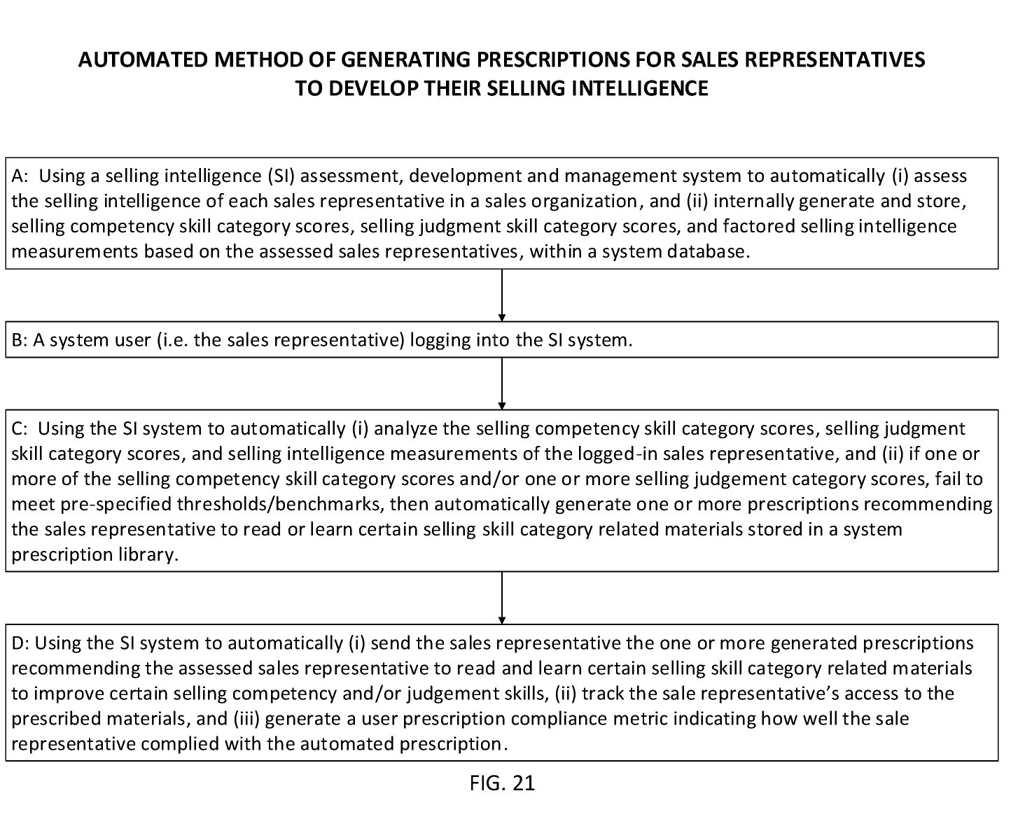

In FIG. 20, a novel suite of services is described for automatically-generating scoreboards and achievements for sales representatives competing against other sales representatives in a sales organization, using the system network shown in FIGS. 1A, 1B, 1C, 1D, 2A, 2B and 2C. The delivery of this service method will be described below with reference to FIG. 21.

FIG. 20 describes the primary steps involved in carrying out the method comprising the steps of:

(a) using a selling intelligence (SI) assessment, development and management system to (i) assess the selling intelligence of one or more sales representatives competing in a sales group, organization or industry, and (ii) generate and store, the selling competency skill category scores, the selling judgment skill category scores, and selling intelligence measurements of each assessed sales representative, within a system database;

(b) in response to a system user (i.e. sales representative) logging into the system and taking a selling intelligence assessment, using the system to automatically (i) analyze the selling competency skill category scores, the selling judgment skill category scores, and selling intelligence measurement of the assessed sales representative, and (ii) generate and display a scoreboard listing the selling intelligence, total selling competency skill score, or total selling judgement score, of all competing sales representatives, according to stored assessment data;

(c) using the system to automatically (i) analyze the selling competency skill category scores, selling judgment skill category scores, and selling intelligence measurements of each assessed sales representative, and (ii) if a predetermined total score of a sales representative exceeds a predetermined threshold, then issue an achievement in the form of a badge to the sales representative, and display the issued achievement (i.e. badge) on the competition scoreboard; and

(d) using the system to automatically (i) analyze the system database, and (ii) if the selling intelligence of any of the sales representatives in competition changes, then changing position of the sales representatives on the competition scoreboard, based on selling intelligence measurements.

Using the automated method supported on the system of the present invention, scoreboards and achievements can be automatically generated for sales representatives competing against other sales representatives in a sales organization.

The automated method described above is carried out by individual sales representatives (e.g. employees, pre-hires, etc.) and sales managers alike using client systems 3 deployed in the service network, to access and receive the various services delivered by the method on the service network of the present invention. Variations of this particular selling intelligence based method will occur to others in view of the present invention disclosure.

Specification of Automated-Method of Generating Prescriptions for Sales Representatives to Develop their Selling Intelligence

In FIG. 21, a novel suite of services is described for automatically-generating prescriptions for sales representatives to develop their selling intelligence, using the system network shown in FIGS. 1A, 1B, 1C, 1D, 2A, 2B and 2C. The delivery of this service method will be described below with reference to FIG. 21.

FIG. 21 describes the primary steps involved in carrying out the method comprising the steps of:

(a) using a selling intelligence (SI) assessment, development and management system to automatically (i) assess the selling intelligence of each sales representative in a sales organization, and (ii) internally generate and store, selling competency skill category scores, selling judgment skill category scores, and factored selling intelligence measurements based on the assessed sales representatives, within a system database;

(b) a system user (i.e. the sales representative) logging into the SI system;

(c) using the system to automatically (i) analyze the selling competency skill category scores, selling judgment skill category scores, and selling intelligence measurements of the logged-in sales representative, and (ii) if one or more of the selling competency skill category scores and/or one or more selling judgement category scores, fail to meet pre-specified thresholds/benchmarks, then automatically generate one or more prescriptions recommending the sales representative to read or learn certain selling skill category related materials stored in a system prescription library; and

(d) using the system to automatically (i) send the sales representative the one or more generated prescriptions recommending the assessed sales representative to read and learn certain selling skill category related materials to improve certain selling competency and/or judgement skills, (ii) track the sale representative's access to the prescribed materials, and (iii) generate a user prescription compliance metric indicating how well the sale representative complied with the automated prescription.

Using the automated method supported on the system of the present invention, prescriptions for sales representatives are automatically-generated to develop their selling intelligence using the system.

The automated method described above is carried out by individual sales representatives (e.g. employees, pre-hires, etc.) using client systems 3 deployed in the service network, to access and receive the various services delivered by the method on the service network of the present invention. Variations of this particular selling intelligence based method will occur to others in view of the present invention disclosure.

### Specification of Automated-Method of Generating Prescriptions for Sales Leadership to Develop the Selling Intelligence of Sales Representatives

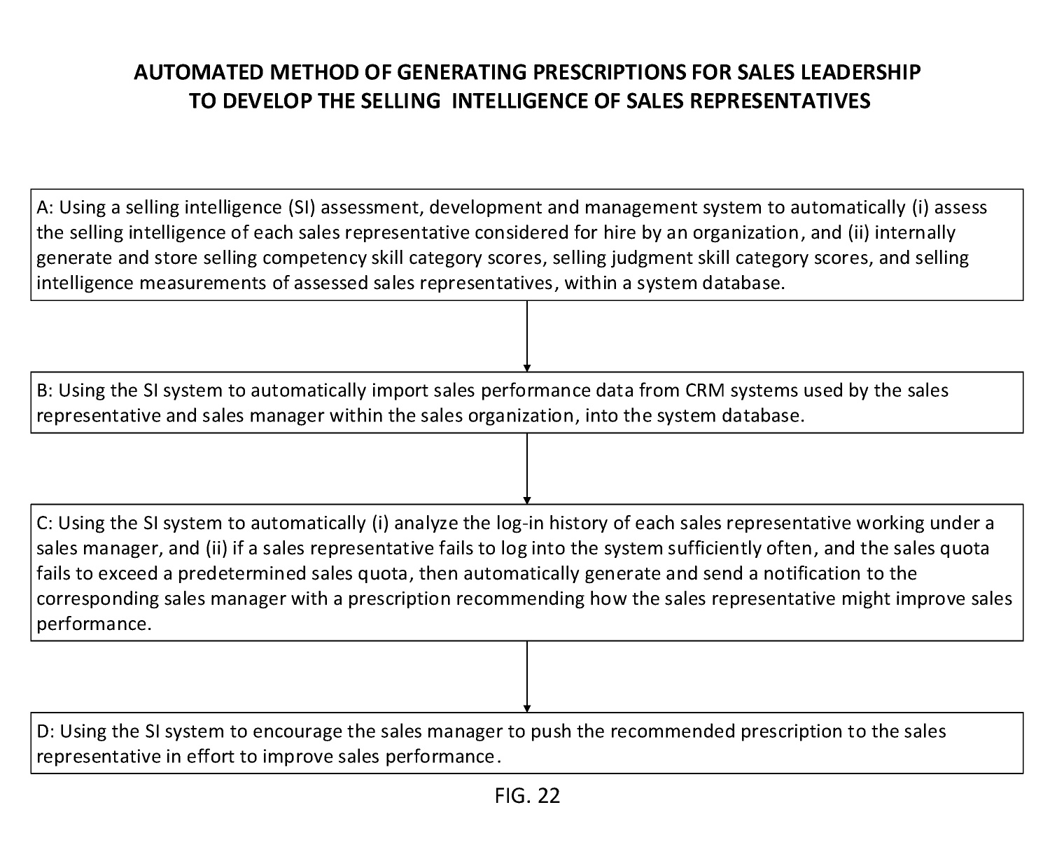

In FIG. 22, a novel suite of services is described for automatically-generating prescriptions for sales leadership to develop the selling intelligence of sales representatives, using the system network shown in FIGS. 1A, 1B, 1C, 1D, 2A, 2B and 2C. The delivery of this service method will be described below with reference to FIG. 22.

FIG. 22 describes the primary steps involved in carrying out the method comprising the steps of:

(a) using a selling intelligence (SI) assessment, development and management system to automatically (i) assess the selling intelligence of each sales representative considered for hire by an organization, and (ii) internally generate and store selling competency skill category scores, selling judgment skill category scores, and selling intelligence measurements of assessed sales representatives, within a system database;

(b) using the system to automatically import sales performance data from CRM systems used by the sales representative and sales manager within the sales organization, into the system database;

(c) using the system to automatically (i) analyze the log-in history of each sales representative working under a sales manager, and (ii) if a sales representative fails to log into the system sufficiently often, and the sales quota fails to exceed a predetermined sales quota, then automatically generate and send a notification to the corresponding sales manager with a prescription recommending how the sales representative might improve sales performance; and

(d) using the system to encourage the sales manager to push the recommended prescription to the sales representative in effort to improve sales performance.

Using the automated method supported on the system of the present invention, prescriptions for sales leadership are automatically generated to develop the selling intelligence of sales representatives using the system.

The automated method described above is carried out by sales managers and leadership using client systems 3 deployed in the service network, to access and receive the various services delivered by the method on the service network of the present invention. Variations of this particular selling intelligence based method will occur to others in view of the present invention disclosure.

### Specification of Automated Method of Generating Training Courses for Sales Representatives Based on Assessed Selling Intelligence

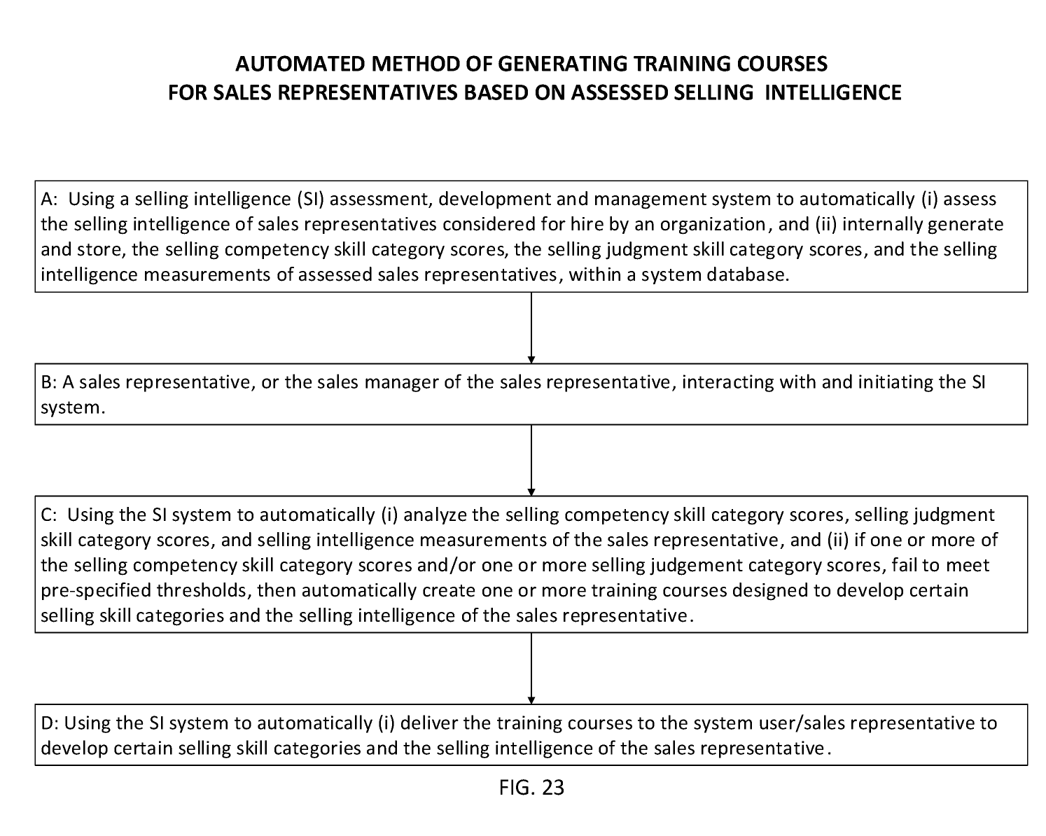

In FIG. 23, a novel suite of services is described for automatically-generating training courses for sales representatives based on assessed selling intelligence, for the purpose of certifying sales representatives in a sales industry, using the system network shown in FIGS. 1A, 1B, 1C, 1D, 2A, 2B and 2C. The delivery of this service method will be described below with reference to FIG. 23.

FIG. 23 describes the primary steps involved in carrying out the method comprising the steps of:

(a) using a selling intelligence (SI) assessment, development and management system to automatically (i) assess the selling intelligence of sales representatives considered for hire by an organization, and (ii) internally generate and store, the selling competency skill category scores, the selling judgment skill category scores, and the selling intelligence measurements of assessed sales representatives, within a system database;

(b) a sales representative, or the sales manager of the sales representative, interacting with and initiating the system;

(c) using the system to automatically (i) analyze the selling competency skill category scores, selling judgment skill category scores, and selling intelligence measurements of the sales representative, and (ii) if one or more of the selling competency skill category scores and/or one or more selling judgement category scores, fail to meet pre-specified thresholds, then automatically create one or more training courses designed to develop certain selling skill categories and the selling intelligence of the sales representative; and

(d) using the system to automatically (i) deliver the training courses to the system user/sales representative to develop certain selling skill categories and the selling intelligence of the sales representative.

Using the automated method support on the system of the present invention, training courses for sales representatives can be automatically generated based on assessed selling intelligence, for the purpose of certifying sales representatives in a sales industry using the system.

The automated method described above is carried out by individual sales representatives (e.g. employees, pre-hires, etc.) and sales managers alike using client systems 3 deployed in the service network, to access and receive the various services delivered by the method on the service network of the present invention. Variations of this particular selling intelligence based method will occur to others in view of the present invention disclosure.

Specification of Automated-Method of Generating Reports with Metrics on the Selling Intelligence, Skill Category Scores and Sales Performance of Sales Representatives within Specific Industries

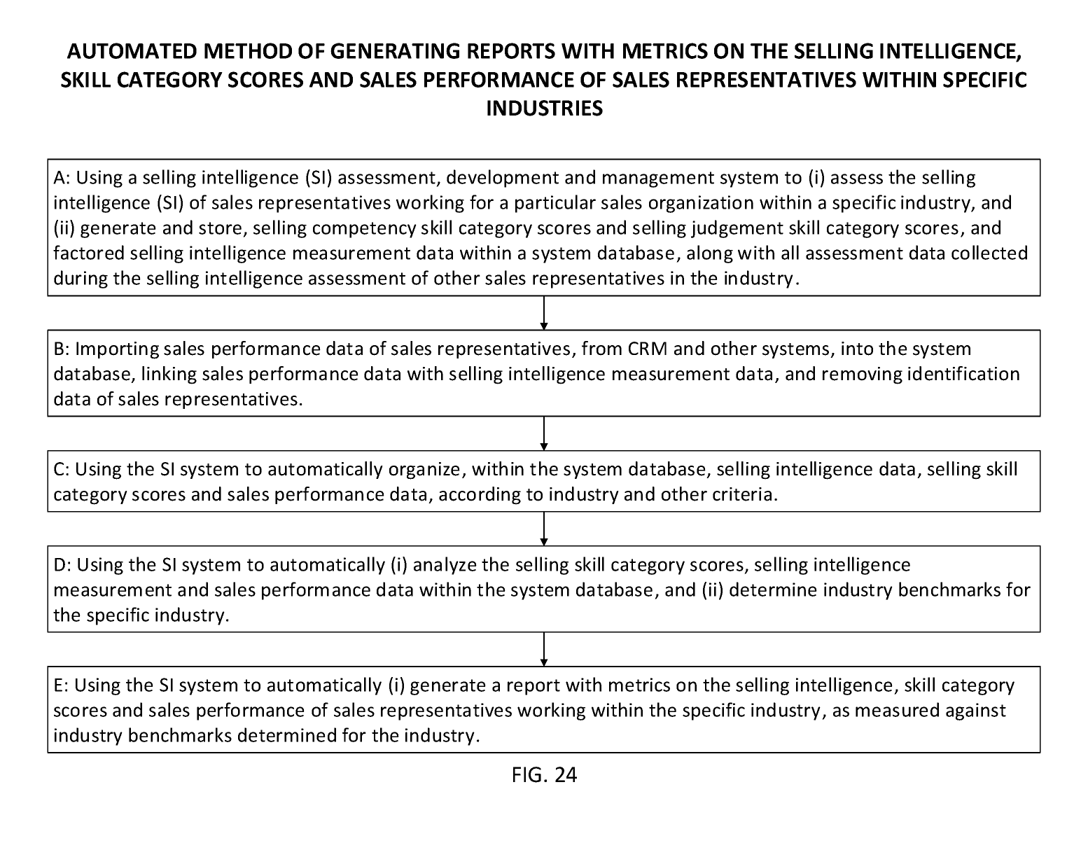

In FIG. 24, a novel suite of services is described for generating reports with metrics on the selling intelligence, skill category scores and sales performance of sales representatives working within specific industries, using the system network shown in FIGS. 1A, 1B, 1C, 1D, 2A, 2B and 2C. The delivery of this service method will be described below with reference to FIG. 24.

FIG. 24 describes the primary steps involved in carrying out the method comprising the steps of:

(a) using a selling intelligence (SI) assessment, development and management system to assess the selling intelligence (SI) of sales representatives working for a particular sales organization within a specific industry, based on factoring assessed selling competency skill category scores and selling judgement skill category scores, and storing the selling intelligence measurement data in a system database, along with all specified assessments used in assessing the selling intelligence and skills of the assessed sales representatives;

(b) importing sales performance data of sales representatives, from CRM and other systems, into the database of the system, linking sales performance data with selling intelligence measurement data, and removing identification data of sales representatives;

(c) using the system to automatically organize, within the system database, selling intelligence data, selling skill category scores and sales performance data, according to industry and other criteria;

(d) using the system to automatically (i) analyze the selling skill category scores, selling intelligence measurement and sales performance data within the system database, and (ii) determine industry benchmarks for the specific industry; and

(e) using the system to automatically (i) generate a report with metrics on the selling intelligence, skill category scores and sales performance of sales representatives working within the specific industry, as measured against industry benchmarks determined for the industry.

Using this automated method supported by the system of the present invention, reports are generated containing metrics on the selling intelligence, skill category scores and sales performance of sales representatives working within specific industries.

The automated method described above is carried out by sales managers and leadership alike using client systems 3 deployed in the service network, to access and receive the various services delivered by the method on the service network of the present invention. Variations of this particular selling intelligence based method will occur to others in view of the present invention disclosure.

Specification of Automated Method of Generating Reports with Metrics on the Selling Intelligence, Skills and Sales Performance of Sales Teams, Based on Sales Team Benchmarks

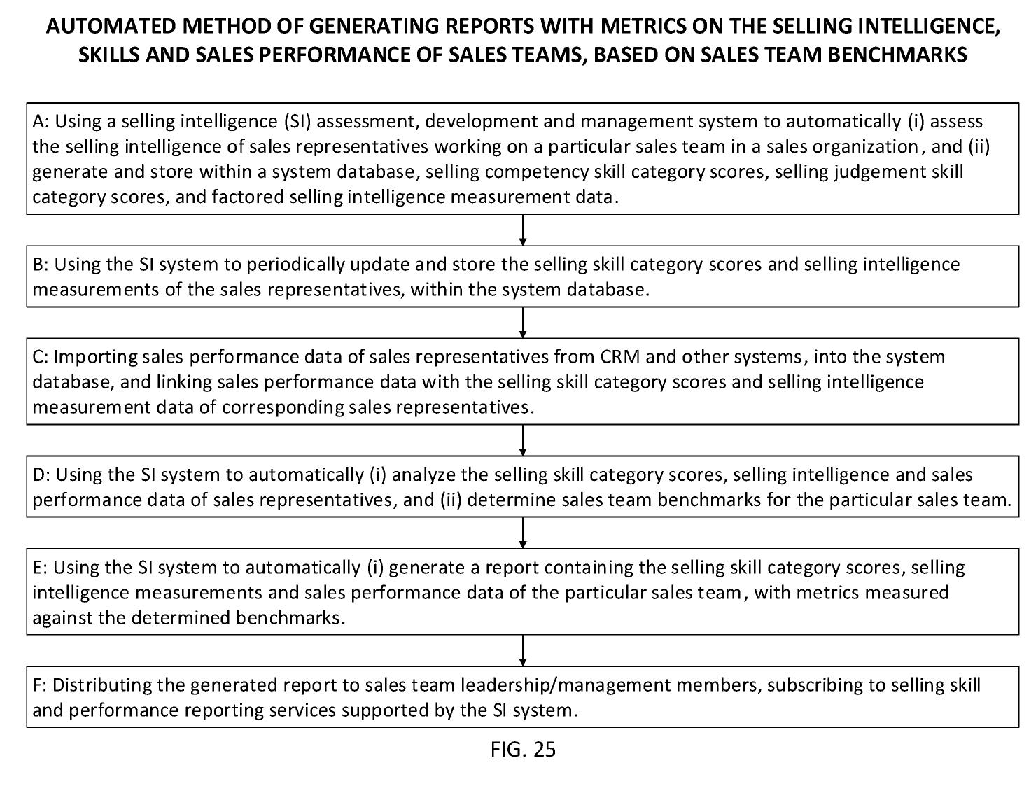

In FIG. 25, a novel suite of services is described for generating reports on the selling intelligence, skills and sales performance of sales teams, against sales team benchmarks, using the system network shown in FIGS. 1A, 1B, 1C, 1D, 2A, 2B and 2C. The delivery of this service method will be described below with reference to FIG. 25.

FIG. 25 describes the primary steps involved in carrying out the method comprising the steps of:

(a) using a selling intelligence (SI) assessment, development and management system to automatically (i) assess the selling intelligence of sales representatives working on a particular sales team in a sales organization, and (ii) generate and store within a system database, selling competency skill category scores, selling judgement skill category scores, and factored selling intelligence measurement data;

(b) using the SI system to periodically update and store the selling skill category scores and selling intelligence measurements of the sales representatives, within the system database;

(c) importing sales performance data of sales representatives from CRM and other systems, into the system database, and linking sales performance data with the selling skill category scores and selling intelligence measurement data of corresponding sales representatives;

(d) using the system to automatically (i) analyze the selling skill category scores, selling intelligence and sales performance data of sales representatives, and (ii) determine sales team benchmarks for the particular sales team;

(e) using the system to automatically (i) generate a report containing the selling skill category scores, selling intelligence measurements and sales performance data of the particular sales team, with metrics measured against the determined benchmarks; and

(f) distributing the generated report to sales team leadership/management members, subscribing to selling skill and performance reporting services supported by the system.

Using this automated method supported on the system of the present invention, reports are generated containing on the selling intelligence, skills and sales performance of sales teams, against sales team benchmarks.

The automated method described above is carried out by sales managers and leadership alike using client systems 3 deployed in the service network, to access and receive the various services delivered by the method on the service network of the present invention. Variations of this particular selling intelligence based method will occur to others in view of the present invention disclosure.

Specification of Automated Method of Generating Certified Selling Intelligence, Skill Competency and Judgement Reports on Particular Sales Representatives Working within a Specific Industry

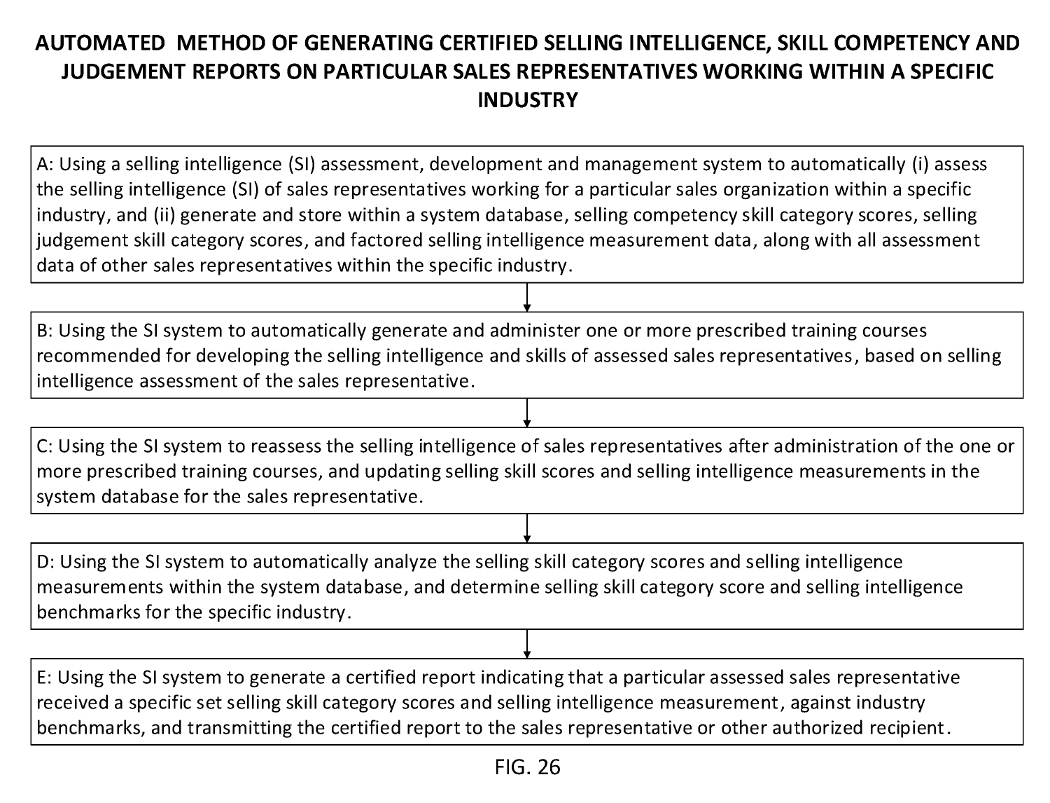

In FIG. 26, a novel suite of services is described for generating certified selling intelligence and skill reports on particular sales representatives working within a specific industry, using the system network shown in FIGS. 1A, 1B, 1C, 1D, 2A, 2B and 2C. The delivery of this service method will be described below with reference to FIG. 26.

FIG. 26 describes the primary steps involved in carrying out the method comprising the steps of:

(a) using a selling intelligence (SI) assessment, development and management system to automatically (i) assess the selling intelligence (SI) of sales representatives working for a particular sales organization within a specific industry, and (ii) generate and store within a system database, selling competency skill category scores, selling judgement skill category scores, and factored selling intelligence measurement data, along with all assessment data of other sales representatives within the specific industry;

(b) using the system to automatically generate and administer one or more prescribed training courses recommended for developing the selling intelligence and skills of assessed sales representatives, based on selling intelligence assessment of the sales representative;

(c) using the system to reassess the selling intelligence of sales representatives after administration of the one or more prescribed training courses, and updating selling skill scores and selling intelligence measurements in the system database for the sales representative;

(d) using the system to automatically analyze the selling skill category scores and selling intelligence measurements within the system database, and determine selling skill category score and selling intelligence benchmarks for the specific industry; and

(e) using the system to generate a certified report indicating that a particular assessed sales representative received a specific set selling skill category scores and selling intelligence measurement, against industry benchmarks, and transmitting the certified report to the sales representative or other authorized recipient.

Using the automated method supported by the system of the present invention, certified selling intelligence and skill reports are generated on particular sales representatives working within a specific industry.

The automated method described above is carried out by sales representatives, sales managers and leadership alike using client systems 3 deployed in the service network, to access and receive the various services delivered by the method on the service network of the present invention. Variations of this particular selling intelligence based method will occur to others in view of the present invention disclosure.

Specification of Automated Method of Generating Industry-Specific Selling Intelligence, Skill and Performance Reports with Metrics Comparing Competing Sales Teams within a Particular Industry

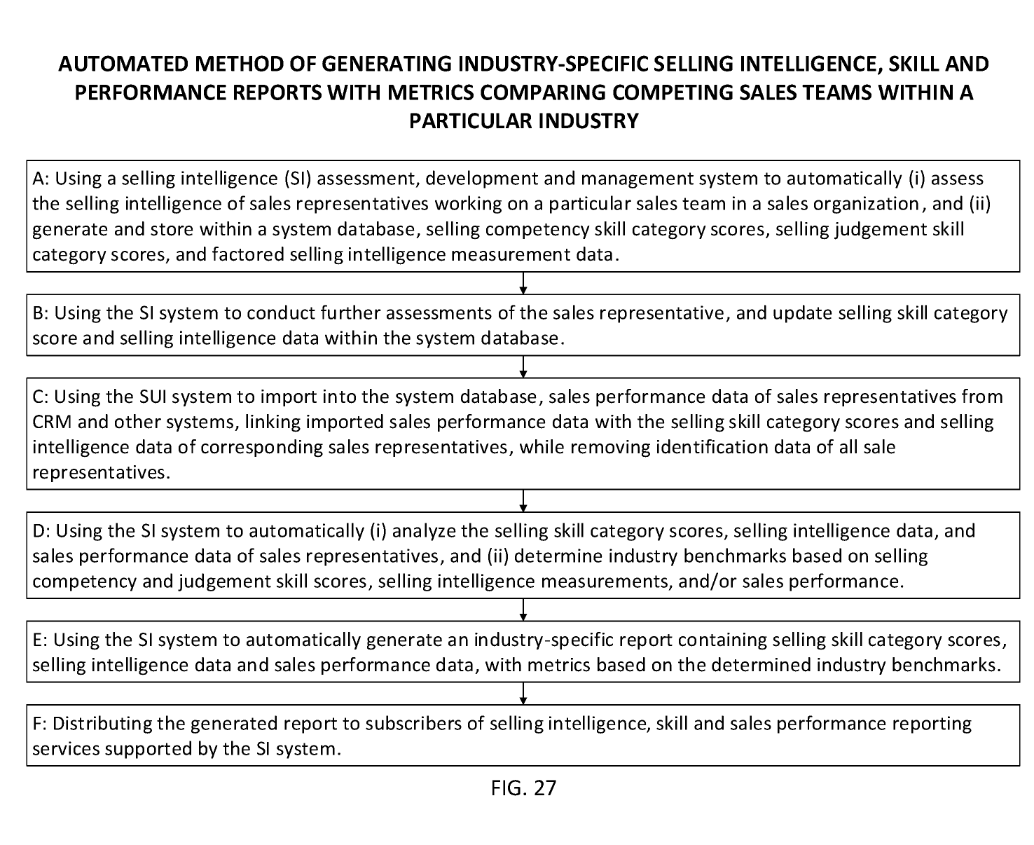

In FIG. 27, a novel suite of services is described for generating industry-specific selling intelligence, skill and performance reports with metrics comparing competing sales teams within a particular industry, using the system network shown in FIGS. 1A, 1B, 1C, 1D, 2A, 2B and 2C. The delivery of this service method will be described below with reference to FIG. 27.

FIG. 27 describes the primary steps involved in carrying out the method comprising the steps of:

(a) using a selling intelligence (SI) assessment, development and management system to automatically (i) assess the selling intelligence of sales representatives working on a particular sales team in a sales organization, and (ii) generate and store within a system database, selling competency skill category scores, selling judgement skill category scores, and factored selling intelligence measurement data;

(b) using the system to conduct further assessments of the sales representative, and update selling skill category score and selling intelligence data within the system database;

(c) using the system to import into the system database, sales performance data of sales representatives from CRM and other systems, linking imported sales performance data with the selling skill category scores and selling intelligence data of corresponding sales representatives, while removing identification data of all sale representatives;

(d) using the system to automatically (i) analyze the selling skill category scores, selling intelligence data, and sales performance data of sales representatives, and (ii) determine industry benchmarks based on selling competency and judgement skill scores, selling intelligence measurements, and/or sales performance;

(e) using the system to automatically generate an industry-specific report containing selling skill category scores, selling intelligence data and sales performance data, with metrics based on the determined industry benchmarks; and

(f) distributing the generated report to subscribers of selling intelligence, skill and sales performance reporting services supported by the system.

Using the automated method supported on the system of the present invention, industry-specific selling intelligence, skill and performance reports are generated containing metrics comparing competing sales teams within a particular industry.

The automated method described above is carried out by sales managers and leadership alike using client systems 3 deployed in the service network, to access and receive the various services delivered by the method on the service network of the present invention. Variations of this particular selling intelligence based method will occur to others in view of the present invention disclosure.

### Other Applications of the System, Network and Method of the Present Invention

The system and network of the present invention has been described for use in assessing, developing and managing a person's selling intelligence as described herein. However, the system and network can be applied to assessing, developing and managing diverse kinds of field-specific intelligence, beyond the field of sales and selling, in which “selling intelligence (SI)” is employed during the pursuit of success in this specific field.

Examples of “field-specific intelligence” would include the following: financial intelligence dependent upon a person's financial competency skills and financial judgement skills; engineering intelligence dependent upon a person's engineering competency skills and engineering judgement skills; medical intelligence dependent upon a person's medical competency skills and medical judgement skills; marketing intelligence dependent upon a person's marketing competency skills and marketing judgement skills; legal intelligence dependent upon a person's legal competency skills and legal judgement skills; government intelligence dependent upon a person's government competency skills and government judgement skills; and investment intelligence dependent upon a person's investment competency skills and investment judgement skills.

### Specification of Engineering-Specific Competency Skill Category Schema for Use in the System of the Present Invention

FIG. 28A shows an exemplary skill category schema (i.e. list of skill categories) pertaining to engineering competency assessed by the assessment scoring submodule of the system network, for the purpose of assessing and measuring engineering competency skills for use in automated measurement and computation of engineering intelligence (EI). As shown, the engineering competency skill categories include: EC1—Stem Skills EC2—Math, EC3—Tech, EC4—Science; EC5—Team Work; EC6—Open Mindness; EC7—Attention To Detail; EC8—Sociability; EC9—Desire To Learn; EC10—Leadership; EC11—CAD Skills; EC12—Creative Thinking; EC13—Self-Starter; EC14—Creativity; EC15—Computer Skills; EC16—Curiosity; EC17—Patience; EC18—Persistence; EC19—Self-Confidence; EC20—Risk-Taking/Bold; EC-21—Indifferent To Social Peer Pressure; . . .

### Specification of Engineering-Specific Judgement Skill Category Schema for Use in the System of the Present Invention

FIG. 28B shows an exemplary skill category schema (i.e. list of skill categories) pertaining to engineering judgement assessed by the assessment scoring submodule of the system network, for the purpose of assessing and measuring engineering judgement skills for use in automated measurement and computation of engineering intelligence (EI). Engineering judgement skill categories include: EJ1—Signal and Systems, EJ2—Linear Time-Invariant Systems, EJ3—Higher-Order Systems, and EJ4—Predicting System Behavior; EJ5—Circuits, EJ6—Kirchoff s Laws, EJ7—NVCC method, EJ8—Op Amps, EJ9—Solution Strategy; EJ10—State Machines, EJ11—Primitive State Machines, EJ12—Parallel Composition, EJ13—Square Spiral, . . .

### Specification of Financial-Specific Competency Skill Category Schema for Use in the System of the Present Invention

FIG. 29A shows an exemplary skill category schema (i.e. list of skill categories) pertaining to financial competency assessed by the assessment scoring submodule of the system network, for the purpose of assessing and measuring financial competency skills for use in automated measurement and computation of financial intelligence (FI). Financial competency skill categories include: FC1—Communication; FC2—Problem Solving; FC3—Listening; FC4—Organized; FC5—Positivity; C6—Open Mindedness; FC7—Ethical; FC8—Sociability; FC9—Integrity; FC10—Customer Relations; FC11—Tech Skills; FC12—Work Ethic; FC13—Self Starter; FC14—Initiative; FC15—Math Skills; . . .

### Specification of Financial-Specific Judgement Skill Category Schema for Use in the System of the Present Invention

FIG. 29B shows an exemplary skill category schema (i.e. list of skill categories) pertaining to financial judgement assessed by the assessment scoring submodule of the system network, for the purpose of assessing and measuring financial judgement skills for use in automated measurement and computation of financial intelligence (FI). Financial judgement skill categories include: FJ1—Finance Foundation, FJ2—Value Line Investment, FJ3—Economics/Trends, FJ4—Stock Basics; FJ5—Investment, FJ6—Capital Investment, FJ7—Project Analysis, FJ8—market History, FJ9—Dividends and Payout Policy; FJ10—Capital, FJ11—Leverage, FJ12—Return, Risk and Security Market Line, FJ13—Cost of Capital; . . .

For the other field-specific intelligence applications for the present invention, it will be necessary to produce field-specific competency skill category schemas, and field-specific judgment skill category schemas, as described in great detail above for selling intelligence (SI), and also in lesser technical detail for engineering intelligence (EI) and financial intelligence (FI) above. Once these skill category (SC) schemas are created and coded for the field-specific intelligence at hand, the SC schemas are loaded into system memory, along with other libraries supporting assessments and prescriptions, and other system interface enabling code, during set up and configuration of the system.

Some Modifications that Readily Come to Mind

The selling intelligence assessment, development and management system 2 of the present invention has been shown and described above with a “company/team” subscription model in mind, in which a company registers with the system and signs up its sales team members, including sales representatives, managers and corporate leadership to receive assessment, development and management services served from the system network. In this deployment configuration or model, the selling competency (SC) skill category scores and selling judgement (SJ) skill category scores automatically generated by the assessment module 31 of the system 2 will be typically ranked (and compared) against the SC skill category scores and SJ skill category scores of fellow company team members, against whom the sales representative (or new pre-hire) will be compared for purposes of benchmarking, metrics calculation and selling intelligence (SI) measure computation, in accordance with the principles of the present invention. However, such SC and SJ skill category scores will be compared against competing members in the same industry when industry reports using metrics and benchmarks are automatically generated from the reporting module 32 of the system 2, as described in great detail above.

However, other deployment configurations for the system of the present invention readily come to mind, specifically, where individuals, not employed by or affiliated with any company, corporation or organization multiple team and/or organization members, desire to subscribe to the selling intelligence (SI) service network of the present invention. With this “individual” subscription model in mind, an individual registers with the system and signs up only one member as a sales representative, and a virtual sales manager and a virtual corporate leader are generated within the prescription module 33, to support the SI development and management services provided to the individual sales representative/agent on the system network.

Optionally, the individual sales representative can also enable virtual team-mates against whom to compete in competitions, based on anonymous data collected from the individual's industry, and used to construct virtual team-mates. In this deployment configuration or model, the selling competency (SC) skill category scores and selling judgement (SJ) skill category scores automatically generated by the assessment module 31 of the system 2 will be typically ranked (and compared) against the SC skill category scores and SJ skill category scores of industry competitors members, against whom the individual sales representative will be compared for purposes of benchmarking, metrics calculation and selling intelligence (SI) measure computation. Also, such SC and SJ skill category scores will be compared against competing members in the same industry when industry reports using metrics and benchmarks are automatically generated from the reporting module 32 of the system 2, as described in great detail above. Data anonymity filters will be used in this deployment environment to protect the identity of industry competitors whose SC and SJ skill category scores are used in the ranking the SC and SJ skill category scores of the individual sales representative subscribing to the SI-based service network of the present invention. In this deployment configuration, the individual sales representative will be able to set up preferences for the virtual sales manager, virtual corporate leader and virtual team-mates, so that these virtual actors (i.e. avatars) exhibit a style and manner which suits the individual sales representative subscribing to the SI-based service network.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

1. A system for assessing, developing and managing the selling intelligence of one or more sales representatives in a sales organization, said system comprising:
an assessment module for (i) assessing and scoring the selling competency skills and the selling judgement skills of sales representatives, including pre-hires and employees and producing selling competency scores and selling judgment scores, (ii) storing said selling competency scores and said selling judgment scores, (iii) processing said selling competency skill scores and said selling judgement skill scores of each sales representative so as to produce a selling intelligence measure for each said sales representative, and (iv) storing said selling intelligence scores for said sales representatives;
a reporting module for generating, storing and presenting reports to sales representatives and sales leadership members, wherein said reports containing selling intelligence measures of said sales representatives; and
a prescription module for (i) generating prescriptions based on said selling intelligence measure generated by said assessment module, (ii) storing said prescriptions, and (iii) providing said prescriptions to said sales representatives so to help improve the selling intelligence of said sales representatives.

2. The system of claim 1, wherein said assessment module includes an assessment interface submodule, an assessment scoring submodule, and an assessment data storage submodule;
wherein said assessment interface submodule delivers assessments to sales representatives, and collects assessment results data from sales representatives whose selling competency skills and selling judgement skills are assessed by said system;
wherein said assessment scoring submodule includes (i) a selling competency scoring submodule for scoring assessments of selling competency skills of sales representatives, (ii) a selling judgment scoring submodule for scoring assessments of selling judgement skills of sales representatives, and (iii) a selling intelligence scoring submodule for measuring and measuring the selling intelligence of each said sales representatives by processing said selling competency score and said selling judgement score of said sales representative, and generating a selling intelligence measure for said selling representative; and
wherein said assessment data storage submodule for storing said selling competency scores, said selling judgment scores, and said selling intelligence measures.

3. The system of claim 2, wherein said reporting module including a reporting interface submodule, a reporting processing submodule, and a reporting data storage submodule;
wherein said reporting interface submodule presents reports to sales representatives and managers;
wherein said reporting processing submodule processes stored data and generates said reports; and
wherein said reporting data storage submodule stores data relating to reports generated by said reporting processing submodule.

4. The system of claim 3, wherein said prescription module including a prescription interface submodule, a prescription processing submodule, and prescription data storage submodule;
wherein said prescription interface submodule presents prescriptions to sales representatives to develop the selling intelligence of said sales representatives;
wherein said prescription processing submodule processes stored data and generates said prescriptions; and
wherein said prescription data storage submodule stores data relating to said prescriptions.

5. The system of claim 1, wherein said prescriptions comprise one or more of the following service interfaces selected from the group consisting of
(i) a competition scoreboard illustrating the ranked standing of sales representatives competing against each other in said system,
(ii) achievements given to system users, including sales representatives and pre-hires, for completing tasks on said system,
(iii) courses designed for sales representatives to improve their selling competency skills, selling judgement skills and also selling intelligence,
(iv) coaching given to system users to improve selling performance, and
(v) feedback advising sales managers how to improve the selling competency skills and selling judgement skills of sales representatives.

6. The system of claim 5, wherein said competition scoreboard is a prescription generated and maintained by said prescription module.

7. The system of claim 5, wherein said achievements are generated and maintained by said prescription module.

8. The system of claim 5, wherein said courses are automatically generated by said prescription module.

9. The system of claim 5, wherein said courses are manually generated by said prescription module.

10. The system of claim 5, wherein said coaching is generated for a sales manager by said prescription module.

11. The system of claim 5, wherein said coaching is generated for a sales representative by said prescription module.

12. The system of claim 5, wherein said feedback messages are generated by said prescription module.

13. The system of claim 2, wherein said assessment data storage submodule further stores data relating to said assessments including multiple choice tests, conversation-based simulations, and game-based simulations;
wherein said reporting data storage submodule further stores data relating to scoring, users, surveys and user performance; and
wherein said prescription data storage submodule further stores data relating to scoreboards, achievements, and courses.

14. The system of claim 13, wherein said assessment interface submodule, said reporting interface submodule and said prescription interface submodule form a system interface layer; and
wherein said assessment scoring submodule, said reporting processing submodule, and said prescription processing submodule form a scoring and processing layer, and
wherein said assessment data storage submodule, said reporting data storage submodule, and prescription data storage submodule forms a data storage layer.

15. The system of claim 14, wherein said system interface layer is implemented using a plurality of client systems operably connected to the infrastructure of a distributed communication network;
wherein each said client subsystem has a display screen for displaying graphical user interfaces (GUIs) supporting a plurality of selling intelligence assessment, development and management services provided to system users, including sales representatives and managers, registered on said system network; and
wherein said scoring and processing layer and said data storage layer are implemented using one or more data centers operably connected to the infrastructure of said distributed communication network.

16. The system of claim 15, wherein each said data center includes:
(i) a one or more communication servers, operably connected to the infrastructure of the said distributed communication network, for supporting communication protocols on said system network;
(ii) an information file storage and retrieval system, operably connected to the infrastructure of the said distributed communication network, and including (i) one or more database servers for organizing information files associated with information objects organized and managed on said system network for supporting said plurality of selling intelligence assessment, development and management services, and (ii) information storage devices for storing the information files associated with said information objects; and
(iii) one or more application servers operably connected to the infrastructure of said distributed communication network and said information file storage and retrieval system, for supporting a client-side, server-side and GUI-based environment for system users requesting and receiving selling intelligence assessment, development and management services supported on said system network;
wherein each said client subsystem supports the client-side of said system generated by said one or application servers;
wherein said application servers support the server-side of said system so that system users can receive services through said GUI screens displayed on said client systems;

17. The system of claim 15, wherein said client systems are selected from the group consisting of tablet computers, desktop computers, laptop computers, tablet computers, mobile devices, and VR gaming systems.

18. The system of claim 15, wherein each said client system comprises: a CPU, program memory, a video memory; a hard drive; a display panel; a microphone/speaker; and a keyboard.

19. The system of claim 15, wherein each said client system includes one or more devices selected from the group consisting of a keyboard, a screen display, a pointing mouse, and VR goggles, VR game controllers, speech recognition, eye-trackers, heart-rate sensing, bio-sensing, a video camera, a touch-screen graphical interface, a GPS positioning system, a temperature sensor, a biometric sensor, a gyroscope, an audio subsystem coupled to a speaker and a microphone to facilitate voice-enabled functions, such as voice recognition, voice replication, digital recording, and telephony functions, and subsystems that can be coupled to the system user interface to facilitate multiple functionalities.

20. The system of claim 1, wherein said system supports a data hierarchy comprising different layers of data comprising: (i) assessment result data collected assessments of sales representatives; (ii) selling judgement skills data, and selling competency skills data, both data types being derived from collected assessment result data; (iii) selling intelligence data derived from processing selling judgment data and selling competency data; (iv) system automated prescriptions based on computed selling intelligence data; (v) report data supplied from selling intelligence data and user performance user tracking and other internal systems data; and (vi) user performance data, user tracking and other internal systems data.

21-186. (canceled)
